(19) United States
(12) Patent Application Publication
(10) Pub. No.: US 2026/0115598 A1
(43) Pub. Date: Apr. 30, 2026

(54) ASSOCIATED VIRTUAL OBJECT CONTROL

(71) Applicant: TENCENT TECHNOLOGY (SHENZHEN) COMPANY LIMITED, Shenzhen (CN)

(72) Inventors: Fenlin CAI, Shenzhen (CN); Liebin GU, Shenzhen (CN); Jiajun WU, Shenzhen (CN); Xiao WANG, Shenzhen (CN); Jiakun SHAO, Shenzhen (CN)

(73) Assignee: TENCENT TECHNOLOGY (SHENZHEN) COMPANY LIMITED, Shenzhen, GD (CN)

(21) Appl. No.: 19/431,695

(22) Filed: Dec. 23, 2025

Related U.S. Application Data
(63) Continuation of application No. 18/740,451, filed on Jun. 11, 2024.
Application No. 18/740,451 is a continuation of application No. PCT/CN2023/071526, filed on Jan. 10, 2023.

(30) Foreign Application Priority Data
Jan. 11, 2022 (CN) 202210028158.4
Apr. 7, 2022 (CN) 202210363870.X
Apr. 7, 2022 (CN) 202210364179.3
Apr. 7, 2022 (CN) 202210364186.3
Apr. 7, 2022 (CN) 202210364187.8
Apr. 7, 2022 (CN) 202210365169.1
Apr. 7, 2022 (CN) 202210365548.0
Apr. 7, 2022 (CN) 202210365549.5
Apr. 7, 2022 (CN) 202210365550.8

(51) Int. Cl. A63F 13/56; A63F 13/537; A63F 13/837

(52) U.S. Cl. CPC A63F 13/56; A63F 13/537; A63F 13/837

(57) ABSTRACT

In a method for controlling an associated virtual object, a virtual scene of a virtual environment including a first virtual object is output for display. The first virtual object is controlled to move in the virtual environment. A state of the associated virtual object of the first virtual object is controlled to switch between a first state and a second state based on a first user input. The associated virtual object is output for display based on the state of the associated virtual object. In the first state, the associated virtual object is carried by the first virtual object and configured to perform a first function. In the second state, the associated virtual object is configured to move separately from the first virtual object and perform a second function that is different from the first function.

### CROSS-REFERENCE TO RELATED APPLICATIONS

This application is a continuation of U.S. application Ser. No. 18/740,451, filed on Jun. 11, 2024, which is a continuation of International Application No. PCT/CN2023/071526, filed on Jan. 10, 2023, and which claims priority to Chinese Patent Application No. 202210028158.4, filed on Jan. 11, 2022 and entitled “METHOD AND APPARATUS FOR CONTROLLING COMPANION OBJECT, DEVICE, AND STORAGE MEDIUM IN VIRTUAL SCENE”; Chinese Patent Application No. 202210363870.X, filed on Apr. 7, 2022 and entitled “METHOD AND APPARATUS FOR PROCESSING SPECIAL EFFECTS PROP, DEVICE, AND COMPUTER-READABLE STORAGE MEDIUM”; Chinese Patent Application No. 202210365169.1, filed on Apr. 7, 2022 and entitled “METHOD AND APPARATUS FOR CONTROLLING VIRTUAL OBJECT, DEVICE, STORAGE MEDIUM, AND PROGRAM PRODUCT”; Chinese Patent Application No. 202210364186.3, filed on Apr. 7, 2022 and entitled “METHOD AND APPARATUS FOR USING VIRTUAL SHIELD, DEVICE, AND STORAGE MEDIUM”; Chinese Patent Application No. 202210364179.3, filed on Apr. 7, 2022 and entitled “EXPLORATION METHOD AND APPARATUS, DEVICE, MEDIUM, AND PROGRAM PRODUCT IN VIRTUAL WORLD”; Chinese Patent Application No. 202210364187.8, filed on Apr. 7, 2022 and entitled “METHOD AND APPARATUS FOR CONTROLLING VIRTUAL OBJECT, DEVICE, STORAGE MEDIUM, AND PROGRAM PRODUCT”; Chinese Patent Application No. 202210365549.5, filed on Apr. 7, 2022 and entitled “METHOD AND APPARATUS FOR CONTROLLING VIRTUAL OBJECT, DEVICE, STORAGE MEDIUM, AND PROGRAM PRODUCT”; Chinese Patent Application No. 202210365548.0, filed on Apr. 7, 2022 and entitled “METHOD AND APPARATUS FOR MANAGING VIRTUAL OBJECT, DEVICE, AND COMPUTER-READABLE STORAGE MEDIUM”; and Chinese Patent Application No. 202210365550.8, filed on Apr. 7, 2022 and entitled “METHOD AND APPARATUS FOR DISPLAYING VIRTUAL OBJECT, ELECTRONIC DEVICE, AND STORAGE MEDIUM”, which are incorporated herein by reference in their entirety.

### FIELD OF THE TECHNOLOGY

This disclosure relates to the technical field of human-computer interaction, and including to a method and an apparatus for controlling a companion object, a terminal device, a computer-readable storage medium, and a computer program product.

### BACKGROUND OF THE DISCLOSURE

In a virtual scene of a game, a battle process between different virtual objects can be simulated.

In the related art, in a case that a user-controlled virtual object has a summoning skill, an additional companion object may be summoned to participate in the interaction, thereby creating a combat synergy effect to expand more possibilities and experiences.

In a case that the user needs to control a plurality of objects (virtual object+at least one companion object) simultaneously, the human-computer interaction scheme provided in the related art is relatively complicated, which leads to a case that the user cannot take in to account the plurality of objects simultaneously, and may cause a case of attending to one thing while losing attention of another.

### SUMMARY

Embodiments of this disclosure provide a method and an apparatus for controlling a companion object, a terminal device, a non-transitory computer-readable storage medium, and a computer program product.

According to an aspect of the embodiments of this disclosure, a method for controlling a companion object is provided. In the method for controlling a companion object, a virtual scene is displayed. The virtual scene includes a first virtual object and a companion object of the first virtual object. The companion object is configured to switch between a first state and a second state. The companion object is controlled to switch between the first state and the second state. When the companion object is in the first state, the companion object is in a first form that is attached to the first virtual object. When the companion object is in the second state, the companion object is (i) in a second form that is not attached to the first virtual object and (ii) configured to move separately from the first virtual object, the first form of the companion object being different from the second form of the companion object.

According to another aspect of the embodiments of this disclosure, an apparatus for controlling a companion object is provided. The apparatus includes processing circuitry that is configured to display a virtual scene. The virtual scene includes a first virtual object and a companion object of the first virtual object. The companion object is configured to switch between a first state and a second state. The processing circuitry is configured to control the companion object to switch between the first state and the second state. When the companion object is in the first state, the companion object is in a first form that is attached to the first virtual object. When the companion object is in the second state, the companion object is (i) in a second form that is not attached to the first virtual object and (ii) configured to move separately from the first virtual object, the first form of the companion object being different from the second form of the companion object.

According to another aspect of the embodiments of this disclosure, a non-transitory computer-readable storage medium is provided, including instructions which when executed by a processor cause the processor to perform the method for controlling the companion object.

According to another aspect of the embodiments of this disclosure, a computer device is provided, including a processor and a memory, the memory storing a computer program, the processor being configured to perform the foregoing method by invoking the computer program stored in the memory.

According to another aspect of the embodiments of this disclosure, a computer program product is provided, including a computer program, the computer program, when executed by a processor, implementing the foregoing method.

The embodiments of this disclosure can have the following beneficial effects:

The companion object of the first virtual object is controlled to switch between the first state and the second state, so that at least one companion object can adapt to different requirements of users in various states, and personalized functions can be provided to the users. For example, in a manner of being attached to the first virtual object in the first form, the companion object can be prevented from exposing the field of view of the first virtual object when following the first virtual object, or prevented from blocking a movement path of the first virtual object in a case that a user controls movement of the first virtual object, and in the second state, can assist the first virtual object in performing tasks such as scouting and patrol, thereby improving efficiency of human-computer interaction and increasing the diversity of interaction.

### BRIEF DESCRIPTION OF THE DRAWINGS

FIG. 1 is a schematic diagram of an application mode of a method for controlling a companion object according to an embodiment of this disclosure.

FIG. 2 is a schematic diagram of an application mode of a method for controlling a companion object according to an embodiment of this disclosure.

FIG. 3 is a schematic structural diagram of a terminal device according to an embodiment of this disclosure.

FIG. 4 is a schematic flowchart of a method for controlling a companion object according to an embodiment of this disclosure.

FIG. 5 is a schematic flowchart of a method for controlling a companion object according to an embodiment of this disclosure.

FIG. 6 is a schematic flowchart of a method for controlling a companion object according to an embodiment of this disclosure.

FIG. 7 is a schematic diagram of an application scene of a method for controlling a companion object according to an embodiment of this disclosure.

FIG. 8 is a schematic diagram of an application scene of a method for controlling a companion object according to an embodiment of this disclosure.

FIG. 9 is a schematic diagram of an application scene of a method for controlling a companion object according to an embodiment of this disclosure.

FIG. 10 is a schematic diagram of an application scene of a method for controlling a companion object according to an embodiment of this disclosure.

FIG. 11 is a schematic diagram of an application scene of a method for controlling a companion object according to an embodiment of this disclosure.

FIG. 12 is a schematic flowchart of a method for controlling a companion object according to an embodiment of this disclosure.

FIG. 13 is a schematic diagram of an application scene of a method for controlling a companion object according to an embodiment of this disclosure.

FIG. 14 is a schematic diagram of summoning a companion object according to an embodiment of this disclosure.

FIG. 15 is a schematic diagram of an application scene of summoning a companion object according to an embodiment of this disclosure.

FIG. 16 is a schematic diagram of an application scene of a method for controlling a companion object according to an embodiment of this disclosure.

FIG. 17 is a schematic diagram of an application scene of a method for controlling a companion object according to an embodiment of this disclosure.

FIG. 18 is a schematic diagram of an application scene of a method for controlling a companion object according to an embodiment of this disclosure.

FIG. 19 is a schematic diagram of an application scene of a method for controlling a companion object according to an embodiment of this disclosure.

FIG. 20 is a schematic diagram of an application scene of a method for controlling a companion object according to an embodiment of this disclosure.

FIG. 21 is a schematic flowchart of summoning a companion object according to an embodiment of this disclosure.

FIG. 22 is a schematic flowchart of controlling conversion of a companion object from a first state to a second state according to an embodiment of this disclosure.

FIG. 23 is a schematic diagram of an application scene of a scouting method according to an embodiment of this disclosure.

FIG. 24 is a schematic flowchart of a scouting method according to an embodiment of this disclosure.

FIG. 25 is a schematic flowchart of a scouting method according to an embodiment of this disclosure.

FIG. 26 is a schematic diagram of an application scene of a scouting method according to an embodiment of this disclosure.

FIG. 27 is a schematic diagram of an application scene of a scouting method according to an embodiment of this disclosure.

FIG. 28 is a schematic diagram of a map display control according to an embodiment of this disclosure.

FIG. 29 is a schematic diagram of an application scene of a scouting method according to an embodiment of this disclosure.

FIG. 30 is a schematic flowchart of a scouting method according to an embodiment of this disclosure.

FIG. 31 is a schematic flowchart of a scouting method according to an embodiment of this disclosure.

FIG. 32 is a schematic diagram of an application scene of a scouting method according to an embodiment of this disclosure.

FIG. 33 is a schematic diagram of an application scene of a scouting method according to an embodiment of this disclosure.

FIG. 34 is a schematic flowchart of a scouting method according to an embodiment of this disclosure.

FIG. 35 is a schematic diagram of a form change of a companion object according to an embodiment of this disclosure.

FIG. 36 is a schematic diagram of an application scene of a scouting method according to an embodiment of this disclosure.

FIG. 37 is a schematic diagram of a form change of a companion object according to an embodiment of this disclosure.

FIG. 38 is a schematic diagram of an application scene of a scouting method according to an embodiment of this disclosure.

FIG. 39 is a schematic diagram of an application scene of a scouting method according to an embodiment of this disclosure.

FIG. 40 is a schematic diagram of detection according to an embodiment of this disclosure.

FIG. 41 is a schematic diagram of detection according to an embodiment of this disclosure.

FIG. 42 is a schematic flowchart of a method for controlling a companion object according to an embodiment of this disclosure.

FIG. 43 is an interface diagram of using a virtual shield monster according to an embodiment of this disclosure.

FIG. 44 is a flowchart of a method for using a virtual shield according to an embodiment of this disclosure.

FIG. 45 is a flowchart of a method for using a virtual shield according to an embodiment of this disclosure.

FIG. 46 is an interface diagram of using a virtual shield according to an embodiment of this disclosure.

FIG. 47 is an interface diagram of using a virtual shield according to an embodiment of this disclosure.

FIG. 48 is a flowchart of a method for using a virtual shield according to an embodiment of this disclosure.

FIG. 49 is a flowchart of a method for using a virtual shield according to an embodiment of this disclosure.

FIG. 50 is an interface diagram of using a virtual shield according to an embodiment of this disclosure.

FIG. 51 is a flowchart of a method for using a virtual shield according to an embodiment of this disclosure.

FIG. 52 is an interface diagram of using a virtual shield according to an embodiment of this disclosure.

FIG. 53 is an interface diagram of using a virtual shield according to an embodiment of this disclosure.

FIG. 54 is a flowchart of a method for using a virtual shield according to an embodiment of this disclosure.

FIG. 55 is a flowchart of a method for using a virtual shield according to an embodiment of this disclosure.

FIG. 56 is a flowchart of using a virtual shield monster according to an embodiment of this disclosure.

FIG. 57 is a flowchart of a method for controlling a virtual object according to an embodiment of this disclosure.

FIG. 58 is a schematic diagram of a display picture according to an embodiment of this disclosure.

FIG. 59 is a schematic diagram of a display picture according to an embodiment of this disclosure.

FIG. 60 is a flowchart of a method for controlling a virtual object according to an embodiment of this disclosure.

FIG. 61 is a schematic diagram of a display picture according to an embodiment of this disclosure.

FIG. 62 is a schematic diagram of a display picture according to an embodiment of this disclosure.

FIG. 63 is a flowchart of a method for controlling a virtual object according to an embodiment of this disclosure.

FIG. 64 is a flowchart of a method for controlling a virtual object according to an embodiment of this disclosure.

FIG. 65 is a flowchart of a method for managing a virtual object according to an embodiment of this disclosure.

FIG. 66 is a schematic display diagram of a display page of an application according to an embodiment of this disclosure.

FIG. 67 is a schematic display diagram of a game picture according to an embodiment of this disclosure.

FIG. 68 is a schematic display diagram of a target page according to an embodiment of this disclosure.

FIG. 69 is a schematic display diagram of a companion object in a second form according to an embodiment of this disclosure.

FIG. 70 is a schematic display diagram of a companion object in a first form according to an embodiment of this disclosure.

FIG. 71 is a schematic display diagram of a third virtual object according to an embodiment of this disclosure.

FIG. 72 is a schematic display diagram of a companion object in a third form according to an embodiment of this disclosure.

FIG. 73 is a schematic display diagram of a fourth virtual object according to an embodiment of this application after being attacked.

FIG. 74 is a schematic display diagram of displaying special effects corresponding to a companion object in a third region of the companion object in a third form according to an embodiment of this disclosure.

FIG. 75 is a schematic display diagram of a target region according to an embodiment of this disclosure.

FIG. 76 is a flowchart of a method for managing a virtual object according to an embodiment of this disclosure.

FIG. 77 is a flowchart of a method for controlling a virtual object according to an embodiment of this disclosure.

FIG. 78 is a flowchart of a method for controlling a virtual object according to an embodiment of this disclosure.

FIG. 79 is a schematic diagram of a state change of a companion object according to an embodiment of this disclosure.

FIG. 80 is a schematic diagram of energy accumulation according to an embodiment of this disclosure.

FIG. 81 is a schematic diagram of energy storage prompt information in a second display form according to an embodiment of this disclosure.

FIG. 82 is a schematic diagram of a first buff according to an embodiment of this disclosure.

FIG. 83 is a schematic diagram of a long-range buff according to an embodiment of this disclosure.

FIG. 84 is a flowchart of a method for controlling a virtual object according to an embodiment of this disclosure.

FIG. 85 is a flowchart of a method for displaying a virtual object according to an embodiment of this disclosure.

FIG. 86 is an interaction flowchart of a method for displaying a virtual object according to an embodiment of this disclosure.

FIG. 87 is an interaction flowchart of a method for controlling a marked prop according to an embodiment of this disclosure.

FIG. 88 is an interaction flowchart of a method for displaying a virtual object according to an embodiment of this disclosure.

FIG. 89 is an interaction flowchart of a method for displaying a virtual object according to an embodiment of this disclosure.

FIG. 90 is an interaction flowchart of a method for displaying a virtual object according to an embodiment of this disclosure.

FIG. 91 is a schematic diagram of an interface of a switching animation according to an embodiment of this disclosure.

FIG. 92 is a schematic diagram of an interface of an invisible summoned creature according to an embodiment of this disclosure.

FIG. 93 is a schematic diagram of an effect of DOT having an electric shock effect according to an embodiment of this disclosure.

FIG. 94 is a schematic diagram of an interface for controlling firing of a marking cartridge according to an embodiment of this disclosure.

FIG. 95 is a schematic diagram of an interface of successful marking of a marking cartridge according to an embodiment of this disclosure.

FIG. 96 is a schematic diagram of an interface where a marking cartridge is destroyed according to an embodiment of this disclosure.

FIG. 97 is a schematic flowchart of a method for processing a special effects prop according to an embodiment of this disclosure.

FIG. 98 is a schematic flowchart of a method for displaying a movement trajectory of a special effects prop according to an embodiment of this disclosure.

FIG. 99 is a schematic flowchart of a method for processing a special effects prop according to an embodiment of this disclosure.

FIG. 100 is a schematic flowchart of a method for processing a special effects prop according to an embodiment of this disclosure.

FIG. 101 is a schematic diagram of an application scene of a method for processing a special effects prop according to an embodiment of this disclosure.

FIG. 102 is a schematic diagram of an application scene of a method for processing a special effects prop according to an embodiment of this disclosure.

FIG. 103 is a schematic diagram of an application scene of a method for processing a special effects prop according to an embodiment of this disclosure.

FIG. 104 is a schematic diagram of an application scene of a method for processing a special effects prop according to an embodiment of this disclosure.

FIG. 105 is a schematic flowchart of a method for processing a special effects prop according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation to this disclosure. Other embodiments shall fall within the scope of this disclosure.

In the following description, the involved term “some embodiments” describes subsets of all possible embodiments, but it may be understood that “some embodiments” may be the same subset or different subsets of all the possible embodiments, and can be combined with each other without conflict.

In the following description, the involved terms “first\second\ . . . ” are merely intended to distinguish between similar objects rather than describe specific orders. It may be understood that, “first\second\ . . . ” may interchange specific order or sequential order if allowed, so that the embodiments of this disclosure described herein can be implemented in an order other than those illustrated or described herein.

In the following description, the involved term “plurality of” means at least two.

Unless otherwise defined, meanings of all technical and scientific terms used in this specification are the same as those usually understood by a person skilled in the art to which this disclosure belongs. The terms used in this specification are merely intended to describe objectives of the embodiments of this disclosure, but are not intended to limit this disclosure.

Before the embodiments of this disclosure are further described in detail, a description is made on nouns and terms in the embodiments of this disclosure, and the nouns and terms in the embodiments of this disclosure are applicable to the following explanations.
1) The expression “in response to” may be used for indicating a condition or a status on which one or more to-be-performed operations depend. In a case that the condition or the status is satisfied, the one or more operations may be performed in real time or have a set delay. Unless otherwise specified, an order in which a plurality of operations are performed is not limited.
2) A virtual scene may include a scene displayed (or provided) in a case that a game program is run on a terminal device. The scene may be a simulation environment for the real world, or may be a semi-simulation and semi-fiction environment, and may further be a purely fictional virtual scene. The virtual scene may be any one of a two-dimensional virtual scene, a 2.5-dimensional virtual scene, or a three-dimensional virtual scene, and the dimensions of the virtual scene are not limited in this embodiment of this disclosure. For example, the virtual scene may include sky, land, ocean, and the like. The land may include environmental elements such as desert and city, and a user may control a virtual object to move in the virtual scene.
3) Virtual objects may include images of various people and things that can be controlled by a player or interact with the player in the virtual scene, or movable objects in the virtual scene. The movable objects may be a virtual character, a virtual animal, a cartoon character, and the like, for example, a character and an animal displayed in a virtual scene. The virtual object may be a virtual image for representing a user in a virtual scene. The virtual scene may include a plurality of virtual objects, and each virtual object has a shape and a volume in the virtual scene, and occupies some space in the virtual scene.
4) Companion objects may include images of various people and things in a virtual scene that can assist a virtual object to interact with other virtual objects. The images may be a virtual character, a virtual animal, a cartoon character, and the like. For example, a companion object may be an object controlled by artificial intelligence (AI) in a virtual scene, or a non-player character (NPC) in a virtual scene. The AI may be any one or at least one of control logics with different intelligence capabilities such as an AI model, a decision tree, a logic tree, and a behavior tree. In some embodiments, the AI is controlled based on a condition-triggered control logic.
(5) Scene data may represent characteristic data of a virtual scene. For example, the scene data may be an area of a construction region in the virtual scene and a current architectural style of the virtual scene. The scene data may also include a location of a virtual building in the virtual scene, a floor area of the virtual building, and the like.
6) A client may be an application running in a terminal device to provide various services, for example, a game client and a metaverse client.
7) An unresponsive state may include a state in which a control target cannot respond to a user instruction due to external factors. For example, for a companion object that can be switched between an independent state and an attached state, the state may represent that the companion object is currently not switchable from the independent state to the attached state in response to an instruction, or not switchable from the attached state to the independent state in response to an instruction. The external factors may be that the companion object is disturbed by a control skill of another object (for example, in a dizzy state), a status value (for example, a health point) of the companion object is less than a status threshold, and the like. In addition, in a case that the external factors are eliminated (for example, the status value of the companion object is restored to be higher than a status threshold or the dizzy state is ended), the state of the companion object is to be switched from the unresponsive state to a responsive state, and in this case, the companion object may be switched from the independent state to the attached state.
8) A first state may include a first state of the companion object. For example, a first form may present a state of being attached to a first virtual object to become a part of the first virtual object, which is also referred to as an attached state, a merged state, and an incomplete state.
9) A second state may include a second state of the companion object, which may be different from the first state. For example, the second form may present a state of acting independently of the first virtual object, which is also referred to as an independent state, a separated state, a split state, and a complete state.

Embodiments of this disclosure include a method and an apparatus for controlling a companion object, an electronic device, a computer-readable storage medium, and a computer program product, so as to control a companion object in a virtual scene in a flexible and concise manner, thereby improving efficiency of human-computer interaction and user experience. In order to make it easier to understand the method for controlling a companion object in a virtual scene provided in this embodiment of this disclosure, an exemplary implementation scenario of the method for controlling a companion object in the virtual scene provided in this embodiment of this disclosure is first described. The virtual scene in the method for controlling a companion object in the virtual scene provided in this embodiment of this disclosure may be outputted based on a terminal device or collaboratively outputted based on the terminal device and a server.

In some embodiments, the virtual scene may be an environment for virtual objects (such as game characters) to interact, for example, for game characters to fight in a virtual scene. By controlling actions of game characters, both parties can interact in the virtual scene, so that users can relieve the pressure of life during the game.

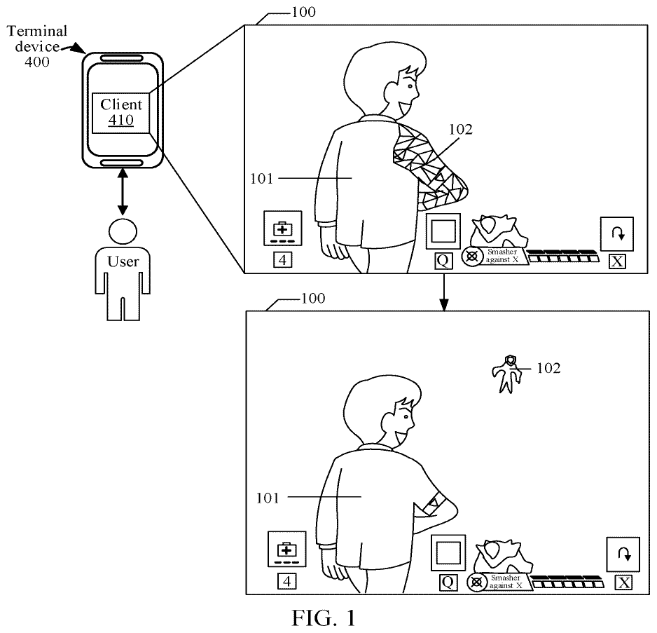

FIG. 1 is a schematic diagram of an application mode of a method for controlling a companion object in a virtual scene according to an embodiment of this disclosure, which is applicable to some application modes of relying on computing power of graphics processing hardware of a terminal device 400 to complete calculation of related data of a virtual scene 100. For example, a game in a stand-alone/an off-line mode, outputting of a virtual scene is completed through various types of terminal devices 400 such as a smart phone, a tablet computer, and a virtual reality/augmented reality device.

As an example, types of graphics processing hardware include processing circuitry, such as a central processing unit (CPU) and a graphics processing unit (GPU).

In a case that visual perception of the virtual scene 100 is formed, the terminal device 400 calculates data required for display through the graphics computing hardware, and completes loading, parsing, and rendering of the displayed data, and outputs a video frame capable of forming visual perception of the virtual scene on the graphics output hardware. For example, a two-dimensional video frame is presented on a display screen of a smart phone, or a video frame with a three-dimensional display effect is projected onto lenses of augmented reality/virtual reality glasses. In addition, in order to enrich the perception effect, the terminal device 400 may further form one or more of auditory perception, tactile perception, motion perception, and taste perception through different hardware.

As an example, a client 410 (for example, a stand-alone game application) is run on the terminal device 400, and a virtual scene including role play is outputted during the running of the client 410. The virtual scene may be an environment for game characters to interact, which may be a plain, a street, a valley, or the like for game characters to fight, for example. The virtual scene 100 being displayed from a third-person perspective is used as an example. A first virtual object 101 is displayed in the virtual scene 100. The first virtual object 101 may be a user-controlled game character, that is, the first virtual object 101 is controlled by a real user and to move in the virtual scene 100 in response to an operation of the real user performed on a controller (such as a touch screen, a voice-operated switch, a keyboard, a mouse, and a joystick). For example, in a case that the real user moves the joystick (including a virtual joystick and a real joystick) to the right, the first virtual object 101 is to move to the right in the virtual scene 100, or may keep still, jump, and control the first virtual object 101 to perform a shooting operation.

For example, a first virtual object 101 and a companion object 102 in an attached state are displayed in a virtual scene 100. The companion object 102 is attached to the first virtual object 101 in a first form (for example, the companion object 102 may be attached to an arm of the first virtual object 101 in the shape of an arm guard, thereby becoming a part of the first virtual object 101). Then the client 410 controls the companion object 102 in the first form to switch from the attached state to the independent state in response to satisfying a release condition (for example, receiving a task triggering operation or satisfying a task automatic triggering condition). The independent state may be a state in which the companion object 102 acts in a second form independently of the first virtual object 101, and the companion object 102 in the second form is controlled to perform a task (for example, in a case that the release condition is satisfied, the companion object 102 may be controlled to switch from the shape of an arm guard to the shape of an independent virtual character, and the companion object 102 in the shape of a character may be controlled to a perform task). In this way, the companion objects in the virtual scene can be controlled in a flexible and concise manner, thereby improving the efficiency of human-computer interaction and user experience.

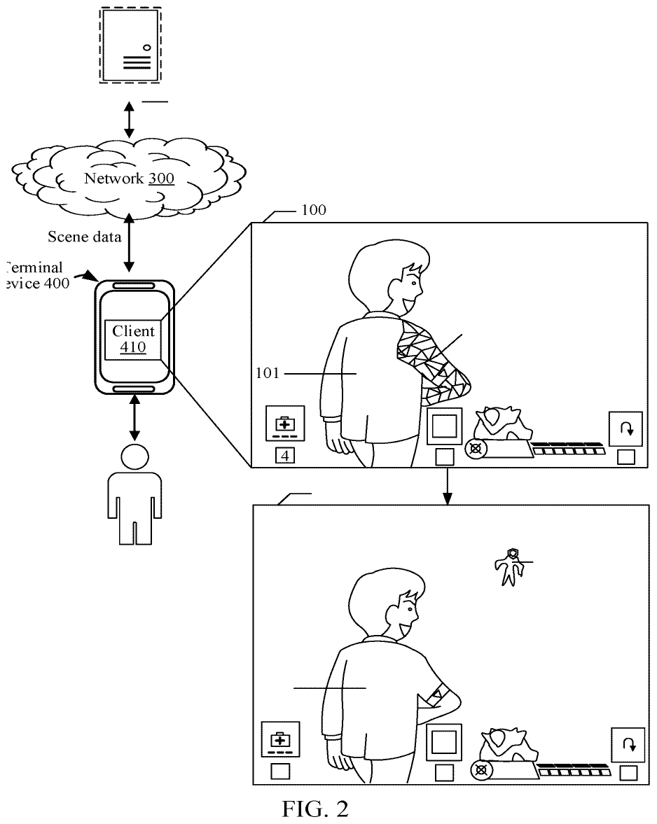

In another implementation scenario, FIG. 2 is a schematic diagram of an application mode of a method for controlling a companion object in a virtual scene according to an embodiment of this disclosure, which is applied to a terminal device 400 and a server 200, and is applicable to an application mode of relying on computing power of the server 200 to complete calculation of the virtual scene and outputting a virtual scene at the terminal device 400.

Visual perception of the virtual scene 100 being formed is used as an example. The server 200 calculates display data (such as scene data) related to the virtual scene and transmits the data to the terminal device 400 through a network 300. The terminal device 400 relies on graphics computing hardware to complete loading, parsing, and rendering of the calculated display data, and relies on the graphics output hardware to output a virtual scene to form visual perception. For example, a two-dimensional video frame may be presented on a display screen of a smart phone, or a video frame with a three-dimensional display effect is projected onto lenses of augmented reality/virtual reality glasses. For the perception in the form of the virtual scene, it may be understood that a virtual scene may be outputted by means of the corresponding hardware of the terminal device 400, for example, using a microphone to form auditory perception, and using a vibrator to form haptic perception.

As an example, a client 410 (for example, an online game application) is run on the terminal device 400, and interacts with other users through a connection server 200 (for example, a game server), and the terminal device 400 outputs the virtual scene 100 of the client 410. The virtual scene 100 being displayed from a third-person perspective is used as an example. A first virtual object 101 is displayed in the virtual scene 100. The first virtual object 101 may be a user-controlled game character, that is, the first virtual object 101 is controlled by a real user and to move in the virtual scene 100 in response to an operation of the real user performed on a controller (such as a touch screen, a voice-operated switch, a keyboard, a mouse, and a joystick). For example, in a case that the real user moves the joystick to the right, the first virtual object 101 is to move to the right in the virtual scene 100, or may keep still, jump, and control the first virtual object 101 to perform a shooting operation.

For example, a first virtual object 101 and a companion object 102 in an attached state are displayed in a virtual scene 100. The companion object 102 is attached to the first virtual object 101 in a first form (for example, the companion object 102 may be attached to an arm of the first virtual object 101 in the shape of an arm guard, thereby becoming a part of the first virtual object 101). Then the client 410 controls the companion object 102 in the first form to switch from the attached state to the independent state in response to satisfying a release condition (for example, receiving a task triggering operation or satisfying a task automatic triggering condition). The independent state may be a state in which the companion object 102 acts in a second form independently of the first virtual object 101, and the companion object 102 in the second form is controlled to perform a task (for example, in a case that the release condition is satisfied, the companion object 102 may be controlled to switch from the shape of an arm guard to the shape of an independent virtual character, and the companion object 102 in the shape of a character may be controlled to a perform task). In this way, the companion objects in the virtual scene can be controlled in a flexible and concise manner, thereby improving the efficiency of human-computer interaction and user experience.

In some embodiments, the terminal device 400 may implement the method for controlling a companion object in the virtual scene provided in this embodiment of this disclosure by running a computer program. For example, the computer program may be a native program or a software module in an operating system; may be a native application (APP), that is, a program that needs to be installed in the operating system to run, such as a shooting game APP (that is, the foregoing client 410); or may be an applet, that is, a program that only needs to be downloaded into a browser environment to run; and may further be a game applet that can be embedded in any APP. In a word, the foregoing computer program may be any form of application, module, or plug-in.

A computer program being an application program is used as an example. During actual implementation, an application program supporting a virtual scene is installed and run in the terminal device 400. The application program may be any one of a first-person shooting game (FPS), a third-person shooting game, a virtual reality application program, a three-dimensional map program, or a multiplayer shootout survival game. A user uses the terminal device 400 to operate a virtual object located in the virtual scene for an activity. The activity includes but is not limited to: at least one of adjusting a body posture, crawling, walking, running, riding, jumping, driving, pickup, shooting, attacking, throwing, and building a virtual building. Exemplarily, the virtual object may be a virtual character, such as a simulated character or a cartoon character.

In some other embodiments, this embodiment of this disclosure may further be implemented through cloud technology. The cloud technology is a hosting technology that unifies a series of resources such as hardware, software, and a network in a wide area network or a local area network to realize data computing, storage, processing, and sharing.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology is to become an important support. Background services of a technology network system require a lot of computing and storage resources.

For example, the server 200 in FIG. 2 may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), a big data, and artificial intelligence platform. The terminal device 400 may be a smart phone, a tablet computer, a notebook computer, a desktop computer, a smart speaker, a smart watch, or the like, which is not limited thereto. The terminal device 400 and the server 200 may be directly or indirectly connected in a manner of wired or wireless communication, which is not limited in this embodiment of this disclosure.

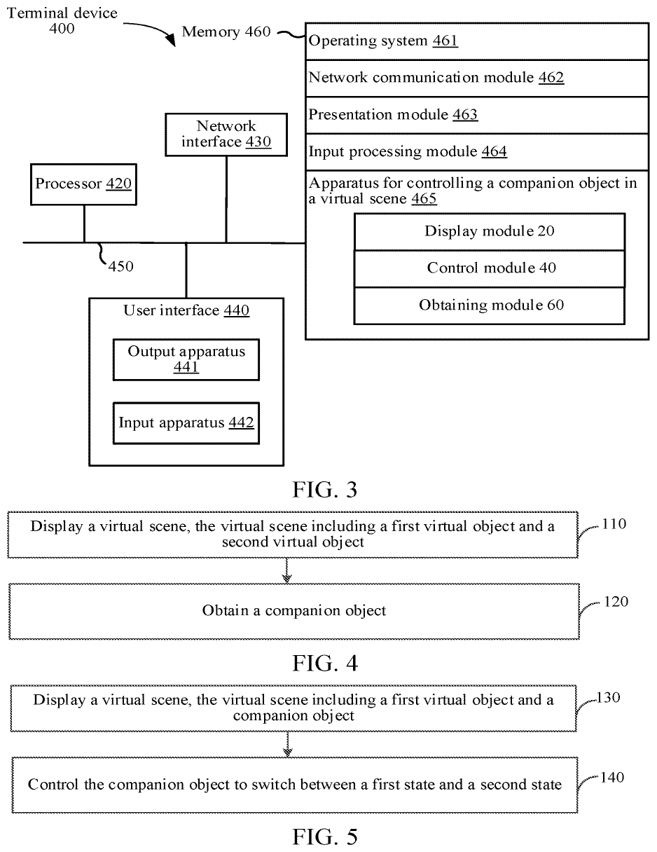

A structure of the terminal device 400 shown in FIG. 1 is described below. FIG. 3 is a schematic structural diagram of a terminal device 400 according to an embodiment of this disclosure. The terminal device 400 shown in FIG. 3 includes: at least one processor 420, a memory 460, at least one network interface 430, and a user interface 440. Various components in the terminal device 400 are coupled together through a bus system 450. It may be understood that the bus system 450 is configured to implement connection and communication between the components. In addition to a data bus, the bus system 450 further includes a power bus, a control bus, and a status signal bus. However, for the sake of clarity, various buses are marked as the bus system 450 in FIG. 3.

The processor 420 may be processing circuitry, such as an integrated circuit chip with signal processing capability, for example, a general processor, a digital signal processor (DSP), another programmable logic device, a discrete gate or a transistor logic device, a discrete hardware component, or the like. The general processor may be a microprocessor, any conventional processor, or the like.

The user interface 440 includes one or more output apparatuses 441 that enable presentation of media content, including one or more speakers and/or one or more visual display screens. The user interface 440 further includes one or more input apparatuses 442, including user interface components that facilitate user input, such as a keyboard, a mouse, a microphone, a touch screen display, a camera, and another input button and control.

The memory 460 is removable, non-removable, or a combination thereof. An exemplary hardware device includes a solid-state memory, a hard disk drive, an optical disk drive, and the like. The memory 460 may include one or more storage devices at a physical location away from the processor 420.

The memory 460 includes a volatile memory or a non-volatile memory, or may include both a volatile memory and a non-volatile memory. The non-volatile memory may be a read-only memory (ROM), and the volatile memory may be a random access memory (RAM). The memory 460 described in this embodiment of this disclosure is intended to include any suitable type of memory.

In some embodiments, the memory 460 can store data and support various operations. Examples of the data include a program, a module, and a data structure, or a subset or a superset thereof. An exemplary description is given below.

An operating system 461 includes system programs for processing various basic system services and performing hardware-related tasks, for example, a frame layer, a core library layer, and a drive layer, which is configured to implement various basic services and processing a task based on hardware.

A network communication module 462 is configured to reach another computing device through one or more (wired or wireless) network interfaces 430. Exemplary network interfaces 430 include: a Bluetooth interface, a Wi-Fi interface, a universal serial bus (USB) interface, and the like.

A presentation module 463 is configured to enable presentation of information (for example, a user interface for operation of a peripheral device and display of content and information) through one or more output apparatuses 441 (for example, a display screen and a speaker) associated with the user interface 440.

An input processing module 464 is configured to detect one or more user inputs or interactions from one of the one or more input apparatuses 442 and translate the detected inputs or interactions.

In some embodiments, an apparatus for controlling a companion object in the virtual scene provided in this embodiment of this disclosure may be implemented by software. FIG. 3 shows an apparatus 465 for controlling a companion object in the virtual scene stored in the memory 460, which may be software in the form of programs and plug-ins, including the following software modules: a display module 20, a control module 40, and an acquisition module 60, which are logical and may be arbitrarily combined or further split according to implemented functions. In FIG. 3, for convenience of expression, all the foregoing modules are shown at one time, which is not deemed that the implementation of the apparatus 465 for controlling a companion object in the virtual scene that may include only the display module 20 and the control module 40 is excluded, and functions of the modules are to be described below.

The method for controlling a companion object in the virtual scene provided in this embodiment of this disclosure is described in detail with reference to the accompanying drawings below. The method for controlling a companion object in the virtual scene provided in this embodiment of this disclosure may be performed by the terminal device 400 in FIG. 1 alone, or may be performed collaboratively by the terminal device 400 and the server 200 in FIG. 1.

A process of controlling the companion object includes at least one of the following stages:
I. summoning a companion object;
II. controlling the companion object to switch between a first state and a second state;
III. controlling the companion object in the first state to enhance a first virtual object; controlling the companion object in the second state to assist the first virtual object; and/or
IV. controlling the companion object to perform another task.

In order to facilitate understanding, the following exemplary comparison table of nouns is provided:

| Nouns | Embodiment | Other expressions |
|---|---|---|
| First | Virtual object operated and | Master virtual object, target |
| virtual object | controlled by a player | virtual object, and player |
| | | virtual object |
| Second | Virtual object controlled by | Monster and neutral object |
| virtual object | artificial intelligence | |
| Third | Virtual object controlled by | Hostile virtual object and |
| virtual object | another player and belonging | hostile unit |
| | to a different camp from the | |
| | first virtual object | |
| Fourth | Virtual object controlled by | Teammate virtual object |
| virtual object | another player and belonging | and friendly unit |
| | to the same camp as the first | |
| | virtual object | |
| companion | Subordinate object of the first | Pet virtual object, |
| object | virtual object | companion object, |
| | | summoned creature, target |
| | | summoned creature, |
| | | summoned object, pet, and |
| | | the like |

In this disclosure, the terms “virtual object” and “virtual character” may be regarded as the same concept, and the terms “companion object” and “companion character” may be regarded as the same concept.

### Stage I: Summon a Companion Object.

FIG. 4 is a schematic flowchart of a method for controlling a companion object according to an embodiment of this disclosure. A description is to be given in combination with steps shown in FIG. 4.

The method shown in FIG. 4 may be performed by various forms of computer programs run on a terminal device 400, which is not limited to the foregoing client 410, and may further be the foregoing operating system 461, software module, and script. Therefore, the client is not to be regarded as a limitation on this embodiment of this disclosure.

Step 110: Display a virtual scene.

In some embodiments, a client supporting a virtual scene is installed on a terminal device (for example, in a case that the virtual scene is a game, the corresponding client may be a game APP, such as a shooting game APP or a multiplayer online tactical competitive game APP). In a case that a user opens a client installed on the terminal device (for example, the user clicks/taps an icon corresponding to a shooting game APP presented on a user interface of the terminal device) and the terminal device runs the client, a first virtual object (for example, a virtual object A controlled by a current user 1) and at least one second virtual object (for example, a virtual object B controlled by AI or a virtual object C controlled by another user 2) may be displayed in a virtual scene presented by a human-computer interaction interface of the client. For the second virtual object in this embodiment, the second virtual object being a monster virtual object controlled by AI is used as an example for description.

In some embodiments, in the human-computer interaction interface of the client, the virtual scene may be displayed from a first-person perspective (for example, a virtual camera plays the role of the first virtual object in the game from the perspective of the controlled virtual object); or the virtual scene may be displayed from a third-person perspective (for example, a game is played from a perspective that the virtual camera is located behind and above a virtual object, which is also referred to as an over-the-shoulder perspective); and the virtual scene may further be displayed with a bird's-eye view (for example, a virtual camera is located above the scene to overlook the whole displayed virtual scene, which may or may not include the controlled virtual object). The foregoing different perspectives may be switched at will, or switched based on user selection, or switched automatically based on the scene.

As an example, the first virtual object may be an object controlled by a current user in a game. The virtual scene may further include another virtual object, for example, a virtual object that may be controlled by another user or by a robot program. Virtual objects may be divided into any one of a plurality of camps, a hostile relationship or a cooperative relationship may exist between the camps, and one or both of the foregoing relationships may exist between the camps in the virtual scene.

A virtual scene being displayed from the first-person perspective is used as an example. Displaying the virtual scene in the human-computer interaction interface may include: determining a field of view region of the first virtual object based on a viewing location and a field of view of the first virtual object in a complete virtual scene, and presenting a part of the virtual scene in the field of view region in the complete virtual scene, that is, the displayed virtual scene may be a part of the virtual scene relative to a panoramic virtual scene. Since the first-person perspective is a viewing perspective that can give the user relatively great impact, immersive perception of the user during operation can be realized.

A virtual scene being displayed with the bird's-eye view is used as an example. Displaying the virtual scene in the human-computer interaction interface may include: presenting a part of the virtual scene corresponding to a zooming operation or a sliding operation in the human-computer interaction interface in response to the zooming operation or the sliding operation on the panoramic virtual scene, that is, the displayed virtual scene may be a part of the virtual scene relative to the panoramic virtual scene. In this way, the operability of the user in the operation process can be improved, so that the efficiency of human-computer interaction can be improved.

Step 120: Obtain a companion object.

In some embodiments, the companion object is automatically obtained by a first virtual object, that is, the companion object can be obtained without an active operation of the first virtual object. For example, at the beginning of a virtual scene, the first virtual object already has a companion object.

In some other embodiments, the first virtual object needs to obtain a companion object through an active operation. For example, the first virtual object needs to obtain the companion object by looking for an interaction mechanism in the virtual scene, or the first virtual object needs to use specific skills, props, or functions to obtain the companion object, or a user needs to control the first virtual object to convert a second virtual object in the virtual scene to the companion object. The second virtual object is displayed. The first virtual object is controlled to convert the second virtual object to the companion object in response to an operation of the user. In some embodiments, the first virtual object is controlled to convert the second virtual object to the companion object by using a summoning skill or a summoning prop or a summoning function. After the second virtual object is converted to a companion object, the companion object may be in an attached state or an independent state by default, or may be in an initial state selected by the user after conversion. In this embodiment, after the second virtual object is converted to the companion object, the companion object being in the attached state by default is used as an example.

Exemplarily, the companion object is a subordinate object of the first virtual object, and the companion object is in the attached state by default. The attached state is a state in which the companion object is attached to the first virtual object in a first form to become a part of the first virtual object. In some embodiments, the first form is a state in which the companion object shrinks and is transformed into one or several pieces or a pair of body armor attached to body parts of the first virtual object. In some other embodiments, the first form may also be a state in which the companion object replaces the body part of the first virtual object after transformation. The first virtual object attached by the companion object may have a physical appearance change or have no visible appearance change.

For example, the first virtual object being a virtual object A is used as an example. A companion object (for example, a companion object B) may be attached to an arm of the virtual object A in the form of an arm guard, thereby becoming a part of the virtual object A and moving with the action of the virtual object A. In this way, the user does not need to be distracted to control a companion object B in the attached state, which reduces the operation burden of the user and improves the efficiency of human-computer interaction.

In some embodiments, the first virtual object is controlled to convert the second virtual object to the companion object by using a summoning skill or a summoning prop or a summoning function. The summoning skill, the summoning prop, or the summoning function may be implemented in the form of skill chip, and the skill chip may be obtained actively or automatically by the first virtual object in the virtual scene.

In some embodiments, the first virtual object is controlled to convert the second virtual object to the companion object in response to satisfying a summoning condition. The summoning condition includes at least one of the following:
The first virtual object obtains or uses a virtual prop for summoning, such as the foregoing skill chip;
At least one second virtual object is selected, for example, the second virtual object may be selected from a plurality of virtual objects; and
An attribute value of the first virtual object satisfies a set condition, and the attribute value may be an energy value.

In some embodiments, the summoning condition includes: the second virtual object is in a weak state. Whether the second virtual object is in a weak state may depend on a plurality of measurement standards, such as an absolute value of a health point is less than a status threshold, a percentage of the health point is less than a status threshold, an absolute value of magic is less than a status threshold, a percentage of magic is less than a status threshold, an absolute value or a percentage of a movement speed is less than a status threshold, in a coma or hypnotic state, a combination of the plurality of measurement standards, or the like.

In some embodiments, step 120 may be implemented in the following manner: controlling the first virtual object to obtain a skill chip; and controlling the first virtual object to interact with at least one second virtual object in a weak state in the virtual scene in a case that an energy value of the first virtual object is greater than an energy threshold, and to perform, in response to a set interaction result being achieved, one of the following processes:
switching the at least one second virtual object from a third form to a fourth form by using the skill chip, playing a special effects animation in which the at least one second virtual object in the fourth form moves to a location of a first virtual object, and converting the at least one second virtual object in the fourth form to at least one companion object in an attached state, the third form being an original form of the at least one second virtual object, and the fourth form being a temporary movement form of the second virtual object, such as a form of granulation (also referred to as fragments), or a form of flowing energy, or a flight form, as shown by flying fragments 102 in FIG. 7; or converting the at least one second virtual object to at least one companion object in an independent state by using the skill chip, controlling the at least one companion object to perform a show-up action in an independent state (for example, the show-up action may be close to the first virtual object, or at least one companion object may move to the location of the first virtual object after performing the show-up action), and switching the at least one companion object from the independent state to an attached state.

Exemplarily, the first virtual object being the first virtual object A controlled by user 1 is used as an example. A skill chip for summoning the foregoing companion object may be pre-configured in a virtual scene. For example, the skill chip may exist at a specific location in the virtual scene (for example, a location of a supply box), that is, a user 1 may assemble the skill chip by controlling the first virtual object A to move to the location of the supply box and by controlling the first virtual object A to perform a picking operation. The skill chip is a virtual prop for summoning. After the user 1 controls the first virtual object A to obtain the skill chip, the client may further obtain a current energy value of the virtual object A (the energy value may be used for transforming the second virtual object, that is, the energy value of the first virtual object needs to be consumed during summoning of the companion object based on the second virtual object), and then determine whether the current energy value of the first virtual object A is greater than the energy threshold (for example, an energy value of 500 points). In a case that the current energy value of the first virtual object A is greater than the energy threshold, the user 1 may control the first virtual object A to interact with at least one second virtual object (for example, the second virtual object C, the second virtual object C being an object included in a neutral camp in the virtual scene or an object included in a hostile camp of a first camp to which the first virtual object belongs) in a weak state in the virtual scene (for example, the user 1 may control the first virtual object A to fight with the second virtual object C in a neutral state), and may transform the second virtual object C based on the obtained skill chip after achieving the set interactive result (such as defeating the virtual object C). For example, the second virtual object C may be first converted from the original form to a fragment form by using the skill chip, and the second virtual object C in the fragment form is controlled to move to the location of the first virtual object A, to be switched from the fragment form to the first form (for example, a form such as an arm guard, an armor, a helmet, or combat boots), and to be attached to an arm of the first virtual object A controlled by the user 1, so as to obtain a companion object corresponding to the virtual object A (for example, the companion object B that converts the virtual object C to the virtual object A).

In some other embodiments, the user 1 may also control the virtual object A to directly summon at least one companion object by using the skill chip, that is, the companion object may also be a brand-new virtual object in the virtual scene, instead of being converted from the second virtual object.

The skill chip may also be pre-assembled for the first virtual object before entering the virtual scene, or exist in a scene setting interface or a store interface of the virtual scene. For example, the user may obtain the skill chip based on a setting operation in the scene setting interface, or obtain the skill chip based on a purchasing operation in the store interface.

In addition, companion objects obtained by using different types of skill chips may be different, attachment parts of different companion objects on the first virtual object may be different, and different skills or attributes of the first virtual object can be promoted. For example, types of the skill chips may include a shield chip, a scouting chip, and an attack chip. The companion object 1 obtained by using the shield chip may be attached to the chest of the first virtual object, and a defensive power of the first virtual object can be increased. A companion object 2 obtained using the scouting chip may be attached to an arm of the first virtual object, and the first virtual object may be enabled to sense surrounding enemies. A companion object 3 obtained using the attack chip may be attached to a leg of the first virtual object, and attack power of the first virtual object can be increased. In some embodiments, the attack chip may be further divided into a melee attack chip and a long-range attack chip. The melee attack chip can summon the companion object for enhancing a melee attribute, and the long-range attack chip can summon the companion object for enhancing a long-range attribute. That is to say, at least two types of virtual props correspond to different companion objects. The at least two types of companion objects provide different attribute promotion and/or skill assistance for the first virtual object.

### Stage II: Control the Companion Object to Switch Between a First State and a Second State.

FIG. 5 is a schematic flowchart of a method for controlling a companion object to switch between different states/forms according to an embodiment of this disclosure. A description is to be given in combination with steps shown in FIG. 5.

Step 130: Display a virtual scene, the virtual scene including a first virtual object and a companion object. In an example, a virtual scene is displayed. The virtual scene includes a first virtual object and a companion object of the first virtual object. The companion object is configured to switch between a first state and a second state.

The virtual scene includes the first virtual object and the companion object. The companion object is a subordinate object of the first virtual object and is configured to enhance or assist the first virtual object. A virtual object may act in the virtual scene, for example, may move in the virtual scene, or interact with the virtual scene and contents therein, such as attacking another hostile virtual object.

The first virtual object may own one or a plurality of companion objects. The plurality of companion objects may be the same type of companion object, or may be different types of companion objects.

Step 140: Control the companion object to switch between a first state and a second state. In an example, when the companion object is in the first state, the companion object is in a first form that is attached to the first virtual object. In an example, when the companion object is in the second state, the companion object is (i) in a second form that is not attached to the first virtual object and (ii) configured to move separately from the first virtual object, the first form of the companion object being different from the second form of the companion object.

In some embodiments, different types of companion objects in the first state are attached to the same part of the first virtual object. In some embodiments, different types of companion objects in the first state are attached to different parts of the first virtual object. In some embodiments, some types of companion objects in the first state are attached to the same part of the first virtual object, and other types of companion objects in the first state are attached to different parts of the first virtual object. That is to say, at least two types of companion objects are attached to different parts of the first virtual object.

In some embodiments, different types of companion objects in the first state correspond to the same first form. In some embodiments, different types of companion objects in the first state correspond to different first forms. In some embodiments, some types of companion objects in the first state correspond to the same first form, and other types of companion objects in the first state correspond to different first forms. That is to say, at least two types of companion objects correspond to different first forms. The first form may be a form such as an arm guard, a helmet, a waist protector, glasses, or a bracelet. That is to say, at least two types of companion objects correspond to different first forms.

The second state is a state in which the companion object acts in a second form independently of the first virtual object. The second state is also referred to as an independent state. The type of the companion object may include at least one of a shield object, a scouting object, and an attack object. In a case that the companion object is the shield object, the shield object is configured to resist an attack performed by another virtual object in the virtual scene on the first virtual object. In a case that the companion object is the scouting object, the scouting object is configured to release a scouting signal in a second region to sense a virtual object existing in the second region. In a case that the companion object is the attack object, the attack object is configured to assist the first virtual object in attacking a virtual object in a hostile camp. The attack object may be a melee attack object or a long-range attack object.

In some embodiments, different types of companion objects in the second state correspond to the same second form. In some embodiments, different types of companion objects in the second state correspond to different second forms. In some embodiments, some types of companion objects in the second state correspond to the same second form, and other types of companion objects in the second state correspond to different second forms. That is to say, at least two types of companion objects correspond to different second forms. The second form may be a strong and burly melee attack object form, a slender and agile long-range attack object form, a nimble scouting object form, a strong-armed shield object form, and the like. That is to say, at least two types of companion objects correspond to different second forms.

In some embodiments, switching between different states includes at least two modes: a manual switching mode and an automatic switching mode.

### Exemplary Manual Switching Mode:

Control the companion object to switch from the first state to the second state in response to a first switching operation on the companion object. Control the companion object to switch from the second state to the first state in response to a second switching operation on the companion object.

The first switching operation is used for triggering the companion object to switch from the first state to the second state. The second switching operation is used for triggering the companion object to switch from the second state to the first state.

The first switching operation and the second switching operation may be received operations from a user that controls the first virtual object, or indirect operations after processing based on user operations.

### Exemplary Automatic Switching Mode:

The companion object is automatically controlled to switch from the first state to the second state in a case that the first virtual object and/or the companion object satisfies a first switching condition. The automatically controlling the companion object to switch from the first state to the second state may not be a direct operation of the user. The first switching condition may also be referred to as an automatic release condition. In some embodiments, the first switching condition includes at least one of the following:
a quantity of second virtual objects within an attack range of the first virtual object is less than or equal to a first quantity threshold;
the first virtual object or another object in a first camp to which the first virtual object belongs needs assistance;
a time to attack a second camp arrives, the second camp being a hostile camp of the first camp to which the first virtual object belongs, and the like;
a duration for which the companion object in the first state is greater than or equal to a first duration threshold; and
the first virtual object enters a specified action state or a specific action state, for example, an aiming state, a shoulder aiming state, and a rocket launcher firing state.

The companion object is controlled to switch from the second state to the first state in a case that the first virtual object and/or the companion object satisfies a second switching condition. The second switching condition is also referred to as a recall condition. In some embodiments, the second switching condition includes at least one of the following:
the quantity of second virtual objects within the attack range of the first virtual object is greater than or equal to a second quantity threshold, the second quantity threshold being the same as or different from the first quantity threshold;
a distance between the first virtual object and the companion object is greater than or equal to a third distance threshold;
a duration for which the companion object is in the second state reaches a second duration threshold;
the companion object completes a given task and does not receive a new task triggering operation within a waiting time after completing the task;
the first virtual object exits a specified action state or a specific action state, for example, an aiming state, a shoulder aiming state, and a rocket launcher firing state, or the like;
an attribute value of the companion object is less than a preset threshold, for example, a health point is less than the preset threshold, for example, entering a dead state; and
the companion object receives an attack from a third virtual object, the third virtual object and the first virtual object belonging to different camps. For example, the third virtual object belongs to the second camp.

Step 140 includes: controlling the companion object to switch from the first state to the second state, and/or controlling the companion object to switch from the second state to the first state.

Switching from the First State to the Second State:

Control at least one companion object to switch from the first state to the second state in response to satisfying a release condition.

In some embodiments, the release condition may include any one of the following: receiving a task triggering operation on at least one companion object; a task automatic triggering condition, the task automatic triggering condition including at least one of the following: the first virtual object or another object in a first camp to which the first virtual object belongs needs assistance; and a time to attack a second camp arrives, the second camp being a hostile camp of the first camp to which the first virtual object belongs.

Exemplarily, the first virtual object being a virtual object A controlled by a user 1 is used as an example. Assuming that a companion object B displayed in the shape of an arm guard is attached to an arm of the virtual object A, when the client receives a task triggering operation on the companion object B, for example, the client receives a click/tap operation performed by the user 1 on a specific key (such as the “X” key on the keyboard), the companion object B is controlled to switch from the first state to the second state (for example, the companion object B in the shape of the arm guard is controlled to be detached from the virtual object A and switched from the shape of the arm guard to the shape of a virtual character).

Exemplarily, an occasion for at least one companion object to switch from the first state to the second state may also be determined based on artificial intelligence. For example, scene recognition processing may be performed on environmental information of the virtual scene by invoking a machine learning model. When the scene recognition result indicates that a status value (such as a health point and a magic point) of the first virtual object or another object in the same camp is less than the status threshold, or a quantity of materials (such as ammunition, drinks, bandages, and medical boxes) of the first virtual object or another object in the same camp is less than a quantity threshold, it is determined that the first virtual object or another object in the same camp need assistance, and at least one companion object is automatically controlled to switch from the first state to the second state, so that at least one companion object in a second form can assist the first virtual object or another object in the same camp.

In addition, when the scene recognition result indicates that a location distribution of the objects included in the first camp to which the first virtual object belongs conforms to an attack condition or it is determined, based on attribute information of objects included in the first camp to which the first virtual object belongs (for example, a quantity of objects included in the first camp, and a formation formed by a plurality of objects) and attribute information of objects included in the second camp, that it is the right time to attack the second camp, at least one companion object may also be automatically controlled to switch from the first state to the second state, so that the at least one companion object in the second form can participate in the attack, thereby speeding up the game progress and reducing resource consumption of the terminal device.

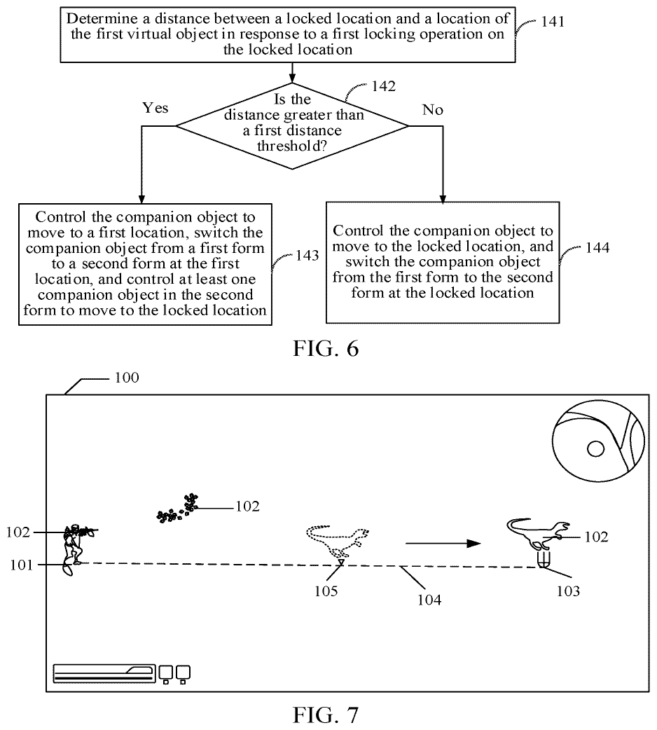

In some embodiments, a target location of the companion object from the attached state to the independent state may be specified through a locking operation, which is also referred to as a locked location. For example, when the companion object is dispatched to attack a locked enemy object or to assist a locked allied object, a location of the locked object is the locked location. In this case, the controlling at least one companion object from the attached state to the independent state may be implemented through step 141 to step 144 shown in FIG. 6, which is to be described in combination with the steps shown in FIG. 6.

Step 141: Determine a distance between a locked location and a location of the first virtual object in response to a first locking operation on the locked location.

In some embodiments, when the first virtual object is presented in the terminal device, a shooting prop held by the first virtual object may further be presented, so that the first virtual object can be controlled to use a shooting prop to select the locked location (that is, a scene location in the virtual scene, for example, a hillside, a tree, or any location on the ground in the virtual scene). For example, the first virtual object may be controlled to select the locked location by using a shooting prop with a crosshair pattern. When the terminal device presents the first virtual object holding the shooting props, the crosshair pattern corresponding to the shooting prop may further be presented. In this way, the user can control the first virtual object to use the shooting prop to perform an aiming operation on the locked location, and control the crosshair pattern to move to the locked location synchronously during the aiming operation, so as to select the locked location in the virtual scene.

Step 142: Determine whether a distance is greater than a first distance threshold, when the distance is greater than the first distance threshold, perform step 143, and when the distance is less than or equal to the first distance threshold, perform step 144.

In some embodiments, after the locked location is determined based on the first locking operation, it may be further determined whether the distance between the locked location and the location of the first virtual object is greater than the first distance threshold (for example, 20 meters). When it is determined that the distance therebetween is greater than the first distance threshold, the subsequent step 143 is performed. When it is determined that the distance therebetween is less than or equal to the first distance threshold, the subsequent step 144 is performed.

Step 143: Control the companion object to move to a first location, switch the companion object from a first form to a second form at the first location, and control at least one companion object in the second form to move to the locked location.

In some embodiments, the first location may be a location with a distance of a first distance threshold from the location of the first virtual object on a first connecting line connecting the locked location and the location of the first virtual object.

FIG. 7 is a schematic diagram of an application scene of a method for controlling a companion object in a virtual scene according to an embodiment of this disclosure. As shown in FIG. 6, when a distance between a location 101 of the first virtual object is located and a locked location 103 in a virtual scene 100 is greater than the first distance threshold, the companion object 102 in a first form (for example, the shape of an arm guard) is first controlled to be detached from the first virtual object, is switched to a flight form immune to damage to fly to the first location 105 (that is, the first location 105 is located on a first connecting line 104 between the location 101 of the first virtual object and the locked location 103, and the distance between the location 101 of the first virtual object and the first location 105 is a first distance threshold), and is switched from the flight form to a second form (for example, the shape of a dinosaur) at the first location 105, and then the companion object 102 in the shape of the dinosaur is controlled to move to the locked location 103. A movement speed of the companion object in the flight form may be greater than that a movement speed of the companion object in the second form. The flight form is an intermediate form or a transitional form during switching from the first form to the second form, and may not be displayed in some embodiments. During switching from the first form to the second form, a display duration of the flight form may be constant, or set by the system, or dynamically determined based on factors such as a traveling speed of the first virtual object and a distance from the locked location.

In some embodiments, this means that the first virtual object can only fly to a limited distance, and the rest of the distance can only be reached by the ground.

Step 144: Control the companion object to move to the locked location, and switch the companion object from the first form to the second form at the locked location.

In some embodiments, when a distance between the location of the first virtual object and the locked location is less than or equal to the first distance threshold, at least one companion object in the first form may be controlled to directly move to the locked location, and is switched from the first form to the second form at the locked location.

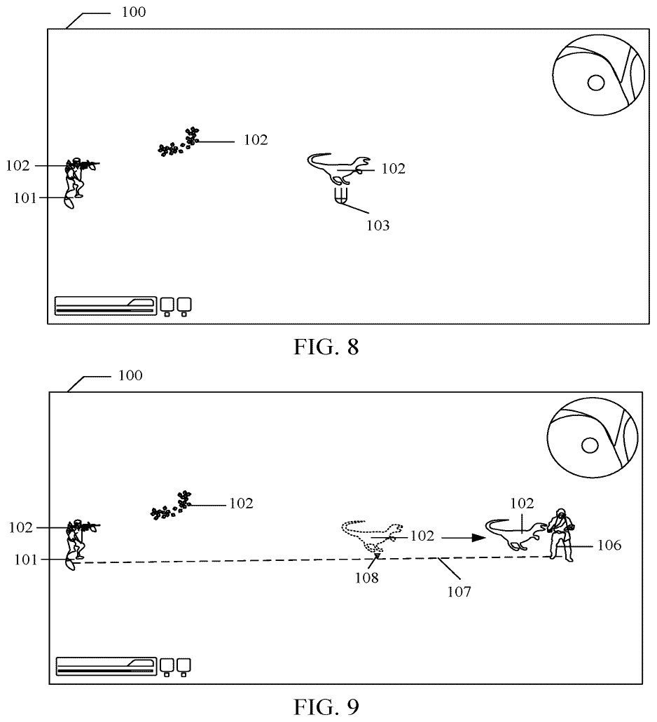

FIG. 8 is a schematic diagram of an application scene of a method for controlling a companion object in a virtual scene according to an embodiment of this disclosure. As shown in FIG. 8, when a distance between a location 101 of the first virtual object is located and a locked location 103 in a virtual scene 100 is less than or equal to the first distance threshold, the companion object 102 in a first form (for example, the shape of an arm guard) may be controlled to be detached from the first virtual object, is switched to a flight form to fly to the locked location 103, and is switched from the shape of an energy particle to a second form (for example, the shape of a dinosaur) at the locked location 103.

In some embodiments, when the locked location is a location unreachable by at least one companion object in the virtual scene (such as a special location such as a wall or a fault), the following processes may further be performed: controlling at least one companion object in the first form to move to a second location, and switching the at least one companion object from the first form to the second form at the second location, the second location being a location reachable by at least one companion object and closest to the locked location on a first connecting line.

For example, at least one companion object being a companion object B is used as an example. When the locked location is a fault in the virtual scene (that is, a location unreachable by the companion object B), the companion object B in the first form may be controlled to move to the second location (that is, a location reachable by the companion object B on a connecting line between the location of the first virtual object and the locked location, and is closest to the locked location), and is switched from the first form to the second form at the second location, and then the companion object B in the second form may be controlled to approach the locked location, so as to perform a task near the fault.

In some embodiments, when the locked location is in the air of the virtual scene, the following processes may further be performed: determining a ground projection location corresponding to the locked location in the virtual scene; and controlling at least one companion object in the second form to fall from the locked location to the ground projection location through a virtual gravity, and reducing a state parameter of the virtual object existing in the first region centered on the ground projection location (for example, a circular region with a radius of 10 meters centered on the ground projection location) after the control companion object reaches the locked location.

For example, at least one companion object being a companion object B is used as an example. When a location selected by a user 1 in the virtual scene (for example, a location 1) is in the air, the ground projection location corresponding to the location 1 in the virtual scene is first determined, and after the companion object B is controlled to move to the location 1 and switched from the first form to the second form at the location 1, the companion object B in the second form is controlled to move to the ground projection location corresponding to the location 1 by gravity acceleration through the gravity engine in the virtual scene and to cause damage to the virtual objects (such as virtual objects C and D) existing in a circular region with a radius of 10 meters centered on the ground projection location to reduce health points of the virtual objects.

In some other embodiments, when the locked object is a third virtual object (which may be any object except the first virtual object in the virtual scene, for example, an object belonging to the same camp as the first virtual object, or an object included in a hostile camp of a first camp to which the first virtual object belongs), the controlling of at least one companion object from the attached state to the independent state may further be implemented in the following manners: in response to a second locking operation on a third virtual object, controlling at least one companion object in the first form to move to a third location, switching the at least one companion object from the first form to the second form at the third location, and controlling the at least one companion object in the second form to move from the third location to the location of the third virtual object. A distance between the third location and the location of the third virtual object on a second connecting line is a second distance threshold, the second connecting line being used for connecting the location of the first virtual object to the location of the third virtual object.

For example, the second locking operation may be implemented by controlling the first virtual object to use a shooting prop. For example, the first virtual object may be controlled to use the shooting prop to select a third virtual object in the virtual scene in the following manners: presenting a crosshair pattern corresponding to the shooting prop, controlling the first virtual object to use the shooting prop to perform an aiming operation on the third virtual object, and controlling the crosshair pattern to move to the third virtual object synchronously during the aiming operation, so as to select the third virtual object in the virtual scene.

When a duration for which the crosshair pattern stays on the third virtual object reaches a duration threshold, it may be determined that a locking instruction is received, thereby automatically determining that the locked object is the third virtual object. The locking instruction may also be triggered by another button, that is, when the crosshair pattern moves to the third virtual object, the third virtual object is determined as a locked object in response to the triggering operation on the foregoing button.

FIG. 9 is a schematic diagram of an application scene of a method for controlling a companion object in a virtual scene according to an embodiment of this disclosure. As shown in FIG. 9, when the locked object is the third virtual object, the companion object 102 in a second form (for example, the shape of an arm guard) is first controlled to be detached from the first virtual object, and is switched from the shape of the arm guard to a form of energy (which may be a form of particle, depending on the world view of the virtual scene), the companion object 102 in a flight form is controlled to move to a third location 108 (that is, the third location 108 is located on a second connecting line 107 between the location 101 of the first virtual object and a location 106 of the third virtual object, and the distance between the location 106 of the third virtual object and the third location 108 is a second distance threshold), and is switched from the form of energy to a second form (for example, the shape of a dinosaur) at the third location 108, and then the companion object 102 in the shape of the dinosaur is controlled to move to the location 106 of the third virtual object to interact with the third virtual object.

In the following embodiments, this means that the first virtual object cannot directly fly around the third virtual object, but can only fly out of a specific range of the third virtual object, and then approach the third virtual object through the ground.

In this way, a reaction time may be reserved for the third virtual object, thereby improving user experience.

In some embodiments, when at least one companion object is a plurality of companion objects, the controlling of at least one companion object from the attached state to the independent state may be implemented in the following manners: controlling a companion object selected from a plurality of companion objects to switch from the attached state to the independent state in response to a companion object selection operation, different companions correspondingly having different skills.

For example, the first virtual object being a virtual object A controlled by the user 1 is used as an example. It is assumed that three companion objects are attached to the virtual object A, that is, a companion object B, a companion object C, and a companion object D. The companion object B is attached to an arm of the virtual object A in the shape of an arm guard, the companion object C is attached to the chest of the virtual object A in the shape of an armor, and the companion object D is attached to a head of the virtual object A in the shape of a helmet. In addition, the companion object B, the companion object C, and the companion object D have different skills. For example, the companion object B has a skill of increasing a movement speed of the virtual object A, the companion object C has a skill of improving the defensive power of the virtual object A, and the companion object D has a skill of enabling the virtual object A to have the ability to sense other virtual objects around. When the release condition is satisfied, identifiers corresponding to the companion object B to the companion object D may be presented in the human-computer interaction interface in the form of a list for the user 1 to select. When the user 1 selects the companion object C, the companion object C is controlled to switch from the attached state to the independent state, and the companion object B and the companion object D are still in the attached state, so that the user can freely select the companion object that needs to perform the task, thereby improving game experience of the user.

In some other embodiments, when at least one companion object is a plurality of companion objects, the controlling of at least one companion object to switch from the attached state to the independent state may further be implemented in the following manners: invoking a second machine learning model for prediction processing to obtain a release probability corresponding to each companion object based on environmental information of the virtual scene (for example, a type and a size of a map), attribute information of objects included in the first camp to which the first virtual object belongs (for example, a quantity of objects included in the first camp, a skill of each object, and a location distribution of each object), attribute information of objects included in the second camp (for example, a quantity of objects included in the second camp, a skill of each object, and a location distribution of each object), and respective skills of a plurality of companion objects, the first camp and the second camp to which the first virtual object belongs being hostile camps; and sorting a plurality of release probabilities in descending order, and controlling the companion objects corresponding to top N release probabilities in the descending order results to switch from the attached state to the independent state, N being a positive integer greater than or equal to 1.

For example, the first virtual object being the virtual object A controlled by the user 1 is used as an example. Assuming that three companion objects are attached to the virtual object A, that is, the companion object B, the companion object C, and the companion object D, the second machine learning model may be invoked to predict the release probabilities respectively corresponding to the companion object B, the companion object C, and the companion object D. For example, assuming that it is predicted that the release probability corresponding to the companion object B is 80%, the release probability of the companion object C is 70%, and the release probability of the companion object D is 85%, the companion object D may be automatically switched from the attached state to the independent state, so that the companion object D in the second form can assist the first virtual object in interaction. In this way, the appropriate companion object can be automatically selected based on artificial intelligence, which further reduces operation costs of the user and improves the game experience of the user.

In some embodiments, the user may choose whether to enable the foregoing function of selection using the machine model.

In some embodiments, carrying on with the above, before invoking the second machine learning model for prediction processing, the following processes may further be performed: obtaining historical operation data of a reference account, the reference account being an account with a game level greater than a level threshold, that is, at least one account with a relatively good historical record or a relatively long game duration; and training a second machine learning model based on the historical operation data and labeled data, the labeled data including companion objects used by reference accounts in the interaction process.

The second machine learning model may be a neural network model (for example, a convolutional neural network, a deep convolutional neural network, or a fully connected neural network), a decision tree model, a gradient lifting tree, a multi-layer perceptron, a support vector machine, and the like. The type of the second machine learning model is not specifically limited in this embodiment of this disclosure.

In some embodiments, after the at least one companion object is controlled to switch from the attached state to the independent state, the following processes may further be performed: invoking, based on environmental information of the virtual scene (for example, a type and a size of a map), attribute information of objects included in the first camp to which the first virtual object belongs (for example, a quantity of objects included in the first camp, a skill of each object, a status value, and a location distribution), and attribute information of objects included in the second camp (for example, a quantity of objects included in the second camp, a skill of each object, a status value, and a location distribution), a first machine learning model for prediction processing to obtain at least one action or a combination of actions to be performed by at least one companion object, the first camp and the second camp to which the first virtual object belongs being hostile camps; and controlling at least one companion object in the second form to perform the determined at least one action or a combination of actions.

For example, at least one companion object being a companion object B is used as an example. The first machine learning model may be invoked to predict at least one action or a combination of actions to be performed by the companion object B. Then, after the companion object switches from the attached state to the independent state, the companion object B in the second form may be controlled to perform at least one action or a combination of actions predicted by the first machine learning model. In this way, the action that the companion object B needs to perform is accurately predicted based on artificial intelligence, so that the repeated execution of unnecessary actions is avoided, the operation burden of the user is further reduced, and game experience of the user is also improved while saving computing resources of the terminal device.

The foregoing first machine learning model may be obtained by training based on the environmental information of a sample virtual scene, attribute information of objects included in a sample winner camp, attribute information of objects included in a sample loser camp, and labeled data. The labeled data includes at least one action or a combination of actions performed by the sample companion objects in the second form during the interaction. For a sample, reference may also be made to a training process similar to the training process of the second machine learning model to select a reference sample that satisfies a specific condition.

Switching from the Second Form to the First Form:

Control at least one companion object to switch from an independent state to an attached state in response to satisfying a recall condition for at least one companion object.

In some embodiments, a combat capability of the first virtual object to which a companion object is attached is stronger than of the first virtual object to which no companion object is attached. A stronger combat capability may be reflected in having more skills that can be used when a companion object is attached to the first virtual object, and the coefficient of existing skills is amplified, such as higher attack power or a wider range. For example, when at least one companion object (for example, the companion object B) is attached to a first virtual object (for example, the virtual object A) in a first form, a skill of the companion object B may be directly superimposed on the virtual object A. Assuming that the companion object B has an invisibility skill, the virtual object A may also have the invisibility skill when the companion object B is attached to the virtual object A in the first form. The foregoing skill may further have a specific amplification factor. For example, assuming that when the companion object B is controlled to release the invisibility skill in an independent state, a maximum duration for which the companion object B can remain invisible each time is 10 seconds, and when the companion object B is attached to the virtual object A in the first form, the maximum duration for which the virtual object A can remain invisible each time is increased to 15 seconds when the virtual object A is controlled to release the obtained invisibility skill.

For another example, when at least one companion object (for example, the companion object B) is attached to a first virtual object (for example, the virtual object A) in the first form, the original skill of the virtual object A can be improved to a certain extent. For example, assuming that the original attack power of the virtual object A is 100, when the companion object B is attached to the virtual object A in the first form, the attack power of the virtual object A is to be increased to 150. When the companion object B is attached to the virtual object A in the first form, the virtual object A may also be enabled to have a new skill that neither the companion object nor the virtual object has (for example, a capability of perceiving another object around, the capability being a skill that neither the individual virtual object A nor the companion object B has).

In some embodiments, the recall condition may include any one of the following: receiving a recall triggering operation on at least one companion object in a task state (for example, receiving a click/tap operation performed by a user on a specific key on a keyboard (for example, the “Q” key)); a duration for which at least one companion object is in the second form reaches a duration threshold (for example, 20 seconds); a distance between at least one companion object in the second form and the first virtual object is greater than a third distance threshold (for example, 10 meters); and at least one companion object in the second form completes a task and does not receive a new task triggering operation within a waiting time after completing the task.

A minimum value of the waiting time may be 0, that is, when the waiting time is 0, at least one companion object in the second form is to be recalled immediately after completing the task.

In some other embodiments, in response to satisfying the recall condition for at least one companion object, the following processes may further be performed: obtaining a state of at least one companion object in the second form; and displaying prompt information when the at least one companion object is in an unresponsive state, the prompt information being used for prompting that the at least one companion object is currently not switchable from an independent state to an attached state. In addition, when the at least one companion object is switched from an unresponsive state to a responsive state, it is determined that the at least one companion object is controlled to switch from the independent state to the attached state in response to satisfying the recall condition for the at least one companion object.

For example, the at least one companion object being a companion object B is used as an example. Before a response to satisfying the recall condition for the companion object B (for example, receiving a recall triggering operation on the companion object B), a client may further perform the following processes: obtaining a state of the companion object B in the second form; and when the companion object B is in an unresponsive state due to external factors (for example, the companion object B is in a dizzy state due to the skill interference released by the virtual object C in the virtual scene, or a health point thereof decreases below a life threshold after bearing the attack skill released by the virtual object C), the following prompt information may be displayed in the human-computer interaction interface: “companion object B is currently in an unresponsive state, please perform the operation again after 10 seconds” or other information with the similar meaning. Moreover, when the companion object B is switched from the unresponsive state to the responsive state (that is, when the external factors are eliminated, for example, when the health point of the companion object B recovers to be higher than the life threshold, or a duration for which the companion object B has been in a dizzy state reaches a duration threshold, the companion object is to be switched from the unresponsive state to the responsive state), the client determines to control the companion object B to switch from the independent state to the attached state in response to a recall triggering operation on the companion object B (for example, receiving a click/tap operation performed by a user on the “Q” key on the keyboard).

In some embodiments, the controlling of the at least one companion object to switch from the independent state to the attached state may be implemented in the following manners: controlling the at least one companion object in the second form to move from a fourth location to the location of the first virtual object in a first manner (that is, a manner in which at least one companion object moves by gradually changing a location, such as flying, walking, or running) and switching the at least one companion object from the second form to the first form when the distance between the at least one companion object in the second form and the first virtual object is less than or equal to the third distance threshold (for example, 15 meters); and controlling the at least one companion object in the second form to move to the fourth location in a second manner (that is, a manner in which at least one companion object moves by instantaneously changing a location, such as flashing), controlling the at least one companion object in the second form to move from the fourth location to the location of the first virtual object in the first manner, and switching the at least one companion object from the second form to the first form when the distance between the at least one companion object in the second form and the first virtual object is greater than the third distance threshold, a distance between the fourth location and the location of the first virtual object on a third connecting line being the third distance threshold, the third connecting line being used for connecting the location of the first virtual object to the location of the at least one companion object in the second form.

In some embodiments, the companion object is controlled to be immune to damage during switching between the first state and the second state. That is to say, during the switching between the first state and the second state, the companion object is immune to damage or negative impact of other effects. For example, when a bomb explodes, the companion object is within a range of the bomb explosion, but has entered the state switching process, then the bomb explosion may not reduce the health point of the companion object.

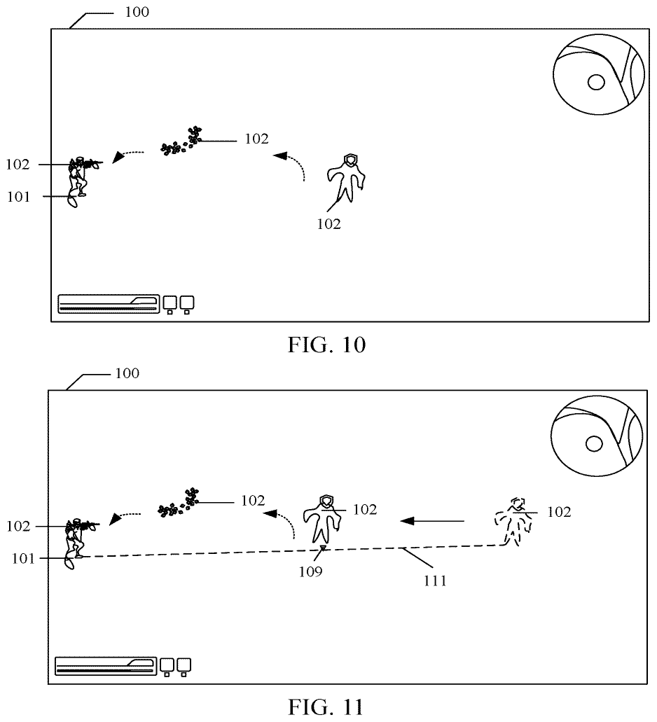

FIG. 10 is a schematic diagram of an application scene of a method for controlling a companion object in a virtual scene according to an embodiment of this disclosure. As shown in FIG. 10, when a distance between a companion object 102 in a second form (for example, the shape of a virtual character) and a first virtual object 101 in a virtual scene 100 is less than or equal to a third distance threshold, the shape of the companion object 102 may be first controlled to switch from the shape of a character to a flight form, the companion object 102 in the flight form is controlled to move to a location of the first virtual object 101 in a manner of flying, and is switched from a form of energy to a first form (for example, the shape of an arm guard), and then the companion object 102 in the shape of an arm guard is controlled to be attached to an arm of the first virtual object 101.

FIG. 11 is a schematic diagram of an application scene of a method for controlling a companion object in a virtual scene according to an embodiment of this disclosure. As shown in FIG. 11, when a distance between a companion object 102 in a second form (for example, the shape of a virtual character) and a first virtual object 101 in a virtual scene 100 is greater than a third distance threshold, the companion object 102 in the shape of a character may be first controlled to flash, or otherwise move, directly to a fourth location 109 (that is, the fourth location 109 is located on the third connecting line 111 between a location of the first virtual object 101 and a location of the companion object 102, and the distance between the location of the first virtual object 101 and the fourth location 109 is the third distance threshold), the shape of the companion object 102 is controlled to switch from the shape of a character to a form of energy at the fourth location 109, the companion object 102 in a flight form is controlled to move to the location of the first virtual object 101 in a manner of flying, and is switched from the flight form to a first form (for example, the shape of an arm guard), and then the companion object 102 in the shape of an arm guard is controlled to be attached to an arm of the first virtual object 101.

According to the method for controlling a companion object in the virtual scene according to this embodiment of this disclosure, the companion object is attached to the first virtual object in the first form when unnecessary to perform a task. When a release condition is satisfied, the companion object is to switch from an attached state to a state of acting in a second form independently of the first virtual object, and performs the task in the second form. That is to say, the companion object can adapt to different requirements of users in various states, thereby improving the efficiency of human-computer interaction and user experience.

Next, an exemplary application of this embodiment of this disclosure in an actual application scene is to be described.

In a shooting game, a user (or player) mainly controls a single virtual object to fight. If a user-controlled virtual object (referred to as an object for short below) can summon an additional fighting object (that is, a companion object), the user may expand more possibilities and experiences than that of a single object. However, this brings a problem that if the user is allowed to accurately control a plurality of objects in a fast-paced real-time battle and launch a concentrated attack on a locked target object, this may lead to a case that the user cannot take in to account the plurality of objects simultaneously, and operation costs of the user are also relatively high, resulting in poor game experience of the user.

In view of this, this embodiment of this disclosure provides a method for controlling a companion object in a virtual scene. A set of release and recall strategies for the companion object (corresponding to the foregoing companion objects, for example, a user-controlled object in the game may be printed by a chip, a companion object with independent fighting and different abilities as the theme can be summoned, and the companion object may perform a corresponding skill and behavior after receiving an instruction to fight against a specified target object, or may be automatically or passively recalled to an arm of the user-controlled object when there is no need to fight, which becomes an arm component with dominant characteristics, such as an arm guard) are designed for automatic execution. The user may assign the companion object to perform a task through a unique instruction, and the companion object may also be actively or passively recalled to the arm of the object when the task is completed or the user has other intentions. In this way, on the one hand, a situation that the companion object exposes the field of vision when following or blocks an action path of the user-controlled object when moving is avoided. On the other hand, the user may focus on the only object that the user controls, which reduces the operation cost brought by the companion object to the greatest extent and realizes the flexible and concise operation mode for the companion object.

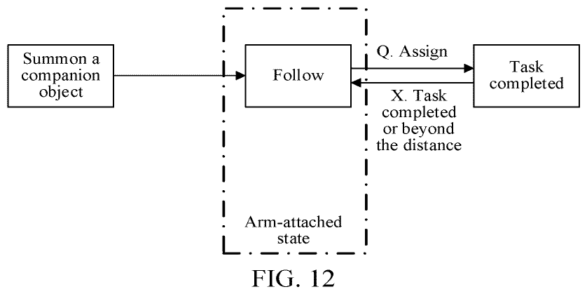

FIG. 12 is a schematic flowchart of a method for controlling a companion object in a virtual scene according to an embodiment of this disclosure. As shown in FIG. 12, a companion object may be summoned by a user-controlled object through a chip, and the companion object initially performs a show-up action. After the show-up action is performed, if a user-triggered task assignment instruction is not received, the companion object is to enter an arm-attached state by default and to present switching from an independent companion object state to the arm-attached state. In addition, the user may assign a task to the companion object in the independent state or the arm-attached state at any time through a unique instruction (for example, the “Q” key on the keyboard), so that the companion object can perform the corresponding task. When the companion object completes the task and does not receive a new user-triggered task assignment instruction, the companion object in the independent state is to automatically fly to the arm of the user-controlled object and enters the arm-attached state. When an IA companion is in a task state, the user may also forcibly recall the companion to the arm of the object through a unique instruction (such as the “X” key on the keyboard), to enter the attached state.

In addition, if the companion object is in a weak or dead state after being assigned, the companion object does not respond to the user-triggered instruction until the weak state ends, and then automatically flies to the arm of the user-controlled object and enters the attached state. Moreover, the companion object may bring special abilities to the object when being attached to the arm of the object, for example, the ability to increase the attack power and the movement speed of the object and to sense surrounding enemies. In addition, the companion object during the state switching is invincible and can remove all debuffs thereon.

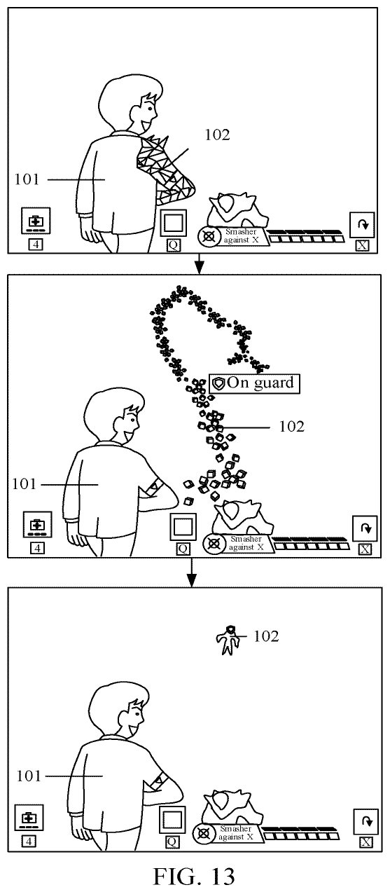

FIG. 13 is a schematic diagram of an application scene of a method for controlling a companion object in a virtual scene according to an embodiment of this disclosure. As shown in FIG. 13, a virtual object 101 controlled by a real user and a companion object 102 in an arm-attached state are presented in the virtual scene. When a user-triggered task assignment instruction is received (for example, the user presses the “Q” key on the keyboard), the companion object 102 in the arm-attached state is controlled to be detached from the virtual object 101 and flies out in a manifestation of a mass of energy or a substance (for example, the companion object 102 is controlled to switch from the shape of an arm guard to the form of particle to fly out), and is converted to the companion object 102 in an independent state (for example, the shape of a virtual character) at a set location, so that the companion object in the shape of a character performs a corresponding task. Moreover, as shown in FIG. 13, when the companion object 102 is assigned, an arm model of the virtual object 101 returns to normal.

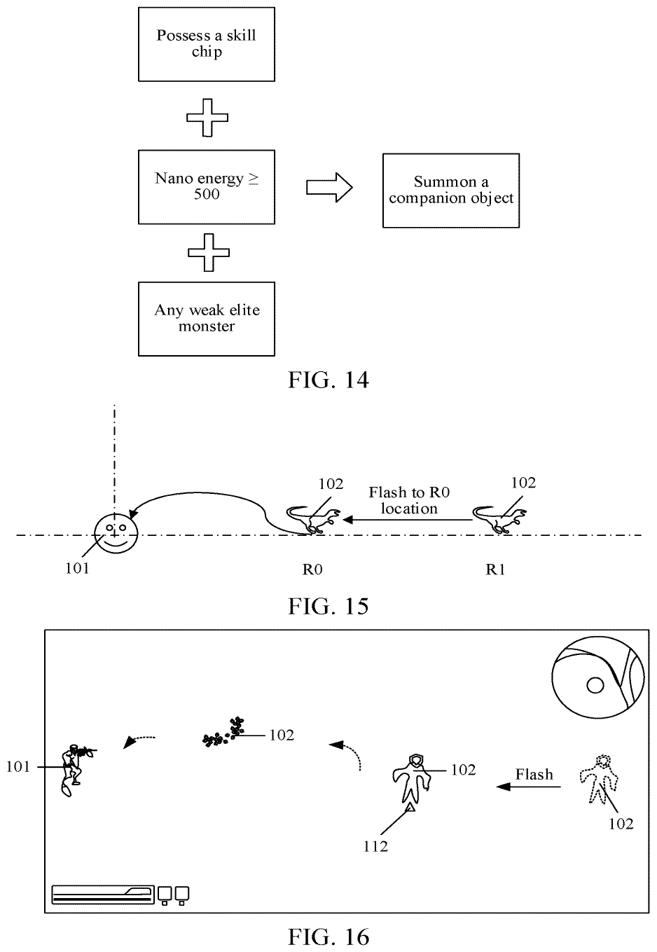

FIG. 14 is a schematic diagram of summoning a companion object according to an embodiment of this disclosure. As shown in FIG. 14, a user may control an object to obtain a skill chip in a virtual scene, and under the condition that an energy value of the object is higher than 500 points, the object is controlled to interact with any elite monster in a weak state in the virtual scene (corresponding to the foregoing third virtual object), thereby summoning the companion object, and the summoned companion object is to perform a corresponding show-up action.

The process of switching the companion object from an independent state to an arm-attached state continues to be described below.

In some embodiments, the initially summoned companion object automatically flies to an arm of a user-controlled object and enters the attached state if not receiving a user-triggered task assignment instruction after performing the show-up action. In addition, for a companion object in a task state, the user may also actively recall the companion object to the arm of the user-controlled object through a unique instruction (such as the “X” key on the keyboard), to enter the attached state. In addition, when the companion object completes the task and does not receive a new user-triggered task assignment instruction, the companion object also automatically fly to the arm of the object to enter the attached state.

In addition, the companion object in the independent state flies to the arm of the user-controlled object and enters the attached state, the performance may vary depending on different distances between the companion object in the independent state and the user-controlled object. For example, when the distance between the companion object in the independent state and the user-controlled object is less than R0, the companion object directly flies to the arm of the user-controlled object. When the distance between the companion object (for example, the companion object 102 shown in FIG. 15) and a user-controlled first virtual object (such as the virtual object 101 shown in FIG. 15) is greater than R0, for example, the companion object 102 in an independent state is at an R1 location, the companion object 102 in the independent state is first controlled to flash directly to the R0 location, and then returns to the arm of the user-controlled object in a flying state. In addition, if the companion object is currently in an unresponsive state, such as weakened, dying, or affected by casting of another object-controlled skill, the companion object cannot actively or passively return to the arm-attached state.

FIG. 16 is a schematic diagram of an application scene of a method for controlling a companion object in a virtual scene according to an embodiment of this disclosure. As shown in FIG. 16, assuming that a distance between a companion object 102 in an independent state and a user-controlled object 101 is greater than R0 when a user-triggered recall instruction is received, the companion object 102 in an independent state may be first controlled to flash directly to an R0 location (that is, a location 112 shown in FIG. 16), and the companion object is switched from a character shape to a manifestation of a mass of energy to fly to an arm of the object 101 at the R0 location and enters the attached state.

The process in which the companion object in an arm-attached state is assigned to perform a task continues to be described below.

In some embodiments, a user may assign a companion object in the attached state to perform a task through a unique instruction (such as the “X” key on the keyboard) at any time. If the companion object is in the arm-attached state before receiving the user-triggered task assignment instruction, logic for switching the companion object from the arm-attached state to the independent state may vary based on a distance between a fighting location and the user-controlled object.

For example, if the distance between the fighting location (corresponding to the foregoing locked location) and the user-controlled object is less than R0, an energy body flying out of the arm of the object may directly fly to the fighting location and is converted to a companion object in an independent state at the fighting location.

For example, if the distance between the fighting location and the user-controlled object is greater than R0, an energy body flying out of the arm of the object first flies to the R0 location and is converted to a companion object in an independent state at the R0 location, and then the companion object in the independent state is controlled to move to the fighting location.

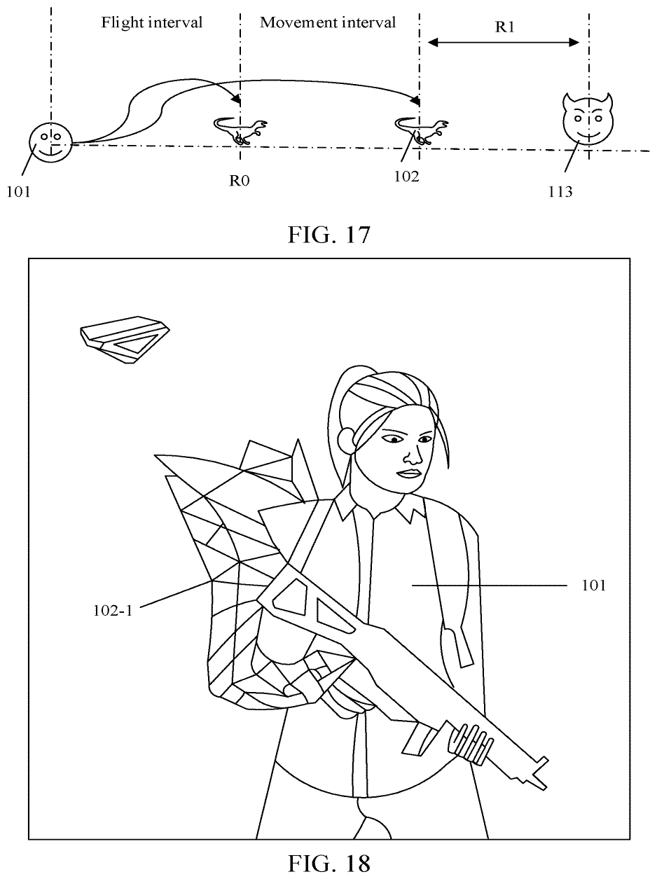

For example, as shown in FIG. 17, if a fighting object is an enemy 114 (corresponding to the foregoing second virtual object, for example, may be an object included in a hostile camp of a camp to which the user-controlled object belongs in the virtual scene), a reaction time needs to be reserved for the enemy 114. Therefore, the energy body flying out of the user-controlled virtual object 101 needs to land and be converted to the companion object 102 in the independent state within a range R1 from the enemy 114 at the latest, and then the companion object 102 in the independent state is controlled to move to a location of the enemy 114. The assumption in this example has a higher priority than those in the foregoing two examples.

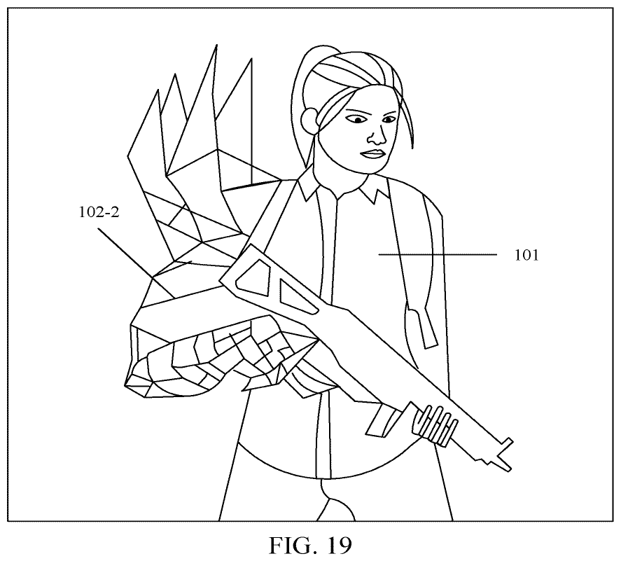

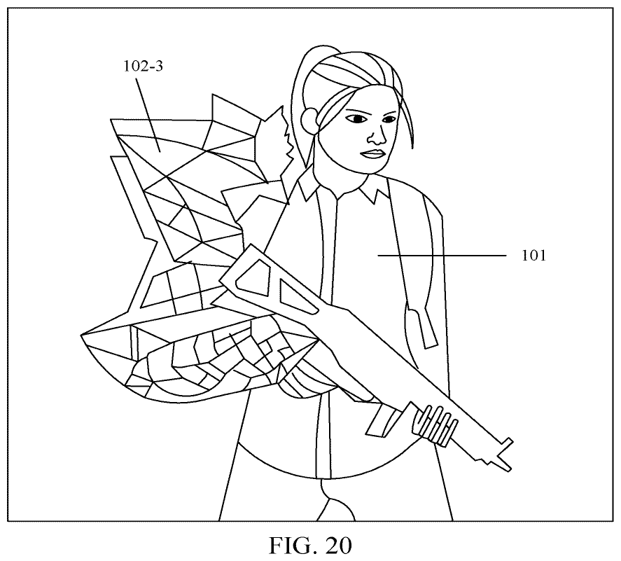

In some embodiments, companion objects with different characteristics display different models and provide different skills for the user-controlled object when being recalled to the arm-attached state. For example, FIG. 18 to FIG. 20 are schematic diagrams of application scenes of a method for controlling a companion object in a virtual scene according to an embodiment of this disclosure. As shown in FIG. 18 to FIG. 20, a companion object 102-1, a companion object 102-2, and a companion object 102-3 are recalled to an arm of a user-controlled object 101, and display different models when entering an attached state, and companion objects with different characteristics can bring different skills to the object 101. For example, the companion object 102-1 can enhance the attack power of the object 101, the companion object 102-2 can enhance the defensive power of the object 101, and the companion object 102-3 can provide the object 101 with the ability to sense surrounding enemies.

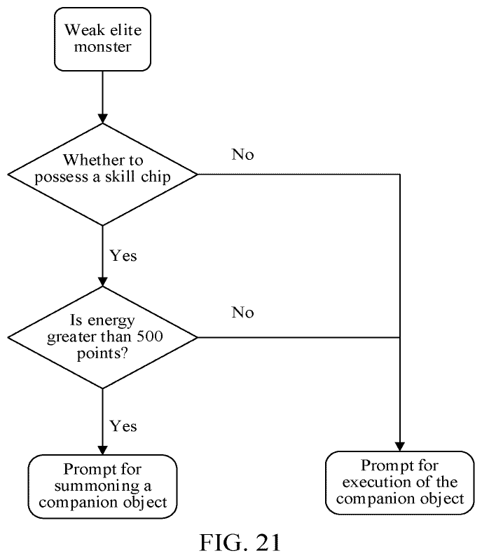

FIG. 21 is a schematic flowchart of summoning a companion object according to an embodiment of this disclosure. As shown in FIG. 21, a user may control an object to obtain a skill chip in a virtual scene, and under the condition that an energy value of the object is higher than 500 points, the object is controlled to interact with any elite monster in a weak state in the virtual scene, thereby summoning the companion object, and the summoned companion object is to perform a corresponding show-up action. In addition, when the user-controlled object does not have a skill chip, or the energy value of the object is less than 500 points, prompt information indicating execution of the companion object may be displayed (that is, the companion object cannot be summoned under the foregoing circumstances).

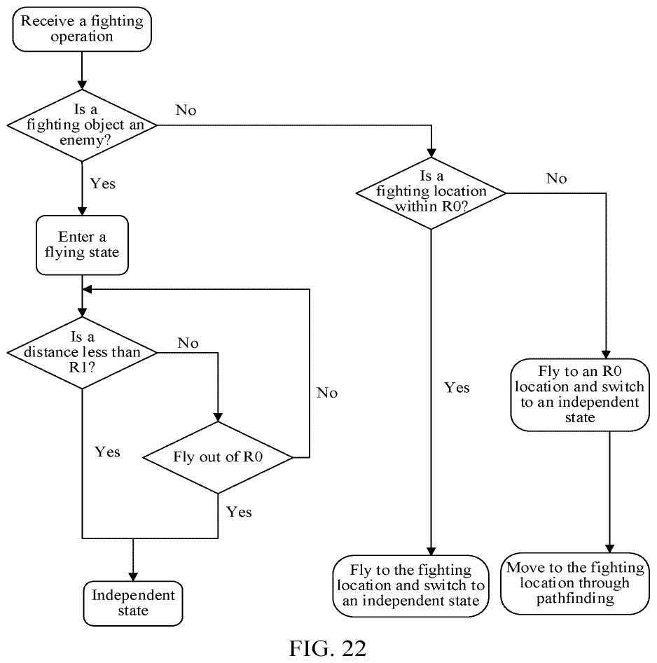

FIG. 22 is a schematic flowchart of controlling a companion object to switch from an attached state to a task state according to this embodiment of this disclosure. As shown in FIG. 22, after receiving a fighting operation triggered by a user, it is first determined whether a fighting object is a coordinate or an enemy. If the fighting object is an enemy, the companion object in an arm-attached state is first controlled to fly out in the form of a mass of energy or substance (which may be set based on the world view of a specific game), and during the flight, a real-time distance between the companion object currently in a flying state and the enemy is detected frame by frame. If the distance is less than a preset value R1, the companion object in the flying state immediately lands, is switched to the companion object in the independent state (such as a companion object in a human form), and then approaches the enemy through automatic pathfinding. If the distance between the companion object currently in the flying state and the enemy is greater than R1 through detection frame by frame, it is still determined whether the distance between the companion object currently in the flying state and the user-controlled object is greater than R0. If so, the companion object currently in the flying state is controlled to land and switch to the independent state, and the companion object in the independent state is controlled to continue to approach the enemy through pathfinding. If not, the companion object is controlled to continue flying and return to the previous step for frame-by-frame detection.

In addition, if the landing location is a location unreachable by the companion object in the virtual scene (for example, a special location such as a wall and a fault) when the previous step is performed, a nearest reachable location for the companion object may be found as a landing point of the companion object by tracing along a line connecting the current location of the companion object to the location of the user-controlled object, so as to control the companion object in the flying state at the landing point to land and switch to an independent state and then perform automatic pathfinding to approach the enemy.

In the air, the companion object may be affected by the gravity of the engine and land with the acceleration of gravity, thereby presenting a more realistic landing effect.

Still referring to FIG. 22, if the fighting object is a coordinate in the virtual scene, the companion object in the attached state is still first controlled to fly out of the arm of the object in the form of a mass of energy or particles, and the distance between the companion object and the user-controlled object is detected frame by frame during the flight. If the companion object has flown out by the R0 distance, the companion object may immediately land, switch to an independent state, and then continue to perform pathfinding to reach the fighting location. If a flight distance does not reach R0, and the fighting location is reached, the companion object directly lands and switches to the independent state. In addition, if the landing point is a location unreachable by the companion object in the virtual scene, the point reachable by the companion object and closest to the fighting location is found as the landing point of the companion object by tracing along the connecting line between the current location of the companion object and the location of the user-controlled object.

Based on the above, the method for controlling a companion object in the virtual scene provided in this embodiment of this disclosure has the following optimized experience compared with the solution provided in the related art: 1) a companion object is described in a battle to assist the user-controlled object in combat; 2) when the user does not transmit any instruction to the companion object, the companion object flies from the companion object in the independent form to the arm of the user-controlled object by default in the form of particles or energy and through transformation, and becomes a part of an arm model; 3) the companion object may bring specific capabilities to the user-controlled object when becoming a part of the user-controlled object; 4) when necessary, the user may assign the companion object to perform the corresponding task through a unique instruction. If the companion object before assignment is in an arm-attached state, corresponding switching performance of flying out of the arm may be presented; 5) for the companion object that is already in an independent state, the user may also actively recall the companion object to the arm-attached state through an instruction different from the foregoing assigned instruction, and corresponding state switching may also be presented; and 6) the companion object automatically returns to the arm-attached state and presents the corresponding state switching performance upon completion of the task.

Stage III: Control a Companion Object in a First State to Enhance a First Virtual Object, and/or Control the Companion Object in a Second State to Assist the First Virtual Object.

In a case that the companion object is in the first state, a user or a client controls the companion object to enhance the first virtual object, the enhancement including at least one of the following:
enhancing a scouting capability of the first virtual object;
enhancing a defense capability of the first virtual object;
increasing a weapon attack speed of the first virtual object;
enhancing a buff of the weapon attack of the first virtual object; and
increasing an energy storage capacity of the first virtual object.

In an aspect of the disclosure, a buff may include a change to a game which increases the utility or effect of game elements, items environments mechanics, etc., while a nerf is a change that decreases the utility or effect. For example, buff can be used to describe a positive status effect that affects mainly player or enemy statistics (usually cast as a spell). Examples of buffs include increasing the movement speed of the target, increasing the attack speed of the target, increasing the health points of the target, increasing the target's perception, increasing the target's physical defense, healing the target over time for a period of time, boosting the damage output of the target, taunting the enemy to avoid other players getting attacked, and stealth to avoid the enemy detecting or hitting the player. In another example, debuffs are effects that may negatively impact a player character or a non-player character in some way other than reducing their hit points. Some examples of debuffs include reducing the movement speed of the target, reducing the attack speed of the target, decreasing the resistance of the target to various elements or forms of attack, reducing the stats of the target, crippling the target's perception, lowering the target's physical defense, draining the target's health capacity, removing the target's health over time while the status effect is active, making the character act on his/her own, and skipping the target's turn. The buff and/or debuff may be applied temporarily, such as for a predetermined period of time, or while one or more certain conditions are met.

In a case that the companion object is in the second state, a user or a client controls the companion object to assist the first virtual object, the assistance including one of the following:
assisting the first virtual object in scouting;
assisting the first virtual object in a defense;
assisting the first virtual object in a patrol;
assisting the first virtual object in an attack; and
assisting the first virtual object in a taunt. Taunting may include attracting attention of the enemy and causing the enemy to actively attack or give priority to attacking the companion object itself instead of attacking the first virtual object.

In different embodiments, there may be one or more types of companion objects. Four different types of companion objects of a scouting object, a shield object, a melee object, and a ranged object are used as examples for description below. However, companion object of other types are within the scope of the present disclosure. For example, a companion object of another type may be formed by different combinations of the enhancements and/or assistance of the following different companion objects, which is not limited in this disclosure.

In some embodiments, the companion object in the first state is controlled to perform a first enhancement on the first virtual object in a case that the companion object is not equipped with an enhancement prop. The companion object in the first state is controlled to perform a second enhancement on the first virtual object in a case that the companion object is equipped with the enhancement prop. An enhancement effect of the second enhancement is better than that of the first enhancement.

In some embodiments, the companion object in the second state is controlled to perform a first assistance on the first virtual object in a case that the companion object is not equipped with an enhancement prop. The companion object in the second state is controlled to perform a second assistance on the first virtual object in a case that the companion object is equipped with the enhancement prop. An assistance effect of the second assistance is better than that of the first assistance.

### Companion Object of a Scouting Type:

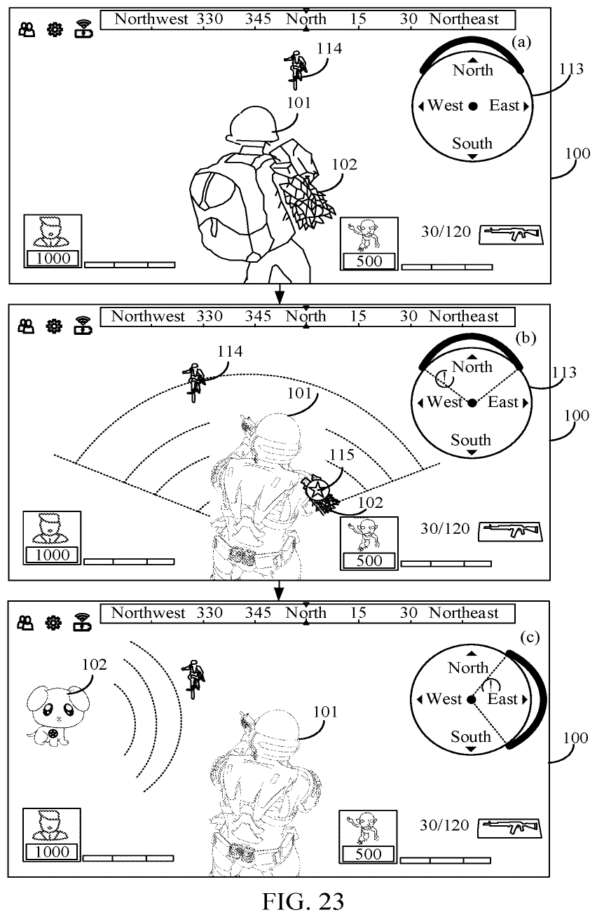

An embodiment of this disclosure provides a technical solution of a scouting method in a virtual scene, and the method may be performed by a terminal or a client on the terminal. As shown in FIG. 23, a first virtual object 101 located in a virtual scene 100 is displayed in the client, and the first virtual object 101 has a companion object 102 for scouting.

Exemplarily, in a case that the companion object 102 is attached to a limb (a first state) of the first virtual object 101 and is not loaded with a scouting enhancement prop 115, in response to discovering a third virtual object 114 through scouting of a circular region centered at the first virtual object 101, the client displays orientation information of the third virtual object 114 in a map display control 113. The scouting enhancement prop 115 may be understood as a prop configured to enhance a scouting capability, also referred to as a virtual scouting prop. In some examples, the scouting enhancement prop 106 may be implemented as a chip.

In an example, the orientation information is used for indicating orientation information of the third virtual object 114 relative to the first virtual object 101, and an orientation indicated in the orientation information is one of at least two preset orientations.

For example, as shown in (a) in FIG. 23, in a case that the companion object 102 is attached to an arm of the first virtual object 101, the companion object 102 scouts the third virtual object 114 in the circular region centered at the first virtual object 101, and in a case that the third virtual object 114 is within a scouting range, the orientation information of the third virtual object 114 is displayed in the map display control 113. For example, if the third virtual object 114 is located in the north of the first virtual object 101, a north part of the map display control 113 is highlighted and outlined in bold in the map display control 113.

Exemplarily, in a case that the companion object 102 is attached to the limb of the first virtual object 101, the companion object 102 is loaded with the scouting enhancement prop 115, and the first virtual object 101 enters an aiming state with directivity, in response to the companion object 102 scouting a first fan-shaped region centered at the first virtual object 101, the client displays, in the map display control 113, location information of the third virtual object 114 in the first fan-shaped region in a case that a third virtual object exists in the first fan-shaped region. In some embodiments, even if the companion object 102 is not equipped with the scouting enhancement prop 115, and even does not enter a standard state of directivity, a region scouted by the companion object may also be a fan-shaped region.

The location information is used for indicating geographic location information of the third virtual object 114 relative to the first virtual object 101.

For example, as shown in (b) in FIG. 23, in a case that the companion object 102 is attached to an arm of the first virtual object 101, the companion object 102 is loaded with the scouting enhancement prop 115, and the first virtual object 101 enters an aiming state, the companion object 102 scouts the first fan-shaped region based on prop attributes of the scouting enhancement prop 115 centered at the first virtual object 101. At this moment, the third virtual object 114 is in the northwest of the first virtual object 101, and the location information of the third virtual object 114 is prominently displayed in the map display control 113, that is, an actual geographical location of the third virtual object 114 is displayed in the northwest of the map display control 113.

In a case that the companion object 102 is attached to the limb of the first virtual object 101, the companion object 102 is loaded with the scouting enhancement prop 106, the companion object 102 may correspondingly have an energy value progress bar, and the first virtual object 101 enters an aiming state, the client displays, in the map display control 113 in response to the companion object 102 scouting a second fan-shaped region within a first duration centered at the first virtual object 101, location information of the third virtual object 114 in the second fan-shaped region in a case that the third virtual object 114 exists in the second fan-shaped region. The first duration is related to an energy value of the companion object 102. The energy value progress bar is configured to indicate a first duration for which the companion object 102 scouts a second region. A size of the second region is greater than a size of the first region.

For example, the energy progress bar of the companion object 102 is further displayed on a user interface. A first time period of 5 seconds may be obtained based on the energy progress bar. Then, in a case that the first virtual object 101 enters the aiming state, the companion object scouts a second fan-shaped region 117 within 5 seconds based on the prop attribute of the scouting enhancement prop 115 and the energy value of the companion object 102 centered at the first virtual object 101. In a case that the third virtual object 114 is in the second fan-shaped region, location information of the third virtual object 114 in the second fan-shaped region is displayed in the map display control 113.

In a case that the companion object 102 is loaded with the scouting enhancement prop 115, and the companion object 102 and the first virtual object 101 are detached from each other, the companion object 102 in an independent state may also perform a scouting operation similar to that in an attached state and its variants. In response to discovering the third virtual object 114 through scouting of the circular region centered at the companion object 102, the client displays, in the map display control 113, the location information of the third virtual object 114 in the circular region centered at the companion object 102.

In an example, in a case that the companion object 102 is loaded with the scouting enhancement prop 115, and the companion object 102 and the first virtual object 101 are detached from each other, the circular region centered at the companion object 102 is scouted. In a case that the third virtual object 114 exists in the circular region centered at the companion object 102 and the third virtual object 114 is behind a virtual obstacle, the third virtual object 114 is displayed in a see-through view, and the location information of the third virtual object 114 in the circular region centered at the companion object 102 is displayed in the map display control 113.

For example, as shown in (c) in FIG. 23, in a case that the companion object 102 is loaded with the scouting enhancement prop 115, and the companion object 102 and the first virtual object 101 are detached from each other, the circular region centered at the companion object 102 is scouted, the third virtual object 114 is in the northeast direction of the companion object 102, and then the actual location of the third virtual object 114 is prominently displayed in the map display control 113, that is, the actual geographical location of the third virtual object 114 is displayed in the northeast direction in the map display control 113.

In a case that the first virtual object 101 is discovered through scouting by the companion object 102 of the third virtual object 114, prompt information is displayed, the prompt information being used for indicating that the location information of the first virtual object 101 is determined by the third virtual object 114.

### Scouting Object in a First State:

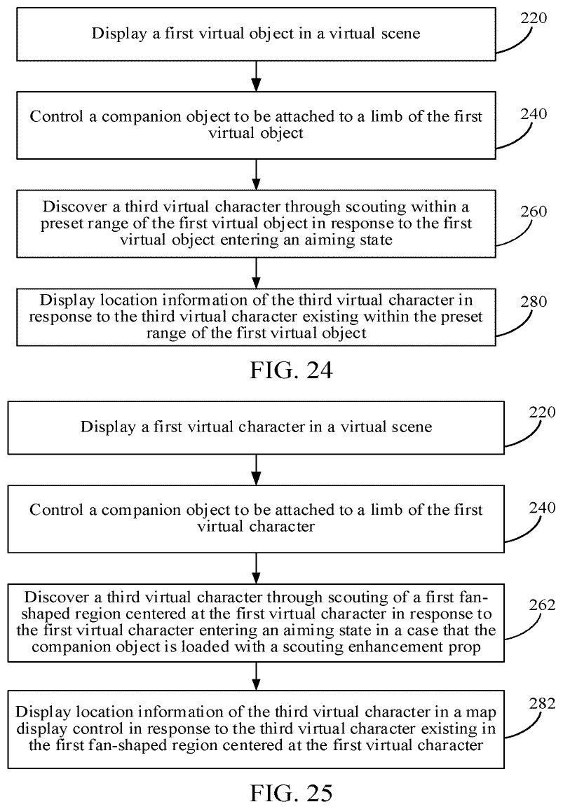

FIG. 24 is a flowchart of a scouting method in a virtual scene according to an exemplary embodiment of this disclosure. The method may be performed by a terminal device or a client on the terminal device. The method includes the following steps.

Step 220: Display a first virtual object in a virtual scene.

A virtual scene is a virtual activity space provided by an application program in a terminal during operation, for the first virtual object to perform various activities in the virtual activity space, and the first virtual object has a companion object for scouting.

Exemplarily, a virtual scene picture is a two-dimensional picture obtained by capturing a picture of the virtual scene and displayed on the client. Exemplarily, a shape of the virtual scene picture is determined based on a shape of a display screen of the terminal or a shape of a user interface of the client. For example, the display screen of the terminal is rectangular, and the virtual scene picture is also displayed as a rectangular picture.

The first virtual object is a virtual object controlled by the client. The client may control the first virtual object to move in the virtual scene based on a received user operation.

Exemplarily, activities of the first virtual object in the virtual scene may include: walking, running, jumping, climbing, getting down, attacking, releasing a skill, picking up a prop, sending a message, which are not limited thereto and not limited in this embodiment of this disclosure.

Step 240: Control the companion object to be attached to a limb of the first virtual object (in a first state).

The companion object is a movable object with different functions of the first virtual object in the virtual scene. The companion object may be obtained through at least one of picking, snatching, and purchasing, which is not limited in this disclosure.

Exemplarily, in a case that the companion object has just been obtained, the companion object is in the first state. Alternatively, the client controls the companion object to be in the first state in response to a second switching operation on the companion object. The companion object is attached to the limb of the first virtual object in the first state. For example, the companion object is attached to an arm of the first virtual object, the companion object is attached to a leg of the first virtual object, and the companion object is attached to a back of the first virtual object, which is not limited thereto and not limited in this embodiment of this disclosure.

Step 260: Discover a third virtual object within a preset range of the first virtual object through scouting in response to the first virtual object entering an aiming state.

In some embodiments, the third virtual object is another virtual object except the first virtual object, that is, the third virtual object is a virtual object in the same camp as the first virtual object, or a virtual object in a different camp from the first virtual object, which is not limited in this embodiment of this disclosure.

The aiming state is a directional operation in which the first virtual object focuses its sight or attention on a location or a direction, for example, the first virtual object enters a waist aiming state or a shoulder aiming state, which is not limited thereto and not limited in this embodiment of this disclosure. For example, in a common shooting game, zoom-in is performed for observation in a direction in a sniper state, which belongs to the aiming state.

Waist aiming is an aiming state without using a sight, and shoulder aiming is an aiming state using a sight.

The preset range is a default scouting range of the first virtual object, which may be at least one of a fan shape, a circle, a circular ring, and a rectangle, which is not limited thereto, and the shape of the preset range is not specifically limited in this embodiment of this disclosure.

Step 280: Display location information of the third virtual object in response to the third virtual object existing within the preset range of the first virtual object.

The location information of the third virtual object is at least one of a location direction and specific geographic information of the third virtual object, which is not limited thereto and not limited in this embodiment of this disclosure.

Exemplarily, in response to the companion object discovering the third virtual object through scouting, a client displays the location information of the third virtual object in a user interface.

Based on the above, according to the method provided in this embodiment, the first virtual object in the virtual scene is displayed, the companion object is controlled to be attached to the limb of the first virtual object, and in a case that the first virtual object enters the aiming state, the third virtual object within the preset range of the first virtual object is discovered through scouting, and the location information of the third virtual object is displayed. A new scouting mode is provided in this disclosure to assist a user in actively discovering the location information of the third virtual object through scouting, thereby improving the efficiency of human-computer interaction and enhancing user experience.

FIG. 25 is a flowchart of a scouting method in a virtual scene according to an exemplary embodiment of this disclosure. The method may be performed by a terminal in the system shown in FIG. 2 or a client on the terminal. The method includes the following steps.

Step 220: Display a first virtual object in a virtual scene.

A first location of the first virtual object or companion object in the virtual scene may be a central location in the map display control, or may be another location in the map display control. That is, the first location of the first virtual object or the companion object in the virtual scene may correspond to the center of the map display control, or may correspond to another location of the map display control. This embodiment of this disclosure is described by using the example that the first location of the first virtual object in the virtual scene may correspond to the center of the map display control.

Step 240: Control the companion object to be attached to a limb of the first virtual object.

Step 262: Discover a third virtual object through scouting of a first fan-shaped region centered at the first virtual object in response to the first virtual object entering an aiming state in a case that the companion object is loaded with a scouting enhancement prop.

The scouting enhancement prop is an item with a scouting function of the first virtual object in the virtual scene.

The scouting enhancement prop may be obtained through at least one of picking, snatching, and purchasing, which is not limited in this disclosure.

In an example, the first virtual object entering the aiming state means that the first virtual object controls a virtual shooting prop or virtual bow and arrow props to enter the aiming state, for example, controls the virtual shooting prop to aim at the third virtual object, or controls the virtual shooting prop to aim at a virtual stone, which is not limited thereto. A controlling prop, an aiming direction, and an aiming item of the first virtual object entering the aiming state are not specifically limited in this embodiment of this disclosure.

Step 282: Display location information of the third virtual object in a map display control in response to the third virtual object existing in the first fan-shaped region centered at the first virtual object.

Exemplarily, a client displays the location information of the third virtual object in the map display control in response to the third virtual object existing in the first fan-shaped region centered at the first virtual object.

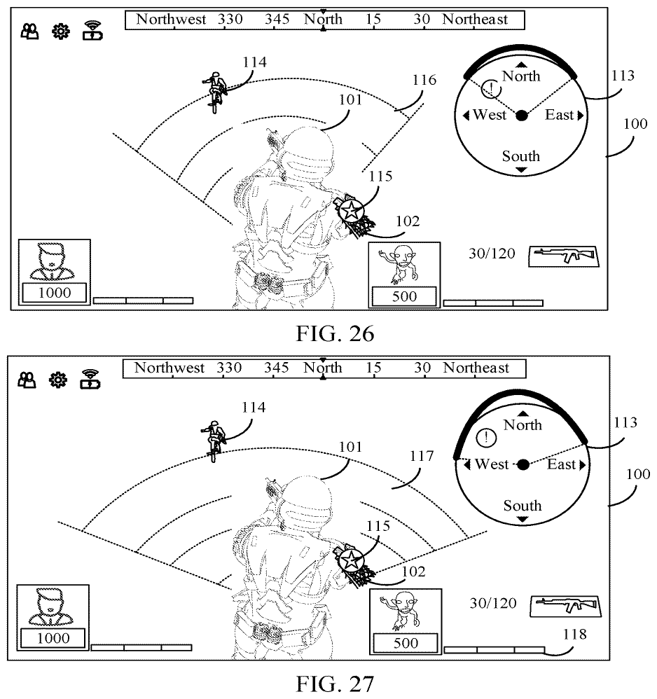

Exemplarily, as shown in FIG. 26, a first virtual object 101 located in a virtual scene 100 is displayed in the client, and the first virtual object 101 has a companion object 102 for scouting. In a case that the companion object 102 is attached to an arm of the first virtual object 101, the companion object 102 is loaded with the scouting enhancement prop 115, and the first virtual object 101 enters an aiming state, the companion object 102 scouts a first fan-shaped region 116 based on prop attributes of the scouting enhancement prop 115 centered at the first virtual object 101. At this moment, the third virtual object 114 is in the northwest of the first virtual object 101, and the location information of the third virtual object 114 is displayed in the map display control 113, that is, an actual geographical location of the third virtual object 114 is displayed in the northwest of the map display control 113.

In a possible implementation, the companion object correspondingly has an energy value progress bar. In response to the first virtual object entering the aiming state, the third virtual object in a second fan-shaped region is discovered through scouting within a first duration centered at the first virtual object, and in response to the third virtual object existing in the second fan-shaped region, the location information of the third virtual object is displayed in the map display control. A size of the second fan-shaped region is greater than a size of the first fan-shaped region.

In an example, in a case that the companion object is loaded with the scouting enhancement prop, the companion object correspondingly has an energy value progress bar. The energy value progress bar is configured to indicate a first duration for which the companion object scouts the second fan-shaped region. That is, the client may determine, based on a value of the energy value progress bar, a duration for which the companion object scouts the second fan-shaped region.

Exemplarily, as shown in FIG. 27, a first virtual object 101 located in a virtual scene 100 is displayed in the client, and the first virtual object 101 has a companion object 102 for scouting. In a case that the companion object 102 is attached to the limb of the first virtual object 101, the companion object 102 is loaded with the scouting enhancement prop 115, the companion object 102 correspondingly has an energy value progress bar 118, and the first virtual object 101 enters an aiming state, the client displays, in the map display control 113 in response to the companion object 102 scouting a second fan-shaped region 117 within a first duration centered at the first virtual object 101, location information of the third virtual object 114 in the second fan-shaped region in a case that the third virtual object 114 exists in the second fan-shaped region 117.

The first duration is related to an energy value of the companion object 102. The energy value progress bar 118 is configured to indicate a first duration for which the companion object 102 scouts the second fan-shaped region 117.

For example, a first time period of 5 seconds may be obtained based on the energy progress bar 118. Then, in a case that the first virtual object 101 enters the aiming state, the companion object 102 scouts the second fan-shaped region 117 within 5 seconds based on the prop attribute of the scouting enhancement prop 115 and the energy value of the companion object 102 centered at the first virtual object 101. In a case that the third virtual object 114 is in the second fan-shaped region 117, location information of the third virtual object 114 in the second fan-shaped region 117 is displayed in the map display control 113. In an example, after the end of 5 seconds, the companion object may continue to scout the first fan-shaped region 116.

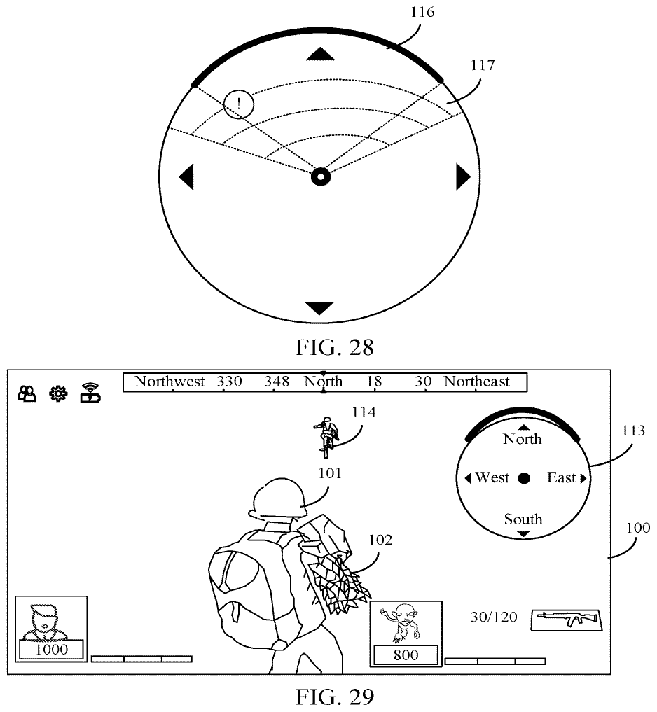

Exemplarily, as shown in the schematic diagram of the map display control shown in FIG. 28, the first fan-shaped region 116 is the first fan-shaped region 116 scouted for the third virtual object centered at the first virtual object, and the second fan-shaped region 117 is the second fan-shaped region 117 scouted for the third virtual object within the first duration centered at the first virtual object. The size of the second fan-shaped region 117 displayed in the map display control is greater than the size of the first fan-shaped region 116.

In a possible implementation, in a case that the companion object is in the first state and does not enter the aiming state, the third virtual object is discovered through scouting of a circular region centered at the first virtual object. A client displays the orientation information of the third virtual object in the map display control in response to the third virtual object existing in the circular region centered at the first virtual object. In an example, in a case that the companion object is in the first state, is not loaded with the scouting enhancement prop, and does not enter the aiming state, the third virtual object is discovered through scouting of the circular region centered at the first virtual object.

In an example, the orientation information is used for indicating orientation information of the third virtual object relative to the first virtual object, and an orientation indicated in the orientation information is one of at least two preset orientations.

Energy corresponding to the energy value progress bar is stored in response to the first virtual object not entering the aiming state. For example, when the first virtual object does not enter the aiming state, an energy value thereof continues to increase.

For example, as shown in FIG. 29, a first virtual object 101 located in a virtual scene 100 is displayed in the client, and the first virtual object 101 has a companion object 102 for scouting. In a case that the companion object 102 is attached to an arm of the first virtual object 101, the companion object 102 scouts the third virtual object 114 in the circular region centered at the first virtual object 101, and in a case that the third virtual object 114 is within a scouting range, the orientation information of the third virtual object 114 is displayed in the map display control 113. For example, if the third virtual object 114 is located in the north of the first virtual object 101, a north part of the map display control 113 is highlighted and outlined in bold in the map display control 113.

In some embodiments, in a case that the third virtual object is discovered through scouting within the first duration, second location information of the third virtual object is displayed in the map display control, and the third virtual object is set to a marked state, the second location information of the third virtual object in the marked state being to be continuously displayed in the map display control, and the marked state having a duration. That is, the marked state is a state in which field of view information of the third virtual object is exposed to fields of view of the first virtual object and teammates of the first virtual object.

Based on the above, according to the method provided in this embodiment, the first virtual object in the virtual scene is displayed, the companion object is controlled to be attached to the limb of the first virtual object, and a plurality of manners of discovering the third virtual object through scouting within the preset range of the first virtual object and displaying the location information of the third virtual object are provided.

In the first scouting manner, the companion object is loaded with a scouting enhancement prop. In response to the first virtual object entering the aiming state, the third virtual object in the first fan-shaped region is discovered through scouting centered at the first virtual object, and the location information of the third virtual object in the first fan-shaped region is displayed in the map display control, thereby assisting the user in discovering the location information of the third virtual object through scouting, improving the efficiency of human-computer interaction, and improving user experience.

In the second scouting manner, the companion object is loaded with a scouting enhancement prop, and the companion object correspondingly has an energy value progress bar. In response to the first virtual object entering the aiming state, the third virtual object in the second fan-shaped region is discovered through scouting centered at the first virtual object, and the location information of the third virtual object in the second fan-shaped region is displayed in the map display control, thereby assisting the user in scouting the location information of the third virtual object in a larger range, improving the efficiency of human-computer interaction, and improving user experience.

In the third scouting manner, the companion object is attached to the limb of the first virtual object and is not loaded with the scouting enhancement prop, and the third virtual object is discovered through scouting of a circular region centered at the first virtual object. In response to the third virtual object existing in the circular region centered at the first virtual object, the orientation information of the third virtual object is displayed in the map display control, which assists the user in discovering an approximate location and direction of the third virtual object through scouting, thereby improving the basic scouting capability without unnecessary operation, and improving the efficiency of human-computer interaction and user experience.

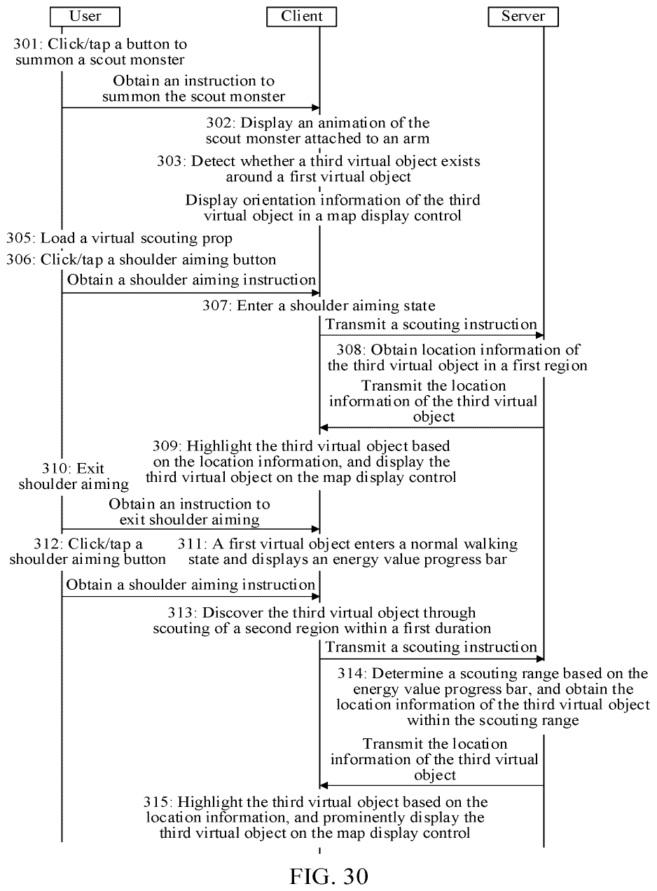

FIG. 30 is a flowchart of a scouting method in a virtual scene according to an exemplary embodiment of this disclosure. The method includes the following steps.

Step 301: Click/tap a button to summon a “scout monster”.

A companion object being the “scout monster” is used as an example. A user clicks the button to summon the “scout monster”, and a client obtains an instruction to summon the “scout monster”.

Step 302: Display an animation of the scout monster attached to an arm.

In a case that the client obtains the instruction to summon the “scout monster”, the animation of the “scout monster” attached to the arm of the first virtual object is displayed on a user interface of the client.

In an example, the animation of the “scout monster” attached to the arm of the first virtual object is the process of “scout monster” attached to the arm of the first virtual object, or a special effects display of the “scout monster” attached to the arm of the first virtual object, which is not limited in this embodiment of this disclosure.

Step 303: Detect, by using a first virtual object as a center, whether a third virtual object exists around the first virtual object.

In a case that the “scout monster” is attached to the arm of the first virtual object, the “scout monster” is in a first scouting state, and the “scout monster” discovers the third virtual object through scouting centered at the first virtual object in the first scouting state.

Step 304: Display orientation information of the third virtual object in a map display control.

In a case that the third virtual object is within a scouting range, the orientation information of the third virtual object is displayed in the map display control. For example, if the third virtual object is located in the north of the first virtual object, a north part of the map display control is highlighted and outlined in bold in the map display control.

Step 305: Load a scouting enhancement prop.

Exemplarily, the “scout monster” may be loaded with the scouting enhancement prop.

In an example, the scouting enhancement prop is an item with a scouting function of the first virtual object in the virtual scene.

The scouting enhancement prop may be obtained through at least one of picking, snatching, and purchasing, which is not limited in this disclosure.

Step 306: Click/tap a shoulder aiming button.

The user controls the first virtual object to enter a shoulder aiming state by clicking/tapping the shoulder aiming button.

Step 307: Enter a shoulder aiming state.

The client controls the first virtual object to enter the shoulder aiming state and transmits a scouting instruction to a server after receiving the shoulder aiming instruction.

Step 308: Obtain location information of the third virtual object in a first region.

It is assumed that not enough energy is stored in a case that the scouting enhancement prop is just loaded. In a case that a master server receives the scouting instruction, the server obtains the location information of the third virtual object in the first region and transmits the location information of the third virtual object in the first region to the client.

Step 309: Prominently display the third virtual object based on the location information, and highlight the third virtual object on the map display control.

In a case that the client receives the location information of the third virtual object in the first region, the client highlights the third virtual object based on the location information, and prominently displays a specific location of an enemy third virtual object on the map display control.

Step 310: Exit shoulder aiming.

The user controls the first virtual object to exit a shoulder aiming state by clicking/tapping the shoulder aiming button again.

Step 311: The first virtual object enters a normal walking state and displays an energy value progress bar.

The client controls the first virtual object to enter the normal walking state, and displays the energy value progress bar on the client after receiving an instruction to exit the shoulder aiming. In the normal walking state, the energy value progress bar may store energy.

Step 312: Click/tap a shoulder aiming button.

The user controls the first virtual object to enter a shoulder aiming state by clicking/tapping the shoulder aiming button.

Step 313: Scout the third virtual object in a second region within a first duration.

Based on the energy value progress bar, the client transmits a scouting instruction to the server in response to the “scout monster” discovering the third virtual object through scouting of the second region within the first duration. That is, the first duration is related to an energy value of the companion object.

Step 314: Determine a scouting range based on the energy value progress bar, and obtain the location information of the third virtual object within the scouting range.

The server determines the scouted second region based on the energy value progress bar, discovers the third virtual object through scouting of the second region, and transmits the location information of the third virtual object to the client. A size of the second region is related to an energy value of the companion object.

Step 315: Highlight the third virtual object based on the location information, and prominently display an enemy object on the map display control.

The client displays, in the map display control, the location information of the third virtual object in the second region and highlights the third virtual object in a case that the location information of the third virtual object is received.

### Scouting Object in a Second State:

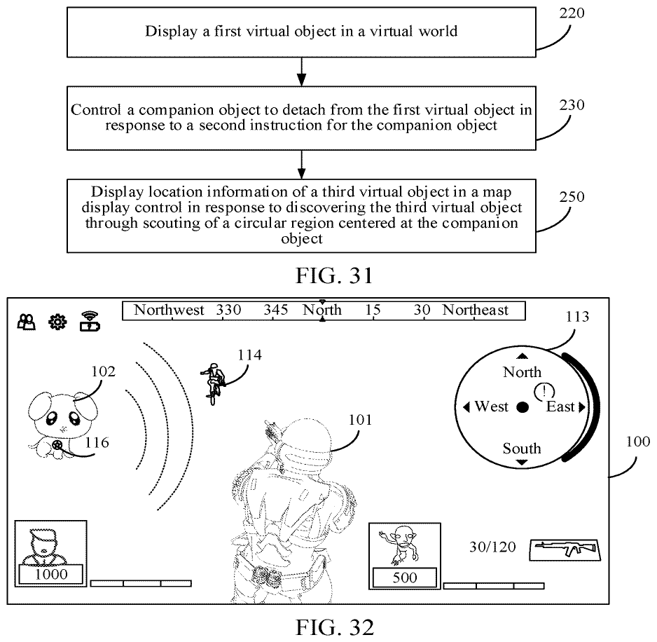

FIG. 31 is a flowchart of a scouting method in a virtual scene according to an exemplary embodiment of this disclosure. The method may be performed by a terminal device or a client on the terminal device. The method includes the following steps.

Step 220: Display a first virtual object in a virtual scene.

A virtual scene is a virtual activity space provided by an application program in a terminal during operation, for the first virtual object to perform various activities in the virtual activity space, and the first virtual object has a companion object for scouting.

The first virtual object is a virtual object controlled by the client. The client controls the first virtual object to move in the virtual scene based on a received user operation.

Step 230: Control a companion object to be detached from the first virtual object (in a second state).

The companion object is a movable object with different functions of the first virtual object in the virtual scene.

The companion object may be obtained through at least one of picking, snatching, and purchasing, which is not limited in this disclosure.

Exemplarily, in response to a second instruction for the companion object, the client controls the companion object to be detached from the first virtual object, for example, the companion object is detached from a leg of the first virtual object, which is not limited in this embodiment of this disclosure.

The companion object is controlled to scout the virtual scene at a specified location or in a specified region therein.

Step 250: Display the location information of the third virtual object in the map display control in response to discovering the third virtual object through scouting of a circular region centered at the companion object.

Exemplarily, a client displays the location information of the third virtual object in the map display control in response to discovering the third virtual object through scouting of the circular region centered at the companion object.

For example, in a case that the companion object and the first virtual object are detached from each other, the companion object can move along with the movement of the first virtual object, or the first virtual object provides a specified location or a specified region, and the companion object is fixed to the specified location or the specified region, which is not limited thereto. States of the companion object and the first virtual object after being detached from each other are not specifically limited in this embodiment of this disclosure.

Exemplarily, as shown in FIG. 32, a first virtual object 101 located in a virtual scene 100 is displayed in the client, and the first virtual object 101 has a companion object 102 for scouting. In a case that the companion object 102 is loaded with the scouting enhancement prop 115, and the companion object 102 and the first virtual object 101 are detached from each other, the circular region centered at the companion object 102 is scouted centered at the companion object, the third virtual object 114 is in the northeast direction of the companion object 102, and then the actual location of the third virtual object 114 is displayed in the map display control 113, that is, the actual geographical location of the third virtual object 114 is displayed in the northeast direction of the map display control 113.

In a possible implementation, in response to discovering the third virtual object through scouting of the circular region centered at the companion object, the client prominently displays the third virtual object, and displays, in the map display control, the location information of the third virtual object in the circular region.

In an example, the prominent display manner includes: at least one of highlighting, using an inverted color, glowing, adding a background color, and adding a prompt label, which is not limited thereto and not limited in this embodiment of this disclosure.

In a possible implementation, in response to discovering the third virtual object through scouting of the circular region centered at the companion object and the third virtual object being behind a virtual obstacle, the client displays the third virtual object in a see-through view, and displays, in the map display control, the location information of the third virtual object in the circular region.

In a possible implementation, in a case that an automatic scouting function is enabled, a target scouting state corresponding to the companion object during scouting at a current location is determined based on a location scouting model. The target scouting state includes one of a first scouting state and a second scouting state. The first scouting state means scouting orientation information of the third virtual object within a preset scouting range of the first virtual object, and the second scouting state means scouting the location information of the third virtual object within the preset scouting range of the first virtual object.

Exemplarily, in a case that the automatic scouting function is enabled, the client may determine the target scouting state corresponding to the companion object during scouting at the current location through the location scouting model.

For example, when the first virtual object arrives at a location A for scouting, the companion object automatically enters the second scouting state.

In a possible implementation, during training of the location scouting model, statistics are collected on historical location scouting records of user accounts. For example, the historical location scouting records are historical location scouting records of user accounts corresponding to sample virtual objects, or historical location scouting records corresponding to another user account, which are not limited in this embodiment of this disclosure.

Behavior characteristics of the sample virtual objects after scouting at first locations are extracted from the historical location scouting records, and corresponding sample scouting states are obtained based on the behavior characteristics. The first locations are locations of the sample virtual objects.

Data processing is performed on each of the first locations through the location scouting model, to obtain a predicted scouting state.

A model parameter of the location scouting model is updated based on a difference between the predicted scouting state and the sample scouting state.

Exemplarily, the behavior characteristics include a combat behavior characteristic and a non-combat behavior characteristic. The behavior characteristics of the sample virtual objects after scouting at the first locations are extracted from the historical location scouting records, a scouting state corresponding to the non-combat behavior characteristic is marked as the first scouting state, and a scouting state corresponding to the combat behavior characteristic is marked as the second scouting state.

In an example, the non-combat behavior characteristic is at least one of chatting, dodging, escaping, and detour, which is not limited thereto and not limited in this embodiment of this disclosure.

For example, the behavior characteristic of the sample virtual object after scouting at the first location is “dodging”, and the scouting state corresponding to the behavior characteristic of “dodging” is marked as the first scouting state. Through the location scouting model, data processing is performed on the first location is to obtain the predicted scouting state. Based on a difference between the predicted scouting state and the first scouting state, the model parameter of the location scouting model is updated to obtain a trained location scouting model.

In a possible implementation, in a case that the first virtual object is discovered through scouting by the companion object of the third virtual object, prompt information is displayed, the prompt information being used for indicating that the location information of the first virtual object is determined by the third virtual object.

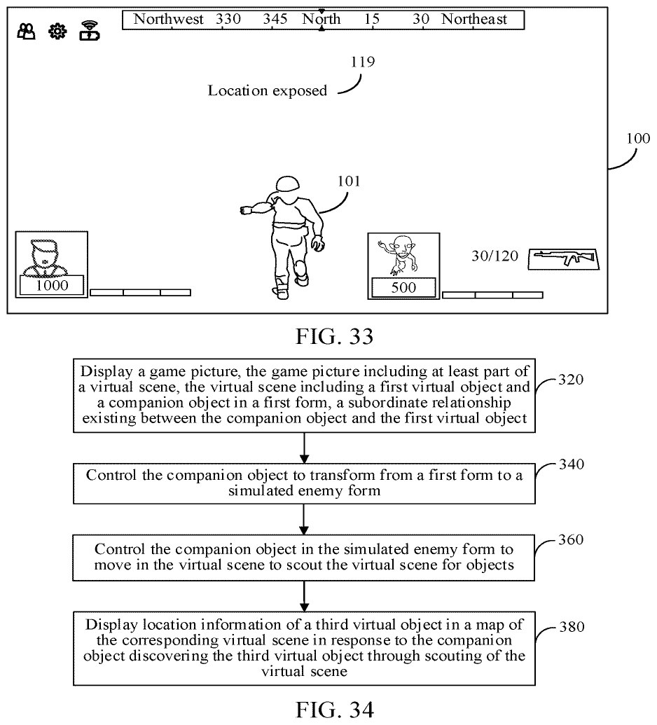

For example, as shown in FIG. 33, the first virtual object 101 located in the virtual scene 100 is displayed in the client, and in a case that the first virtual object 101 is discovered through scouting by the companion object of the third virtual object, the prompt information 119 is displayed, and the content of the prompt information 119 is at least one of “location has been exposed” and “warning”, which is not limited thereto and not limited in this embodiment of this disclosure.

Based on the above, according to the method provided in this embodiment, the first virtual object in the virtual scene is displayed, the companion object is controlled to be detached from the first virtual object, the third virtual object is discovered through scouting of the circular region centered at the companion object, and the location information of the third virtual object is displayed in the map display control. A new scouting mode is provided in this disclosure to assist a user in actively discovering the location information of the third virtual object through scouting, thereby improving the efficiency of human-computer interaction and enhancing user experience.

FIG. 34 is a flowchart of a scouting method in a virtual scene according to an exemplary embodiment of this disclosure. The method includes the following steps.

Step 320: A client displays a game picture.

The game picture includes at least part of a virtual scene, the virtual scene includes a first virtual object and a companion object in a second form, and a subordinate relationship exists between the companion object and the first virtual object.

In some embodiments, the client may display the game picture in the following manners. The client may display a summoning control configured to summon the companion object in an interface of the virtual scene; receive a summoning instruction in response to a triggering operation on the summoning control; and generate and transmit a summoning request for the companion object to a server in response to the summoning instruction, the summoning request carrying an object identifier of a to-be-summoned companion object, and the server determining, based on the summoning request, a relevant parameter of the companion object to be summoned by the summoning request, and pushing the determined relevant parameter of the companion object to the client, so that the client can render the picture based on the relevant parameter and display the rendered summoning picture (that is, the foregoing game picture).

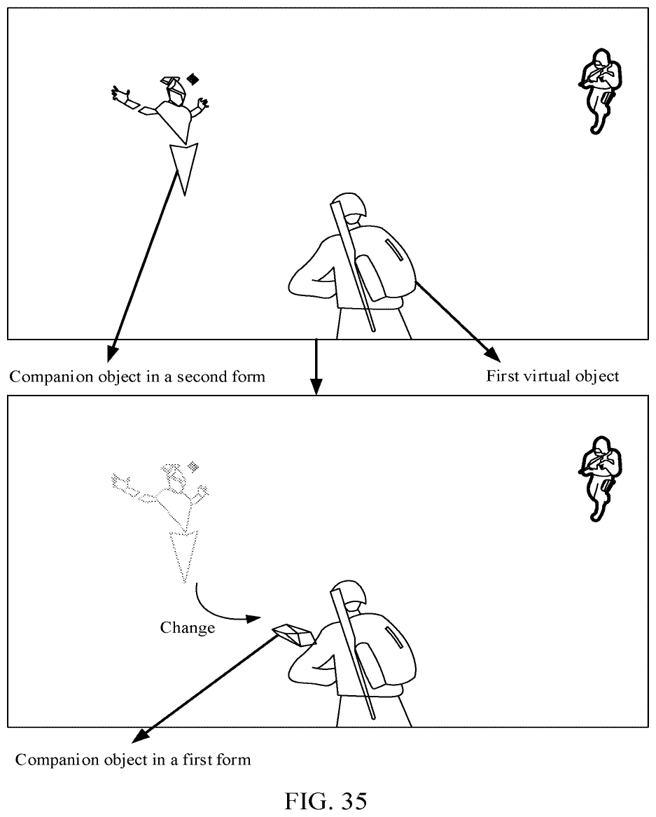

FIG. 35 is a schematic diagram of a form change of a companion object according to an embodiment of this disclosure. A client displays a summoned companion object in a second form in response to a summoning instruction, and shows a process that the companion object in the second form is transformed into the companion object in a first form and the companion object in the first form is adsorbed (for example, conformed, formed, worn, or other incorporated) on a first virtual object to become a part of a first virtual object. For example, a summoned wild monster of an animation image is first displayed, and then an animation in which the wild monster of the animation image turns into fragments and the fragments are adsorbed on an arm of the first virtual object is displayed.

Companion objects in different forms can have different auxiliary effects on the first virtual object. For example, the companion object in the second form may be an independent virtual image located at a distance around the first virtual object. When the first virtual object moves in the virtual scene, the companion object in the second form moves with the movement of the first virtual object. After the companion object in the second form is summoned, and before the companion object is changed from the second form to the first form, the client may also control the companion object in the second form to scout a target region centered on the companion object in the virtual scene, and when a target object (such as a second virtual object or a virtual material) is discovered through scouting, indication information of the discovered target object through scouting is displayed. The companion object in the first form is attached to the arm of the first virtual object, and the companion object in the first form is less easily perceived by the second virtual object than the companion object in the second form. Therefore, during control of the companion object in the first form to scout the virtual scene for objects or resources, it is more conducive to discovering or detection of valuable information through scouting, such as a location of the second virtual object and distribution of resources around and nearby the second virtual object, so as to improve the interaction capability of the first virtual object.

In some embodiments, the client may control the companion object in the first form to scout the virtual scene for objects in response to the companion object in the first form being adsorbed onto the first virtual object; and display location information of a third virtual object in a map of a corresponding virtual scene when the third virtual object being discovered through scouting of a first region centered on the first virtual object.

In practical application, the client may control the companion object in the first form to assist the first virtual object in the virtual scene and interact with another virtual object in a different virtual object group from the first virtual object. Therefore, in order to learn location information of the another virtual object, the companion object in the first form may be controlled to scout the virtual scene for objects. A collider component (such as a collision box or a collision ball) is bound to another virtual object (such as a virtual object or a non-player character in a different group from the first virtual object, collectively referred to as a third virtual object) in the virtual scene. In the process of controlling the companion object in the first form to scout the virtual scene for objects, a detection ray is emitted from the companion object in a direction of the first virtual object or the companion object through a camera component on the companion object. When the detection ray intersects with the collider component bound to the third virtual object, it is determined that the companion object discovers the third virtual object through scouting. When the detection ray does not intersect with the collider component bound to the third virtual object, it is determined that the companion object has not discovered the third virtual object through scouting. When the third virtual object is discovered through scouting, a warning is sent for the third virtual object, and the location information of the third virtual object is displayed in the map of the virtual scene, such as a distance and a direction of the third virtual object relative to the first virtual object.

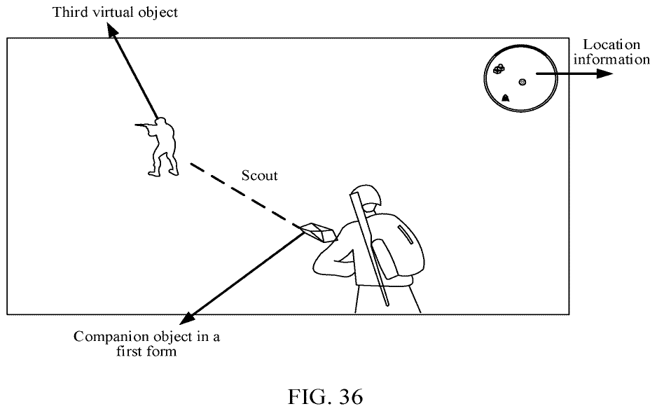

FIG. 36 is a schematic diagram of scouting according to an embodiment of this disclosure. A companion object in a first form is controlled to scout a virtual scene for objects. When a third virtual object is discovered through scouting of a first region centered on a first virtual object or the companion object, location information of the third virtual object is displayed in a map of the virtual scene, so as to send a warning to the first virtual object or all virtual objects (friends) in a group to which the first virtual object belongs and view the location information of the third virtual object. After the location information of the third virtual object is learned, it is convenient for a client to control the corresponding virtual object to interact with the third virtual object by adopting the most suitable interaction strategy at present, which is beneficial to improving interaction capability of the first virtual object or the group to which the first virtual object belongs.

Step 340: Control a companion object to transform from a first form to a simulated enemy form.

In an example, the companion object is controlled to transform from the first form to the simulated enemy form in response to a switching operation. That is, the companion object is controlled to mimic an image of the third virtual object. The simulated enemy form is a form of the companion object independent of the first virtual object, and is configured to simulate an appearance form of the third virtual object. The simulated enemy form may be understood as mimicry in a second form. A first instruction triggered by a first switching operation is also referred to as a transformation instruction, which may be triggered by triggering a transformation control. For example, the client may display the transformation control for the companion object in an interface of the virtual scene. In response to the triggering operation for the transformation control, a transformation instruction is received. In response to the transformation instruction, a transformation request for the companion object is generated and transmitted to the server. The transformation request carries an object identification of the companion object. Based on the transformation request, the server determines a relevant parameter of the companion object requested to transform by the transformation request (such as a non-player character or another virtual object in a different group from the first virtual object near the companion object), and pushes the determined relevant parameter of the companion object to the client, so that the client can render a picture based on the relevant parameter and display the rendered summoning picture, that is, display a process of the transformation of the companion object from the first form to the simulated enemy form.

The simulated enemy form corresponds to (such as consistent with) the image of the third virtual object in the virtual scene. The third virtual object may be a virtual object existing in the first region centered on the companion object in the virtual scene, and a hostile relationship exists between the third virtual object and the first virtual object. A display style of the third virtual object may be the same or different from the perspective of both sides between which the hostile relationship exists. For example, from the perspective of the enemy (such as the third virtual object or another virtual object having a friend relationship with the third virtual object), the third virtual object (such as an enemy hero or an enemy wild monster) is displayed in a style consistent with the image of the third virtual object. From the perspective of the first virtual object, the third virtual object is displayed in a prominent display manner to give a significant prompt to a user. The prominent display manner includes at least one of the following display manners: displaying with a target color, superposing a mask, displaying with a highlight color, outlining in bold, and displaying in a see-through view.

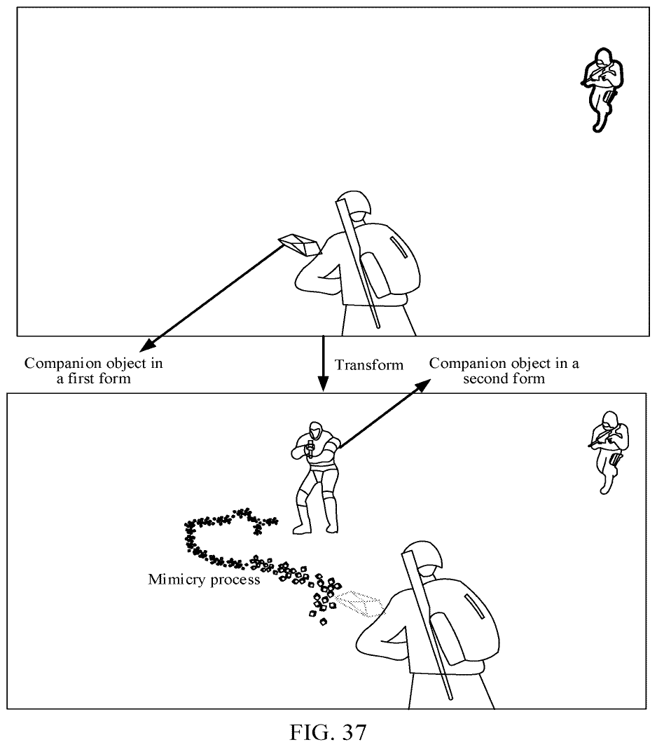

FIG. 37 is a schematic diagram of a form change of a companion object according to an embodiment of this disclosure. When the companion object in a first form is a fragment adsorbed on an arm of a first virtual object (obtained by disintegration of a wild monster of an animation image), in response to a transformation instruction, a client displays an animation in which the fragment adsorbed onto the arm of the first virtual object is detached from the arm to move to a target location and the detached fragment is transformed into a companion object (that is, a companion object in a simulated enemy form) with the same image as the third virtual object at the target location.

In some embodiments, when a quantity of third virtual objects is at least two, the client may determine the simulated enemy form to be transformed in the following manners: displaying an image selection interface, and displaying selectable images corresponding to at least two third virtual objects in the form selection interface; and using the selected image as an image in the simulated enemy form in response to a selection operation on one image in the at least two third virtual objects, that is, the selected image of the third virtual object. In this way, a user can manually select the transformation form of the companion object, which further improves operation experience of the user.

For example, the client receives the transformation instruction in response to a triggering operation on a transformation control, and generates and transmits a transformation request for the companion object to a server in response to the transformation instruction. The transformation request carries an object identifier of the companion object, and the server detects the third virtual object in a third region centered on the companion object in the virtual scene based on the transformation request, and returns a detection result to the client. When the detection result indicates that a plurality of third virtual objects are detected, a form selection interface is displayed in the interface of the virtual scene, and selectable forms corresponding to at least two third virtual objects are displayed in the form selection interface, such as a form of a third virtual object 1, a form of a third virtual object 2, and a form of a third virtual object 3. The user may perform selection on the forms of the plurality of third virtual objects displayed in the form selection interface. Assuming that the user selects the form of the third virtual object 2 in the form selection interface, the client determines the form of the third virtual object 2 selected by the user as the simulated enemy form of the companion object to be transformed.

In some embodiments, before controlling the companion object to transform from the first form to the simulated enemy form, the client may predict the simulated enemy form in the following manners: obtaining scene data of a first region centered on the companion object in the virtual scene, the scene data including another virtual object located in the first region (such as another virtual object or a non-player character located in a different group from the first virtual object); and invoking a machine learning model to perform prediction processing based on the scene data, to obtain the simulated enemy form, The machine learning model is trained based on the scene data in a sample region and a labeled form (the form of the companion object). In this way, the form of the companion object that can maximally improve the interaction capability of the first virtual object or a group to which the first virtual object belongs is predicted by invoking the machine learning model, thereby improving the prediction accuracy, causing the greatest interference to the enemy, and further improving the interaction capability of the first virtual object or the group to which the first virtual object belongs.

The machine learning model may be a neural network model (for example, a convolutional neural network, a deep convolutional neural network, or a fully connected neural network), a decision tree model, a gradient lifting tree, a multi-layer perceptron, a support vector machine, and the like. The type of the machine learning model is not specifically limited in this embodiment of this disclosure.

Step 360: Control a companion object in a simulated enemy form to move in a virtual scene to scout the virtual scene.

In a case that the companion object is transformed to correspond to the image of the third virtual object, the user controls the companion object to move in the virtual scene to scout the virtual scene for objects. For example, a mobile control for the companion object in the simulated enemy form is displayed in the interface of the virtual scene. When the user triggers the mobile control, the client controls the companion object in the simulated enemy form to move in the virtual scene in response to a movement instruction triggered by the triggering operation, and scouts the virtual scene for objects during the movement. In practical application, a collider component (such as a collision box or a collision ball) is bound to a virtual object in the virtual scene. In the process of controlling the companion object in the simulated enemy form to scout the virtual scene for objects, a detection ray is emitted from the companion object in a direction of the companion object through a camera component on the companion object. When the detection ray intersects with the collider component bound to the virtual object, it is determined that the companion object discovers the virtual object through scouting. When the detection ray does not intersect with the collider component bound to the virtual object, it is determined that the companion object does not scout the virtual object. In addition, after the companion object is transformed to correspond to the image of the third virtual object, the companion object may also automatically move in the virtual scene without user control to scout the virtual scene for objects. In this way, the operation flow is simplified, and the scouting efficiency can be improved.

Step 380: Display location information of a third virtual object in a map of the corresponding virtual scene in response to the companion object discovering the third virtual object through scouting of the virtual scene.

The third virtual object may be a general name of the virtual object belonging to a different group from the first virtual object discovered through scouting of a target region centered on the companion object or a non-player character associated with the virtual object (that is, another object having a hostile relationship with the virtual object), which may include the foregoing third virtual object. When the third virtual object is discovered through scouting, the location information of the third virtual object is displayed in the map of the virtual scene, for viewing by the first virtual object or all virtual objects in a group to which the first virtual object belongs. After the location information of the third virtual object is learned, it is convenient for a client to control the corresponding virtual object to interact with the third virtual object by adopting the most suitable interaction strategy at present, which is beneficial to improving interaction capability of the first virtual object or the group to which the first virtual object belongs.

In some embodiments, the client may control the companion object in the simulated enemy form to move in the virtual scene to scout the virtual scene for objects in the following manners: controlling the companion object in the simulated enemy form to move in the virtual scene; controlling the companion object to release a marking wave around and displaying a second region affected by the marking wave during the movement of the companion object in the virtual scene; and controlling the companion object to scout the second region. Correspondingly, in response to the companion object discovering the third virtual object through scouting of the virtual scene, the client may display the location information of the third virtual object in the map of the corresponding virtual scene in the following manners: prominently displaying the third virtual object and displaying the location information of the third virtual object in the map of the corresponding virtual scene when the third virtual object is discovered through scouting of the second region, for viewing by the first virtual object or another virtual object in the group to which the first virtual object belongs.

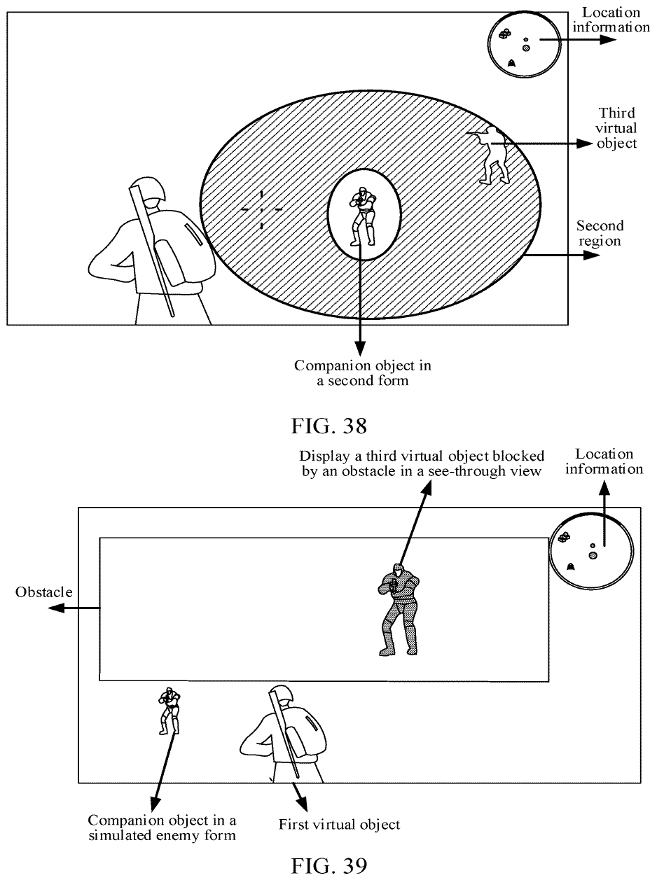

FIG. 38 is a schematic diagram of scouting according to an embodiment of this disclosure. In the process of controlling the movement of the companion object in the simulated enemy form, the companion object in the simulated enemy form is controlled to release a marking wave around, and a second region affected by the marking wave is displayed (the second region may be a circular region using the companion object as the center and a target distance as the radius, or may be a region in another shape, and the shape of the second region is not limited in this embodiment of this disclosure). In addition, the companion object may be controlled to scout the second region for objects, for example, a detection ray is emitted around from the companion object through a camera component on the companion object, and when the detection ray intersects with the collider component bound to the third virtual object, it is determined that the third virtual object is discovered through scouting of the second region. When the detection ray does not intersect with the collider component bound to the third virtual object, it is determined that the third virtual object is not discovered through scouting of the second region. When the third virtual object is discovered through scouting, a special effects element may be displayed in an associated region of the third virtual object. For example, an added special effects element is displayed on a periphery wrapped by the third virtual object. The special effects element may change the skin material and color of the third virtual object to prominently display the third virtual object. The location information of the third virtual object is displayed in the map of the virtual scene, for the first virtual object or all virtual objects in the group to which the first virtual object belongs to view the location information of the third virtual object. In this way, in a case that the location information of the third virtual object is obtained, it is beneficial for the first virtual object or all virtual objects in the group to which the first virtual object belongs to formulate an interaction strategy that can cause the greatest harm to the third virtual object, and perform corresponding interaction operations according to the interaction strategy, thereby improving the interaction capability of the first virtual object or another virtual object in the group to which the first virtual object belongs.

In some embodiments, the companion object is controlled to exit mimicry and return to the second form in response to the companion object after mimicry being attacked by the third virtual object; and the companion object in the second form is controlled to scout the virtual scene for objects.

In some embodiments, when the third virtual object is discovered through scouting of the second region, the client may further control the companion object in the simulated enemy form to lock the third virtual object; and the third virtual object at a target location is displayed in a see-through view in a case that the third virtual object moves in the virtual scene and moves to the target location blocked by an obstacle.

FIG. 39 is a schematic diagram of scouting according to an embodiment of this disclosure. After a companion object discovers a third virtual object through scouting and prominently displays, for example highlights, the third virtual object, if the third virtual object moves in a virtual scene, the companion object is controlled to lock the third virtual object, and the companion object is controlled to continuously release a marking wave to the third virtual object and always prominently display the third virtual object. If the third virtual object moves to a place blocked by an obstacle (such as a wall) in the virtual scene, the third virtual object blocked by the obstacle is displayed in a see-through view. That is, even if the third virtual object is blocked by an obstacle, the third virtual object is still highlighted, so that the third virtual object blocked by the obstacle is visible to the first virtual object or all virtual objects in the group to which the first virtual object belongs, and the location information of the third virtual object can be displayed in the map of the virtual scene, so that the third virtual object is exposed within a field of view of the first virtual object or all virtual objects in the group to which the first virtual object belongs. In this way, it is beneficial for the first virtual object or all virtual objects in the group to which the first virtual object belongs to formulate an interaction strategy that can cause the greatest harm to the third virtual object, and perform corresponding interaction operations according to the interaction strategy, thereby improving the interaction capability of the first virtual object or the group to which the first virtual object belongs.

In some embodiments, the client displays the location information of the third virtual object in the map of the corresponding virtual scene in response to the companion object discovering the third virtual object through scouting of the virtual scene and the companion object being attacked by the third virtual object. Herein, when the companion object discovers the third virtual object through scouting and the companion object is attacked by the third virtual object, the location information of the third virtual object may be immediately displayed in the map of the virtual scene, so that the first virtual object or another virtual object in the group to which the first virtual object belongs can view the location information of the third virtual object.

In some embodiments, the client may display the location information of the third virtual object in the map of the corresponding virtual scene in the following manners: obtaining an interaction parameter of each of the third virtual objects in a case that at least two third virtual objects exist, the interaction parameter including at least one of the following: an interaction character, an interaction preference, an interaction capability, and a distance from the first virtual object; and displaying the location information of each of the third virtual objects by using a display style corresponding to the interaction parameter in the map of the corresponding virtual scene.

Herein, when a plurality of third virtual objects are discovered through scouting, a threat degree of each of the third virtual objects to the first virtual object may be determined based on the interaction parameter of each of the third virtual objects, a display priority of each of the third virtual objects may be determined based on the threat degree, and each of the third virtual objects may be displayed differently based on the display priority. For example, a more hostile relationship between the interaction character of the third virtual object and the interaction character of the first virtual object, a stronger interaction capability, the interaction preference being something that the first virtual object is not good at and cannot cope with, a shorter distance from the first virtual object, or the like leads to a greater threat degree to the first virtual object and a higher corresponding display priority of the third virtual object. In this way, location information of a target quantity of third virtual objects with the display priority higher than a target priority may be selected for display, or the location information of each of the third virtual objects is displayed in a form of a higher display priority leading to a more prominent display style of the corresponding third virtual object. In this way, it is convenient for the first virtual object or the virtual object in the group to which the first virtual object belongs to select an appropriate third virtual object to attack, so as to improve the interaction capability.

In some embodiments, the client may control the companion object in the simulated enemy form to move in the virtual scene to scout the virtual scene for objects in the following manners: controlling the companion object in the simulated enemy form to move in the virtual scene; controlling the companion object to transform from the simulated enemy form to the second form in response to the companion object in the simulated enemy form being attacked by a fifth virtual object during the movement of the companion object in the simulated enemy form in the virtual scene; and controlling the companion object in the second form to scout the virtual scene for objects, for example, controlling the companion object in the second form to release the marking wave around, so as to scout the virtual scene for objects through the marking wave. Correspondingly, when the third virtual object is discovered through scouting of the virtual scene, the client may display the location information of the third virtual object in the map of the corresponding virtual scene in the following manners: prominently displaying the third virtual object and displaying the location information of the third virtual object in the map of the corresponding virtual scene when the third virtual object is discovered through scouting of the virtual scene.

In some embodiments, in a case that the companion object in the simulated enemy form scouts the third virtual object, the client may further receive a tracking instruction of the companion object in the simulated enemy form for the third virtual object when the third virtual object moves in the virtual scene. In response to the tracking instruction, the companion object in the simulated enemy form is controlled to track the third virtual object in a tracking direction indicated in the tracking instruction, and the location information of the third virtual object is updated and displayed in the map of the corresponding virtual scene.

Herein, after the companion object discovers the third virtual object through scouting and displays the location information of the third virtual object, if the third virtual object moves in the virtual scene, the client may control the companion object to track the third virtual object, that is, the companion object moves along with the movement of the third virtual object, and the location information of the third virtual object is updated and displayed in the map, so that the third virtual object is exposed, such as always exposed, within a field of view of the first virtual object or the virtual object in the group to which the first virtual object belongs. In this way, it is beneficial for the first virtual object or the virtual object in the group to which the first virtual object belongs to formulate an interaction strategy that can cause the greatest harm to the third virtual object, and perform a corresponding interaction operation according to the interaction strategy, thereby improving the interaction capability of the first virtual object or the group to which the first virtual object belongs.

In some embodiments, the client may determine that the third virtual object is discovered through scouting in the following manners: controlling the companion object in the simulated enemy form to release a pulse wave for penetrating the obstacle to the obstacle during the scouting of the virtual scene for objects by the companion object in the simulated enemy form when an obstacle is discovered through scouting of the virtual scene; and determining that the third virtual object is discovered through scouting of the virtual scene, and controlling the companion object in the simulated enemy form to scout and mark the third virtual object to see through the third virtual object when it is detected based on the pulse wave that the third virtual object is blocked by the obstacle.

A collider component (such as a collision box and a collision ball) is bound to the obstacle. In the process of controlling the companion object to scout the virtual scene, it may be first determined whether an obstacle is discovered through scouting of the virtual scene, for example, through a camera component on the companion object, and a detection ray is emitted from the companion object in a direction of the companion object. When the detection ray intersects with the collider component bound to the obstacle, it is determined that the companion object discovers the obstacle through scouting. In this case, it is further determined whether a third virtual object hides behind the obstacle, and when it is determined that the third virtual object hides behind the obstacle, the companion object is controlled to scout and mark the third virtual object and see through the third virtual object to prominently display the third virtual object. In this way, even if the third virtual object is blocked by an obstacle, the third virtual object is still highlighted in a see-through view, so that the third virtual object blocked by the obstacle is visible to the first virtual object or all virtual objects in the group to which the first virtual object belongs. In addition, the location information of the third virtual object may further be displayed in the map of the virtual scene, so that the third virtual object is always exposed within a field of view of the first virtual object or all virtual objects in the group to which the first virtual object belongs. Therefore, it is beneficial for the first virtual object or all virtual objects in the group to which the first virtual object belongs to formulate an interaction strategy that can cause the greatest harm to the third virtual object, and perform corresponding interaction operations according to the interaction strategy, thereby improving the interaction capability of the first virtual object or the group to which the first virtual object belongs, so as to improve the interaction efficiency.

In some embodiments, the client may further control the companion object in the simulated enemy form to perform material detection on the virtual scene in response to the first virtual object having a material detection skill. When a virtual material is detected in the virtual scene, indication information of the corresponding virtual material is displayed. The virtual material is configured for the first virtual object to pick up, and the picked virtual material is configured to improve the interaction capability of the first virtual object in the virtual scene.

The material detection skill is a skill used for material detection. When the first virtual object is equipped with the material detection skill or the companion object has the material detection skill, the client may control the companion object in the simulated enemy form to perform material detection in the virtual scene through the material detection skill. In practical application, a collider component (such as a collision box or a collision ball) is bound to the virtual material. In the process of controlling the companion object to perform material detection in the virtual scene, a detection ray is emitted from the companion object in a direction of the companion object through a camera component on the companion object. When the detection ray intersects with the collider component bound to the virtual material, it is determined that the companion object discovers the virtual material through scouting. When the detection ray does not intersect with the collider component bound to the virtual material, it is determined that the companion object does not scout the virtual material.

The virtual material that can be detected through the material detection skill includes but is not limited to: a gold coin, a building material (such as ore), food, weapons and equipment, and equipment or character upgrading materials. When a companion object detects a virtual material in a virtual scene, the indication information of the corresponding virtual material is displayed. Based on the indication information of the virtual material, the client may control the first virtual object or another virtual object in the group to which the first virtual object belongs to pick up or exploit the detected virtual material, and may control the first virtual object or the another virtual object in the group to which the first virtual object belongs to upgrade equipment thereof or build a virtual building based on the picked or exploited virtual material. In this way, the interaction capability of the first virtual object or the another virtual object in the group to which the first virtual object belongs in the virtual scene is improved, such as attack capability or defense capability.

In some embodiments, the client may display the indication information of the corresponding virtual material in the following manners when detecting the virtual material in the virtual scene: displaying category indication information of the virtual material at a location of the virtual material in a second region and displaying location indication information of the virtual material in a map of the corresponding virtual scene when the virtual material is detected in the second region centered on the companion object in the virtual scene; and using at least one of the category indication information and the location indication information as the indication information of the corresponding virtual material.

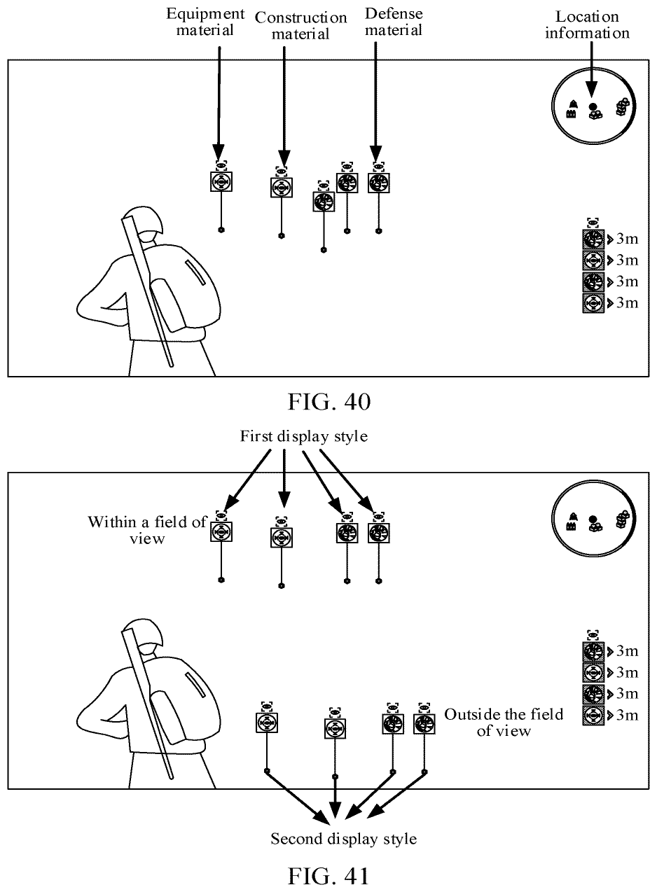

FIG. 40 is a schematic diagram of detection according to an embodiment of this disclosure. When a companion object in a simulated enemy form detects a virtual material in a second region centered on the companion object in a virtual scene, category indication information of the virtual material is displayed at a location of the virtual material, such as an equipment virtual material, a construction virtual material, and a defense virtual material, and location information of the virtual material is displayed in a map of the virtual scene, such as a distance and a direction of the virtual material relative to the first virtual object or another virtual object in the group to which the first virtual object belongs. Based on the indication information of the virtual material, the client may control the first virtual object or the another virtual object in the group to which the first virtual object belongs to pick up the virtual material, so as to improve the interaction capability.

In some embodiments, the client may display the indication information of the corresponding virtual material in the following manners: displaying indication information of a first quantity of virtual materials in the at least two virtual materials by using a first display style, and displaying indication information of a second quantity of virtual materials in the at least two virtual materials by using a second display style when a quantity of virtual materials is at least two. The first display style is different from the second display style. The first display style indicates that the first quantity of virtual materials are within a field of view of the first virtual object, and the second display style indicates that the second quantity of virtual materials are outside the field of view of the first virtual object.

FIG. 41 is a schematic diagram of detection according to an embodiment of this disclosure. When a companion object in a first form detects a plurality of virtual materials in a virtual scene, different display styles (such as different colors and different brightness) may be used to display the indication information of the virtual materials within and outside the field of view depending on whether the virtual materials are within the field of view of the first virtual object. It may be understood that with the change of the field of view of the first virtual object, the display style of each of the virtual materials may vary with the change of the field of view of the first virtual object. In this way, different display styles are used to display the indication information of the virtual materials within and outside the field of view of the first virtual object, which can give a player a significant prompt, which is beneficial to controlling the first virtual object to choose and pick up suitable virtual materials, so as to improve the interaction capability.

In some embodiments, the client may display the indication information of the corresponding virtual material in the following manners: displaying indication information of a virtual material of a target type in the at least two virtual materials by using a third display style and displaying indication information of a virtual material of another type except the target type in the at least two virtual materials by using a fourth display style when virtual materials of at least two types exist. The third display style is different from the fourth display style. The third display style represents a picking priority of the virtual material of the target type, which is higher than a picking priority of the virtual material of the another type.

Herein, when a plurality of types of virtual props are detected, based on different picking priorities, different display styles are adopted to display the indication information of the corresponding type of virtual material, especially prominently display the indication information of the virtual material of the type with the highest picking priority, so that the virtual object can be controlled to pick up the prominently displayed virtual prop of the target type. In this way, the virtual material of the target type most needed by the first virtual object is selected from a plurality of detected virtual materials, which is beneficial to improving the interaction capability of the first virtual object.

During actual implementation, the client may determine the virtual material of the target type in the following manners: obtaining a matching degree of the virtual material of each type and usage preference based on usage preference of the first virtual object, and selecting the virtual material corresponding to the highest matching degree as indication information of the virtual material of the target type for prominent display. For example, the types of detected virtual materials include: an equipment virtual material, a construction virtual material, and a defense virtual material. The usage preference of the first virtual object is predicted through a neural network model based on a character of the first virtual object in the virtual scene or the virtual material of a historical use type of the first virtual object, that is, preference and proficiency of the first virtual object for various types of virtual materials, and the like. A matching degree of the equipment virtual material and usage preference, a matching degree of the construction virtual material and usage preference, and a matching degree of the defense virtual material and usage preference are determined respectively based on the usage preference of the first virtual object, from which the defense virtual material with the highest matching degree is selected, and the indication information of the screened defense virtual material is prominently displayed. In addition, the virtual material of the target type that best matches the first virtual object may further be screened out from a plurality of types of virtual materials to prominently display the indication information of the virtual material based on a parameter of at least one of consumption degrees and picking difficulty coefficients of various virtual materials and distances from the first virtual object. In this way, the most suitable virtual material of the target type that the first virtual object likes best and most needs are screened out from the detected virtual materials, which is beneficial to improving the interaction capability of the first virtual object.

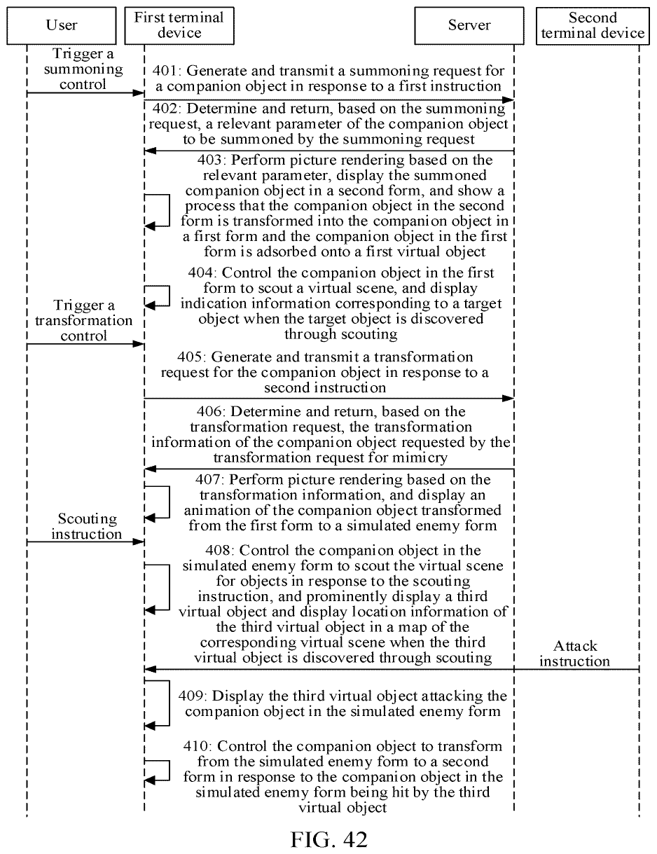

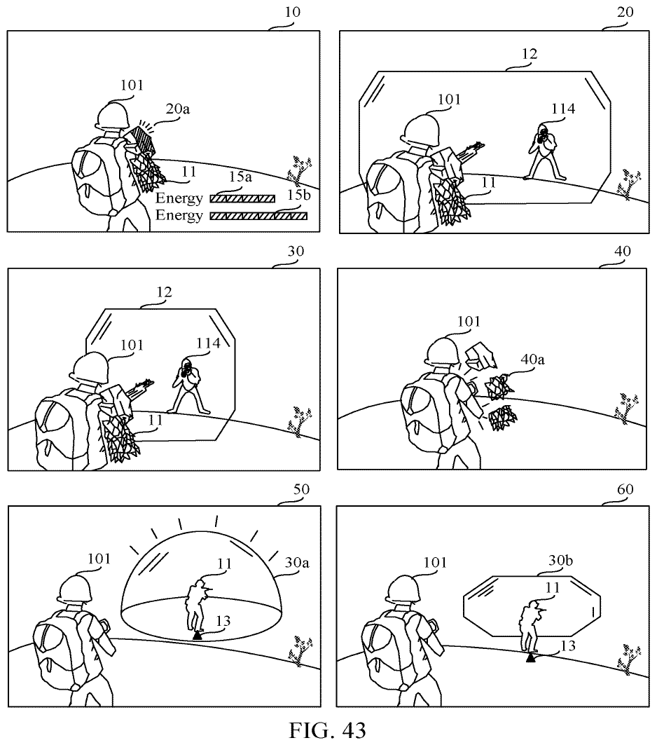

FIG. 42 is a schematic flowchart of a method for controlling a companion object in a virtual scene according to an embodiment of this disclosure. The method includes the following steps.

Step 401: A first client generates and transmits a summoning request for a companion object to a server in response to a summoning instruction.

Herein, a first instruction is the summoning instruction, and a summoning control configured to summon the companion object may be displayed in a game interface. When a user triggers the summoning control, the first client receives the summoning instruction in response to a triggering operation on the summoning control, and the generated summoning request carries an object identifier of a to-be-summoned companion object in response to the summoning instruction.

Step 402: The server determines, based on the summoning request, a relevant parameter of the companion object to be summoned by the summoning request, and returns the relevant parameter to the first client.

Step 403: The first client performs picture rendering based on relevant parameter, displays the summoned companion object in an initial form, and shows a process that the companion object in the initial form is transformed into the companion object in a first form and the companion object in the first form is adsorbed onto a first virtual object.

Herein, the first client performs picture rendering based on the relevant parameter, and displays the rendered summoning picture, for example, first displays a summoned wild monster of an animation image, and then displays an animation in which the wild monster of the animation image turns into fragments and the fragments are adsorbed onto an arm of the first virtual object (a player) (that is, the fragments become a part of a player model).

After the companion object in the initial form is summoned, and before the companion object is changed from the initial form to the first form, a client may also control the companion object in the initial form to scout a virtual scene (such as a target region centered on the companion object), and when a target object (such as a virtual object or a virtual material) is discovered through scouting, indication information of the discovered target object through scouting may be displayed.

Step 404: The first client controls the companion object in the first form to scout a virtual scene, and displays indication information corresponding to a target object when the target object is discovered through scouting.

The target object includes at least one of a third virtual object and the virtual material. When the third virtual object (an enemy) is discovered through scouting, location information of the third virtual object is displayed in a game map, such as a distance and a direction of the third virtual object relative to the first virtual object. When the first virtual object is equipped with a material detection skill, the client may control the companion object in the first form to perform material detection on the virtual scene through the material detection skill, and when the virtual material (such as a gold coin, a building material (such as ores), a food material, weapons and equipment, equipment or character upgrading materials) is detected, the indication information of the virtual material (such as information indicating the type of the virtual material and the location of the virtual material) is displayed.

In practical application, when a quantity of detected target objects is greater than or equal to 2, different display styles (such as different colors and different brightness) may be used to display each of the target objects based on characteristics of the target objects. For example, when the target objects are third virtual objects, different display styles may be used to display each of the third virtual objects based on different distances between each of the third virtual objects and the first virtual object. When the target objects are virtual materials, different display styles (such as different colors and different brightness) are used to display indication information of the virtual materials within and outside the field of view of the first virtual object.

Step 405: The first client generates and transmits a transformation request for the companion object to the server in response to a second instruction.

The second instruction is a mimicry instruction or a transformation instruction, which may be triggered by triggering a transformation control. For example, the client may display the transformation control for the companion object in an interface of the virtual scene, receive the transformation instruction in response to a triggering operation for the transformation control, and generate and transmit a transformation request for the companion object to the server in response to the transformation instruction. The transformation request carries information such as an object identifier of the companion object and a current form of the companion object.

Step 406: The server determines and returns, based on the transformation request, transformation information of the companion object requested to transform by the transformation request to the first client.

The transformation information may be related information of the third virtual object (including a non-player character or another virtual object in a different group from the first virtual object) in a region centered on the companion object.

Step 407: The first client performs picture rendering based on the transformation information, and displays an animation of the companion object transformed from the first form to a simulated enemy form.

For example, an animation that the fragments adsorbed onto the arm of the first virtual object are transformed into the wild monster of the animation image (the wild monster is detached from the arm of the first virtual object and moves to another location) is first displayed, and then an animation that the wild monster of the animation image is transformed into a companion object consistent with the image of the third virtual object is displayed.

Step 408: The first client controls the companion object in the simulated enemy form to scout the virtual scene for objects in response to a scouting instruction, and prominently displays a third virtual object and displays location information of the third virtual object in a map of the corresponding virtual scene when the third virtual object is discovered through scouting of the virtual scene.

For example, after the companion object is transformed from the first form into a companion object in the simulated enemy form, the client may control the companion object in the simulated enemy form to move in the virtual scene and scout the virtual scene for objects during the movement, such as controlling the companion object in the simulated enemy form to release marking waves around, so as to scout the virtual scene for objects through the marking waves. When the third virtual object is discovered through scouting, a special effects element may be displayed in an associated region of the third virtual object. For example, an added special effects element is displayed on a periphery wrapped by the third virtual object. The special effects element may change the skin material and color of the third virtual object to prominently display the third virtual object. The location information of the third virtual object is displayed in the map of the virtual scene, for viewing by the first virtual object or all virtual objects in the group to which the first virtual object belongs. After the location information of the third virtual object is learned, it is convenient for the client to control the corresponding virtual object to interact with the third virtual object by adopting the most suitable interaction strategy at present, which is beneficial to improving the interaction capability of the first virtual object or the group to which the first virtual object belongs. The third virtual object is a general name of the virtual object belonging to a different group from the first virtual object discovered through scouting of a target region centered on the companion object or a non-player character associated with the virtual object, which may include the foregoing third virtual object.

In a case that the location information of the third virtual object is obtained, it is beneficial for the first virtual object or another virtual object in the group to which the first virtual object belongs to formulate an interaction strategy that can cause the greatest harm to the third virtual object, and perform a corresponding interaction operation according to the interaction strategy, thereby improving the interaction capability of the first virtual object or another virtual object in the group to which the first virtual object belongs.

Step 409: The first client displays the third virtual object attacking the companion object in the simulated enemy form.

A second client receives an attack instruction from another player user, the attack instruction being used for controlling the third virtual object to attack the companion object in the simulated enemy form. Through a synchronization mechanism of the server, the attack instruction is synchronized to the first client. The first client receives the attack instruction, and displays the third virtual object attacking the companion object based on the attack instruction.

Step 410: The first client controls the companion object to transform from the simulated enemy form to a second form in response to the companion object in the simulated enemy form being hit by the third virtual object.

Herein, after the companion object is transformed into the second form, the virtual scene may still be scouted for objects or resources, and when another virtual object or virtual material is discovered through scouting of the virtual scene, location information of the virtual object or virtual material that is discovered through scouting is displayed in the map of the corresponding virtual scene for the player to view.

Through the foregoing manners, through transformation of the companion object associated with the first virtual object, the companion object is transformed from the first form into the simulated enemy form consistent with the image of the third virtual object having a hostile relationship with the first virtual object, and the companion object in the simulated enemy form is controlled to scout the virtual scene for objects. Since the form of the companion object is consistent with the image of the third virtual object during the scouting for objects, the companion object is not easy to be discovered by the enemy, may even reach the vicinity of the enemy for scouting, and can more easily obtain effective information of the enemy, which improves the scouting ability of the companion object, and can improve the interaction capability of the first virtual object through the improvement of the scouting ability of the companion object.

In addition, by controlling the companion objects associated with the first virtual object to scout the virtual scene for material detection or objects, when the virtual material is detected, the indication information of the corresponding virtual material is displayed. The first virtual object may more easily view and pick up the detected virtual material based on the indication information, so as to improve the interaction capability of the first virtual object in the virtual scene based on the picked-up virtual material, for example, upgrading equipment or building defensive buildings by using the picked-up virtual material, so as to enhance the attack capability or defense capability. When enemy information such as the third virtual object (which may include the third virtual object) is discovered through scouting, the location information of the third virtual scene is further displayed in the map for the first virtual object or another virtual object in the group to which the first virtual object belongs to view. In a case that the location information of the third virtual object is learned, it is beneficial for the first virtual object or another virtual object in the group to which the first virtual object belongs to formulate an interaction strategy that can cause the greatest harm to the enemy based on a location of the enemy, and perform a corresponding interaction operation according to the interaction strategy, thereby improving the interaction capability (such as attack capability or defense capability) of the first virtual object or another virtual object in the group to which the first virtual object belongs. In a case that the interaction capability of the first virtual object or another virtual object in the group to which the first virtual object belongs is improved, the client can reduce a quantity of interactions in interactive operations to be performed for achieving an interactive purpose (such as obtaining effective information of the enemy or defeating the enemy), thereby improving the efficiency of human-computer interaction and reducing occupation of hardware processing resources.

### Companion Object of a Shield Type:

FIG. 43 is an interface diagram of using a virtual shield monster according to an exemplary embodiment of this disclosure.

In a first interface 10, a first virtual object 101 summons a virtual shield monster 11 through a virtual chip. For example, in a case that the first virtual object 101 carries a virtual chip and a virtual wild monster in a weak state appears, the virtual shield monster 11 is summoned by consuming an attribute value (such as an energy value). The virtual shield monster 11 being attached to an arm of the first virtual object 101 is displayed. In this case, the virtual shield monster 11 is in a first state.

When the first virtual object 101 does not perform an aiming action, virtual energy is accumulated. The virtual energy is displayed as a first energy value 15a at a first time stamp. Through accumulation of the virtual energy, the virtual energy is displayed as a second energy value 15b at a second time stamp. At the second time stamp, the virtual energy exceeds an energy threshold, and the virtual shield monster 11 displays a light-emitting effect 20a.

In a second interface 20, in a case that the virtual energy is accumulated to a second energy value, the first virtual object 101 performs the aiming action, the virtual shield monster 11 deploying the virtual shield 12 in front of the first virtual object 101 is displayed, and a relative position between the virtual shield 12 and the first virtual object 101 remains unchanged, that is, the virtual shield 12 moves with the movement of the first virtual object 101. Exemplarily, a third virtual object 114 is further displayed in the second interface 20. A virtual area of the virtual shield 12 is determined based on the accumulated virtual energy.

In a third interface 30, the first virtual object 101 performing a virtual attack activity on the third virtual object 114 is displayed, and the virtual area of the virtual shield 12 is reduced. The virtual shield monster 11 is attached to the arm of the first virtual object 101. The first virtual object 101 performs the virtual attack activity and consumes virtual energy, and the reduced virtual area of the virtual shield 12 is determined based on the consumed virtual energy.

The virtual area of the virtual shield 12 is reduced based on an activity parameter of the virtual attack activity. The activity parameter includes, but is not limited to, at least one of types, durations, a number of times, activity effects, and a quantity of virtual attack activities acting on the third virtual object.

In a fourth interface 40, the virtual shield monster is switched from the first state to a second state. An animation 40a in which the virtual shield monster is separated from the arm of the first virtual object 101 is displayed.

In a fifth interface 50, the virtual shield monster 11 is in the second state, showing that the virtual shield monster 11 leaves the arm of the first virtual object 101. In a case that the virtual shield monster 11 is loaded with a virtual enhancement prop, the virtual shield monster 11 deploys the first virtual shield 30a at a target location 13. The first virtual shield 30a displays a light-emitting effect. The first virtual shield 30a is a double-sided shield. When the first virtual shield is subject to a virtual attack, the virtual shield monster 11 is subject to damage twice the virtual attack.

In a sixth interface 60, the virtual shield monster 11 is in the second state, showing that the virtual shield monster 11 leaves the arm of the first virtual object 101. In a case that the virtual shield monster 11 is not loaded with a virtual enhancement prop, the virtual shield monster 11 deploys a second virtual shield 30b at the target location 13. The second virtual shield 30b is a double-sided shield.

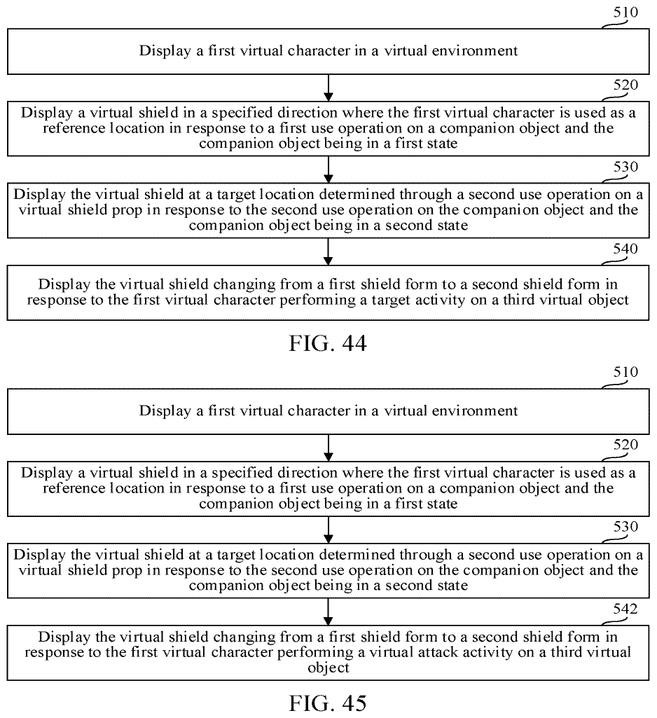

FIG. 44 is a flowchart of a method for using a virtual shield according to an embodiment of this disclosure. The method applicable to a terminal is used as an example for description. The method includes the following steps.

Step 510: Display a first virtual character in a virtual scene.

Exemplarily, the first virtual character is a virtual character controlled by a user account logged in by the terminal, and the virtual scene is configured to provide virtual tactical competition among different virtual characters.

Exemplarily, displaying the first virtual character includes directly displaying the first virtual character or displaying a perspective picture of the first virtual character. The perspective picture of the first virtual character is a scene picture obtained by observing the virtual scene from the perspective of the first virtual character. In an example, in this embodiment of this disclosure, a virtual character is observed through a camera model in the virtual scene.

Exemplarily, the first virtual character having a virtual shield prop represents that the first virtual character has a capability of controlling the virtual shield prop. The virtual shield prop includes but is not limited to at least one of the following: a virtual shield projectile, a virtual shield skill, a virtual shield ultimate skill, and a companion object.

Step 520: Display a virtual shield in a specified direction where the first virtual character is used as a reference location in response to a first use operation on a companion object and the companion object being in a first state.

In this embodiment, the virtual shield prop includes a companion object of the first virtual character, and a binding relationship exists between the companion object and the first virtual character. Exemplarily, the first use operation is a shoulder aiming operation. That is to say, the first use operation is used for controlling usage of a virtual pet character and controlling the first virtual character to perform the shoulder aiming operation.

Exemplarily, a display mode of the companion object in the first state is different from that of the companion object in a second state. For example, in a case that the companion object is in the first state, the companion object being attached to an arm part of the first virtual character is displayed, and in a case that the companion object is in the second state, the companion object being separated from the first virtual character is displayed.

In some embodiments, the companion object in the first form is controlled to increase a shield energy storage capacity for the first virtual object not in an aiming state.

Step 530: Display the virtual shield at a target location determined through a second use operation on a virtual shield prop in response to the second use operation on the companion object and the companion object being in a second state.

In this embodiment, the companion object may be switched between the first state and the second state through a switching operation, or the companion object may be switched from the first state to the second state through the second use operation on the companion object, and the virtual shield is displayed at the target location.

Exemplarily, the first use operation and the second use operation on the companion object may be the same operation or different operations. Specifically, the implementation of the use operation on the companion object includes but is not limited to at least one of the following: clicking/tapping, sliding, and rotating, for example, tapping a touchscreen or a button, sliding on the touchscreen or a joystick, and rotating a terminal or the joystick.

In this embodiment, step 540 is performed after step 530. It may be understood by a person skilled in the art that in an implementation, the virtual shield changing from the first virtual form to the second virtual form is displayed in response to the first virtual character performing a target activity on the third virtual object only in a case that the companion object is in the first state. That is to say, in an implementation, step 540 is not performed after step 530. Exemplarily, in the foregoing implementation, a change in a virtual form of the virtual shield is displayed in response to the first virtual character performing the target activity in a case that the companion object is in the first state. The virtual form of the virtual shield does not change in a case that the companion object is in the second state.

In some embodiments, the companion object in the second state is controlled to release a first virtual shield in an aiming direction where the first virtual object is used as a reference location in response to the first virtual object being in an aiming state. The companion object in the second state is controlled to release the first virtual shield in a changed aiming direction in response to the aiming direction of the first virtual object being changed.

In an implementation of this embodiment, based on this embodiment, the method further includes displaying the virtual shield moving towards an attack direction of a virtual attack in response to the virtual shield blocking the virtual attack.

Exemplarily, the attack direction includes a direction that a center point location of the virtual shield is directed at a source location of the virtual attack. For example, the virtual shield moves in a direction close to a virtual attack source.

Exemplarily, the attack direction includes a direction that a center point location of the virtual shield is directed at a direction of a location at which the virtual shield blocks the virtual attack. For example, the virtual shield moves in the direction of blocking the virtual attack.

Based on the above, according to the method provided in this embodiment, the virtual shield prop is implemented as the companion object of the first virtual character, and the corresponding virtual shield is displayed based on the state of the companion object, thereby enriching the human-computer interaction mode of using the virtual shield prop. The virtual form of the virtual shield is changed in a case that the first virtual character performs the target activity on the third virtual object, and the virtual form of the virtual shield can also be dynamically changed based on the target activity in a case that the virtual shield is not actively controlled, which enriches the human-computer interaction mode of the virtual shield.

Step 540: Display the virtual shield changing from a first shield form to a second shield form in response to the first virtual character performing a target activity on a third virtual object.

Exemplarily, the target activity is a virtual activity directed to the third virtual object that the first virtual character actively performs. The third virtual object is a virtual character in the virtual scene, and the third virtual object is different from the first virtual character. The third virtual object and the first virtual character may be in the same virtual camp or in different virtual camps. No limitation is imposed on a relationship between the first virtual character and the third virtual object in this embodiment.

The first shield form of the virtual shield is an initial form of the virtual shield, and the second shield form is different from the first shield form. The first shield form is also referred to as the first shield form, and the second shield form is also referred to as the second shield form.

Based on the above, according to the method provided in this embodiment, the virtual form of the virtual shield is changed in a case that the first virtual character performs the target activity on the third virtual object, and a connection is established between the virtual form of the virtual shield and the target activity performed on the first virtual character, so that the virtual form of the virtual shield can be dynamically changed following the target activity performed by the first virtual character. A new human-computer interaction mode is provided for the virtual shield. The virtual form of the virtual shield can also be dynamically changed based on the target activity in a case that the virtual shield is not actively controlled, which enriches the human-computer interaction mode of the virtual shield.

Next, the target activity is to be described through two embodiments, specifically as follows.

Implementation I: The target activity includes a virtual attack activity.

Implementation II: The target activity includes a virtual rescue activity.

Then the activities are respectively described below.

Implementation I: An embodiment shown in FIG. 45 describes the implementation of the target activities including the virtual attack activity.

FIG. 45 is a flowchart of a method for using a virtual shield according to an embodiment of this disclosure. The method applicable to a terminal is used as an example for description. That is to say, in the embodiment shown in FIG. 44, step 540 may be implemented as step 542.

Step 542: Display a virtual shield changing from a first shield form to a second shield form in response to a first virtual character performing a virtual attack activity on a third virtual object.

Exemplarily, a protecting effect of the first shield form is better than that of the second shield form, and the first virtual character and the third virtual object belong to different camps.

Exemplarily, the virtual attack activity is used for describing a virtual activity that causes damage to the virtual object. Exemplarily, the virtual attack activity damages at least one of a virtual health point, a virtual protection value, and a virtual energy value of the virtual object.

Further, the damage caused by the virtual attack activity includes direct damage and indirect damage. For example, the virtual attack activity includes using at least one of a virtual launcher, a virtual projectile, and a virtual ultimate skill prop to act on the third virtual object, which directly produces the damage; the virtual attack activity includes arranging a virtual contact prop or a virtual delay prop to act on the third virtual object when a triggering condition is satisfied, which directly produces the damage; and the virtual attack activity includes using a virtual skill to act on the third virtual object, and reducing the virtual ability of the second virtual object by reducing at least one of a movement speed, attack capability, and operability, so that the second virtual object is at a poor location, which indirectly produces the damage.

In some embodiments, the reduced virtual energy of the virtual shield is displayed based on the virtual energy consumed by the virtual attack activity in response to the first virtual character performing a virtual attack activity on the third virtual object. After the virtual energy is reduced, the virtual shield changing from the first shield form to the second shield form is displayed, and the second shield form is determined based on the reduced virtual energy.

Exemplarily, when the first virtual character performs a virtual attack activity on the third virtual object, the virtual energy of the virtual shield is consumed. The consumed virtual energy is related to at least one of types, a duration, a number of times, activity effects, and a quantity of, including, but not limited to, virtual attack activities acting on the third virtual object. This embodiment does not impose any limitation on the relationship between the consumed virtual energy and the virtual attack activity.

Exemplarily, the virtual energy may be displayed directly through a value of virtual energy or an energy bar corresponding to the virtual energy, or may be displayed indirectly in a manner of displaying an animation when the energy threshold is satisfied. This embodiment does not impose any limitation on the display mode of virtual energy.

Exemplarily, the virtual form of the virtual shield is positively correlated with the virtual energy of the virtual shield. Based on the reduced virtual energy, the protecting effect of the second shield form is reduced compared with that of the first shield form.

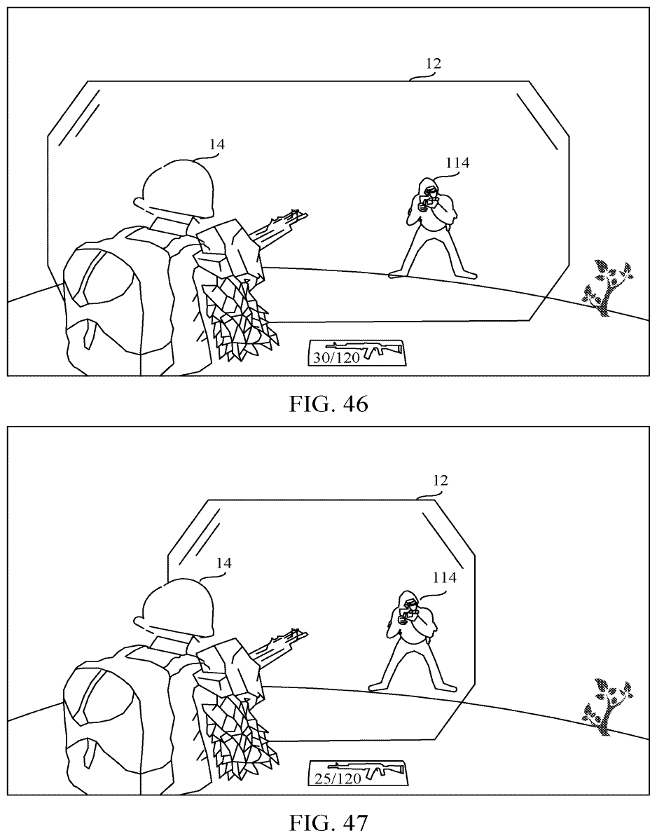

FIG. 46 is an interface diagram of using a virtual shield according to an exemplary embodiment of this disclosure. In the interface diagram of using the virtual shield, a first virtual character 14, a third virtual object 114, and a virtual shield 12 are displayed. In response to the first virtual character 14 performing a virtual attack activity on the third virtual object 114, as shown in FIG. 47, a virtual area of the virtual shield 12 is reduced.

Based on the above, according to the method provided in this embodiment, in a case that the first virtual character performs the virtual attack activity on the third virtual object, the virtual form of the virtual shield is changed to reduce the protecting effect of the virtual shield. A connection is established between the virtual form of the virtual shield and the target activity performed by the first virtual character. In this way, virtual attack of the first virtual character in the virtual scene is limited when being protected by the virtual shield, the intensity of virtual tactical competition is intensified, and a game time of the virtual tactical competition is shortened, and the virtual form of the virtual shield is dynamically changed following the target activity performed by the first virtual character. A new human-computer interaction mode is provided for the virtual shield. The virtual form of the virtual shield can also be dynamically changed based on the target activity in a case that the virtual shield is not actively controlled, which enriches the human-computer interaction mode of the virtual shield.

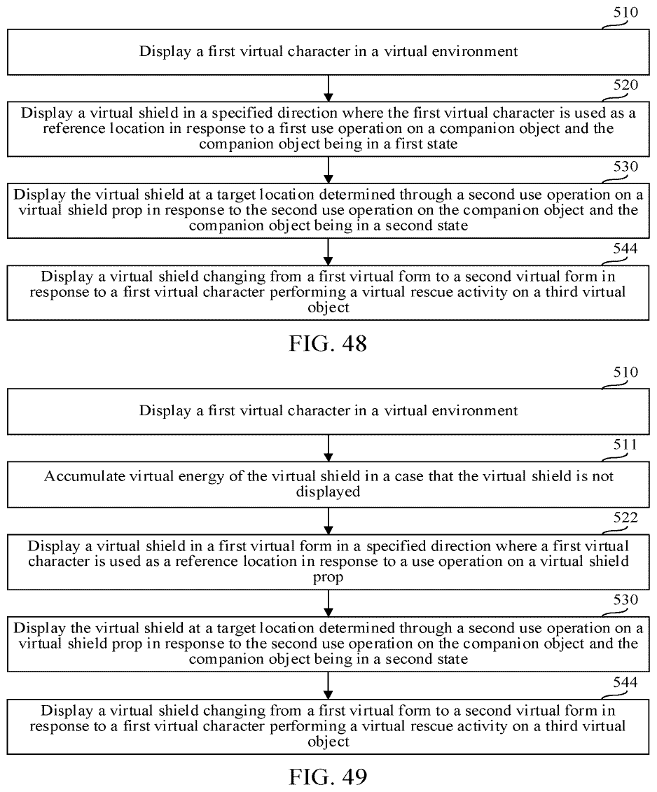

Implementation II: An embodiment shown in FIG. 48 describes the implementation of the target activities including the virtual rescue activity.

FIG. 48 is a flowchart of a method for using a virtual shield according to an embodiment of this disclosure. The method applicable to a terminal is used as an example for description. That is to say, in the embodiment shown in FIG. 44, step 540 may be implemented as step 544.

Step 544: Display a virtual shield changing from a first shield form to a second shield form in response to a first virtual character performing a virtual rescue activity on a third virtual object.

Exemplarily, a protecting effect of the first shield form is inferior to that of the second shield form, and the first virtual character and the third virtual object belong to the same camp.

Exemplarily, the virtual rescue activity is used for describing a virtual activity that has a buff on the virtual object. Exemplarily, the virtual rescue activity gains at least one of a virtual health point, a virtual protection value, and a virtual energy value of the virtual object.

Further, the buff caused by the virtual rescue activity includes a direct buff and an indirect buff. For example, the virtual rescue activity includes using a virtual prop to act on the third virtual object, which directly produces the buff; the virtual rescue activity includes adjusting a location of the virtual shield to protect the third virtual object, which directly produces the buff; and the virtual rescue activity includes using a virtual skill to act on the third virtual object, and improving the virtual ability of the second virtual object by at least one of increasing a movement speed, improving attacking ability, and improving operability, so that the second virtual object is at a favorable location, which indirectly produces the buff.

In some embodiments, the increased virtual energy of the virtual shield is displayed based on the virtual energy recovered by the virtual rescue activity in response to the first virtual character performing the virtual rescue activity on the third virtual object. After virtual energy is increased, the virtual shield changing from the first shield form to the second shield form is displayed, and the second shield form is determined based on the increased virtual energy.

Exemplarily, when the first virtual character performs the virtual rescue activity on the third virtual object, the virtual energy of the virtual shield is recovered. The recovered virtual energy is related to at least one of types, a duration, a number of times, activity effects, and a quantity of, including, but not limited to, virtual rescue activities acting on the third virtual object. This embodiment does not impose any limitation on the relationship between the recovered virtual energy and the virtual rescue activity. Exemplarily, the virtual energy may be displayed directly or indirectly. This embodiment does not impose any limitation on the display mode of virtual energy.

Exemplarily, the virtual form of the virtual shield is positively correlated with the virtual energy of the virtual shield. Based on the increased virtual energy, the protecting effect of the second shield form is improved compared with that of the first shield form.

Based on the above, according to the method provided in this embodiment, in a case that the first virtual character performs the virtual rescue activity on the third virtual object, the virtual form of the virtual shield is changed to improve the protecting effect of the virtual shield. A connection is established between the virtual form of the virtual shield and the target activity performed by the first virtual character. A virtual rescue of the first virtual character in the virtual scene is facilitated when being protected by the virtual shield. The intensity of virtual tactical competition is intensified, and a game time of the virtual tactical competition is shortened. The virtual form of the virtual shield is dynamically changed following the target activity performed by the first virtual character. A new human-computer interaction mode is provided for the virtual shield. The virtual form of the virtual shield can also be dynamically changed based on the target activity in a case that the virtual shield is not actively controlled, which enriches the human-computer interaction mode of the virtual shield.

Next, the virtual form of the virtual shield is described.

Exemplarily, the virtual form of the virtual shield includes but is not limited to at least one of the following:
Virtual shape: It is used for describing an outline shape of the virtual shield.

Exemplarily, the virtual shape includes but is not limited to at least one of rectangle, triangle, circle, ellipse, sphere, and hemisphere.
Virtual area: It is used for describing an area of the virtual shield.
Blocking type for blocking a virtual attack: It is used for describing the protecting effect of the virtual shield from the perspective of a virtual attack type that can be blocked.

Exemplarily, the types of blocking virtual attacks include but are not limited to at least one of a virtual projectile attack, a virtual launcher attack, a virtual skill attack, a physical attribute attack, and a magical attribute attack.
Blocking probability for blocking a virtual attack: It is used for describing the protecting effect of the virtual shield from the perspective of a success probability that the virtual shield blocks the virtual attack.

For example, the virtual shield has a probability of 90% of blocking a virtual attack, and the virtual shield can block 85% of virtual damage from the virtual attack.
Blocking time interval for blocking the virtual attack: It is used for describing the protecting effect of the virtual shield from the perspective of a time interval at which the virtual shield blocks the virtual attack. For example, one virtual attack can be blocked per second.

Exemplarily, in the embodiment shown in FIG. 45, the protecting effect of the first shield form is better than that of the second shield form, including but not limited to at least one of the following:
a first virtual area corresponding to the first shield form is greater than a second virtual area corresponding to the second shield form;
a first blocking type corresponding to the first shield form is more than a second blocking type corresponding to the second shield form;
a first blocking probability corresponding to the first shield form is greater than a second blocking probability corresponding to the second shield form; and
a first blocking time interval corresponding to the first shield form is greater than a second blocking time interval corresponding to the second shield form.

It may be understood by a person skilled in the art that the foregoing description is only an exemplary description, and the foregoing descriptions may be superimposed and split to describe the protecting effects of the first shield form and the second shield form. In the embodiment shown in FIG. 48, the protecting effect of the first shield form is inferior to that of the second shield form, which is similar to the foregoing description.

Next, the observation of the virtual character through a camera model in the embodiment shown in FIG. 44 is to be described in detail.

In an example, the camera model automatically follows the virtual character in the virtual scene. That is, when a location of the virtual character in the virtual scene changes, the camera model changes along with the location of the virtual character in the virtual scene, and the camera model is always within a preset distance range of the virtual character in the virtual scene. In an example, during automatic following, relative locations of the camera model and the virtual character do not change.

The camera model is a three-dimensional model around the virtual character in the virtual scene. When a first-person perspective is adopted, the camera model is located near or at a head of the virtual character. When a third-person perspective is adopted, the camera model may be located behind the virtual character and bound to the virtual character, or may be located at any location at a preset distance from the virtual character, and the virtual character in the virtual scene may be observed from different angles through the camera model. In an example, when the third-person perspective is an over-the-shoulder perspective of a first person, the camera model is located behind the virtual character (such as a head and shoulders of the virtual character). In an example, in addition to the first-person perspective and the third-person perspective, the perspective further includes another perspective, such as an overhead perspective. When the overhead perspective is adopted, the camera model may be located above the head of the virtual character, and the overhead perspective is a perspective for observing a virtual scene from the air. In an example, the camera model is not actually displayed in the virtual scene, that is, the camera model is not displayed in the virtual scene displayed in the user interface.

The camera model being located at any location at a preset distance from the virtual character is used as an example for description. In an example, a virtual character corresponds to a camera model, and the camera model can rotate around the virtual character as a rotation center. For example, the camera model is rotated by using any point of the virtual character as the rotation center. During the rotation, the camera model not only rotates in angle, but also deviates in displacement, and a distance between the camera model and the rotation center remains unchanged during the rotation. That is, the camera model is rotated on a surface of a sphere with the rotation center as the spherical center. Any point of the virtual character may be the head or trunk of the virtual character or any point around the virtual character, which is not limited in this embodiment of this disclosure. In an example, when the camera model observes the virtual character, the center of the perspective of the camera model is directed at a direction in which the point on the spherical surface where the camera model is located is directed at the center of the sphere.

In an example, the camera model may further observe the virtual character in different directions of the virtual character at preset angles.

FIG. 49 is a flowchart of a method for using a virtual shield according to an embodiment of this disclosure. The method applicable to a terminal is used as an example for description. That is to say, based on the embodiment shown in FIG. 44, step 511 is further included, and step 520 may be implemented as step 522.

Step 511: Accumulate virtual energy of the virtual shield in a case that the virtual shield is not displayed.

Exemplarily, not displaying the virtual shield may include not performing a use operation of the virtual shield prop, or may include exiting the use operation of the virtual shield prop after performing the use operation of the virtual shield prop. This embodiment does not impose any limitation on the implementation of not displaying the virtual shield. It may be understood by a person skilled in the art that step 511 in this embodiment may be performed before, after, or simultaneously with step 522 or step 530 in this embodiment, and only a case that step 511 is performed before step 522 is used as an example for description in this embodiment.

Exemplarily, the virtual energy may be displayed directly through a value of virtual energy or an energy bar corresponding to the virtual energy, or may be displayed indirectly in a manner of displaying an animation when the energy threshold is satisfied. This embodiment does not impose any limitation on the display mode of virtual energy.

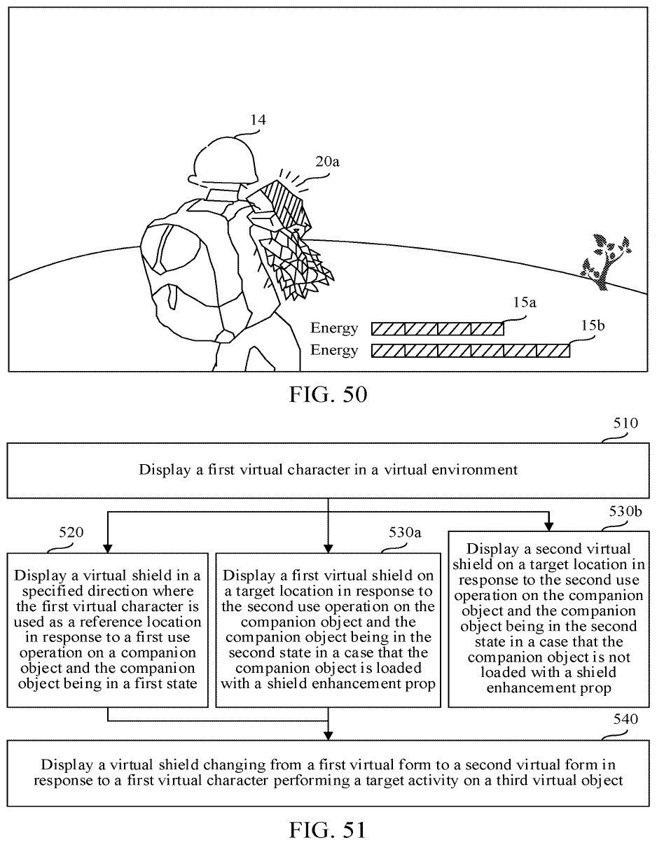

FIG. 50 is an interface diagram of using a virtual shield according to an exemplary embodiment of this disclosure. A first virtual character 14 is displayed in the interface diagram of using the virtual shield. In a case that the accumulated virtual energy of the virtual shield reaches an energy threshold, a light-emitting effect 20a is displayed on an arm of the first virtual character 14. In the interface diagram of the virtual shield, the virtual energy of the virtual shield being first virtual energy 15a is displayed through an energy bar. In a case that the virtual shield is not displayed, the virtual energy is accumulated from the first virtual energy 15a to second virtual energy 15b.

Step 522: Display a virtual shield in a first shield form in a specified direction where a first virtual character is used as a reference location in response to a use operation on a virtual shield prop.

Exemplarily, the first shield form is determined based on the accumulated virtual energy. Exemplarily, the virtual form of the virtual shield is positively correlated with the virtual energy of the virtual shield. Based on the accumulated virtual energy, the protecting effect of the virtual shield increases with the increase of the accumulated virtual energy.

In an implementation of this embodiment, the virtual shield prop includes a companion object of the first virtual character. The virtual energy of the virtual shield is accumulated in a case that the companion object is in a first state and the virtual shield is not displayed. The virtual energy of the virtual shield does not change in a case that the companion object is in a second state. It may be understood by a person skilled in the art that the foregoing implementation is merely an alternative implementation, and in different implementations, the virtual energy of the virtual shield may be accumulated in a case that the companion object is in the second state.

Based on the above, according to the method provided in this embodiment, the virtual energy of the virtual shield is accumulated in a case that the virtual shield is not displayed. A relationship between the virtual energy of the virtual shield and the virtual form of the virtual shield is established, and the virtual energy is accumulated through a behavior of the first virtual character, thereby realizing flexible configuration of the virtual form of the virtual shield. The virtual form of the virtual shield is dynamically changed following the target activity performed by the first virtual character. A new human-computer interaction mode is provided for the virtual shield. The virtual form of the virtual shield can also be dynamically changed based on the target activity in a case that the virtual shield is not actively controlled, which enriches the human-computer interaction mode of the virtual shield.

FIG. 51 is a flowchart of a method for using a virtual shield according to an embodiment of this disclosure. The method applicable to a terminal is used as an example for description. That is to say, in the embodiment shown in FIG. 44, step 530 may be implemented as the following steps.

Step 530a: Display a first virtual shield on a target location in response to the second use operation on the companion object and the companion object being in the second state in a case that the companion object is loaded with a shield enhancement prop.

Exemplarily, the shield enhancement prop is used for enhancing the protecting effect of the virtual shield. The shield enhancement prop may be obtained in the virtual scene, or may be brought into the virtual scene by the first virtual character, which is not limited in this embodiment.

Exemplarily, the first virtual shield is a double-sided shield. That is, the first virtual shield may block a virtual attack from a first side to a second side, and may also block the virtual attack from the second side to the first side. The first side and the second side are two opposite sides of the first virtual shield.

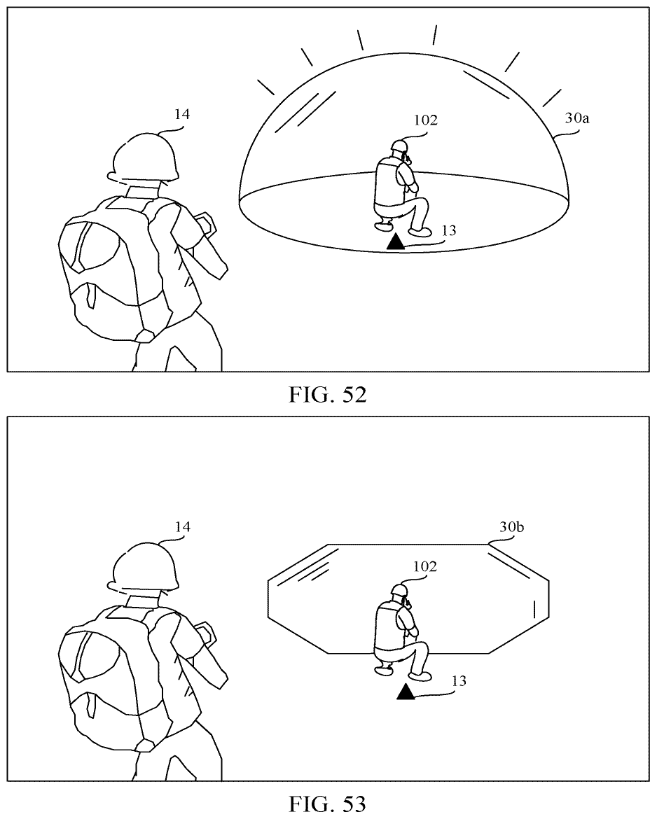

FIG. 52 is an interface diagram of using a virtual shield according to an exemplary embodiment of this disclosure. A first virtual character 14, a first virtual shield 30a, and a companion object 102 are displayed in the interface diagram of using the virtual shield. The first virtual shield 30a is placed on a target location 13 by the companion object 102. In the interface diagram of the virtual shield, the first virtual shield 30a is displayed with a luminous style, indicating that the first virtual shield 30a is a double-sided shield.

Step 530b: Display a second virtual shield on a target location in response to the second use operation on the companion object and the companion object being in the second state in a case that the companion object is not loaded with a shield enhancement prop.

Exemplarily, the second virtual shield is a single-sided shield. The second virtual shield may block a virtual attack from a first side to a second side. The first side and the second side are two opposite sides of the second virtual shield. Further, the second side is a side of the first virtual character when the second virtual shield is displayed.

FIG. 53 is an interface diagram of using a virtual shield according to an exemplary embodiment of this disclosure. A first virtual character 14, a second virtual shield 30b, and a companion object 102 are displayed in the interface diagram of using the virtual shield. The second virtual shield 30b is placed on a target location 13 by the companion object 102. In the interface diagram of the virtual shield, the second virtual shield 30b is displayed with a non-luminous style, indicating that the second virtual shield 30b is a single-sided shield.

Based on the above, according to the method provided in this embodiment, by loading the shield enhancement prop for the companion object, the corresponding virtual shield is displayed based on a loading condition of the shield enhancement prop, which enriches the human-computer interaction mode of using the virtual shield prop. The virtual form of the virtual shield is changed in a case that the first virtual character performs the target activity on the third virtual object, and the virtual form of the virtual shield can also be dynamically changed based on the target activity in a case that the virtual shield is not actively controlled, which enriches the human-computer interaction mode of the virtual shield.

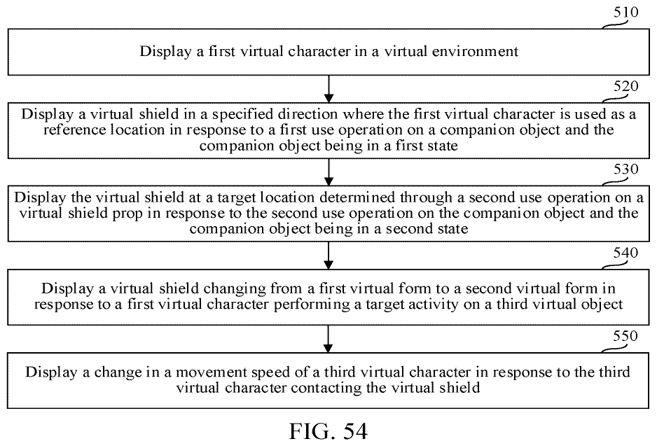

FIG. 54 is a flowchart of a method for using a virtual shield according to an embodiment of this disclosure. The method applicable to a terminal is used as an example for description. That is to say, based on the embodiment shown in FIG. 44, step 550 is further included.

Step 550: Display a change in a movement speed of a third virtual character in response to the third virtual character contacting the virtual shield.

Exemplarily, any part of the third virtual character touches the virtual shield. In an example, the virtual shield may or may not have a blocking effect on the movement of the third virtual character. That is, this embodiment does not impose a limitation on whether the third virtual character can move from one side of the virtual shield across the virtual shield to an other side of the virtual shield. Exemplarily, the third virtual character in this embodiment is a virtual character in the virtual scene, and the third virtual character is different from the first virtual character.

In an exemplary design, step 550 has at least the following two implementations.

Implementation 1: Display the movement speed of the third virtual character changing from a first speed to a second speed in response to the third virtual character contacting the virtual shield in a case that the third virtual character and the first virtual character are in the same virtual camp.

The second speed is greater than the first speed. The first speed is an initial movement speed of the third virtual character.

Implementation 2: Display the movement speed of the third virtual character changing from a first speed to a third speed in response to the third virtual character contacting the virtual shield in a case that the third virtual character and the first virtual character are in different virtual camps.

The third speed is less than the first speed. The first speed is an initial movement speed of the third virtual character.

It may be understood by a person skilled in the art that the foregoing two implementations of step 550 may be split and merged, and combined with step 510 to step 540 in this embodiment to form a new embodiment, which is not limited in this embodiment.

Based on the above, according to the method provided in this embodiment, the movement speed of the third virtual character that contacts the virtual shield is changed in a case that the virtual shield is displayed, which enriches the human-computer interaction mode of using the virtual shield in the virtual scene. The virtual form of the virtual shield is changed in a case that the first virtual character performs the target activity on the third virtual object, so that a new human-computer interaction mode is provided for the virtual shield. The virtual form of the virtual shield can also be dynamically changed based on the target activity in a case that the virtual shield is not actively controlled, which enriches the human-computer interaction mode of the virtual shield.

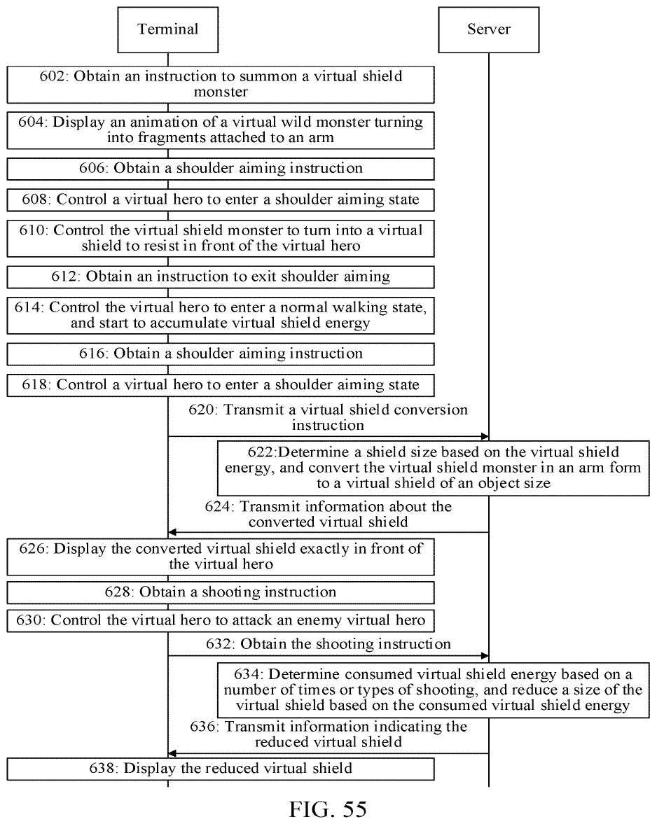

FIG. 55 is a flowchart of a method for using a virtual shield according to an embodiment of this disclosure. The method includes the following steps.

Step 602: A terminal obtains an instruction to summon a virtual shield monster.

Exemplarily, a virtual shield prop includes the virtual shield monster. Exemplarily, the virtual shield monster is summoned through a virtual chip. For example, in a case that a virtual hero carries a virtual chip and a virtual wild monster in a weak state appears, the virtual shield monster is summoned by consuming a virtual economic value.

Step 604: The terminal displays an animation of the virtual wild monster turning into fragments attached to an arm.

Exemplarily, an animation of the virtual shield monster attached to an arm of the virtual hero is displayed. Exemplarily, the virtual hero is a virtual character in a virtual scene. For example, the virtual hero is a first virtual character.

Step 606: The terminal obtains a shoulder aiming instruction.

Exemplarily, the implementation of the shoulder aiming instruction includes but is not limited to at least one of the following: clicking/tapping, sliding, and rotating.

Step 608: The terminal controls the virtual hero to enter a shoulder aiming state.

Exemplarily, the virtual hero entering the shoulder aiming state is displayed.

Step 610: The terminal controls the virtual shield monster to turn into a virtual shield to resist in front of the virtual hero.

Exemplarily, the virtual shield monster deploying the virtual shield in front of the virtual hero is displayed.

Step 612: The terminal obtains an instruction to exit shoulder aiming.

Exemplarily, the implementation of the instruction to exit shoulder aiming includes but is not limited to at least one of the following: clicking/tapping, sliding, and rotating.

Step 614: The terminal controls the virtual hero to enter a normal walking state, and starts to accumulate virtual shield energy.

Exemplarily, the virtual hero entering the normal walking state is displayed. In response to the virtual hero entering the normal walking state, an increase in the virtual shield energy is displayed.

Step 616: The terminal obtains a shoulder aiming instruction.

Step 618: The terminal controls the virtual hero to enter a shoulder aiming state.

Exemplarily, the virtual hero entering the shoulder aiming state is displayed.

Step 620: The terminal transmits a virtual shield conversion instruction to a server.

Exemplarily, the terminal forwards the virtual shield conversion instruction to the server after obtaining the virtual shield conversion instruction.

Step 622: The server determines a shield size based on the virtual shield energy, and converts the virtual shield monster in an arm form to a virtual shield of an object size.

Exemplarily, the virtual shield of the object size is determined based on the virtual shield energy. The object size is positively correlated with shield energy.

Step 624: The server transmits information about the converted virtual shield to the terminal.

Exemplarily, the information about the converted virtual shield includes the object size of the virtual shield.

Step 626: The terminal displays the converted virtual shield exactly in front of the virtual hero.

Exemplarily, the converted virtual shield is determined based on the information about the virtual shield transmitted by the server. In an implementation, in response to an enemy virtual hero passing through the virtual shield, a movement speed of the enemy virtual hero is reduced.

Step 628: The terminal obtains a shooting instruction.

Step 630: The terminal controls the virtual hero to attack an enemy virtual hero.

Exemplarily, in response to the terminal obtaining the shooting instruction, the virtual hero being controlled to attack the enemy is displayed.

Step 632: The server obtains the shooting instruction.

Exemplarily, the terminal forwards the shooting instruction to the server after obtaining the shooting instruction.

Step 634: The server determines consumed virtual shield energy based on a number of times or types of shooting, and reduces a size of the virtual shield based on the consumed virtual shield energy.

Exemplarily, an instruction is designed to consume the virtual shield energy.

Step 636: The server transmits information indicating the reduced virtual shield to the terminal.

Exemplarily, the server updates the information about the virtual shield.

Step 638: The terminal displays the reduced virtual shield.

Exemplarily, the reduced virtual shield is determined based on the information about the reduced virtual shield transmitted by the server.

Based on the above, according to the method provided in this embodiment, the virtual size of the virtual shield is reduced in a case that the virtual hero performs virtual shooting, and a connection is established between the virtual size of the virtual shield and virtual shooting performed by the virtual hero, so that the virtual form of the virtual shield is dynamically changed following the target activity performed by the first virtual character. A new human-computer interaction mode is provided for the virtual shield. The virtual form of the virtual shield can also be dynamically changed based on the target activity in a case that the virtual shield is not actively controlled, which enriches the human-computer interaction mode of the virtual shield. A virtual attack of the virtual hero in the virtual scene is limited when being protected by the virtual shield. This solves a problem that the enemy virtual hero in the virtual scene cannot actively participate in the virtual tactical competition with the virtual hero, intensifies the intensity of the virtual tactical competition, shortens the time of the virtual tactical competition, and increases a quantity of virtual tactical competition battle services provided by the server between units.

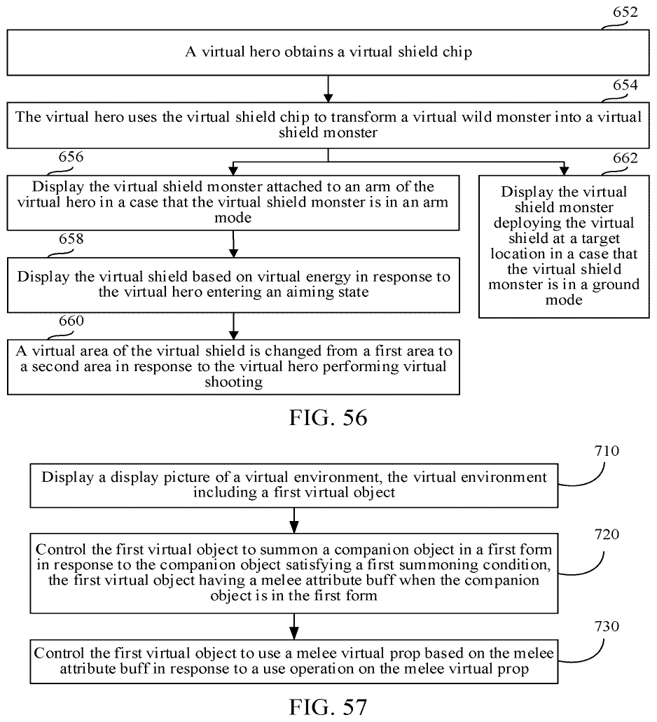

FIG. 56 is a flowchart of using a virtual shield monster according to an exemplary embodiment of this disclosure. The method includes the following steps.

Step 652: A virtual hero obtains a virtual shield chip.

Exemplarily, the virtual shield chip is configured to transform a virtual wild monster into a virtual shield monster. The virtual shield chip may be obtained in a virtual scene, or may be added to the virtual scene by the virtual hero. That is, the obtaining manner of the virtual shield chip is not limited.

Step 654: The virtual hero uses the virtual shield chip to transform a virtual wild monster into a virtual shield monster.

Exemplarily, the virtual hero attacks the virtual wild monster to a weak state, and the virtual hero transforms the virtual wild monster into the virtual shield monster by consuming a virtual economic value, such as consuming virtual nano energy. Further, after the virtual wild monster is transformed into the virtual shield monster, the information about the virtual shield monster is displayed in a virtual shield monster information region. Exemplarily, the information about the virtual shield monster includes but is not limited to at least one of virtual energy of the virtual shield and a health point of the virtual shield monster.

Step 656: Display the virtual shield monster adsorbed to an arm of the virtual hero in a case that the virtual shield monster is in a first form.

Exemplarily, after the virtual wild monster is transformed into the virtual shield monster, the virtual shield monster enters the first form. In an implementation, the virtual shield monster may be switched between the first form and a ground mode through a mode switching operation. Exemplarily, in a case that the virtual shield monster is in the first form, the virtual shield monster turns into virtual fragments and attaches to the arm of the virtual hero. Further, after the virtual shield monster is in the first form, the virtual energy of the virtual shield is accumulated, that is, the virtual energy of the virtual shield is accumulated in a case that the virtual shield is not deployed. Exemplarily, in a case that the virtual shield is not displayed, virtual energy is not consumed during performing of virtual movement and/or virtual shooting. Specifically, in an implementation, the virtual energy is not consumed when virtual shooting is performed without entering an aiming state. That is, when virtual hip shooting is performed or virtual hip shooting and virtual non-aiming shooting are performed, virtual energy is not consumed.

Step 658: Display the virtual shield based on virtual energy in response to the virtual hero entering an aiming state.

Exemplarily, the virtual hero entering the aiming state includes but is not limited to at least one of an aiming state using a sight or an aiming state using a machine. A virtual area of virtual shield is determined based on the virtual energy, and the virtual area of the virtual shield is positively correlated with the virtual energy.

Step 660: A virtual area of the virtual shield is changed from a first area to a second area in response to the virtual hero performing virtual shooting.

The virtual shooting consumes virtual energy, and the virtual area of the virtual shield is determined as the second area based on the virtual energy. The first area is an initial area of the virtual shield.

Step 662: Display the virtual shield monster deploying the virtual shield at a target location in a case that the virtual shield monster is in a second form.

In a case that the virtual shield monster is in the second form, the virtual shield monster is no longer attached to the arm of the virtual hero, and the virtual shield monster deploys the virtual shield at the target location indicated by the virtual hero.

In an implementation, in a case that the virtual shield monster is not loaded with a shield enhancement prop, the virtual shield monster deploys a single-sided rectangular virtual shield at the target location. In another implementation, in a case that the virtual shield monster is loaded with the shield enhancement prop, the virtual shield monster deploys a double-sided hemispherical virtual shield at the target location.

Based on the above, according to the method provided in this embodiment, the virtual area of the virtual shield is reduced in a case that the virtual hero performs virtual shooting, and a connection is established between the virtual area of the virtual shield and virtual shooting performed by the virtual hero. In this way, the virtual area of the virtual shield is dynamically changed following the virtual shooting performed by the first virtual character. A new human-computer interaction mode is provided for the virtual shield. The virtual form of the virtual shield can also be dynamically changed based on the virtual shooting in a case that the virtual shield is not actively controlled, which enriches the human-computer interaction mode of the virtual shield. The virtual energy of the virtual shield is accumulated. A relationship between the virtual energy of the virtual shield and the virtual form of the virtual shield is established, and the virtual energy is accumulated through a behavior of the virtual hero, thereby realizing flexible configuration of the virtual form of the virtual shield. By adding the first form and the second form to the virtual shield monster, the human-computer interaction mode of the virtual shield monster is enriched. In the second form, the protecting effect and the virtual shape of the virtual shield monster are determined based on the shield enhancement prop, which expands the use mode and the human-computer interaction mode of the virtual shield monster.

Attack objects are divided into a melee object and a long-range object.

For the first form, an attack object in a first form is controlled to increase a weapon attack speed of a first virtual object, and/or the attack object in the first form is controlled to add a weapon attack buff of the first virtual object. The weapon attack speed may be divided into a melee attack speed and a long-range attack speed, and the buff may be divided into a melee buff and a long-range buff. In some embodiments, it is determined whether a weapon equipped on the first virtual object satisfies a weapon enhancement condition of a companion object. If the weapon enhancement condition of the companion object is a melee enhancement condition, the weapon equipped on the first virtual object satisfies the weapon enhancement condition of the companion object when being a melee weapon. If the weapon enhancement condition of the companion object is a long-range enhancement condition, the weapon equipped on the first virtual object satisfies the weapon enhancement condition of the companion object when being a long-range weapon.

The melee object and the long-range object are described respectively below.

Melee Object (Companion Object with Melee Assistance/Enhancement Ability):

FIG. 57 is a flowchart of a method for controlling a virtual object according to an embodiment of this disclosure. An execution subject of steps of the method may be a terminal device 400 in a solution implementation environment shown in FIG. 1. For example, the execution subject of the steps may be a client of a target application. In the following method embodiments, for the convenience of description, only the execution subject of the steps being the “client” is described. The method may include at least one of the following steps (710-730).

Step 710: Display a display picture of a virtual scene, the virtual scene including a first virtual object.

Display picture of the virtual scene may include a picture of observing a virtual scene from the perspective of the first virtual object, and the virtual scene includes the first virtual object. The perspective of a virtual object may be a third perspective of the virtual object, or may be a first perspective of the virtual object. In an example, the display picture of the virtual scene is a virtual scene picture displayed to a user on a user interface. The display picture of the virtual scene may be a picture obtained by a virtual camera from the virtual scene. In a possible implementation, the virtual camera obtains a virtual scene picture from a third perspective of the first virtual object. For example, the virtual camera is arranged diagonally above the first virtual object, and the client observes the virtual scene with the virtual object as the center through the virtual camera, and obtains and displays the display picture of the virtual scene with the first virtual object as the center. In another possible implementation, the virtual camera obtains the display picture of the virtual scene from a first perspective of the first virtual object. For example, the virtual camera is arranged exactly in front of the first virtual object, and the client observes the virtual scene from the perspective of the first virtual object through the virtual camera, and obtains and displays the display picture of the virtual scene using the first virtual object as the first perspective. In addition, in an exemplary embodiment, a placement location of the virtual camera is adjustable in real time. For example, the user may adjust the location of the virtual camera through a touch operation on the user interface, and then obtain the display pictures corresponding to the virtual scenes at different locations. For example, the user adjusts the location of the virtual camera by dragging the display picture of the virtual scene. For another example, the user may adjust the location of the virtual camera by clicking/tapping a location in a map display control and using the location as the adjusted location of the virtual camera. The foregoing map display control is a control configured to display a global map in a shooting application.

In this embodiment of this disclosure, during running of the shooting application, the client displays the display picture of the virtual scene, the virtual scene including the first virtual object. In an example, in the shooting application, the user controls the first virtual object to shoot a second virtual object in the virtual scene by using a virtual prop. In some embodiments, in the shooting application, the user controls the first virtual object to attack a second virtual object in the virtual scene by using a virtual prop.

Step 720: Control the first virtual object to summon a companion object in a first form in response to the companion object satisfying a first summoning condition, the first virtual object having a melee attribute buff when the companion object is in the first form.

The companion object may include one or more of a plurality of virtual summoned creatures. In some embodiments, different virtual summoned creatures can provide different buffs for the first virtual object, and the virtual summoned creature selected by the first virtual object according to its own situation is the companion object. In some embodiments, a plurality of second virtual objects exist around the first virtual object. In this case, the first virtual object needs to improve its own melee attribute. In order to obtain the melee attribute buff, the first virtual object chooses a companion object “Da Zhuang”, and “Da Zhuang” can provide the melee attribute buff for the first virtual character. The melee attribute buff includes but is not limited to: increasing the weapon attack speed (including a movement speed) of the first virtual object in a melee, and increasing the weapon attack buff of the first virtual object. In an example, the buff is probabilistic or triggered probabilistically.

The first summoning condition may include a condition that needs to be satisfied to summon the companion object in the first form. The first summoning condition includes but is not limited to at least one of the following: the first virtual object obtains or uses a virtual prop for summoning a companion object, the companion object is selected, and an attribute value of the first virtual object satisfies a set condition. In some embodiments, the first summoning condition is that the first virtual object obtains a virtual prop for summoning a target virtual summoned creature and the companion object is selected. In an example, a manner of obtaining the virtual prop by the first virtual object includes at least one of purchasing by using resources in a target application, killing a specific virtual wild monster, and killing virtual wild monsters with a quantity reaching a wild monster quantity threshold. In an example, the first virtual object obtains a virtual prop after killing a specific virtual wild monster. After using the virtual prop, a plurality of virtual summoned creatures may appear. During the summoning time, the first virtual object selects a companion object. In an example, the summoning time is a time interval between the use of the virtual prop and the first virtual object being summoned. In some embodiments, the first virtual object kills a specific virtual nano-monster in the virtual scene, a virtual prop (which may be referred to as a “core chip” in this embodiment) appears at a location where the virtual nano-monster disappears, and after spending energy (in this embodiment, the first virtual object can obtain energy after performing a virtual task in the virtual scene), the first virtual object can choose to summon one of the plurality of virtual summoned creatures. In some embodiments, the first virtual object directly spends energy, exchanges a virtual prop, and uses the virtual prop to summon a companion object. In some embodiments, the first summoning condition further includes that the attribute value of the first virtual object satisfies the set condition. In some embodiments, the first virtual object can only use the virtual prop to summon the companion object when a health point of the first virtual object is below the pass line.

In some embodiments, the companion object has a plurality of forms, and the forms of the companion object include but are not limited to at least one of a first form and a second form. The second form corresponds to the first form. The companion object may move or attack independently of the first virtual object when appearing in the second form. In some embodiments, the second form of the companion object includes but is not limited to at least one of a human form and an animal form. Correspondingly, the companion object cannot exist separately from the first virtual object when appearing in the first form. In some embodiments, the first form is a form that does not have a specific shape but changes based on the first virtual object. In an example, the first form of the companion object is a form of fragments. In some embodiments, the companion object is attached to an arm of the first virtual object in the form of fragments, which can improve the melee attribute of the first virtual object. In some embodiments, the companion object is attached to another part of the first virtual object in the form of fragments, which can improve the melee attribute of the first virtual object. In an example, the companion object is transformed into a shield form to block the periphery of the first virtual object, which can increase the melee attribute buff (such as defense capability) of the first virtual object. In an example, the companion object is in the form of a mount, which can carry the first virtual object and provide the first virtual object with melee attribute buffs (such as a melee movement speed and a melee attack speed). In this embodiment of this disclosure, the first virtual object uses a virtual prop to summon a companion object (referred to as “Crusher/Da Zhuang”). The companion object is attached to the arm of the first virtual object in the form of fragments, which improves the melee attribute of the first virtual object.

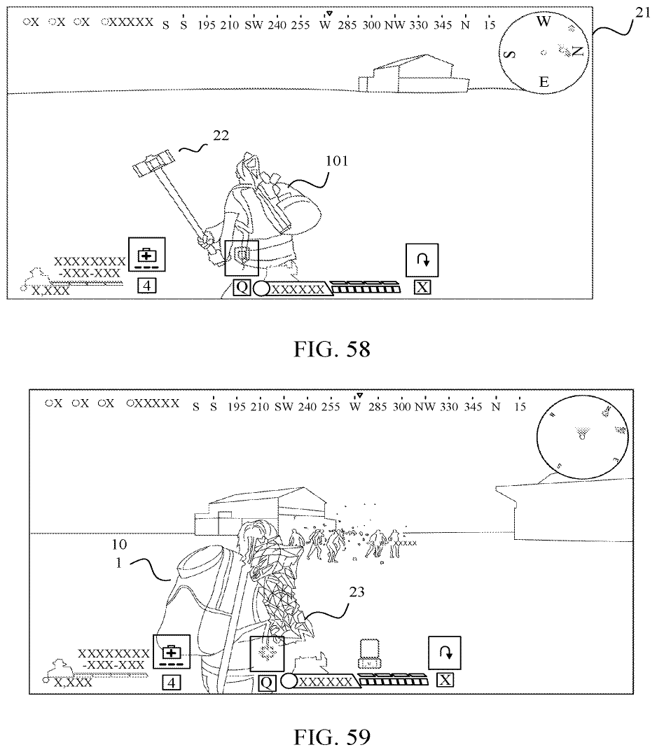

In some embodiments, the melee virtual prop in this embodiment of this disclosure is the virtual prop corresponding to a ranged virtual prop, and an attack distance of the melee virtual prop is less than an attack distance of the ranged virtual prop. In some embodiments, the melee virtual prop is a virtual prop with an attack distance less than a melee distance threshold. In some embodiments, the melee virtual prop includes but is not limited to at least one of the following: a virtual axe, a virtual spear, a virtual pan, and a virtual crowbar. FIG. 58 is a schematic diagram of a display picture according to an embodiment of this disclosure. A display picture 21 of a virtual scene includes a first virtual object 101 and a melee virtual prop 22.

In this embodiment of this disclosure, a melee may be a fight in which the first virtual object uses the melee virtual prop, and the attack distance of the melee may be constant. Melee attributes are all attributes of the first virtual object in a melee. A buff is, for example, promotion/improvement. The buff can mean a helpful effect. A melee attribute buff is an effect that is helpful to the melee of the first virtual object, and is a buff during use of the melee virtual prop. In this embodiment of this disclosure, the melee attribute buff includes at least one of the following: an attack speed buff during use of the melee virtual prop, a throwing speed buff during use of the melee virtual prop, an attack value buff during use of the melee virtual prop, and a critical hit value buff during use of the melee virtual prop.

The attack speed buff during use of the melee virtual prop may be an increase in the attack speed of the melee virtual prop of the first virtual object. In some embodiments, the attack speed of the first virtual object using the melee virtual prop is increased from an attack interval of 0.5 s to an attack interval of 0.25 s.

In an example, the throwing speed buff during use of the melee virtual prop is an increase in a speed at which the first virtual object throws the melee virtual prop. In some embodiments, a time for the first virtual object to throw a virtual axe is increased from 0.1 s to 0.05 s.

The attack value buff during use of the melee virtual prop is a buff of damage caused by the first virtual object to a second virtual object during use of the melee virtual prop. In some embodiments, the damage caused by the first virtual object using a melee virtual prop to the second virtual object is 100 health points, but after the attribute buff, the first virtual object may cause damage of 200 health points to the second virtual object by using the melee virtual prop.

In an example, the critical hit value buff during use of the melee virtual prop means that an increased probability of a critical hit during use of the melee virtual prop. In some embodiments, the critical hit value of the first virtual object using the melee virtual prop is one critical hit every ten attacks, and the critical hit value is twice a normal attack value. However, after the buff of the critical hit value, the critical hit value of the first virtual object using the melee virtual prop is one critical hit every five attacks, and the critical hit value is three times the normal attack value.

In some embodiments, the melee attribute buff is directly applied to the attribute of the first virtual object. When the first virtual object uses the melee virtual prop, the melee attribute buff is obtained by directly improving the melee attribute of the first virtual object itself. In some embodiments, the melee attribute buff is applied to the melee virtual prop, which is the attribute of the upgraded virtual prop. By improving the attribute of the melee virtual prop, the purpose of improving the melee attribute of the first virtual object using the melee virtual prop is achieved during use of the melee virtual prop by the first virtual object. In some embodiments, the melee attribute buff is applied to the first virtual object itself and the melee virtual prop simultaneously. Through the buffs of both sides, the melee attribute of the first virtual object using the melee virtual prop is improved. In a shooting game, a player is usually accustomed to using a virtual prop for a long-range attack, and a usage rate of the melee virtual prop/props such as an axe and a sickle is low, resulting in low resource utilization and a waste of resources. By adopting the solution of this disclosure, resources can be actively utilized and a waste of resources can be avoided.

In this embodiment of this disclosure, the first virtual object is controlled to summon a companion object in a first form in response to the companion object satisfying a first summoning condition, and the first virtual object has a melee attribute buff when the companion object is in the first form. In some embodiments, if the companion object does not satisfy the first summoning condition, the first virtual object does not have the melee attribute buff. In some embodiments, when the companion object is not in the first form, the first virtual object does not have the melee attribute buff.

Step 730: Control a first virtual object to use a melee virtual prop based on the melee attribute buff in response to a use operation on the melee virtual prop.

The use operation includes but is not limited to an attack operation and a throwing operation. The attack operation means using the melee virtual prop to directly cause damage to a second virtual object. The throwing operation means throwing the melee virtual prop to cause damage to the second virtual object indirectly.

In some embodiments, a client controls the first virtual object to use the melee virtual prop based on an attack speed buff in response to a use operation of a first virtual character performed on the melee virtual prop, so that the attack speed of the first virtual object using the melee virtual prop is increased. In some embodiments, a client controls the first virtual object to throw the melee virtual prop based on a throwing speed buff in response to a throwing operation of a first virtual character performed on the melee virtual prop, so that the throwing speed of the first virtual object using the melee virtual prop is increased.

In some embodiments, when the companion object is in the first form, the first virtual object has the melee attribute buff, and the second virtual object is attacked by using the melee virtual prop in a case that the first virtual object has the melee attribute buff. In some embodiments, the companion object is attached to the first virtual object in the form of fragments, and the first virtual object has an attack speed buff of using the melee virtual prop and a throwing speed buff of using the melee virtual prop. In some embodiments, a companion object “Da Zhuang” is attached to an arm of the first virtual object in the form of fragments, so that a speed of throwing a virtual axe and an attack speed of waving a virtual dagger by the first virtual object are increased.

In this embodiment of this disclosure, controlling the first virtual object to summon the companion object in the first form includes displaying a first summoning animation of the companion object. The first summoning animation includes an animation process of generating the companion object in the first form in a virtual scene, and in the first form, the companion object is attached to the first virtual object. In this embodiment of this disclosure, the first summoning animation is a dynamic animation. In some embodiments, the first form of the companion object is a form of fragments. In an example, the first summoning animation is an animation process in which when the companion object is in the form of fragments, the fragments gradually aggregate to a body part of the first virtual object. In an example, the animation process that the companion object Da Zhuang gradually aggregates to the arm of the first virtual object in the form of fragments is displayed. In the first form, the companion object is attached to a body part (such as an arm) of the first virtual object in the form of fragments. FIG. 59 is a schematic diagram of a display picture according to another embodiment of this disclosure. A companion object being attached to a first virtual object 101 in a first form 23 is displayed in a first summoning animation, and the first form 23 of the companion object is a form of fragments.

By displaying the first summoning animation, a picture display effect is improved, and the product quality and attractiveness are improved, thereby increasing a utilization rate of products and avoiding a waste of server resources.

According to the technical solution provided in this embodiment of this disclosure, the melee attribute of the first virtual object is improved by controlling the first virtual object to summon the companion object in the first form and when the companion object is in the first form, so that the purpose of improving the melee attribute of the first virtual object is achieved by summoning the companion object, the manner of improving the melee attribute of the virtual object is increased, and the manner of improving the melee attribute is diversified.

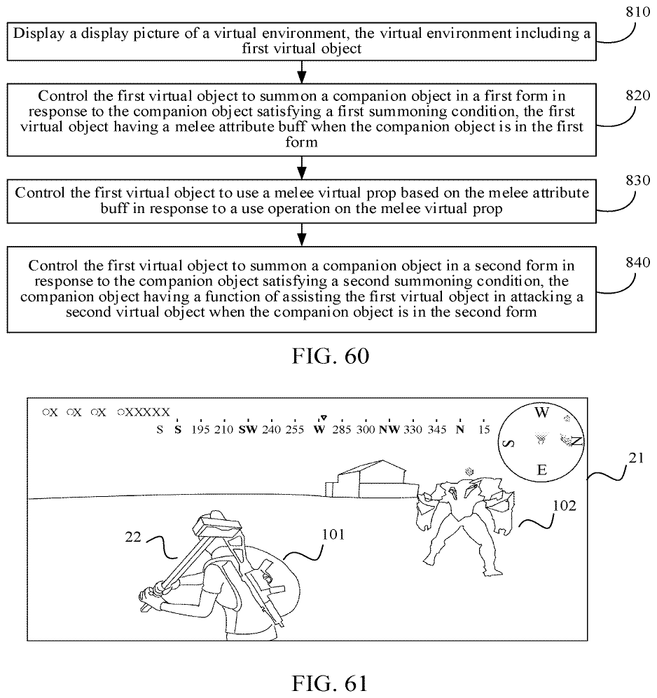

FIG. 60 is a flowchart of a method for controlling a virtual object according to another embodiment of this disclosure. An execution subject of steps of the method may be a terminal device 400 in a solution implementation environment shown in FIG. 1. For example, the execution subject of the steps may be a client of a target application. In the following method embodiments, for the convenience of description, only the execution subject of the steps being the “client” is described. The method may include at least one of the following steps (810-840).

Step 810: Display a display picture of a virtual scene, the virtual scene including a first virtual object.

Step 820: Control the first virtual object to summon a companion object in a first form in response to the companion object satisfying a first summoning condition, the first virtual object having a melee attribute buff when the companion object is in the first form.

Step 830: Control a first virtual object to use a melee virtual prop based on the melee attribute buff in response to a use operation on the melee virtual prop.

Step 840: Control the first virtual object to summon a companion object in a second form in response to the companion object satisfying a second summoning condition, the companion object having a function of assisting the first virtual object in attacking a second virtual object when the companion object is in the second form.

Second summoning condition includes, for example, a condition that needs to be satisfied to summon the companion object in the second form. In some embodiments, when the client receives a touch/press operation performed by a user on a specific summoning button, the first virtual object is controlled to summon the companion object in the second form. In some embodiments, when the companion object appears in the first form for a duration threshold, the first virtual object is controlled to summon the companion object in the second form. In some embodiments, when a distance between the second virtual object and the first virtual object exceeds a summoning distance threshold, the first virtual object is controlled to summon the companion object in the second form.

The second form is a form different from the first form in a plurality of forms of the companion object. In some embodiments, the second form of the companion object is a complete form of the companion object. In some embodiments, the complete form is a state of being separated from the second virtual object and able to act independently. The complete form includes, but is not limited to, at least one of a human form and an animal form. In an example, the first virtual object is controlled to summon a companion object in a human form. In some embodiments, the first virtual object is controlled to summon a companion object in an animal form. FIG. 61 is a schematic diagram of a display picture according to another embodiment of this disclosure. In a display picture 21, a first virtual object 101 holds a melee virtual prop 22 and summons a companion object 102 in a second form. A summoned creature has a plurality of forms, and different forms have different functions/capabilities, thereby increasing the diversity of products and gameplay.

In an example, the second form of companion object is a companion object that can act independently. In some embodiments, the second form of the companion object is different from the first form of the companion object, and the user can choose different skins for the second form of the companion object.

The companion object has the function of assisting the first virtual object in attacking a second virtual object, which means that in the second form, the companion object can play an extra role in helping the first virtual object in a battle between the first virtual character and the second virtual character. In some embodiments, the companion object having the function of assisting the first virtual object in attacking the second virtual object means that the companion object performs an attack behavior on the second virtual object in the second form or the companion object performs a patrol behavior in a virtual scene in the second form.

Attack behavior means, for example, that the companion object in the second form can attack the second virtual object. In some embodiments, the attack behavior of the companion object includes at least one of the following: swinging arms, punching, kicking, and delivering combos. In some embodiments, the companion object can also taunt the second virtual object before attacking the second virtual object. The taunting behavior means attracting hatreds of second virtual objects and gathering the second virtual objects, so that a plurality of second virtual objects can be attacked at one time. In some embodiments, the companion object is Da Zhuang, and in response to Da Zhuang satisfying the second summoning condition, the first virtual object is controlled to summon Da Zhuang in a second form. Before attacking the second virtual object, Da Zhuang taunts the second virtual object with a roar, gathers the plurality of second virtual objects, and then attacks the plurality of second virtual objects. In some embodiments, the attack behavior of the companion object is controlled by Artificial Intelligence (AI). In some embodiments, the attack behavior of the companion object is controlled by a user.

Patrol behavior means, for example, that the companion object in the second form can patrol and give a prompt to the first virtual object when discovering the second virtual object. In some embodiments, the patrol behavior of the companion object is controlled by AI. In some embodiments, the patrol behavior of the companion object is controlled by a user.

In this embodiment of this disclosure, in order to control the first virtual object to summon the companion object in the second form, it is necessary to first determine an aiming location of the first virtual object in the virtual scene. If a second virtual object exists in an effective region corresponding to the aiming location, a virtual summoned creature is controlled to perform an attack behavior on the second virtual object in a second form. If no second virtual object exists in the effective region corresponding to the aiming location, the virtual summoned creature is controlled to perform a patrol behavior in the virtual scene in the second form. Aiming location may correspond to a crosshair on a user interface in a shooting application.

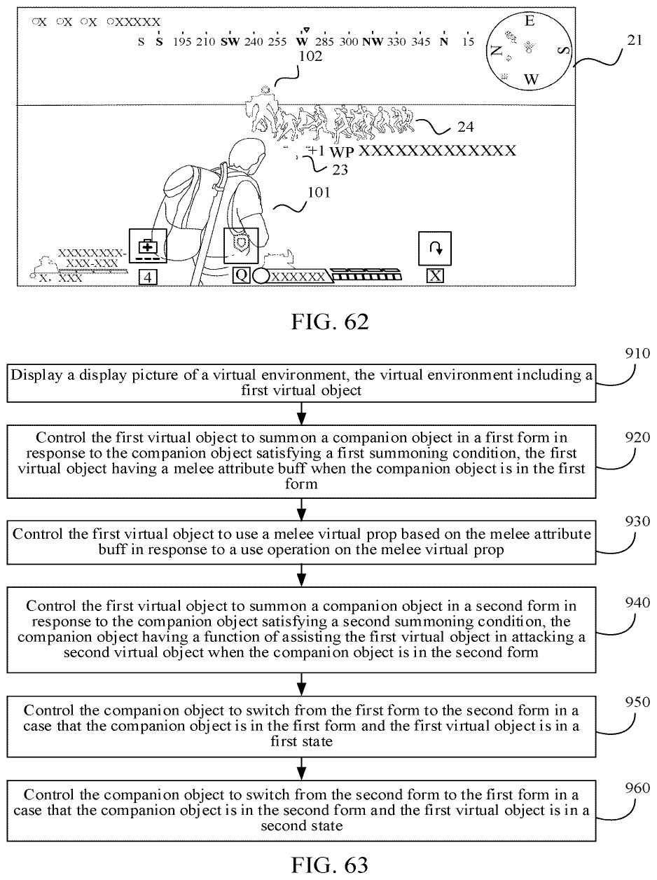

In an example, the second virtual object exists in the effective region corresponding to the aiming location. FIG. 62 is a schematic diagram of a display picture according to another embodiment of this disclosure. In a display picture 21, a first virtual object 101 summons a companion object 102 in a second form. When it is determined that a second virtual object 24 exists in an effective region corresponding to an aiming location 23, the companion object 102 is controlled to perform an attack behavior on the second virtual object 24.

In an example, if no second virtual object exists in the effective region corresponding to the aiming location, as shown in FIG. 62, the companion object 102 performs a patrol behavior in a virtual scene, and can give a prompt to the first virtual object when discovering the second virtual object.

When the companion object is in the second form, the first virtual object does not have a melee attribute buff. When the companion object is in a first form, the companion object does not have the function of assisting the first virtual object in attacking the second virtual object. In some embodiments, the companion object is attached to the first virtual object in the first form, and the first virtual object has the melee attribute buff only when the companion object is attached to the first virtual object. Correspondingly, since the companion object in the first form is not separated from the first virtual object, the companion object does not have the function of assisting the first virtual object in attacking the second virtual object. In some embodiments, when the companion object is in the second form and the companion object in the second form is separated from the first virtual object, the first virtual object no longer has the melee attribute buff. Correspondingly, the companion object has the function of assisting the first virtual object in attacking the second virtual object. The companion object in the second form separated from the first virtual object can help the first virtual object attack the second virtual object. When no second virtual object exists, the companion object can patrol the ground and give a prompt when the second virtual object appears. The function/ability corresponding to the first form does not exist in the second form, and the function/ability corresponding to the second form does not exist in the first form, which helps maintain the difference and balance of abilities in the forms.

The first form and the second form of the companion object can be switched between each other. In some embodiments, when the companion object is in the first form, the companion object is controlled to switch from the first form to the second form in response to a first switching operation on the companion object. In some embodiments, when the companion object is in the second form, the companion object is controlled to switch from the second form to the first form in response to a second switching operation on the companion object. In an example, the first switching operation is an operation on a first switching button. In an example, the second switching operation is an operation on a second switching button. In an example, the first switching button and the second switching button are the same button. In an example, the first switching button and the second switching button are different buttons.

In some embodiments, when the companion object is in the first form, the companion object is controlled to switch from the first form to the second form in response to a touch/press operation on the first switching button. In some embodiments, when the companion object is in the second form, the companion object is controlled to switch from the second form to the first form in response to a touch/press operation on the second switching button.

In this disclosure, the purpose of manipulating the companion object can be achieved through the control operation on the companion object. In some embodiments, in response to a movement control operation on the companion object, the companion object is controlled to move based on the movement control operation. In some embodiments, in response to a behavior control operation on the companion object, the companion object is controlled to perform a corresponding behavior based on the behavior control operation. A control operation includes at least one of the following: the movement control operation and the behavior control operation. The movement control operation is an operation in which a user controls movement of the companion object in the second state. In some embodiments, the user can control the movement of the companion object through a mouse. In some embodiments, the companion object is controlled to move in response to the movement control operation of the companion object by the user through the mouse. The behavior control operation is an operation in which the user controls an attack mode of the companion object in the second state. In some embodiments, the user can control the attack mode of the companion object through a button. In some embodiments, in response to the behavior control operation performed by the user on the companion object through the mouse, the attack mode of the companion object on the second virtual object is controlled. By giving the user more control and operation rights for a summoned creature, the diversity of gameplay is improved. In addition, the movement/behavior control herein and the manual switching of a form of the summoned creature can bring more manipulation experience and strategy experience to a high-level player.

According to the technical solution provided in this embodiment of this disclosure, the first form of the companion object may be switched to the second form, and the companion object in the second form has the function of assisting the first virtual object in attacking the second virtual object, so that the first virtual object can attack the second virtual object in the distance, the game design can be enriched, and user experience can be improved.

In addition, the first form and the second form of the companion object can be switched by the user through a switching operation, so that the user needs to determine, according to the environment, which form of the companion object is to be used. The user can further control the companion object in the second form, further enhancing the strategy of the game and improving interactive experience of the user.

FIG. 63 is a flowchart of a method for controlling a virtual object according to another embodiment of this disclosure. An execution subject of steps of the method may be a terminal device 400 in a solution implementation environment shown in FIG. 1. For example, the execution subject of the steps may be a client of a target application. In the following method embodiments, for the convenience of description, only the execution subject of the steps being the “client” is described. The method may include at least one of the following steps (910-960).

Step 910: Display a display picture of a virtual scene, the virtual scene including a first virtual object.

Step 920: Control the first virtual object to summon a companion object in a first form in response to the companion object satisfying a first summoning condition, the first virtual object having a melee attribute buff when the companion object is in the first form.

Step 930: Control a first virtual object to use a melee virtual prop based on the melee attribute buff in response to a use operation on the melee virtual prop.

Step 940: Control the first virtual object to summon a companion object in a second form in response to the companion object satisfying a second summoning condition, the companion object having a function of assisting the first virtual object in attacking a second virtual object when the companion object is in the second form.

When the companion object is in the first form, step 950 is performed. When the companion object is in the second form, step 960 is performed.

Step 950: Control the companion object to switch from the first form to the second form in a case that the companion object is in the first form and the first virtual object is in a first state.

The first state includes a quantity of second virtual objects within a melee attack range of the first virtual object being less than or equal to a first threshold. The melee attack range is a range within which the first virtual object can attack using a melee virtual prop.

As shown in FIG. 62, when a quantity of second virtual objects 24 within the melee attack range of the first virtual object is less than or equal to the first threshold, the companion object is controlled to switch from the first form to the second form.

In some embodiments, the first threshold is 5, and the quantity of second virtual objects within the melee attack range of the first virtual object is less than or equal to 5, that is, the quantity of second virtual objects within the melee attack range of the first virtual object is small, and other second virtual objects are not within the melee attack range of the first virtual object. Therefore, the companion object is controlled to switch from the first form to the second form, and the companion object in the second form is separated from the first virtual object, which can assist the first virtual object in attacking the second virtual object outside the melee attack range.

Step 960: Control the companion object to switch from the second form to the first form in a case that the companion object is in the second form and the first virtual object is in a second state.

The second state includes a quantity of second virtual objects within a melee attack range of the first virtual object being greater than or equal to a second threshold. The first threshold is less than or equal to the second threshold.

As shown in FIG. 62, when a quantity of second virtual objects 24 within the melee attack range of the first virtual object is greater than or equal to the second threshold, the companion object is controlled to switch from the second form to the first form.

In some embodiments, the second threshold is 10, and the quantity of second virtual objects within the melee attack range of the first virtual object is greater than or equal to 10, that is, a relatively large quantity of second virtual objects are within the melee attack range of the first virtual object. Therefore, the companion object is controlled to switch from the second form to the first form, and the companion object in the first form is attached to the first virtual object, which can improve the melee attribute of the first virtual object and help the first virtual object attack the second virtual object nearby.

By automatically controlling the form of the companion object, the diversity of gameplay is improved. Moreover, the automatic switching herein simplifies the user operation and can bring more interactive experience to a low-level player. In some embodiments, the form of the companion object can be switched manually or automatically, which can be selected by the user and configured in advance, or determined based on a game mode.

According to the technical solution provided in this embodiment of this disclosure, the form of the companion object is controlled based on the quantity of the second virtual objects within the melee range of the first virtual object, and the form of the summoned creature is automatically switched based on the state of the virtual object, so that the user operation is simplified.

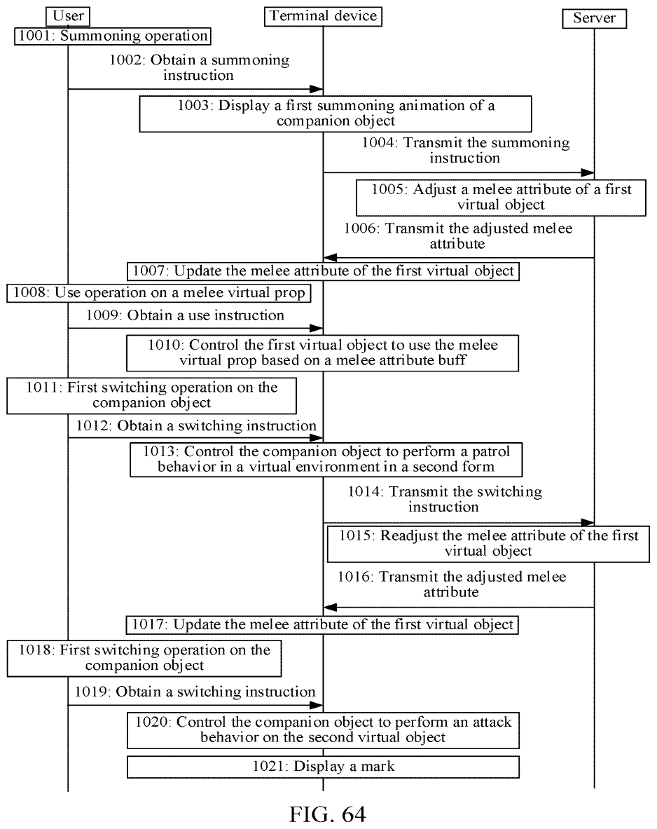

FIG. 64 is a flowchart of a method for controlling a virtual object according to another embodiment of this disclosure. The method may include at least one of the following steps (1001-1021).

Step 1001: A user performs a summoning operation.

The summoning operation is used for summoning a companion object satisfying a first summoning condition. The summoning operation of the user is a touch/press operation on a summon button. The summon button is a button configured to summon a virtual summoned creature.

Step 1002: A terminal device obtains a summoning instruction.

Step 1003: The terminal device displays a first summoning animation of a companion object.

Step 1004: The terminal device transmits the summoning instruction.

Step 1005: A server adjusts a melee attribute of a first virtual object.

Step 1006: The server transmits the adjusted melee attribute.

Step 1007: The terminal device updates the melee attribute of the first virtual object.

Step 1008: The user performs a use operation on a melee virtual prop.

Step 1009: The terminal device obtains a use instruction.

Step 1010: The terminal device controls the first virtual object to use the melee virtual prop based on a melee attribute buff.

Step 1011: The user performs a first switching operation on the companion object.

Step 1012: The terminal device obtains a switching instruction.

Step 1013: The terminal device controls the companion object to perform a patrol behavior in a virtual scene in a second form.

Step 1014: The terminal device transmits the switching instruction.

Step 1015: The server readjusts the melee attribute of the first virtual object.

Step 1016: The server transmits the adjusted melee attribute.

Step 1017: The terminal device updates the melee attribute of the first virtual object.

Step 1018: The user performs the first switching operation on the companion object.

Step 1019: The terminal device obtains the switching instruction.

Step 1020: The terminal device controls the companion object to perform an attack behavior on the second virtual object.

Step 1021: The terminal device displays marks.

The marks in this embodiment are used for referring to different forms of the companion object. When the companion object is in a first form, a first mark appears on a display picture. When the companion object is in the second form, a second mark appears on a display picture. The first mark is different from the second mark. In some embodiments, the first mark is a colored cross identifier, and the second mark is a circular shield.

According to the technical solution provided in this embodiment of this disclosure, the melee attribute of the first virtual object is improved by controlling the first virtual object to summon the companion object in the first form and when the companion object is in the first form, so that the purpose of improving the melee attribute of the first virtual object is achieved by summoning the companion object, the manner of improving the melee attribute of the virtual object is increased, and the manner of improving the melee attribute is diversified.

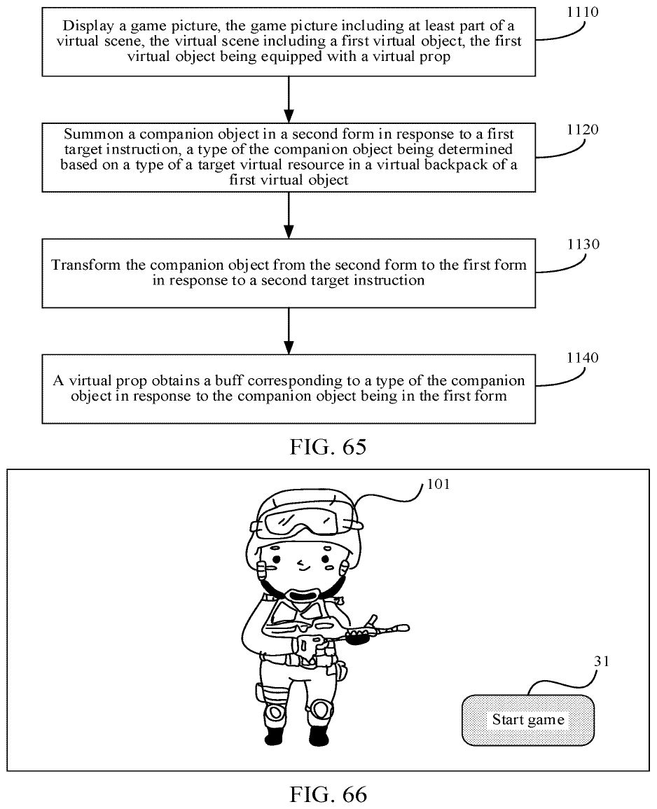

Based on the foregoing implementation environment, this embodiment of this disclosure provides a method for managing a virtual object. A flowchart of the method for managing a virtual object provided in this embodiment of this disclosure shown in FIG. 65 is used as an example. The method may be performed by the terminal device 400 in FIG. 1. As shown in FIG. 65, the method includes the following steps.

Step 1110: Display a game picture, the game picture including at least part of a virtual scene, the virtual scene including a first virtual object, the first virtual object being equipped with a virtual prop.

In an exemplary embodiment of this disclosure, an application (referred to as an application for short below) capable of providing a virtual scene is installed and run in a terminal device. The application may be any type of application, which is not limited in this embodiment of this disclosure. In response to the application being a game application, the application may be a game from a first-person perspective or a game from a third-person perspective, which is not limited in this embodiment of this disclosure.

In response to an instruction of selecting the application by an interactive object, the terminal device displays a display page of the application, and a “Start Game” control is displayed in the display page. In an example, the first virtual object corresponding to an interactive object may further be displayed in the display page. The first virtual object corresponding to the interactive object is a virtual object controlled by the interactive object in the application. An image of the first virtual object is set by the interactive object. The “Start Game” control is configured to start a game and then enter a game picture provided in the application. Other controls such as a setting control and a dressing control may further be displayed in the display page of the application, which is not limited in this embodiment of this disclosure. FIG. 66 is a schematic display diagram of a display page of an application according to an embodiment of this disclosure. A first virtual object 101 corresponding to an interactive object and a “Start Game” control 31 are displayed in FIG. 66.

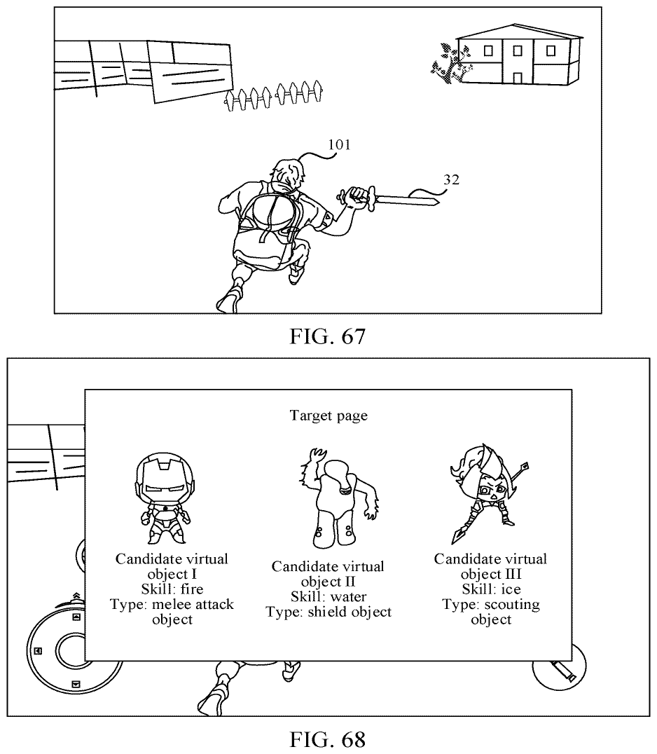

In a possible implementation, a game picture is displayed in response to an instruction of selecting the “Start Game” control displayed in the display page by the interactive object. The game picture includes at least part of a virtual scene, the virtual scene including a first virtual object, the first virtual object being equipped with a virtual prop. Exemplarily, the virtual prop may be a melee prop or a ranged prop in a game, which is not limited in this embodiment of this disclosure. The melee prop is a prop that can be only used for a melee attack, such as a virtual knife and a virtual club, and the ranged prop is a prop that can be used for a long-range attack, such as a virtual gun and a virtual bomb. The manner in which the first virtual object is equipped with the virtual prop may be that the first virtual object holds the virtual prop, and the first virtual object may also be equipped with the virtual prop in another manner. The manner in which the first virtual object is equipped with the virtual prop is not limited in this embodiment of this disclosure. FIG. 67 is a schematic display diagram of a game picture according to an embodiment of this disclosure. In FIG. 67, a virtual scene is displayed, and the virtual scene includes a first virtual object 101. The first virtual object 101 holds a virtual prop 32. Another virtual object may further be displayed in the game picture, which is not limited in this embodiment of this disclosure.

Step 1120: Summon a companion object in a second form in response to a first target instruction, a type of the companion object being determined based on a type of a target virtual resource in a virtual backpack of a first virtual object.

In a possible implementation, the virtual scene includes various types of virtual resources, and the first virtual object has a virtual backpack. The first virtual object may collect various types of virtual resources in the virtual scene and put the collected virtual resources in the virtual backpack of the first virtual object. In response to a quantity of target virtual resources included in the virtual backpack of the first virtual object satisfying a quantity threshold, the first virtual object may summon a companion object corresponding to the type of the target virtual resource. The quantity threshold is set based on experience or adjusted according to an implementation environment, which is not limited in this embodiment of this disclosure. Exemplarily, the quantity threshold is 10.

In an example, a notification message is displayed in response to the first virtual object having the ability to summon the companion object, and the notification message is used for notifying an interactive object that the first virtual object controlled by the interactive object can summon the companion object. The content of the notification message may be any content, which is not limited in this embodiment of this disclosure. When the interactive object learns that the first virtual object controlled by the interactive object may summon the companion object, the interactive object summons the companion object in the second form through the first target instruction, and the type of the companion object is determined based on the type of the target virtual resource in the virtual backpack of the first virtual object.

The first target instruction is used for summoning a companion object, and the companion object may be a summoned creature, or may be a virtual pet, and may further be another kind of companion object, which is not limited in this embodiment of this disclosure. A target page is displayed in response to the first target instruction. At least one candidate companion object corresponding to the type of the target virtual resource in the virtual backpack of the first companion object is displayed in the target page. The target page may be an independent page, or may be a page attached to the game picture, which is not limited in this embodiment of this disclosure. The type of the at least one candidate companion object displayed in the target page may be the same or different, which is not limited in this embodiment of this disclosure. At least one candidate companion object displayed in the target page is the companion object corresponding to the target virtual resource in the virtual backpack of the first companion object. Information such as a name, a skill, and a type of each candidate companion object may further be displayed in the target page, which is not limited in this embodiment of this disclosure.

FIG. 68 is a schematic display diagram of a target page according to an embodiment of this disclosure. In FIG. 68, the target page is a page attached to a game picture. Three candidate companion objects are displayed in FIG. 68, which are respectively a candidate companion object I to a candidate companion object III. A skill of the candidate companion object I is fire, and the type thereof is a melee attack object (also referred to as Da Zhuang), a skill of the candidate companion object II is water, and the type thereof is a shield object (also referred to as a charge monster), and a skill of the candidate companion object III is ice, and the type thereof is a scouting object (also referred to as an observation monster). In an example, another candidate companion object may further be displayed in the target page, which is not limited in this embodiment of this disclosure.

The first target instruction may be a selection instruction for any key in a keyboard connected to a terminal device, and the first target instruction may further be a selection instruction for a control displayed in a game picture, which is not limited in this embodiment of this disclosure.

In response to any candidate companion object in at least one candidate companion object being selected, the selected candidate companion object is used as a companion object. Then a companion object in a second form is summoned. The companion object in the second form may be the companion object itself, or may be an appearance of the companion object after being transformed, which is not limited in this embodiment of this disclosure.

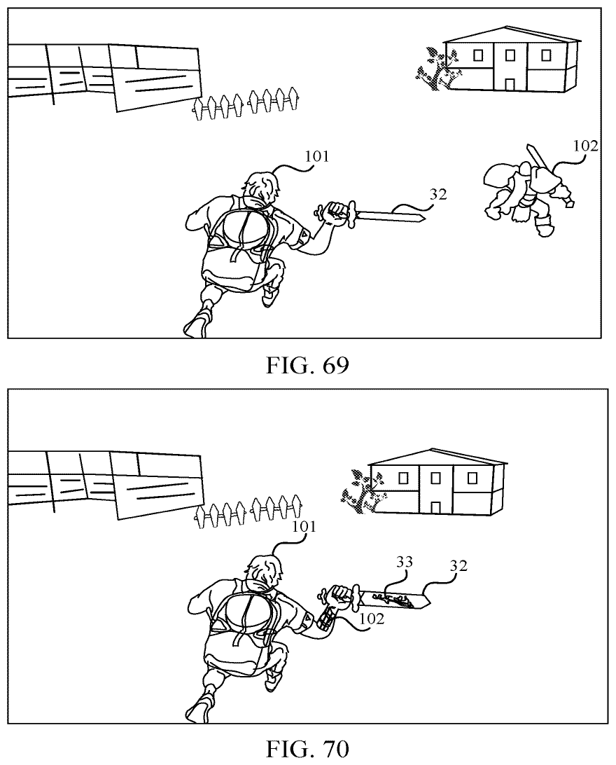

FIG. 69 is a schematic display diagram of a companion object in a second form according to an embodiment of this disclosure. A companion object 102 in a second form is displayed in FIG. 69. A first virtual object 101 and a virtual prop 32 equipped on the first virtual object may further be displayed in FIG. 69.

Step 1130: Transform a companion object from a second form to a first form in response to a second target instruction.

In a possible implementation, the form of the companion object may further be changed. The companion object is transformed from the second form to the first form in response to the second target instruction. In an example, a terminal device stores a transition animation, and the companion object is transitioned from the second form to the first form based on the transition animation, thereby obtaining the companion object in the first form.

Exemplarily, based on the transition animation, the process of transforming the companion object from the second form to the first form may be: breaking the companion object in the second form into a plurality of fragments, and then splicing the plurality of fragments to obtain the companion object in the first form. Fragments may be star-shaped, or may be diamond-shaped, and may further be in other shapes, which are not limited in this embodiment of this disclosure.

When the companion object is in the first form, the companion object in the first form is attached to a target part of the first virtual object. The target part may be a left arm of the first virtual object, or may be a right arm of the first virtual object, and may further be another body part of the first virtual object, which is not limited in this embodiment of this disclosure.

Step 1140: A virtual prop obtains a buff corresponding to a type of the companion object in response to the companion object being in the first form.

In a possible implementation, in response to the companion object being in the first form, the type of the companion object is determined, and the buff corresponding to the type of the companion object is determined. A prop attribute of the virtual prop is adjusted, and the buff corresponding to the type of the companion object is added to the virtual prop, that is, the virtual prop obtains the buff corresponding to the type of the companion object. When the first virtual object attacks using a first virtual prop, the attack of the virtual prop is accompanied by the buff corresponding to the type of the companion object.

In an example, the terminal device stores a correspondence between an object type and the buff, and determines the buff corresponding to the type of the companion object based on the type of the companion object and the correspondence between the object type and the buff.

Exemplarily, the type of the companion object is a first type, and a buff corresponding to the first type is a flame buff. That is to say, when the first virtual object attacks using a virtual prop that obtains the flame buff, the attack of the virtual prop is accompanied by the flame buff.

In an example, when the companion object is in the first form, special effects corresponding to the companion object are determined, and the special effects corresponding to the companion object are displayed on the virtual prop. The process of determining the special effects corresponding to the companion object includes: determining a skill corresponding to the companion object; and determining the special effects corresponding to the companion object based on the skill corresponding to the companion object.

A plurality of special effects are stored in the terminal device, and the process of determining the special effects corresponding to the companion object based on the skill corresponding to the companion object includes: determining a matching degree between the skill corresponding to the companion object and the plurality of special effects, and using the special effects whose matching degree satisfies a matching requirement as the special effects corresponding to the companion object. For example, the special effects with the highest matching degree are used as the special effects corresponding to the companion object.

In a possible implementation, a plurality of special effects and the correspondence between each of the special effects and the skill are stored in the terminal device. After the skill corresponding to the companion object is determined, the special effects matching the skill corresponding to the companion object are used as the special effects corresponding to the companion object. Exemplarily, the special effects corresponding to a fire skill stored in the terminal device are flame special effects, the special effects corresponding to a water skill are water drop special effects, and the special effects corresponding to an ice skill are ice cube special effects. The skill corresponding to the companion object is the fire skill, and the special effects matching the skill corresponding to the companion object are the flame special effects. Therefore, it is determined that the special effects corresponding to the companion object are the flame special effects.

FIG. 70 is a schematic display diagram of a companion object in a first form according to an embodiment of this disclosure. A first virtual object 101, a companion object 102 in a first form, and a virtual prop 32 are displayed in FIG. 70. The first virtual object holds a virtual prop, and the companion object 102 in the first form is displayed on a right arm of the first virtual object. Special effects 33 corresponding to the companion object are displayed on the virtual prop. In FIG. 70, the special effects corresponding to the companion object displayed on the virtual prop are flame special effects.

In a possible implementation, a virtual scene further includes a third virtual object. The third virtual object may be a virtual object different from a team to which the first virtual object belongs. Exemplarily, the third virtual object is an enemy virtual object, or the third virtual object is a neutral virtual object in a game. The third virtual object may also be the same virtual object as the team to which the first virtual object belongs. Exemplarily, the third virtual object is a friendly virtual object. This is not limited in this embodiment of this disclosure.

In response to a third target instruction and the third virtual object being selected, the first virtual object is controlled to attack the third virtual object using a first virtual prop, so that the special effects corresponding to the companion object are displayed in a first region of the third virtual object. The first region of the third virtual object may be an attacked location of the third virtual object, or may be any one body part of the third virtual object, and may further be a location of the third virtual object, which is not limited in this embodiment of this disclosure.

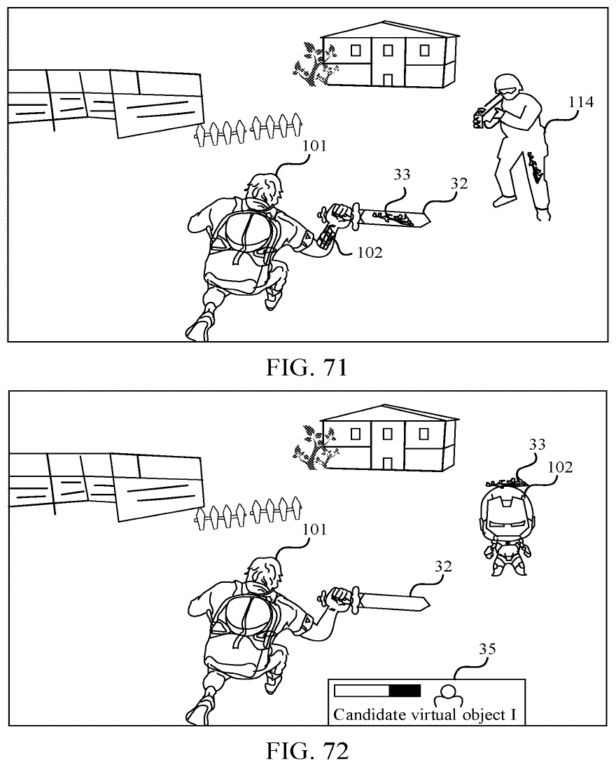

FIG. 71 is a schematic display diagram of a third virtual object according to an embodiment of this disclosure. In FIG. 71, a third virtual object 114 is displayed, and special effects (flame special effects) corresponding to a companion object are displayed on a leg of the third virtual object 114. In FIG. 71, a virtual prop 32 and a first virtual object 101 may further be displayed. A companion object 102 in a first form is displayed on a right arm of the first virtual object 101, and special effects (flame special effects) 33 corresponding to the companion object are displayed on the virtual prop 32. The special effects are visual special effects used for showing a melee buff.

After attacking the third virtual object using a first virtual prop, the first virtual object may bring harm to the third virtual object. Therefore, it is necessary to adjust a health point of the third virtual object in time. Before the health point of the third virtual object is adjusted, it is necessary to obtain the health point of the third virtual object after being attacked. The health point of the third virtual object after being attacked may be obtained in the following two manners.

First manner: Determine an attack value of a first virtual prop, and determine the health point of the third virtual object after being attacked based on an initial health point of the third virtual object and the attack value of the first virtual prop.

Assuming that a buff corresponding to a type of the companion object is a target buff, a virtual prop that obtains the target buff is the first virtual prop, and a virtual prop that does not obtain the target buff is a second virtual prop. The attack value of the first virtual prop and an attack value of the second virtual prop may be the same or different, which is not limited in this embodiment of this disclosure. In response to the attack value of the first virtual prop being the same as the attack value of the second virtual prop, the attack value of the second virtual prop is used as the attack value of the first virtual prop, that is, the attack value of the second virtual prop is used as an initial attack value of the first virtual prop. Exemplarily, the attack value of the first virtual prop is 20.

In response to the attack value of the first virtual prop being different from the attack value of the second virtual prop, an attack gain value of the second virtual prop is obtained, and a sum of the attack value of the second virtual prop and the attack gain value of the first virtual prop is used as the attack value of the first virtual prop. Exemplarily, if the attack value of the second virtual prop is 20, and the attack gain value of the first virtual prop is 10, the attack value of the first virtual prop is 20+10=30.

The attack gain value of the first virtual prop is determined based on a skill of the companion object. Exemplarily, if the skill of the companion object is fire, the attack gain value of the first virtual prop is 10. If the skill of the companion object is water, the attack gain value of the first virtual prop is 5. The attack gain value of the first virtual prop may further be a constant value, which is not limited in this embodiment of this disclosure.

The initial health point of the third virtual object is a health point of the third virtual object before being attacked. Exemplarily, the initial health point of the third virtual object is 90. A difference between the initial health point of the third virtual object and the attack value of the first virtual prop is used as the health point of the third virtual object after being attacked. That is to say, the health point of the third virtual object after being attacked is 90−20=70.

Second manner: A terminal device transmits a health point obtaining request to a server, the server determines a health point of the third virtual object after being attacked based on the health point obtaining request, and the server transmits the health point of a third virtual object after being attacked to the terminal device.

The health point obtaining request carries an object identifier and prompt information of the third virtual object, the prompt information being used for indicating that the third virtual object is attacked by a first virtual object using a first virtual prop. After receiving the health point obtaining request, the server parses the health point obtaining request to obtain the object identifier and prompt information of the third virtual object, and then determines an initial health point of the third virtual object based on the object identifier of the third virtual object. The health point of the third virtual object after being attacked is determined based on the initial health point of the third virtual object and an attack value of the first virtual prop. The process is similar to the foregoing first manner, and details are not described herein again. Any one of the foregoing manners may be selected to determine the health point of the third virtual object after being attacked, which is not limited in this embodiment of this disclosure. After the health point of the third virtual object after being attacked is determined, a current health point of the third virtual object is adjusted to the health point of the third virtual object after being attacked, and the current health point of the third virtual object may further be displayed, so that the interactive object can understand a life state of the third virtual object.

After the first virtual object attacks the third virtual object by using the first virtual prop, the special effects corresponding to the companion object are displayed in a first region of the third virtual object, and a display duration of the special effects is a reference duration. After the reference duration, the special effects corresponding to the companion object are not displayed in the first region of the third virtual object. The reference duration is set based on experience or adjusted according to an implementation environment, and may further be determined based on a reference virtual object, which is not limited in this embodiment of this disclosure. Exemplarily, the reference duration is 3 seconds.

When special effects are displayed in the first region of the third virtual object, the special effects displayed in the first region bring continuous damage to the third virtual object, that is, the health point of the third virtual object is reduced due to the special effects displayed in the first region of the third virtual object. Therefore, a product of a damage value corresponding to the special effects and the reference duration is used as a first damage value. A difference between the damage value of the third virtual object after being attacked and the first damage value is used as the health point of the third virtual object when no special effects are displayed in the first region of the third virtual object.

In an example, in response to a fourth target instruction and a target location being selected, the companion object is transformed into a second form, and the companion object in the second form is located at the target location. In response to the companion object being in the second form, the buff corresponding to the type of the companion object is displayed on the virtual prop, the companion object in the second form obtains the buff corresponding to the type of the companion object, and the special effects corresponding to the companion object are displayed in the second region of the companion object in the second form. The companion object in the first form is not displayed on a target part of the first virtual object, and the special effects corresponding to the companion object are not displayed on the virtual prop. In an example, the companion object in the second form may be the companion object itself, or may be a virtual object of the companion object after being transformed. Only the companion object in the second form being the companion object is used as an example for description in this embodiment of this disclosure.

The target location being selected means that an aiming operation on the target location is received, or an operation of clicking/tapping the target location by the interactive object is received, which is not limited in this embodiment of this disclosure. In response to the target location being selected and a separation control being selected, it means that the interactive object wants to transform the companion object from the first form to the second form. Since the companion object in the first form is attached to the target part of the first virtual object, the companion object is transformed from the first form to the second form, that is, the companion object in the first form is separated from the target part of the first virtual object.

FIG. 72 is a schematic display diagram of a companion object in a second form according to an embodiment of this disclosure. A companion object 102 in a second form, a virtual prop 32, and a first virtual object 101 are displayed in FIG. 72. The companion object in the second form is located at a target location, and flame special effects 33 are displayed in a second region (overhead) of the companion object in the second form. The companion object in the first form is not displayed on a right arm of the first virtual object, and special effects corresponding to the companion object are not displayed on the virtual prop.

In a possible implementation, if a fourth virtual object exists at the target location, the companion object in the second form is controlled to attack the fourth virtual object in response to a fourth target instruction and the target location being selected, so that the special effects corresponding to the companion object are displayed in a first region of the fourth virtual object. The first region may be an attacked location of the fourth virtual object, or may be any one body part of the fourth virtual object, and may further be a location of the fourth virtual object, which is not limited in this embodiment of this disclosure.

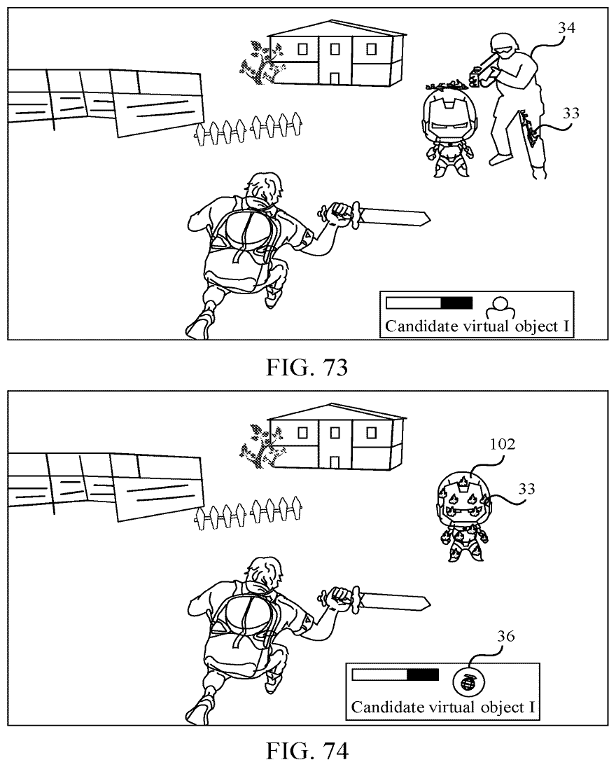

FIG. 73 is a schematic display diagram of a fourth virtual object according to an embodiment of this disclosure after being attacked. In FIG. 73, flame special effects 33 are displayed in a first region (leg) of the fourth virtual object 34.

In a possible implementation, when a companion object in a first form is located at a target part of a first virtual object, and another virtual object attacks the first virtual object, a health point of the first virtual object decreases, but a health point of the companion object does not decrease. When the companion object in a second form is summoned, the companion object in the second form may be attacked by another virtual object. When the companion object in the second form is attacked by the another virtual object, a health point of the companion object in the second form may decrease. Therefore, when the companion object in the second form is attacked, a health point of the companion object in the second form after being attacked is determined. Based on the health point of the companion object in the second form after being attacked being not greater than a reference threshold, the special effects corresponding to the companion object are displayed in a third region of the companion object in the second form, and a range of the third region is larger than a range of the first region and a range of the second region. Exemplarily, the reference threshold is set based on experience or adjusted according to an implementation environment, which is not limited in this embodiment of this disclosure. Exemplarily, the reference threshold is 0.

The process of determining the health point of the companion object in the second form after being attacked may be determined by the server, or may be determined by a terminal device. The process determined by the server is similar to the process determined by the terminal device, and only the terminal device determining the health point of the companion object in the second form after being attacked is used as an example for description in this embodiment of this disclosure. The process includes: determining an attack value of a virtual object that attacks the companion object in the second form; and using, as the health point of the companion object in the second form after being attacked, a difference between an initial health point of the companion object in the second form and the attack value of the virtual object attacking the companion object in the second form. In an example, the initial health point of the companion object in the second form is the health point of the companion object in the second form before being attacked.

The third region may be the whole body of the companion object in the second form, or may be some body parts of the companion object in the second form, and may further be a location of the companion object in the second form, which is not limited in this embodiment of this disclosure.

FIG. 74 is a schematic display diagram of displaying special effects corresponding to a companion object in a second form in a third region of the companion object according to an embodiment of this disclosure. In FIG. 74, flame special effects 33 are displayed on the whole body of the companion object 102 in the second form.

In an example, based on a duration for which the special effects corresponding to the companion object are displayed in the third region of the companion object in the second form exceeding a target duration, a target region is determined based on a location of the companion object in the second form. Further, the companion object in the second form is controlled to disappear in the target region, and the special effects corresponding to the companion object are displayed in the target region. The target duration is set based on experience or adjusted according to an implementation environment, which is not limited in this embodiment of this disclosure. Exemplarily, the target duration is 5 seconds.

An information display region of the companion object in the second form is displayed in a virtual scene, and the information display region is used for displaying object information of the companion object in the second form. The object information includes a health point, an object avatar, and an object name, and the object information may further include other information, which is not limited in this embodiment of this disclosure. A region 35 shown in FIG. 72 is the information display region of the companion object in the second form, and the health point, the object avatar, and the object name of the companion object in the second form are displayed in the region 35.

Based on the health point of the companion object in the second form after being attacked being not greater than a reference threshold, a trigger button is displayed in the information display region of the companion object in the second form, and the trigger button is configured to control the companion object in the second form to spontaneously detonate and disappear. A control 36 in FIG. 74 is a trigger control, and the trigger control is configured to control the companion object in the second form to spontaneously detonate and disappear. In response to the trigger control being selected, the target region is determined based on the location of the companion object in the second form. Further, the companion object in the second form is controlled to spontaneously detonate and disappear in the target region, and attack special effects corresponding to the companion object are displayed in the target region.

Exemplarily, the process of determining the target region based on the location of the companion object in the second form includes: determining a region by using the location of the companion object in the second form as a reference point and using a target length as a reference distance, and using the region as the target region. For example, a circle is determined by using the location of the companion object in the second form as a center of a circle and using the target length as a radius, and a region covered by the circle is used as a target region.

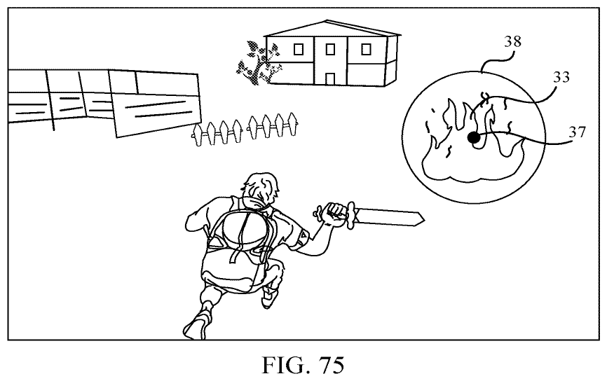

FIG. 75 is a schematic display diagram of a target region according to an embodiment of this disclosure. In FIG. 75, a location of a companion object in a second form is a location 37, a circle is determined by using the location of the companion object in the second form as a center of a circle and using a target length as a radius, and a region 38 covered by the circle is used as the target region. Flame special effects 33 are displayed in the target region, and the companion object in the second form spontaneously detonates and disappears in the target region.

In an example, based on a third virtual object existing in the target region and a team to which the third virtual object belongs being different from a team to which the first virtual object belongs, the special effects displayed in the target region may attack the third virtual object. Therefore, it is necessary to adjust a health point of the third virtual object. The process of adjusting the health point of the third virtual object by the terminal device includes: determining the health point of the third virtual object after being attacked based on an initial health point of the third virtual object and a duration for which the third virtual object is in the target region with special effects displayed; and adjusting a current health point of the third virtual object to the health point of the third virtual object after being attacked.

The process of determining the health point of the third virtual object after being attacked based on an initial health point of the third virtual object and a duration for which the third virtual object is in the target region with special effects displayed includes: obtaining a health point change speed of the third virtual object located in the target region with special effects displayed; determining a health point decrease value of the third virtual object based on the health point change speed of the third virtual object and the duration for which the third virtual object is in the target region with special effects displayed; and using a difference between the initial health point of the third virtual object and the health point decrease value of the third virtual object as the health point of the third virtual object after being attacked. The initial health point of the third virtual object is a health point of the third virtual object at a previous moment when special effects are displayed in the target region.

Exemplarily, the initial health point of the third virtual object is 50, and the health point change speed of the third virtual object is 3 points per second, that is, the health point of the third virtual object decreases by 3 points every second that the third virtual object stays in the target region with special effects displayed. If the duration for which the third virtual object is in the target region with special effects displayed is 5 seconds, it may be determined that the health point of the third virtual object decreases by 15 points, and then it is determined that the health point of the third virtual object after being attacked is 35 points.

In an example, after the health point of the third virtual object after being attacked is determined, a current health point of the third virtual object is adjusted to the health point of the third virtual object after being attacked, so that the interactive object can understand a life state of the third virtual object.

In an example, an adjustment instruction may further be transmitted to a server, the adjustment instruction carries an object identifier of the third virtual object, and the adjustment instruction is used for instructing to determine the health point of the third virtual object after being attacked. After the server determines the health point of the third virtual object after being attacked, the server transmits the health point of the third virtual object after being attacked to the terminal device, so that the terminal device can obtain the health point of the third virtual object after being attacked. A terminal determines the health point of the third virtual object after being attacked, and the server further performs further legitimacy determination, to reduce a calculation amount of the server.

In a possible implementation, in response to the companion object being in the first form, a gain obtaining instruction may further be transmitted to the server. The gain obtaining instruction carries an identifier of the companion object and a prop identifier of a virtual prop, and the gain obtaining instruction is used for obtaining an attribute gain of the virtual prop that obtains the buff corresponding to the type of the companion object. After receiving the gain obtaining instruction, the server parses the gain obtaining instruction to obtain the identifier of the companion object and the prop identifier of the virtual prop. Based on the identifier of the companion object and the prop identifier of the virtual prop, an attribute gain value of the virtual prop is obtained. The server transmits the attribute gain value of the virtual prop to the terminal device. The terminal device determines a target attribute value of the virtual prop based on an initial attribute value of the virtual prop and the attribute gain value of the virtual prop. The initial attribute value is the attribute value of the virtual prop when the virtual prop does not obtain the buff corresponding to the type of the companion object, and the target attribute value is the attribute value of the virtual prop when the virtual prop obtains the buff corresponding to the type of the companion object. That is to say, a sum of the initial attribute value of the virtual prop and the attribute gain value of the virtual prop is used as the target attribute value of the virtual prop. In some embodiments, the terminal determines the attribute gain value corresponding to the virtual prop based on the identifier of the companion object and the prop identifier of the virtual prop, and the server performs further legitimacy determination, to reduce the calculation amount of the server.

The attributes of the virtual prop include but are not limited to an attack attribute and a critical hit attribute. Exemplarily, when the attribute of the virtual prop is an attack attribute, the initial attribute value of the virtual prop is the initial attack value of the virtual prop, the attribute gain value of the virtual prop is the attack gain value of the virtual prop, and the target attribute value of the virtual prop is a target attack value of the virtual prop.

Exemplarily, if the attribute gain value of the virtual prop is 3, and the initial attribute value of the virtual prop is 20, the target attribute value of the virtual prop is 23.

In a possible implementation, in response to the companion object being in the first form, an attribute value obtaining instruction is transmitted to the server. The attribute value obtaining instruction carries an identifier of the companion object and a prop identifier of a virtual prop, and the attribute value obtaining instruction is used for obtaining the target attribute value of the virtual prop. After receiving the attribute value obtaining instruction, the server parses the attribute value obtaining instruction to obtain the identifier of the companion object and the prop identifier of the virtual prop, and then determines the attribute gain value corresponding to the virtual prop based on the identifier of the companion object and the prop identifier of the virtual prop. Based on the prop identifier of the virtual prop, the initial attribute value of the virtual prop is determined. Based on the attribute gain value corresponding to the virtual prop and the initial attribute value of the virtual prop, the target attribute value of the virtual prop is determined. The server transmits the target attribute value of the virtual prop to the terminal device, so that the terminal device can adjust the attribute value of the virtual prop to the target attribute value. In some embodiments, the terminal determines the attribute gain value corresponding to the virtual prop based on the identifier of the companion object and the prop identifier of the virtual prop, and the server performs further legitimacy determination, to reduce the calculation amount of the server.

In a possible implementation, in response to the companion object being in the second form, the attribute value of the virtual prop is adjusted, and the attribute value of the virtual prop is adjusted to the initial attribute value of the virtual prop, that is, the attribute value of the virtual prop when the virtual prop does not obtain the buff corresponding to the type of the companion object. The process is similar to the foregoing process of adjusting the attribute value of the virtual prop to the target attribute value, and details are not described herein again.

The target instruction in this embodiment of this disclosure may be a selection instruction for any key in a keyboard connected to a terminal device, and may further be a selection instruction for a control displayed in a game picture, which is not limited in this embodiment of this disclosure. The function of any target instruction is different.

According to the method, the companion object in the second form is summoned, and the companion object is transformed from the second form to the first form, so that the virtual prop equipped on the first virtual object can obtain the buff corresponding to the type of the companion object, thereby enriching the function of the virtual prop. In addition, the function of the virtual prop is associated with the type of the companion object, which improves the flexibility of managing the virtual object, and expands the function of using the virtual prop by the first virtual object.

When the first virtual object attacks another virtual object using a virtual prop that obtains the buff corresponding to the type of the companion object, the special effects corresponding to the companion object are displayed in a first region of the another virtual object, so that display modes of the special effects are diversified, and the displayed special effects are more flexible and abundant, thereby improving game experience.

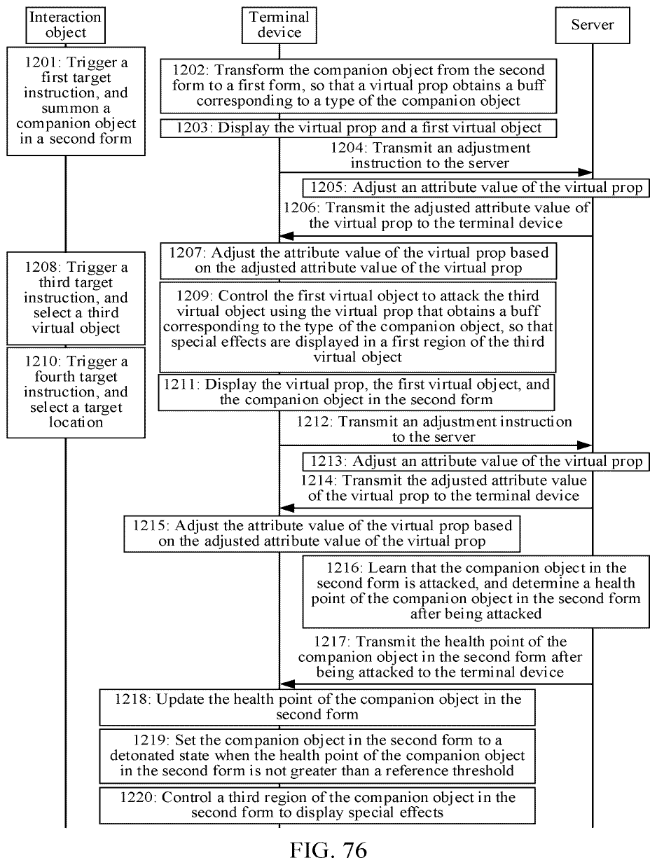

FIG. 76 is a flowchart of a method for managing a virtual object according to an embodiment of this disclosure. The method for managing a virtual object includes the following steps.

Step 1201: An interactive object triggers a first target instruction and summons a companion object in a second form.

Step 1202: The interactive object triggers a second target instruction, and a terminal device transforms the companion object from the second form to a first form, so that a virtual prop obtains a buff corresponding to a type of the companion object.

Step 1203: The terminal device displays the virtual prop and a first virtual object, the companion object in the first form being displayed on a target part of the first virtual object, and special effects corresponding to the companion object being displayed on the virtual prop.

Step 1204: The terminal device transmits an adjustment instruction to a server, and the server adjusts an attribute value of the virtual prop.

Step 1205: The server receives the adjustment instruction and adjusts the attribute value of the virtual prop.

Step 1206: The server transmits the adjusted attribute value of the virtual prop to the terminal device.

Step 1207: The terminal device adjusts the attribute value of the virtual prop based on the adjusted attribute value of the virtual prop.

Step 1208: The interactive object triggers a third target instruction and selects a third virtual object.

Step 1209: The terminal device controls the first virtual object to attack the third virtual object using a first virtual prop, so that special effects are displayed in a first region of the third virtual object.

Step 1210: The interactive object triggers a fourth target instruction and selects a target location.

Step 1211: The terminal device displays the virtual prop, the first virtual object, and the companion object in the second form, the companion object in the second form being located at the target location, special effects being displayed in a second region of the companion object in the second form, the companion object in the first form being not displayed on the target part of the first virtual object, and the special effects being not displayed on the virtual prop.

Step 1212: The terminal device transmits the adjustment instruction to the server.

Step 1213: The server receives the adjustment instruction and adjusts the attribute value of the virtual prop.

Step 1214: The server transmits the adjusted attribute value of the virtual prop to the terminal device.

Step 1215: The terminal device adjusts the attribute value of the virtual prop based on the adjusted attribute value of the virtual prop.

Step 1216: The server learns that the companion object in the second form is attacked, and determines a health point of the companion object in the second form after being attacked.

Step 1217: The server transmits the health point of the companion object in the second form after being attacked to the terminal device.

Step 1218: The terminal device updates the health point of the companion object in the second form.

Step 1219: Set the companion object in the second form to a detonated state when the health point of the companion object in the second form is not greater than a reference threshold.

Step 1220: The terminal device controls a third region of the companion object in the second form to display special effects.

Long-Range Object (Companion Object with Long-Range Assistance/Enhancement Ability):

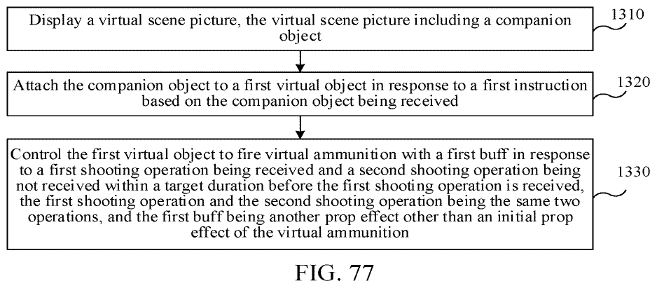

FIG. 77 is a flowchart of a method for controlling a virtual object according to an exemplary embodiment of this disclosure. The method may be performed by a computer device. Exemplarily, the method may be performed by a terminal, or may be performed by a server, or may be performed by the terminal and the server interactively. As shown in FIG. 77, the method for controlling a virtual object may include the following steps.

Step 1310: Display a virtual scene picture, the virtual scene picture including a companion object.

In an example, the virtual scene picture may be a scene picture obtained by observing a virtual scene from a first-person perspective of a first virtual object, or the virtual scene picture may be a scene picture obtained by observing the virtual scene from a third-person perspective, which is not limited in this disclosure.

The companion object may be implemented as a mechanical unit in the virtual scene, or the companion object may be implemented as a virtual pet in the virtual scene. An image of the companion object in the virtual scene is not limited in this disclosure.

Step 1320: Attach the companion object to a first virtual object in response to a first instruction based on the companion object being received.

Attaching the companion object to the first virtual object may mean causing a virtual model corresponding to the companion object to contact a virtual model corresponding to the first virtual object. For example, the companion object “lies on” the back of the first virtual object. Alternatively, the virtual model corresponding to the companion object is fused with the virtual model corresponding to the first virtual object to form a complete whole. Exemplarily, when the first instruction based on the companion object is received, the companion object may be implemented as an equipment component on the first virtual object. The form in which the companion object is attached to the first virtual object is not limited in this disclosure.

Step 1330: Control the first virtual object to fire virtual ammunition with a first buff in response to a first shooting operation being received and a second shooting operation being not received within a target duration before the first shooting operation is received, the first shooting operation and the second shooting operation being the same two operations, and the first buff being another buff other than an initial buff of the virtual ammunition.

The first buff may be an electromagnetic explosion effect or an electromagnetic gun effect.

In a possible implementation, the first virtual object may be equipped with a second virtual prop configured to fire the virtual ammunition, and the first shooting operation and the second shooting operation are both shooting operations on the second virtual prop. In response to the shooting operation based on the second virtual prop being received, the second virtual prop may be triggered to fire the virtual ammunition. In this embodiment of this disclosure, the virtual ammunition may have the initial buff.

On the premise that the companion object is attached to the first virtual object, and the first virtual object has not fired for the target duration, or has not fired beyond the target duration, if the shooting operation is received, the buff of the virtual ammunition fired based on the shooting operation is changed from the initial buff to the first buff, that is, the first virtual object is controlled to fire the virtual ammunition with the first buff. The first buff is different from the initial buff, and the first buff is not the buff of the virtual ammunition itself. Exemplarily, an action range of the first buff is different from an action range of the initial buff. For example, the action range of the first buff is larger than the action range of the initial buff.

Based on the above, according to the method for controlling a virtual object provided in this embodiment of this disclosure, when the first instruction is received, the companion object in the virtual scene is attached to the first virtual object, and the first virtual object is controlled to fire the virtual ammunition with the first buff through the companion object if the shooting operation is received on the premise that the shooting operation is not received within the target duration. The first buff is different from the initial buff of the virtual ammunition, thereby changing the original buff of the virtual ammunition, changing the buff, avoiding the operation required for switching the buff, and improving the efficiency and effect of switching the buff.

When the method for controlling a virtual object shown in this embodiment of this disclosure is performed by the server, the server may control the terminal corresponding to the server to display a corresponding picture. Exemplarily, the server may generate or update, based on the received instruction or operation transmitted by the terminal, a virtual scene picture corresponding to the instruction or operation, and then push the generated or updated virtual scene picture to the terminal, so that the terminal can display the received virtual scene picture to realize display of a related picture in the terminal.

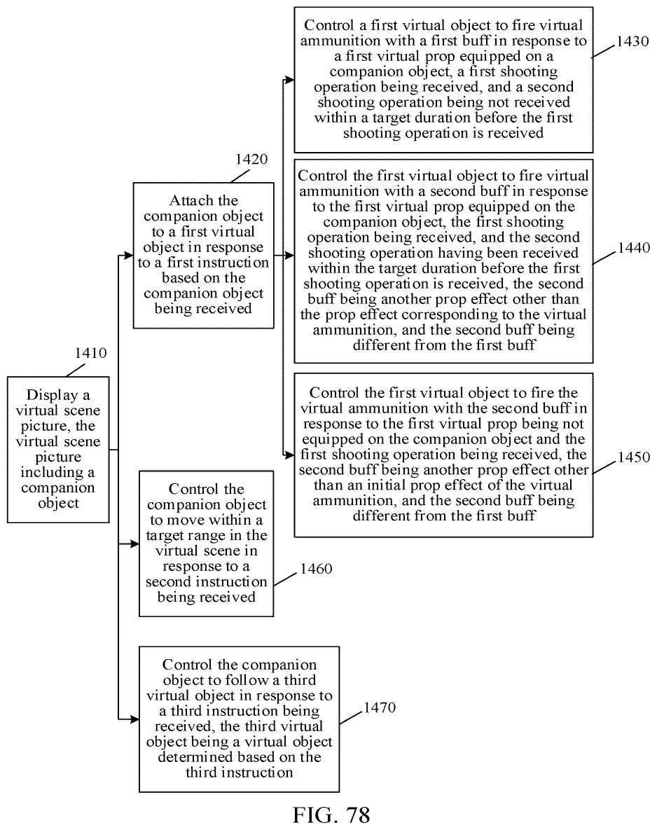

In a possible implementation of this embodiment of this disclosure, the companion object may be equipped with a virtual prop, and the virtual prop equipped on the companion object may cause the companion object to affect the behavior and activities of the first virtual object in the virtual scene after being attached to the first virtual object, for example, changing the buff of the virtual ammunition fired by the first virtual object to the first buff. In an example, in this embodiment of this disclosure, the first buff is implemented on the basis that the companion object is equipped with the first virtual prop. On this basis, FIG. 78 is a flowchart of a method for controlling a virtual object according to an exemplary embodiment of this disclosure. The method may be performed by a computer device. Exemplarily, the method may be performed by a terminal, or may be performed by a server, or may be performed by the terminal and the server interactively. As shown in FIG. 78, the method for controlling a virtual object may include the following steps.

Step 1410: Display a virtual scene picture, the virtual scene picture including a companion object.

In this embodiment of this disclosure, the companion object may be a virtual summoned creature having a behavior model in a virtual scene. Exemplarily, the companion object may be controlled by artificial intelligence (AI) to move in the virtual scene, or the companion object may also move in the virtual scene based on a received behavior control instruction. The behavior control instruction is generated based on a received control operation. Alternatively, the movement of the companion object in the virtual scene may be controlled by both AI and the received control operation.

In an example, the companion object is an existing virtual summoned creature in the virtual scene picture. For example, the companion object is a virtual summoned creature displayed in the virtual scene picture when a first virtual object enters the virtual scene. In this case, the companion object may be a virtual summoned creature selected from at least one virtual summoned creature existing in the first virtual object before entering the virtual scene.

Alternatively, the companion object is a summoned creature displayed in the virtual scene picture based on a summoning operation of the first virtual object. In this case, the companion object may be a virtual summoned creature in at least one virtual summoned creature obtained by the first virtual object that is displayed in the virtual scene based on the summoning operation of the first virtual object.

In an example, when the first virtual object satisfies a target condition in the virtual scene, the function of summoning the companion object may be unlocked. Exemplarily, when the first virtual object does not satisfy the target condition in the virtual scene, a virtual control configured to summon the companion object is in a locked state, that is, the virtual control cannot perform feedback based on a selection operation of the virtual control. When the first virtual object satisfies the target condition in the virtual scene, a virtual control configured to summon the companion object is in an unlocked state, that is, the virtual control may perform feedback based on the selection operation of the virtual control.

In an example, when the first virtual object satisfies the target condition in the virtual scene, a summoned creature selection interface is displayed in response to the summoning operation being received. At least one virtual summoned creature may be displayed in the summoned creature selection interface, and the at least one virtual summoned creature is the summoned creature obtained by the first virtual object.

In response to a selection and determination operation based on the virtual summoned creature being received, the virtual summoned creature corresponding to the selection and determination operation is obtained and used as a companion object.

The companion object is displayed in the virtual scene picture.

In a possible implementation, the process of selecting the virtual summoned creature is limited by a duration. That is to say, within a first duration, in response to the selection and determination operation based on the virtual summoned creature being received, the virtual summoned creature corresponding to the selection and determination operation is obtained and used as the companion object. The first duration is timed starting from a moment when the summoned creature selection interface is displayed.

In response to the selection and determination operation based on the virtual summoned creature being not received within the first duration, the virtual summoned creature in a selected state at the end of the first duration is obtained and used as the companion object. If no click-and-select operation is received, the companion object is the virtual summoned creature in the selected state by default. If a click-and-select operation has been received, the companion object is the virtual summoned creature in the selected state determined based on the received click-and-select operation.

Exemplarily, the first duration is 30 s by way of example. If an operation of selecting a virtual summoned creature from at least one virtual object and determining the virtual summoned creature (a selection and determination operation) is received within 30 s, the selected summoned creature is obtained and used as a companion object. If the selection and determination operation is not received within 30 s, the virtual summoned creature currently in the selected state is obtained and used as the companion object after timing of 30 s ends.

The target condition may be a condition designed based on a behavior and activity of the virtual object in the virtual scene. Exemplarily, a quantity of first target virtual props reaches a quantity threshold, a collection progress of second target virtual props reaches a progress threshold, or the like. The condition content and a quantity of conditions included in the target condition are not limited in this disclosure. For example, when a quantity of synthetic materials collected by the first virtual object reaches a first quantity threshold, and a quantity of collected target resources reaches a second threshold, the function of summoning the companion object is unlocked.

Step 1420: Attach the companion object to a first virtual object in response to a first instruction based on the companion object being received.

In a possible implementation, the companion object is attached to a target part of the first virtual object in response to the first instruction based on the companion object being received. The target part may be a target body part on the first virtual object. The target part may be set by a relevant person based on actual needs. Exemplarily, the target part may be an arm part of the first virtual object, or the target part may be the back of the first virtual object.

In an example, when the companion object is attached to the first virtual object, the companion object may maintain a second form. The second form is a form of the companion object in the virtual scene when being not attached to the first virtual object. That is to say, when the companion object is attached to the first virtual object, a posture of the companion object may be changed to a posture of the companion object attached to the first virtual object, and the form of the companion object remains unchanged.

In an example, when the companion object is attached to the first virtual object, the companion object is controlled to change from the second form to a first form. The first form is different from the second form. In this case, for example, when a first instruction based on the companion object is received, a form change animation is displayed. The form change animation is configured to show a process of changing from the companion object in the second form in the virtual scene to the companion object in the first form attached to the first virtual object.

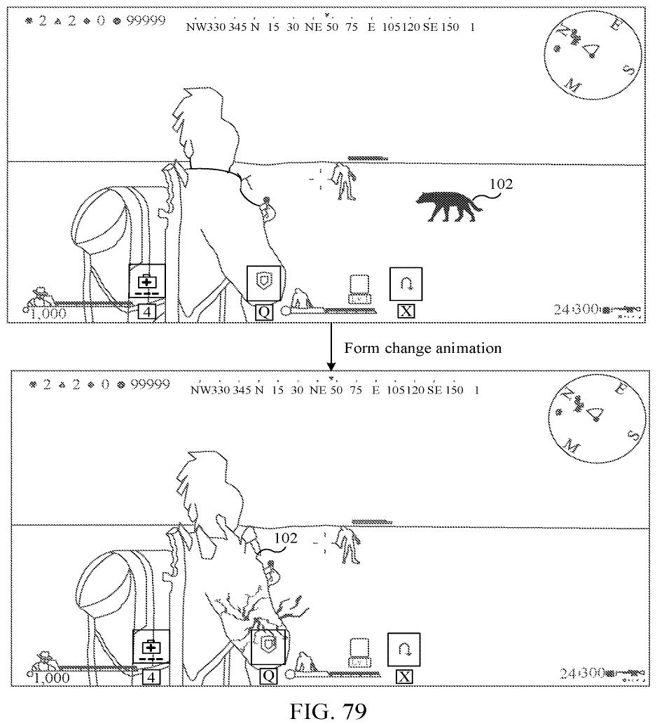

Exemplarily, the target part is the arm part of the first virtual object by way of example. FIG. 79 is a schematic diagram of a state change of a companion object according to an exemplary embodiment of this disclosure. As shown in FIG. 79, when the first instruction based on the companion object is not received, a companion object 102 in a second form may be displayed in the virtual scene, and in FIG. 79, the companion object is in the form of a virtual pet. When the first instruction based on the companion object is received, the companion object 102 in the first form is displayed in the virtual scene after the form change animation is displayed. In FIG. 79, the companion object is in the form of virtual equipment attached to the arm part of the first virtual object.

Step 1430: Control a first virtual object to fire virtual ammunition with a first buff in response to a first virtual prop equipped on a companion object, a first shooting operation being received, and a second shooting operation being not received within a target duration before the first shooting operation is received.

The first shooting operation and the second shooting operation are the same two operations, and the first buff is another buff other than an initial buff of the virtual ammunition. Exemplarily, the initial buff is an ordinary shooting effect without any special effects, and the first buff is an electromagnetic explosion effect with a higher damage value than the ordinary shooting effect.

That is to say, if the first shooting operation is a first shooting operation within the target duration, the virtual ammunition with the first buff is fired. If the first shooting operation is not the first shooting operation within the target duration, the virtual ammunition without the first buff is fired.

In an example, in this embodiment of this disclosure, a difference between the first buff of the virtual ammunition and the initial buff of the virtual ammunition may be reflected in an action range, action special effects, an action duration, an action object, and the like.

In a possible implementation, on the premise that the companion object is attached to the first virtual object and a long-range enhancement prop is attached to the companion object, energy is accumulated before the first shooting operation is received, and the accumulated energy value is positively correlated with a duration for which the shooting operation is not received. That is to say, a longer duration for which the shooting operation is not performed leads to a larger accumulated energy value. When the duration for which the shooting operation is not received reaches or exceeds the target duration, it indicates that the accumulated energy value reaches an energy threshold, and in this case, the buff of the virtual ammunition is changed from the initial buff to the first buff. That is to say, the first virtual object is controlled to store explosion energy of the virtual ammunition in response to the companion object being loaded with the long-range enhancement prop and a current shooting operation being not received.

In a possible implementation, in response to the long-range enhancement prop equipped on the companion object and the second shooting operation being not received within the target duration before the first shooting operation is received, energy storage prompt information is displayed. The energy storage prompt information is used for indicating that the buff of the virtual ammunition has been changed to the first buff.

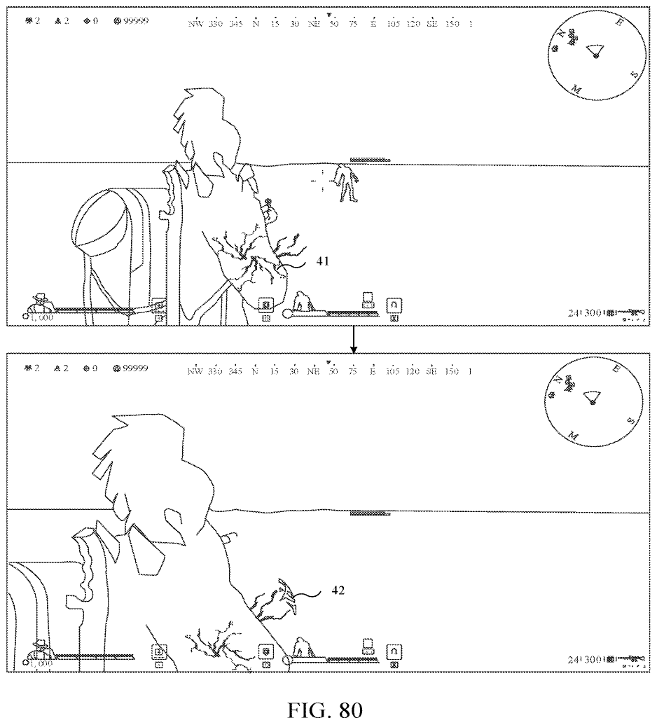

That is to say, the energy storage prompt information is used for indicating that the accumulated energy value reaches the energy threshold. FIG. 80 is a schematic diagram of energy accumulation according to an exemplary embodiment of this disclosure. As shown in FIG. 80, after a companion object is attached to a first virtual object, energy special effects 41 corresponding to energy accumulation may be displayed on the companion object to indicate that the companion object is currently in an energy accumulation state. When the duration for which the shooting operation is not received reaches a target duration, energy storage prompt information 42 is displayed to indicate that the energy storage is completed, so that the first virtual object can be controlled to fire virtual ammunition with a first buff.

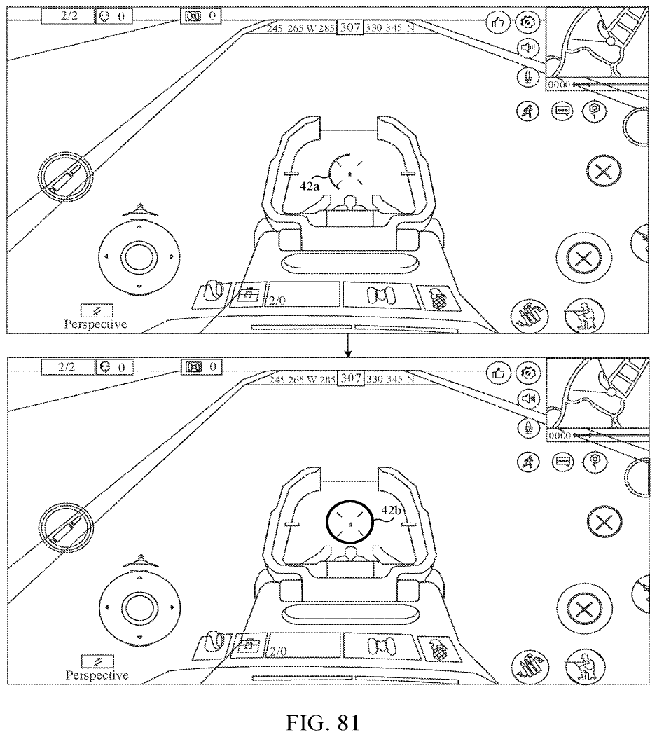

In a possible implementation, when a virtual scene picture is a scene picture obtained by observing a virtual scene from different person perspectives, display forms of the energy storage prompt information may be different in the virtual scene pictures corresponding to different person perspectives. The display form of the energy storage prompt information shown in FIG. 80 may be a first display form in the virtual scene picture corresponding to the virtual scene observed from a third-person perspective. When the virtual scene picture corresponding to the virtual scene is observed from the third-person perspective, the energy storage prompt information shown in FIG. 80 cannot be displayed in the virtual scene picture. In this case, in order to facilitate the control of the energy accumulation state, the energy storage prompt information in a second display form may be displayed in the virtual scene from a first-person perspective. FIG. 81 is a schematic diagram of energy storage prompt information in a second display form according to an exemplary embodiment of this disclosure. As shown in FIG. 81, a virtual scene picture is a scene picture obtained by observing a virtual scene from a first-person perspective. In this case, energy storage prompt information 42a in the second display form may be displayed in the virtual scene picture. The energy storage prompt information 42a may be implemented as a progress bar. A longer energy accumulation time leads to a longer duration of the progress bar. Until the energy accumulation time reaches a target duration, it is determined that the energy accumulation is completed and the progress bar is full, as shown by energy storage prompt information 42b in FIG. 81. A display shape and a display location of the energy storage prompt information in FIG. 81 are only schematic. The progress bar may be displayed in a series of shapes such as a circle and a strip, and the display location of the energy storage prompt information may be displayed at a middle location of the virtual scene picture, or may be displayed at another location, which is not limited in this disclosure.

In some embodiments, explosion energy of virtual ammunition is stored again in response to another shooting operation being received before a storage time of the explosion energy of the virtual ammunition reaches the target duration.

In an example, the energy storage prompt information may further be displayed as special effect information additionally displayed around a shooting control configured to trigger a shooting operation. Alternatively, the energy storage prompt information may further be target sound effect information to be played, and the like, and the foregoing energy storage prompt information may be applied separately or in combination, which is not limited in this disclosure.

After a computer device controls a first virtual object to fire the virtual ammunition with a first buff, for example, the method further includes: displaying the fired virtual ammunition in a first bullet form, the first bullet form being different from a second bullet form, the second bullet form being an original form of the virtual ammunition; and triggering the first buff in response to the virtual ammunition in the first bullet form colliding with a second virtual model in the virtual scene.

That is to say, when the computer device determines to fire the virtual ammunition with the first buff, the form of the virtual ammunition is changed from the second bullet form (the original form) to the first bullet form, and the virtual ammunition is fired in the first bullet form. Exemplarily, if the original form of the virtual ammunition is a virtual bullet, the first form of the virtual ammunition may be implemented as a form such as a virtual electromagnetic gun or a virtual light ball.

When a long-range enhancement prop is an electromagnetic model, the first bullet form of the virtual ammunition may be a virtual electromagnetic gun, and the first buff may be implemented by: at least one of displaying an electromagnetic explosion effect within a first range centered on the virtual ammunition in the first bullet form, causing electromagnetic influence on a virtual object within the first range, reducing a target attribute value of the virtual object within the first range, and forming an electromagnetic field with an action duration being a second duration in the virtual scene. The electromagnetic influence may mean causing electromagnetic interference to target equipment of the virtual object within the first range, for example, causing the target equipment to sleep or damage. The target attribute value may be a health point of the virtual object.

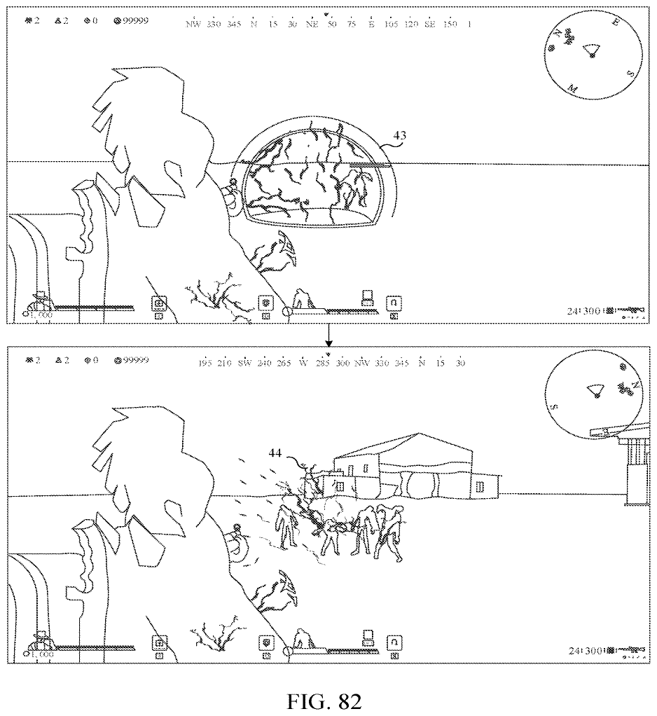

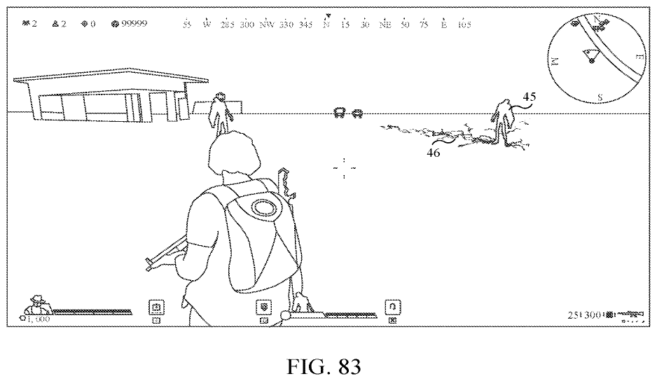

The first bullet form of the virtual ammunition is a virtual electromagnetic gun by way of example. FIG. 82 is a schematic diagram of a first buff according to an exemplary embodiment of this disclosure. As shown in FIG. 82, when a shooting operation on virtual ammunition with the first buff is received, a virtual electromagnetic gun is displayed in a virtual scene, and when the virtual electromagnetic gun collides with a first virtual model in the virtual scene, the first buff 43 is triggered at the collision point. An action range of the first buff is a sphere centered on the collision point and with a first length as a radius, which may cause electromagnetic interference to the target equipment of the virtual object within the action range and explosive damage to the virtual object within the action range. After the buff on the virtual object is completed, an electromagnetic field 44 is formed within a range of triggering the first buff. In an example, the electromagnetic field has a time limit and may cause electromagnetic interference to the virtual object that enters the electromagnetic field within an effective duration.

In an example, after the first virtual object is controlled to fire the virtual ammunition with the first buff, an energy storage state (that is, a state of energy accumulation) is entered again, that is, the duration for which no shooting operation is performed is timed again. When the duration for which no shooting operation is performed reaches the target duration, the first virtual object may be controlled again to fire the virtual ammunition with the first buff. If the shooting operation is received within the target duration, the energy storage state is interrupted. In this case, the computer device needs to perform timing again from the moment when the shooting operation is completed, that is, energy is accumulated again.

Step 1440: Control a first virtual object to fire virtual ammunition with an added second buff in response to a long-range enhancement prop equipped on a companion object, a first shooting operation being received, and a second shooting operation having been received within a target duration before the first shooting operation is received. The second buff is another buff other than the corresponding buff of the virtual ammunition, and the second buff is different from the first buff.

Exemplarily, the second buff is a charged buff in a case that the first buff is not satisfied, which is a long-range buff between the initial buff and the first buff. For example, the second buff is causing electromagnetic influence to the virtual object within the first range, reducing the target attribute value of the virtual object, and adding the charged buff without the explosion effect.

That is to say, in the process of energy accumulation, before the energy accumulation reaches the energy threshold, the virtual ammunition with the first buff cannot be fired since the received first shooting operation interrupts the energy accumulation process. In an example, a state in which the companion object is equipped with the long-range enhancement prop and attached to the first virtual object may still affect the buff of the virtual ammunition, and therefore the computer device may control the first virtual object to fire the virtual ammunition with the added second buff through the foregoing conditions. The second buff is a buff added on the basis of the initial buff of the virtual ammunition. The second buff is different from both the initial buff and the first buff of the virtual ammunition.

Exemplarily, the virtual ammunition with the added second buff may be maintained in the original form of the virtual ammunition, and applies an additional buff to the virtual model on the basis of the original buff when colliding with the virtual model in the virtual scene. For example, when the virtual ammunition is a virtual bullet, and the virtual bullet hits a virtual object in the virtual scene, the virtual ammunition may apply an electric effect to the virtual object with a specific probability on the basis of reducing the target attribute value of the virtual object. The electric effect is implemented by delaying a recovery speed of the target prop of the virtual object, reducing the attribute value of the defense attribute of the virtual object, and the like, which is not limited in this disclosure.

In a possible implementation, when the long-range enhancement prop is equipped on the companion object, and the duration for which the shooting operation is not received reaches the target duration, it is determined that the virtual ammunition with the first buff may be fired. In this case, the computer device may arrange an effect switching control in the virtual scene picture. If a selection operation on the effect switching control is received, the buff of the virtual ammunition is switched from the initial buff to the first buff, and when the first shooting operation is received, the virtual ammunition with the first buff is fired. If the selection operation on the effect switching control is not received, the buff of the virtual ammunition is not changed, and when the first shooting operation is received, the virtual ammunition with the initial buff is fired. Alternatively, if the selection operation on the effect switching control is not received, a second buff is added to the virtual ammunition, and when the first shooting operation is received, the virtual prop with the initial buff and the second buff is fired.

In another possible implementation, when the companion object is equipped with the long-range enhancement prop and the duration for which the shooting operation is not received reaches the target duration, the computer device may determine the buff of the fired virtual ammunition based on a use state of a second virtual prop, and the buff of the virtual ammunition is different under different use states of the second virtual prop.

Exemplarily, in response to the long-range enhancement prop equipped on the companion object, the first shooting operation being received in a non-aiming state, and the second shooting operation being not received within the target duration before the first shooting operation is received, the first virtual object is controlled to fire the virtual ammunition with the first buff.

That is to say, after the energy storage process is completed, if the second virtual prop is in a non-aiming state, the virtual ammunition with the first buff may be fired when the virtual ammunition is fired based on the firing operation.

In response to the long-range enhancement prop equipped on the companion object, the first shooting operation being received in an aiming state, and the second shooting operation being not received within the target duration before the first shooting operation is received, the first virtual object is controlled to fire the virtual ammunition with the added second buff. The second buff is another buff other than the initial buff of the virtual ammunition, and the second buff is different from the first buff. The second buff is also referred to as a long-range buff or a buff.

After the energy storage process is completed, if the second virtual prop is in the aiming state, the virtual ammunition with the initial buff and the second buff may be fired when the virtual ammunition is fired based on the firing operation.

The description of the initial buff, the first buff, and the second buff involved in this embodiment of this disclosure is only exemplary. In application, the buff may be implemented as effects such as an explosion effect, a damage effect, a paralysis effect, an electric effect, a shielding effect, and a blood sucking effect that may be realized in the virtual scene. Under the premise of satisfying different requirements or the same requirement, various buffs involved in this application may be set differently based on different requirements, which is not limited in this disclosure.

In some embodiments, the buff includes at least one of the following effects: damage over time (DOT); paralysis; reducing an armor recovery rate; and reducing a defensive power.

Step 1450: Control the first virtual object to fire the virtual ammunition with the added second buff in response to no long-range enhancement prop equipped on the companion object and the first shooting operation being received. The second buff is another buff other than the initial buff of the virtual ammunition, and the second buff is different from the first buff.

When the companion object is not equipped with the long-range enhancement prop, the state in which the companion object is attached to the first virtual object cannot change the buff of the virtual ammunition to the first buff. However, in this embodiment of this disclosure, an attached state of the companion object (that is, the state in which the companion object is attached to the first virtual object) may still affect the buff of the virtual ammunition, that is, when the shooting operation is received, a second buff is added in addition to the initial buff of the virtual ammunition.

The virtual ammunition with the added second buff may be represented in the virtual scene as follows: displaying the virtual ammunition with target special effects in the virtual scene picture, the target special effects being special effects corresponding to the second buff; and applying a second buff to the first virtual model according to a target probability while applying the buff of the virtual ammunition to the first virtual model in response to the virtual ammunition colliding with the first virtual model in the virtual scene.

The target probability may be a fixed probability value set by the relevant personnel, or the target probability may be a value randomly determined through different shooting operations. This is not limited in this disclosure.

The target special effect is used for indicating that the virtual ammunition comes with the second buff. Exemplarily, the target special effect may be an electric special effect. In this case, the virtual ammunition with electric special effects around may be displayed in the virtual scene picture. The expression form of the target special effect may be set by relevant personnel, which is not limited in this disclosure.

FIG. 83 is a schematic diagram of a second buff according to an exemplary embodiment of this disclosure. As shown in FIG. 83, when the virtual ammunition is a virtual bullet, the computer device controls the first virtual object to fire a virtual bullet with the second buff, and the virtual bullet hits a virtual object 45 in the virtual scene, an electric effect 46 on the virtual object 45 may be probabilistically triggered while reducing a health point (a target attribute value) of the virtual object 45, that is, the second buff.

Step 1460: Control the companion object to move within a target range in the virtual scene in response to a second instruction being received.

The target range may be a range determined centered on the first virtual object. The companion object may be controlled by AI, or the companion object may be controlled based on the received control operation on the companion object. Exemplarily, the companion object may patrol in the target range and move toward and attack a second virtual object when finding that the second virtual object exists in the target range. In an example, the process may be implemented by: controlling the companion object to move toward the second virtual object in response to a distance between the companion object and the second virtual object being less than a first distance threshold; and controlling the companion object to apply a first action effect to the second virtual object in response to a distance between the companion object and the second virtual object being less than a second distance threshold, the second distance threshold being less than the first distance threshold.

The second virtual object may be any virtual object in the virtual scene except the first virtual object, or the second virtual object is any one of virtual objects in the virtual scene that is in a different camp from the first virtual object.

The first action effect applied by the companion object to the second virtual object may be at least one of the electric effect and reducing the target attribute value of the second virtual object, or the first action effect may be another effect, which is not limited in this disclosure.

If the companion object is in a non-attached state, the companion object may directly enter a patrol state (that is, a state in which the companion object moves within the target range in the virtual scene) after receiving the second instruction. If the companion object is in the attached state, the companion object needs to be detached and then enters the patrol state after receiving the second instruction. That is to say, in response to the companion object being in the attached state and the second instruction being received, the companion object is detached. The attached state is used for indicating a state in which the companion object is attached to the first virtual object.

The companion object in the detached state is controlled to move within the target range in the virtual scene.

Step 1470: Control the companion object to follow a third virtual object in response to a third instruction being received, the third virtual object being a virtual object determined based on the third instruction.

In a possible implementation, the second instruction and the third instruction are triggered and generated based on different instruction controls. Alternatively, the second instruction and the third instruction may also be triggered and generated based on the same instruction control. When the second instruction and the third instruction are triggered and generated based on the same instruction control, the computer device may determine a type of a generated instruction based on a received touch operation on the instruction control. Exemplarily, after the selection operation on the instruction control is received, an object selection interface may be displayed. If a selection operation on a non-virtual object is received, it is determined that the instruction generated based on the instruction control is a second instruction. If a selection operation on the virtual object is received, it is determined that the virtual object is a third virtual object, and the third instruction is generated based on the instruction control. Alternatively, after the instruction control is clicked, the instruction control may be dragged without lifting the finger, and the selected object is determined based on a dragging point of the instruction control. When the selected object is a non-virtual object, it is determined that a second instruction is generated. When the selected object is a virtual object, it is determined that a third instruction is generated.

In a possible implementation, the companion object is controlled to apply a second action effect to the third virtual object in response to a distance between the companion object and the third virtual object being less than a third distance threshold.

The second action effect may be the same as the first action effect, or the second action effect may be different from the first action effect, which is not limited in this disclosure.

In a possible case, a following state of the companion object (a state in which the companion object follows the third virtual object) has a time limit. When a duration of the following state reaches a first duration threshold, the following state of the companion object is removed and the companion object is controlled to enter the patrol state.

In another possible case, the companion object has a specific perception range, that is, the companion object may determine whether a third virtual object exists within the perception range. If the distance between the third virtual object and the companion object indicates that the third virtual object is not within the perception range, it is determined that the companion object has lost the following target, the following state of the companion object is removed, and the companion object is controlled to enter the patrol state.

If the companion object is in the non-attached state, the companion object may directly enter the following state after receiving the third instruction. If the companion object is in the attached state, the companion object needs to be detached and then enters the following state after receiving the third instruction. That is to say, in response to the companion object being in the attached state and the third instruction being received, the companion object is detached. The companion object in the detached state is controlled to follow the third virtual object.

Based on the above, according to the method for controlling a virtual object provided in this embodiment of this disclosure, when the first instruction is received, the companion object in the virtual scene is attached to the first virtual object, and the first virtual object is controlled to fire the virtual ammunition with the first buff through the companion object if the shooting operation is received on the premise that the shooting operation is not received within the target duration. The first buff is different from the initial buff of the virtual ammunition, thereby changing the original buff of the virtual ammunition, changing the buff, avoiding the operation required for switching the buff, and improving the efficiency and effect of switching the buff.

In addition, through arrangement of the effect switching control in the virtual scene picture or by determining whether to determine the buff of the virtual ammunition based on the use state of the second virtual prop, the switching of the buff of the virtual ammunition can be more consistent with the use requirements, thereby improving flexibility of switching the buff.

Further, through the method for controlling a virtual object provided in this embodiment of this disclosure, the attack mode of the virtual ammunition is enriched, and under different attack requirements, the attack mode of the virtual ammunition can be changed by controlling an interval between the shooting operations. For example, the electric shock attack can be realized on the basis of abandoning the ordinary attack in a short time, thereby enriching decision points in the use process of the virtual ammunition, and enriching the interactive control mode in the virtual scene.

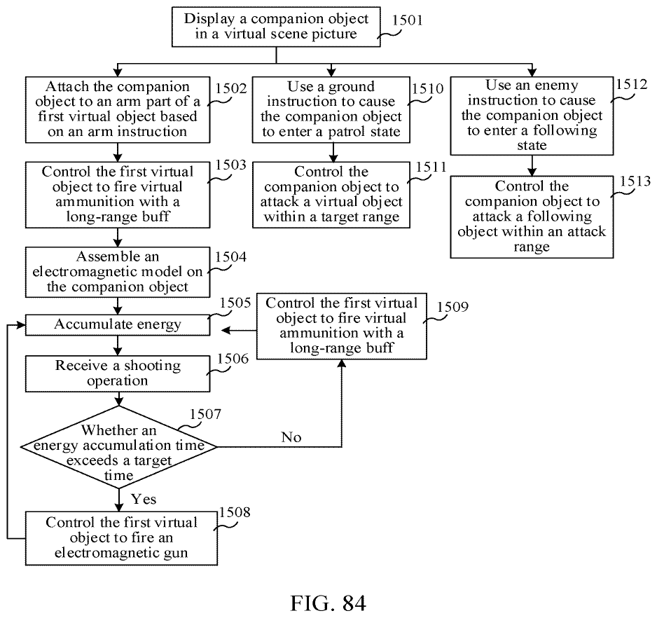

Based on the related contents of the embodiments shown in FIG. 77 and FIG. 78, exemplarily, this embodiment of this disclosure provides a possibility of applying a method for controlling a virtual object provided in this application in the virtual scene. FIG. 84 is a flowchart of a method for controlling a virtual object according to an exemplary embodiment of this disclosure. The method may be performed by a computer device. Exemplarily, the method may be performed by a terminal, or may be performed by a server, or may be performed by the terminal and the server interactively. As shown in FIG. 84, the method for controlling a virtual object may include the following steps.

Step 1501: Display a companion object in a virtual scene picture.

Step 1502: Attach the companion object to an arm part of a first virtual object based on an arm instruction.

The arm instruction is a first instruction based on the companion object.

Step 1503: Control the first virtual object to fire virtual ammunition with a second buff.

The second buff is an electric effect.

Step 1504: Assemble an electromagnetic model on the companion object.

The electromagnetic model (an electromagnetic gun MOD or an electromagnetic gun chip) being able to apply an electromagnetic gun effect to the companion object, that is, a first buff.

Step 1505: Accumulate energy.

Step 1506: Receive a shooting operation.

Step 1507: Determine whether an energy accumulation time exceeds a target time, if so, perform 1508, otherwise, perform 1509.

Step 1508: Control the first virtual object to fire an electromagnetic gun.

The arm instruction is used after the electromagnetic gun MOD is loaded on the companion object. When the first virtual object is in a non-firing state, energy is accumulated. When an energy storage time exceeds the target duration (for example, 5 s), the virtual ammunition fired by the first virtual object next time may become an electromagnetic gun. Specifically, the computer device may receive a shooting instruction. In this case, a detection as to whether the energy storage time is greater than 5 s is performed. If so, the first virtual object is controlled to fire the electromagnetic gun, causing a ranged attack, and leaving an electromagnetic field to apply an electric effect to nearby enemies. Further, after the energy accumulation is completed, energy storage prompt information may be displayed. For example, in a mobile gaming scene, electromagnetic special effects prompts may be provided around a firing button, and in a desktop gaming scene, sound effects or special effects prompts may be provided.

After the electromagnetic gun is fired, the energy accumulation may be resumed.

Step 1509: Control the first virtual object to fire the virtual ammunition with the second buff.

After the shooting operation is performed, the energy storage state is entered again, that is, after step 1508 or 1509 is performed, step 1505 is performed.

Step 1510: Use a ground instruction to cause the companion object to enter a patrol state.

Step 1511: Control the companion object to attack a virtual object within a target range.

Step 1512: Use an enemy instruction to cause the companion object to enter a following state.

Step 1513: Control the companion object to attack a following object within an attack range.

The foregoing arm instruction, the target instruction, and the enemy instruction may be switched based on the received operation, so that the state of the companion object can be switched among the attached state, the patrol state, and the following state.

Based on the above, according to the method for controlling a virtual object provided in this embodiment of this disclosure, when the first instruction is received, the companion object in the virtual scene is attached to the first virtual object, and the first virtual object is controlled to fire the virtual ammunition with the first buff through the companion object if the shooting operation is received on the premise that the shooting operation is not received within the target duration. The first buff is different from the initial buff of the virtual ammunition, thereby changing the original buff of the virtual ammunition, changing the buff, avoiding the operation required for switching the buff, and improving the efficiency and effect of switching the buff.

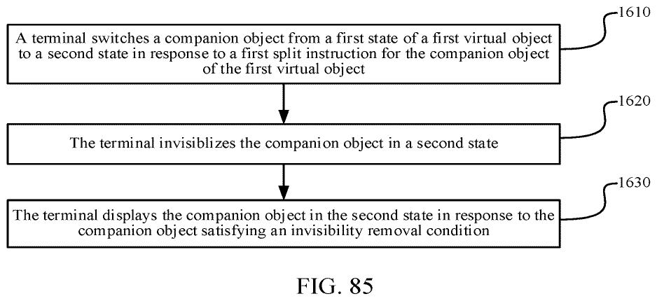

FIG. 85 is a flowchart of a method for displaying a virtual object according to an embodiment of this disclosure. Referring to FIG. 85, the embodiment is performed by an electronic device. The electronic device is a terminal by way of example for description. The embodiment includes the following steps.

Step 1610: A terminal switches a companion object from a first state of a first virtual object to a second state in response to a first split instruction for the companion object of the first virtual object.

The terminal involved in this embodiment of this disclosure is any electronic device having a display function of a virtual object used by a user, and an application supporting a virtual scene is installed and run on the terminal.

The first virtual object referred to in this embodiment of this disclosure is, for example, a virtual object controlled by the user using the terminal, also referred to as a virtual object under control, a controlled virtual object, or the like. The first virtual object is controlled by the user corresponding to the terminal and can perform various activities in the virtual scene, the activities including but not limited to: at least one of adjusting a body posture, crawling, walking, running, riding, jumping, driving, pickup, shooting, attacking, throwing, and confronting.

The companion object involved in this embodiment of this disclosure is, for example, a virtual object that has a master-slave relationship with the virtual object controlled by the user. In some embodiments, the companion object may accompany the first virtual object to perform an activity in the virtual scene, and can assist the first virtual object in performing confrontational behaviors. For example, when the user transmits a control instruction to the companion object, the companion object with a master-slave relationship with the first virtual object performs a corresponding behavior in the virtual scene based on the control instruction, and when the user does not transmit a control instruction to the companion object, the companion object perform an activity in the virtual scene based on behavior logic of the companion object in a current state. The foregoing behavior logic is set according to a preset rule or an AI behavior model, and the companion object may also be referred to as: a virtual summoned creature, a virtual pet, a virtual servant, a virtual follower, a virtual auxiliary elf, and the like.

The split instruction involved in this embodiment of this disclosure may include a first split instruction and a second split instruction. The first split instruction is a split instruction without specifying a third virtual object, and the second split instruction is a split instruction specifying a third virtual object. The third virtual object is a virtual object to be followed by the companion object in a current split. Generally, the third virtual object is a virtual object that belongs to a different team from the first virtual object and is controlled by an enemy player, or the third virtual object is a companion object of a virtual object that belongs to a different team from the first virtual object and is controlled by an enemy player, or the third virtual object is a neutral virtual object within a field of view observed by the user from a third-person perspective.

In some embodiments, after the user starts an application such as a game application on the terminal, a virtual scene is loaded and displayed in the application, and at least the first virtual object controlled by the terminal is displayed in the virtual scene. In an example, the first virtual object can summon the companion object of the first virtual object into the virtual scene based on a summoning operation of the user in a case that a summoning condition is satisfied. Exemplarily, the summoning condition is that the first virtual object has a summoning prop. For example, the user can consume a specific quantity of virtual resources in the virtual scene to purchase the summoning prop from a virtual store, or the user can obtain a virtual material of a neutral virtual object falling reward by defeating the neutral virtual object in the virtual scene, and can exchange the summoning prop when the accumulated virtual materials reach a specified amount. Alternatively, the user can be equipped with the summoning prop in advance before the start of a game and apply the summoning prop to the battle, or after the user defeats a second virtual object of a different team, the user can control the first virtual object to pick up the summoning prop dropped by the second virtual object if the second virtual object is equipped with an unused summoning prop, and the source of the summoning prop is not specifically limited in this embodiment of this disclosure.

In some embodiments, in a case that the first virtual object has a summoning prop, the user can trigger a summoning instruction for the companion object through a summoning control, thereby displaying the currently summoned companion object in the virtual scene. Exemplarily, the user performs a triggering operation on the summoning control to trigger one or more summonable companion objects to emerge in the virtual scene. After the user performs a selection operation on the summoned companion object, the summoning instruction for the companion object selected by the selection operation is triggered.

The foregoing triggering operation on the summoning control includes but is not limited to: a clicking/tapping operation, a double-clicking/tapping operation, a pressing operation, a sliding operation in a specified direction (such as sliding to the left, right, up, or down) based on the summoning control, a voice instruction, a gesture instruction, and the like. The triggering operation is not specifically limited in this embodiment of this disclosure.

In some embodiments, the foregoing summonable companion object is the companion object of the first virtual object that has the summoning permission. In an example, the summoning permission depends on an object type of the first virtual object. In this case, a server side is pre-configured with a correspondence between the virtual object and the companion object, and the correspondence is used for indicating which companion objects each type of virtual object has the summoning permission. For example, the technician configures the foregoing correspondence according to the character setting of the virtual object and the companion object, and then the terminal determines each summonable companion object of the first virtual object that has the summoning permission based on the foregoing correspondence. In an example, the summoning permission depends on a scene type of the virtual scene. In this case, a server side is pre-configured with a mapping relationship between a scene map and the companion object, and the mapping relationship is used for indicating which companion objects are suitable to live and move in each type of scene map. For example, the technician configures the mapping relationship according to the living environment of the scene map and the living condition of the companion object, and then the terminal determines each summonable companion object in the current virtual scene based on the mapping relationship. The manner of determining a summonable companion object is not specifically limited in this embodiment of this disclosure.

In some embodiments, when the summonable companion object is displayed in the virtual scene, each summonable companion object is displayed in the form of a ring control around the summoning control, or each summonable companion object is displayed in the form of a list control around the summoning control. The display mode of the summonable companion object is not specifically limited in this embodiment of this disclosure.

In some embodiments, in a case that the terminal summons the companion object of the first virtual object, the companion object is displayed within a first target range of the first virtual object by default. The first target range is a following range of the companion object. In this case, it means that the companion object is in the second state by default after being successfully summoned. In the second state, the user can switch the companion object from the second state to the first state by triggering a combination instruction for the companion object.

In some embodiments, in a case that the terminal summons the companion object of the first virtual object, the companion object is attached to a target part of the first virtual object by default, and the target part is a part associated with the first virtual object and provided for the companion object to attach in the first state. The target part includes but is not limited to: 1) a body part of the first virtual object, such as an arm, a shoulder, a waist, and a back of the first virtual object; 2) an equipment part of the first virtual object, such as a hand-held virtual prop (such as a virtual instrument) of the first virtual object, a backpack, armor equipment (such as an energy armor, an armor, and protective clothing), and special equipment dedicated to storing companion objects (such as a pet storage bag); and 3) a carrier of the first virtual object, such as a virtual vehicle or a virtual aircraft, the target part being not specifically limited in this embodiment of this disclosure, which means that the companion object is in the first state by default after being successfully summoned.

In some embodiments, the companion object is to switch from the first state of the first virtual object to the second state through the first split instruction, and the second state does not specify the third virtual object to follow, that is, the companion object in the second state appears on the ground. Therefore, the first split instruction is also referred to as the “ground instruction”, which means firing the companion object from the target part of the first virtual object to the ground to realize the separation of the companion object.

In some embodiments, the trigger mode of the first split instruction includes: performing a triggering operation on the companion object attached to the target part of the first virtual object by a user. The foregoing triggering operation includes but is not limited to a click/tap operation, a double-clicking/tapping operation, a pressing operation, a drag operation in a specified direction, a voice instruction, a gesture instruction, and the like. The triggering operation is not specifically limited in this embodiment of this disclosure.

Exemplarily, the triggering operation being the drag operation in a specified direction is used as an example. If the user performs the drag operation on the companion object attached to the target part of the first virtual object in the specified direction, the first split instruction to control the companion object to fire from the target part to the specified direction is to be triggered. In this case, the companion object may land at the intersection of a ray extending in the specified direction with the target part as the endpoint and the ground, so as to flexibly control the landing direction of the companion object through the first split instruction.

In some embodiments, the trigger mode of the first split instruction further includes: providing a user interface (UI) control for the companion object in the virtual scene, the user triggering the first split instruction for the companion object by performing a triggering operation on the UI control.

In an example, only one UI control is provided in the virtual scene. When the companion object is in the first state, the UI control is provided as a split control, and when the companion object is in the second state, the UI control is provided as a combination control, so as to switch the state of the companion object through the UI control.

In the foregoing cases, when the companion object is in the first state, the user may respectively trigger the first split instruction and the second split instruction by performing different triggering operations on the split control. For example, the user clicks/taps the split control to trigger the first split instruction, and double clicks/taps the split control to trigger the second split instruction. For another example, the user holds down the split control and performs a drag operation on the split control in a specified direction, and then determines a ray extending in the specified direction by using the target part as the endpoint. If the ray intersects with a collision detection range of any virtual object, the virtual object is determined as the third virtual object, and the second split instruction specifying the third virtual object to be followed is triggered. If the ray does not intersect with the collision detection range of any virtual object, the first split instruction without specifying the third virtual object is triggered.

In an example, both the combination control and the split control are provided in the virtual scene, which are collectively referred to as UI controls for the companion object. When the companion object is in the first state, the combination control is set to a disabled state, and when the companion object is in the second state, the split control is set to the disabled state.

In the foregoing cases, when the companion object is in the first state, the combination control is set to the disabled state, and in this case, the split control is in an available state, and the user may respectively trigger the first split instruction and the second split instruction by performing different triggering operations on the split control. The triggering operations on the first split instruction and the second split instruction are similar to those in the foregoing cases, which is not specifically limited in this embodiment of this disclosure.

In some embodiments, after the user triggers the first split instruction for the companion object, the terminal reports the first split instruction to the server in response to the first split instruction, and then switches the companion object from the first state to the second state. The first state means that the companion object cannot move in the virtual scene as an independent individual, but can only be attached to the target part of the first virtual object and move with the movement of the first virtual object. The second state means that the companion object can move in the virtual scene as an independent individual, but the movement of the companion object is still limited in the second state. That is, the companion object in the second state can still be controlled by the user, and in a case that the user does not control the movement of the companion object, the companion object is to move under the control of behavior logic, for example, move under the control of the preset rule or the AI behavior model.

Step 1620: The terminal makes the companion object invisible in a second state.

In some embodiments, the terminal makes the companion object invisible in the second state by default in response to the first split instruction, that is, invisibility of the companion object is unconditionally limited. In some other embodiments, the terminal makes the companion object invisible in the second state in response to the first split instruction only in a case that the companion object has an invisibility function attribute. Otherwise, in a case that the companion object does not have the invisibility function attribute, the companion object in the second state is not made invisible, but the companion object in the second state patrolling within a patrol range may be displayed. The interactive modes of the companion object in different situations are to be respectively described in the following embodiments, and details are not described herein again.

Exemplarily, assuming that the invisibility of the companion object is unconditionally limited, then the terminal switches the companion object from the first state to the second state after detecting the first split instruction, and reports the first split instruction carrying a subordinate object ID of the companion object to the server. After receiving the first split instruction, the server transmits an invisibility instruction carrying the subordinate object ID of the companion object to each terminal participating in a battle, to control the companion object to be invisible in each terminal participating in the battle.

Exemplarily, assuming that the companion object can only be invisible when having the invisibility function attribute, then the terminal switches the companion object from the first state to the second state after detecting the first split instruction, and reports the first split instruction carrying a subordinate object ID of the companion object to the server. After the first split instruction is received, based on the subordinate object ID, it is queried whether the companion object has the invisibility function attribute, so that in a case that it is queried that the companion object has the invisibility function attribute, the invisibility instruction carrying the subordinate object ID of the companion object is transmitted to each terminal participating in the battle to control the companion object to be invisible in each terminal participating in the battle. Otherwise, in a case that it is queried that the companion object does not have the invisibility function attribute, the patrol range of the companion object may be returned to each terminal participating in the game.

In some embodiments, when the server queries whether the companion object has the invisibility function attribute, if the server side maintains an invisibility attribute parameter of the companion object, it may be determined whether the companion object has the invisibility function attribute by querying the invisibility attribute parameter of the companion object. The invisibility attribute parameter is used for indicating whether the companion object has the invisibility function attribute. For example, when the invisibility attribute parameter value is 0, it represents that the companion object does not have the invisibility function attribute, and when the invisibility attribute parameter value is 1, it represents that the companion object has the invisibility function attribute. Alternatively, when a value of the invisibility attribute parameter is False, it represents that the companion object does not have the invisibility function attribute, and when the value of the invisibility attribute parameter is True, it represents that the companion object has the invisibility function attribute. How the user controls the companion object to obtain the foregoing invisibility function attribute is to be described in detail in the next embodiment, and details are not described herein again. In some embodiments, the invisibility attribute parameter may also be stored and queried by the terminal.

In some embodiments, the terminal makes the companion object invisible in the second state in response to the invisibility instruction returned by the server. The invisibility of the companion object does not mean that the companion object is removed from the virtual scene, but the companion object is still in the virtual scene and is invisible to each terminal participating in the battle, that is, the terminal does not display the companion object indicated in the invisibility instruction.

In an example, an object model of the companion object is invisible to all terminals. In this case, in order to facilitate viewing of a location of the companion object thereof by the terminal corresponding to the first virtual object, the object model of the companion object may not be displayed, but the location of the companion object may be identified in the virtual scene or a map control. However, for each terminal participating in the battle except the terminal corresponding to the first virtual object, neither the object model of the companion object nor the location of the companion object can be seen.

In an example, the object model of the companion object is only visible to the terminal corresponding to the first virtual object with the master-slave relationship, but not to the other terminals participating in the battle. In this case, in order to make the user know that the companion object is invisible, the object model of the companion object may be displayed differently. For example, a specific transparency or edge flicker special effects are set for the companion object to prompt that the companion object is only visible to itself (only visible to the owner).

In an example, the object model of the companion object is only visible to the first virtual object and the terminal belonging to the same team as the first virtual object, but not to the other terminals participating in the battle. The display mode of the object model is similar to that in the previous case, and details are not described herein again.

Step 1630: The terminal displays the companion object in the second state in response to the companion object satisfying an invisibility removal condition.

In some embodiments, since the companion object cannot always be invisible unconditionally, the invisibility removal condition is set for the companion object. When the companion object satisfies the invisibility removal condition, the companion object in the second state is to be displayed in the virtual scene.

In some embodiments, the invisibility removal condition includes that an invisibility duration reaches an invisibility threshold. Then when the invisibility duration of the companion object reaches the invisibility threshold, the companion object is to be displayed in the virtual scene. The invisibility threshold is any value greater than 0. For example, the invisibility threshold is 10 seconds, 30 seconds, 1 minute, and the like. The invisibility threshold is not specifically limited in this embodiment of this disclosure.

In some embodiments, the invisibility removal condition includes: a virtual health point of the companion object is reduced. Then when the virtual health point of the companion object is reduced due to an external attack, the companion object is to be displayed in the virtual scene. Since the companion object is revealed when being attacked by the external attack, a manner of actively checking the invisible companion object can be provided.

In some embodiments, the invisibility removal condition includes that the companion object initiates an interaction with the first virtual object. The companion object is invisible to the first virtual object when being invisible. In other words, the first virtual object is a virtual object that has no permission to see the companion object when the companion object is invisible. In an example, when the companion object is only visible to the owner, then the companion object is only visible to the first virtual object, and all virtual objects except the first virtual object have no permission to see the invisible companion object. Therefore, all virtual objects except the first virtual object belong to the first virtual object. When the companion object is only visible to friends, then the companion object is only visible to the first virtual object and a friendly virtual object belonging to the same team as the first virtual object (also including the companion object of the friendly virtual object), and all of the virtual objects belonging to different teams from the first virtual object (including the neutral virtual object, the second virtual object belonging to a different team from the first virtual object, and the companion object of the second virtual object) have no permission to see the invisible companion object. Therefore, all of the virtual objects belonging to different teams from the first virtual object belong to the first virtual object, and whether the first virtual object includes a friendly virtual object is not specifically limited in this embodiment of this disclosure. Under the constraint of the foregoing invisibility removal condition, when the companion object actively attacks the first virtual object in the virtual scene, the companion object is to be displayed in the virtual scene, so as to facilitate identification of the orientation of the initiator of the interaction by the first virtual object, that is, the companion object, in time after the interaction.

In an exemplary scene, it is assumed that the invisible companion object does not actively attack the companion object of the second virtual object and the neutral virtual object. In this case, the invisible companion object only actively attacks the second virtual object. In a case that the invisibility removal condition is that the virtual health point of the companion object is reduced or the companion object initiates interaction with the first virtual object, then when the companion object is attacked by the second virtual object, the companion object of the second virtual object, or the neutral virtual object, resulting in the decrease in the health point of the companion object, the companion object is to be revealed in the virtual scene. Alternatively, when the companion object actively attacks the second virtual object, the companion object is also revealed in the virtual scene, which is equivalent to that under this setting, although the companion object of the second virtual object and the neutral virtual object have no permission to see the companion object of the currently invisible first virtual object, since the invisible companion object is set not to actively attack the companion object of the second virtual object and the neutral virtual object, it represents that the companion object only actively attacks the second virtual object, and the first virtual object and the second virtual object are the same in this case.

Any combination of the foregoing technical solutions can be used to obtain additional embodiments of the present disclosure, and the details are not described herein again.

According to the method provided in this embodiment of this disclosure, an interactive mode that supports the invisibility of the companion object after switching to the second state is provided, so that the companion object remains invisible in a case that the invisibility removal condition is not satisfied. Only in a case that the invisibility removal condition is satisfied, the companion object is revealed, so that the companion object can assist the first virtual object in confrontation and ambush more effectively, thereby enriching the interactive modes among different virtual objects and improving the efficiency of human-computer interaction.

In the foregoing embodiment, the interactive mode of the companion object from invisibility to revealing is briefly described. However, in this embodiment of this disclosure, how to control the invisibility and revealing of the companion object through instruction interaction between the terminal and the server is described in detail by using an example that the companion object can be invisible only when having the invisibility function attribute. The companion object may obtain the invisibility function attribute in various ways. The companion object obtaining the invisibility function attribute by assembling a target functional chip is used as an example for description in this embodiment of this disclosure.

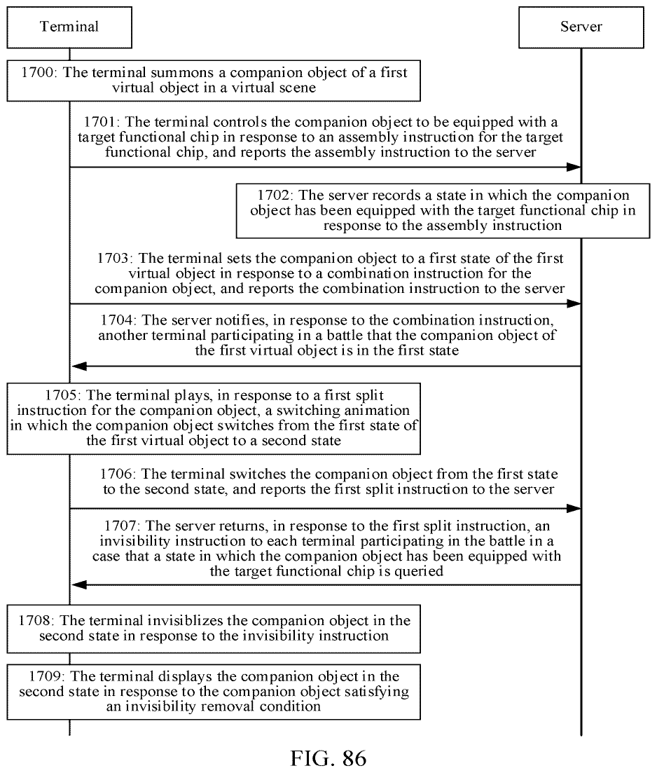

FIG. 86 is an interaction flowchart of a method for displaying a virtual object according to an embodiment of this disclosure. Referring to FIG. 86, the embodiment is performed through interaction between a terminal and a server. The terminal and the server are both examples of an electronic device. The embodiment includes the following steps.

Step 1700: A terminal summons a companion object of a first virtual object in a virtual scene.

In some embodiments, after a user starts an application such as a game application on the terminal, a virtual scene is loaded and displayed in the application, and at least the first virtual object controlled by the terminal is displayed in the virtual scene. In an example, in a case that a summoning condition of the companion object is satisfied, the companion object of the first virtual object can be summoned into the virtual scene based on a summoning operation of the user.

In an example, the summoning condition includes any one of the following or a combination of at least two options: the first virtual object has a summoning prop; or a duration of a battle is greater than a summoning unlocking threshold; or a character level of the first virtual object is greater than a level threshold; or the first virtual object belongs to a camp with a summoning talent, the summoning condition including more or less options, and the summoning condition being not specifically limited in this embodiment of this application.

Exemplarily, the summoning condition is that the first virtual object has a summoning prop. For example, the user can consume a specific quantity of virtual resources in the virtual scene to purchase the summoning prop from a virtual store, or the user can obtain a virtual material of a neutral virtual object falling reward by defeating the neutral virtual object in the virtual scene, and can exchange the summoning prop when the accumulated virtual materials reach a specified amount. Alternatively, the user can be equipped with the summoning prop in advance before the start of a game and apply the summoning prop to the battle, or after the user defeats a second virtual object of a different team, the user can control the first virtual object to pick up the summoning prop dropped by the second virtual object if the second virtual object is equipped with an unused summoning prop, and the source of the summoning prop is not specifically limited in this embodiment of this disclosure.

Exemplarily, the summoning condition is that the battle duration of the battle is greater than the summoning unlocking threshold. The summoning unlocking threshold is any value greater than 0. For example, the summoning unlocking threshold is 3 minutes, 5 minutes, or 10 minutes. In this case, the companion object can be summoned to the virtual scene only in a case that the battle duration is greater than the summoning unlocking threshold, and more interactive gameplay based on the summoned companion object can be gradually unlocked as the battle is played, thereby enriching the manner of participating in the interaction in the battle.

Exemplarily, the summoning condition is that the character level of the first virtual object is greater than the level threshold. The level threshold is any value greater than 0. In view of the fact that the first virtual object can be upgraded with the accumulation of experience points in the battle, the summoning condition that the companion object can be summoned is provided only when the level threshold level is greater than the level threshold, so that the user can be encouraged to control the first virtual object to participate in various interactive gameplay in the battle that increases experience points.

Exemplarily, the summoning condition is that the first virtual object belongs to the camp with a summoning talent. This case is aimed at the character setting of the game. If different types of virtual objects are divided into different camps, it may be set that only some virtual objects in the camp with the summoning talent can summon the companion object. Alternatively, it may also be set that all virtual objects in all camps have the talent of summoning the companion object, and whether the summoning talent is bound to the camp of the virtual object is not specifically limited in this embodiment of this disclosure.

In some embodiments, in a case that the summoning condition of the companion object is satisfied, the user can trigger a summoning instruction for the companion object through a summoning control, thereby displaying the currently summoned companion object in the virtual scene. Exemplarily, the user performs a triggering operation on the summoning control to trigger one or more summonable companion objects to emerge in the virtual scene. After the user performs a selection operation on the summoned companion object, the summoning instruction for the companion object selected by the selection operation is triggered. Then, the summoning animation of the selected companion object is played in the virtual scene, and the summoned companion object is displayed in the virtual scene.

The foregoing triggering operation on the summoning control includes but is not limited to: a clicking/tapping operation, a double-clicking/tapping operation, a pressing operation, a sliding operation in a specified direction (such as sliding to the left, right, up, or down) based on the summoning control, a voice instruction, a gesture instruction, and the like. The triggering operation is not specifically limited in this embodiment of this disclosure.

In some embodiments, the foregoing currently summonable companion object is the companion object of the first virtual object that has the summoning permission. For example, the first virtual object has summoning permission for all companion objects, or different types of virtual objects have summoning permission for different companion objects, or the first virtual object has summoning permission for different companion objects in different scene maps, or different companion objects have different summoning unlocking levels, and the first virtual object only has the summoning permission for the companion object whose summoning unlocking level is less than or equal to its own level, which is not specifically limited in this embodiment of this disclosure.

In an example, the summoning permission depends on an object type of the first virtual object. In this case, a server side is pre-configured with a correspondence between the virtual object and the companion object, and the correspondence is used for indicating which companion objects each type of virtual object has the summoning permission. For example, the technician configures the foregoing correspondence according to the character setting of the virtual object and the companion object. Next, the terminal pulls the foregoing correspondence from the server, and determines each summonable companion object of the first virtual object that has the summoning permission based on the foregoing correspondence.

In an example, the summoning permission depends on a scene type of the virtual scene. In this case, a server side is pre-configured with a mapping relationship between a scene map and the companion object, and the mapping relationship is used for indicating which companion objects are suitable to live and perform an activity in each type of scene map. For example, the technician configures the mapping relationship according to the living environment of the scene map and the living condition of the companion object. Next, the terminal pulls the foregoing mapping relationship from the server, and determines each summonable companion object in the current virtual scene based on the mapping relationship. The manner of determining a summonable companion object is not specifically limited in this embodiment of this disclosure.

In an example, the summoning permission depends on the summoning unlocking level of the companion object. The summoning unlocking level means that the character level of the virtual object can unlock the summoning permission of the corresponding companion object only when reaching a specified level. In an example, the server side pre-configures the summoning unlocking level of each companion object, and the terminal transmits a pull request for a summonable companion object to the server. The pull request carries a current character level of the first virtual object, and the server side returns, to the terminal in response to the pull request, each summonable companion object whose summoning unlocking level is less than or equal to the character level.

In some embodiments, when the summonable companion object is displayed in the virtual scene, each summonable companion object is displayed in the form of a ring control around the summoning control, or each summonable companion object is displayed in the form of a list control around the summoning control. The display mode of the summonable companion object is not specifically limited in this embodiment of this disclosure.

In the foregoing process, after the user selects the current companion object to be summoned, the terminal plays an animation of summoning the selected companion object. In an example, the summoning animation is preloaded locally after the terminal starts a battle, or immediately pulled by the terminal from the server in response to the summoning instruction. When to pull the summoning animation is not specifically limited in this embodiment of this disclosure.

In some embodiments, after the summoning animation is played, the companion object is rendered in the virtual scene, so that the companion object is displayed in the virtual scene. In an example, when the companion object is summoned, the user can freely choose whether the companion object enters the virtual scene in the first state or the second state. When the user does not choose the companion object that enters the virtual scene in an entry state, the companion object may enter the virtual scene in the first state or the second state by default, which is not specifically limited in this embodiment of this disclosure.

In some embodiments, the user can perform confrontation behaviors with the neutral virtual object, the second virtual object in a different team, or the companion object of the second virtual object with the assistance of the companion object after summoning the companion object into the virtual scene.

Step 1701: The terminal controls the companion object to be equipped with a target functional chip in response to an assembly instruction for the target functional chip, and reports the assembly instruction to a server.

In some embodiments, the user can control the first virtual object and the companion objects thereof to collect target functional chip in the virtual scene through the terminal. In an example, the target functional chip in this embodiment of this disclosure is a kind of functional chip configured to improve the confrontation capability of the companion object, and the target functional chip can support invisibility of the companion object in the second state. In an example, the target functional chip can also support the companion object in the second state to fire a marked prop. The marked prop is to be described in detail in the next embodiment, and details are not described herein again.

In some embodiments, the target functional chip can be purchased from the virtual store in the virtual scene. The user can consume a specific amount of virtual resources in the virtual store to purchase or exchange the target functional chip. Purchasing and exchanging the target functional chip may consume different types of virtual resources. For example, purchasing the target functional chip consumes virtual coupons, and exchanging the functional chip consumes virtual points.

In some embodiments, the target functional chip can be obtained by participating in the confrontation behavior with other virtual objects. In an example, after a first target quantity of other virtual objects are defeated or a second target quantity of other virtual objects are continuously defeated, the target functional chip falls into the backpack of the first virtual object or can be picked up interactively after being approached by the first virtual object in the virtual scene, which is equivalent to using the target functional chip as a reward item to encourage effective confrontation and interaction between players or between the player and an NPC object. The other virtual objects include non-friendly virtual objects such as the neutral virtual object, the second virtual object in different teams, the companion object of the second virtual object, and the like. The first target quantity and the second target quantity are both any integer greater than 0. For example, the first target quantity is 5, 10, 15, or the like, and the second target quantity is 3, 5, 10, or the like.

In some embodiments, after the target functional chip is obtained, the target functional chip can be viewed in the backpack. During viewing of the target functional chip, function description information and assembly options of the target functional chip may be shown. In response to a triggering operation on each of the assembly options by the user, an assembly instruction for the target functional chip is to be triggered. In this case, on the one hand, the assembly instruction is reported to the server, and on the other hand, the currently summoned companion object is controlled to be equipped with the target functional chip.

In some embodiments, during assembly of the target functional chip, an assembly animation of the target functional chip is played, In an example, the assembly animation is preloaded locally after the terminal starts a battle, or immediately pulled by the terminal from the server in response to the assembly instruction. When to pull the assembly animation is not specifically limited in this embodiment of this disclosure.

In some embodiments, after the assembly animation is played, the target functional chip is removed from the backpack, and in addition, different appearances may be configured for companion objects with and without the target functional chip. For example, assuming that the target functional chip is inserted into a chip loading part of the companion object, the chip loading part is vacant when the target functional chip is not assembled, and the target functional chip is displayed in the chip loading part when the target functional chip is assembled. For another example, an outline effect is displayed on the companion object equipped with the target functional chip to remind the user that the target functional chip is currently assembled.

Step 1702: The server records a state in which the companion object has been equipped with the target functional chip in response to the assembly instruction.

In some embodiments, the server receives the assembly instruction reported by the terminal, and records the state in which the companion object has been equipped with the target functional chip in response to the assembly instruction. In an example, the server side maintains an assembly state parameter of the companion object for the target functional chip. Since the assembly state parameter can indicate whether the companion object is equipped with the target functional chip, it can be reflected whether the companion object has the invisibility function attribute. The server sets the assembly state parameter to the assembled state in response to the assembly instruction.

Exemplarily, the assembly state parameter is binary data. A value of the assembly state parameter being 0 represents an unassembled state, and in this case, the companion object does not have the invisibility function attribute. The value of the assembly state parameter being 1 represents the assembled state, and in this case, the companion object has the invisibility function attribute. Assuming that the default value being 0 represents the unassembled state by default, when the server receives the assembly instruction reported by the terminal, the assembly state parameter is set to 1, and the state in which the companion object has been equipped with the target functional chip is recorded, thereby reflecting that the companion object has the invisibility function attribute.

Exemplarily, the assembly state parameter is Boolean data. The value of the assembly state parameter being False represents an unassembled state, and in this case, the companion object does not have the invisibility function attribute. The value of the assembly state parameter being True represents the assembled state, and in this case, the companion object has the invisibility function attribute. Assuming that the default value being False represents the unassembled state by default, when the server receives the assembly instruction reported by the terminal, the assembly state parameter is set to True, and the state in which the companion object has been equipped with the target functional chip is recorded, thereby reflecting that the companion object has the invisibility function attribute.

Steps 1701-1702 of this embodiment of this disclosure only provide an exemplary description that the companion object obtains the invisibility function attribute by assembling the target functional chip. In some other embodiments, the companion object can further obtain the invisibility function attribute by assembling invisible equipment, or obtain the invisibility function attribute under a specific condition (such as improving the character level) based on inherent talent, or the companion object can have the invisibility function attribute during releasing or lasting of a target virtual skill by releasing the first virtual object (such as the invisibility skill). The foregoing cases are only exemplary descriptions of the manner of obtaining the invisibility function attribute, but do not constitute a limitation on the manner of obtaining the invisibility function attribute.

Exemplarily, the companion object has the invisibility function attribute in the following cases. A) The companion object is equipped with the target functional chip, so that the object equipped with the target functional chip can have the invisibility function attribute. This case is used as an example for description in this embodiment of this disclosure. B) The companion object is equipped with invisible equipment (such as an invisible cloth and an invisible cloak), so that an object wearing the invisible equipment can have the invisibility function attribute. C) Due to the inherent talent, the companion object obtains the invisibility function attribute under a specific condition. For example, when belonging to the dark elf force, the companion object automatically has the invisibility function attribute when reaching a specific level. D) The first virtual object or the companion object releases the target virtual skill, so that the companion object can have the invisibility function attribute during releasing or lasting of the target virtual skill by releasing the first virtual object (such as the invisibility skill). The foregoing cases are only exemplary descriptions of the manner of obtaining the invisibility function attribute, but do not constitute a limitation on the manner of obtaining the invisibility function attribute.

In some embodiments, when the user controls the companion object so that the companion object has the invisibility function attribute, the server side records that the companion object has the invisibility function attribute. Exemplarily, the companion object obtaining the invisibility function attribute in a plurality of ways is used as an example for description. When the companion object obtains the invisibility function attribute in any way, the server side sets the invisibility attribute parameter to a state that can indicate “having the invisibility function attribute”, such as setting the invisibility attribute parameter to 1 or to True, so that the subsequent server can query whether the companion object has the invisibility function attribute in response to a first split instruction. The assembly state parameter involved in the foregoing steps 301-302 is an exemplary description of the invisibility attribute parameter. That is, if the companion object can only obtain the invisibility function attribute in a way of being equipped with the target functional chip, the assembly state parameter of the target functional chip is the same as the invisibility attribute parameter of the companion object.

Step 1703: The terminal sets the companion object to a first state of the first virtual object in response to a combination instruction for the companion object, and reports the combination instruction to the server.

In some embodiments, a UI control for the companion object is provided in the virtual scene, and the user triggers the combination instruction for the companion object by performing a triggering operation on the UI control. Alternatively, the user triggers the combination instruction for the companion object through a voice instruction or a gesture instruction, and the trigger mode of the combination instruction is not specifically limited in this embodiment of this disclosure.

In some embodiments, only one UI control is provided in the virtual scene. When the companion object is in the first state, the UI control is provided as a split control, and when the companion object is in the second state, the UI control is provided as a combination control, so as to switch the state of the companion object through the UI control. In this case, when the companion object is in the second state, the UI control is provided as a combination control. In this case, the user can trigger the combination instruction by performing a triggering operation on the combination control. In this case, the terminal reports the combination instruction to the server, sets the companion object to the first state of the first virtual object, and switches the combination control to a split control. In other words, the combination control is no longer displayed, and the split control is displayed at the location where the combination control is originally displayed.

In some embodiments, both the combination control and the split control are provided in the virtual scene, which are collectively referred to as UI controls for the companion object. When the companion object is in the first state, the combination control is set to a disabled state, and when the companion object is in the second state, the split control is set to the disabled state. In this case, when the companion object is in the second state, the split control is set to the disabled state, and the combination control is set to an available state. In this case, the user can trigger the combination instruction by performing a triggering operation on the combination control. In this case, the terminal reports the combination instruction to the server, sets the companion object to the first state of the first virtual object, and switches the combination control to the disabled state and the split control to the available state.

In some embodiments, the foregoing UI control is summoned through the interactive operation between the user and the companion object. For example, the user clicks/taps a head of the companion object to summon the UI control, or the user touches and holds the companion object to summon the UI control. Whether the UI control is always displayed in the virtual scene or summoned for display through the specified interactive operation is not specifically limited in this embodiment of this disclosure.

In some embodiments, the user triggers the combination instruction for the companion object through a voice instruction or a gesture instruction. For example, the user inputs the voice instruction “summoned creatures merge”, or the user makes a gesture instruction such as holding down the companion object and performing a sliding operation on the target part of the first virtual object, thereby triggering the foregoing combination instruction, and the terminal reports the combination instruction to the server and sets the companion object to the first state of the first virtual object.

In some embodiments, when the terminal sets the companion object to the first state, a merged animation of the companion object is played. The merged animation is preloaded locally after the terminal starts a battle, or pulled by the terminal immediately from the server in response to the combination instruction. When to pull the merged animation is not specifically limited in this embodiment of this disclosure. Exemplarily, the merged animation is shown as follows. After the companion object is broken into pieces and then attached to the target part of the first virtual object, or the companion object flies to and attaches to the target part of the first virtual object in a changed form (transformed from a form corresponding to the second state to a form corresponding to the first state). The content of the merged animation is not specifically limited in this embodiment of this disclosure.

In some embodiments, after the merged animation is played, the terminal displays the companion object on the target part of the first virtual object. The target part is a part associated with the first virtual object and provided for the companion object to attach in the first state. The target part includes but is not limited to: 1) a body part of the first virtual object, such as an arm, a shoulder, a waist, and a back of the first virtual object; 2) an equipment part of the first virtual object, such as a hand-held virtual prop (such as a virtual instrument) of the first virtual object, a backpack, armor equipment (such as an energy armor, an armor, and protective clothing), and special equipment dedicated to storing companion objects (such as a pet storage bag); and 3) a carrier of the first virtual object, such as a virtual vehicle or a virtual aircraft, the target part being not specifically limited in this embodiment of this disclosure, which means that the companion object is in the first state by default after being successfully summoned.

Step 1704: The server notifies, in response to the combination instruction, another terminal participating in a battle that the companion object of the first virtual object is in the first state.

In some embodiments, after the terminal reports the combination instruction to the server, the server needs to synchronize a message indicating that the companion object on the terminal is switched to the first state to other terminals participating in the battle. Therefore, the server transmits a combination instruction message to other terminals participating in the battle. The combination instruction message carries a target object identifier (ID) of the first virtual object and a subordinate object ID of the companion object. After receiving the combination instruction message, other terminals switch the companion object corresponding to the subordinate object ID to the first state of the first virtual object corresponding to the target object ID, and display the companion object corresponding to the subordinate object ID on the target part of the first virtual object corresponding to the target object ID.

In some embodiments, the server further records that the companion object is in the first state after receiving the combination instruction reported by the terminal. In the first state, since the companion object does not perform an activity as an independent individual in the virtual scene, the companion object may provide a specific confrontation assistance function for the first virtual object to which the companion object is attached.

Exemplarily, in a case that the companion object and the first virtual object are both in the first state, a health point loss caused by the first virtual object to any other virtual object has a first target probability of carrying a debuff corresponding to the companion object. The other virtual objects include but are not limited to: non-friendly virtual objects such as a neutral virtual object, a second virtual object belonging to a different team from the first virtual object, and a companion object of the second virtual object. In other words, in the first state, the companion object has a specific probability of adding a debuff to the damage caused by the first virtual object. The debuff corresponds to the companion object, and different types of companion objects may provide different debuffs. For example, debuffs include DOT damage with various effects. The DOT damage is periodic continuous damage, such as dealing a preset amount of damage every cycle, for example, dealing 5 points of damage every 3 seconds for a total of duration of 15 seconds. In an example, the debuff is provided as DOT damage having an electric shock effect or a paralysis effect. The electric shock effect is used as an example. If a virtual object controlled by a player is hit, the armor regeneration speed is reduced (that is, the recovery speed of energy armor is reduced). If an NPC object controlled by a non-player is hit, the NPC object is subject to increased health point loss or the defense capability of the NPC object is weakened. The paralysis effect is used as an example. A movement speed of the hit virtual object may be reduced. The debuff is not limited to the foregoing electric shock effect or paralysis effect, and not limited to the DOT damage. For example, the debuff may further be provided as a burning effect, a dizzy effect, and the like. The types of debuffs are not specifically limited in this embodiment of this disclosure.

In the foregoing cases, whenever the server receives confrontation operation information of the first virtual object reported by the terminal, it is determined based on the confrontation operation information whether a confrontation operation of the first virtual object hits any other virtual object. In a case that another virtual object is hit, the health point loss caused by the foregoing confrontation operation to the hit another virtual object has the first target probability of carrying the debuff corresponding to the companion object. In some embodiments, the terminal determines, based on the confrontation operation information, whether the confrontation operation of the first virtual object hits any other virtual object. In a case that another virtual object is hit and the server completes the legitimacy determination, the foregoing another virtual object has the first target probability of carrying the debuff corresponding to the companion object.

Exemplarily, in a case that the companion object and the first virtual object are both in the first state, the health point loss caused by the first virtual object to any other virtual object due to the shooting operation has the first target probability of carrying the debuff corresponding to the companion object. In other words, only the health point loss caused by a long-range shooting attack performed by the first virtual object has a specific probability of carrying the debuff.

In the foregoing cases, whenever the server receives shooting operation information of the first virtual object reported by the terminal, it is determined based on the shooting operation information whether a projectile fired by a shooting operation of the first virtual object hits any other virtual object. In a case that another virtual object is hit, the health point loss caused by the foregoing shooting operation to the hit another virtual object has the first target probability of carrying the debuff corresponding to the companion object. In some embodiments, the terminal determines, based on the shooting operation information, whether a projectile fired by the shooting operation of the first virtual object hits any other virtual object. In a case that another virtual object is hit and the server further completes the legitimacy determination, the foregoing another virtual object has the first target probability of carrying the debuff corresponding to the companion object.

That is to say, the foregoing step of determination performed by the server may also be performed by the terminal, and only the server needs to further complete the legitimacy check to avoid cheating behavior of the terminal, thereby reducing the calculation amount of the server when accessing a large quantity of clients.

Step 1705: The terminal plays, in response to a first split instruction for the companion object, a switching animation in which the companion object switches from the first state of the first virtual object to a second state.

In some embodiments, the user triggers the first split instruction by performing a triggering operation on the companion object in the first state. The foregoing triggering operation includes but is not limited to a click/tap operation, a double-clicking/tapping operation, a pressing operation, a drag operation in a specified direction, a voice instruction, a gesture instruction, and the like. The triggering operation is not specifically limited in this embodiment of this disclosure.

Exemplarily, the triggering operation being the drag operation in a specified direction is used as an example. If the user performs the drag operation on the companion object attached to the target part of the first virtual object in the specified direction, the first split instruction to control the companion object to fire from the target part to the specified direction is to be triggered. In this case, the companion object may land at the intersection of a ray extending in the specified direction with the target part as the endpoint and the ground, so as to flexibly control the landing direction of the companion object through the first split instruction.

In some embodiments, in a case that a UI control for the companion object is provided in the virtual scene, the user can trigger the first split instruction for the companion object by performing a triggering operation on the UI control. In an example, the foregoing UI control is constantly displayed in the virtual scene, or the UI control is summoned by the user by performing an interaction operation with the companion object. For example, the user clicks/taps a head of the companion object to summon the UI control, or the user touches and holds the companion object to summon the UI control. Whether the UI control is always displayed in the virtual scene or summoned for display through the specified interactive operation is not specifically limited in this embodiment of this disclosure.

In some embodiments, only one UI control is provided in the virtual scene. When the companion object is in the first state, the UI control is provided as a split control, and when the companion object is in the second state, the UI control is provided as a combination control, so as to switch the state of the companion object through the UI control. In this case, when the companion object is in the first state, the UI control is provided as a split control, and the user may respectively trigger the first split instruction and a second split instruction by performing different triggering operations on the split control.

Exemplarily, the user clicks/taps the split control to trigger the first split instruction, and double clicks/taps the split control to trigger the second split instruction. Alternatively, the user holds down the split control and performs a drag operation in a specified direction, and then determines a ray extending in the specified direction by using the target part as the endpoint. If the ray intersects with a collision detection range of any virtual object, the virtual object is determined as a third virtual object, and a second split instruction specifying the third virtual object to be followed is triggered. If the ray does not intersect with the collision detection range of any virtual object, the first split instruction without specifying the third virtual object is triggered. Alternatively, when the user holds down the split control and performs an upward drag operation, the first split instruction is triggered, and when the user holds down the split control and performs a downward drag operation, the second split instruction is triggered.

In some embodiments, both the combination control and the split control are provided in the virtual scene, which are collectively referred to as UI controls for the companion object. When the companion object is in the first state, the combination control is set to a disabled state, and when the companion object is in the second state, the split control is set to the disabled state. In this case, when the companion object is in the first state, the combination control is set to the disabled state, and the split control is set to the available state. In this case, the user may respectively trigger the first split instruction and the second split instruction by performing different triggering operations on the split control. The triggering operations on the first split instruction and the second split instruction are similar to those in the foregoing cases, and details are not described herein again.

In some embodiments, after the user triggers the first split instruction for the companion object, the terminal plays, in response to the first split instruction, the switching animation in which the companion object switches from the first state to the second state. The switching animation may be preloaded locally after the terminal starts a battle, or may be immediately pulled from the server by the terminal in response to the first split instruction. When to pull the switching animation is not specifically limited in this embodiment of this disclosure. Exemplarily, the switching animation is shown as follows. The companion object is transformed in form after being separated from the target part of the first virtual object, that is, transformed from the form corresponding to the first state to the form corresponding to the second state. The content of the switching animation is not specifically limited in this embodiment of this disclosure.

Step 1706: The terminal switches the companion object from the first state to the second state, and reports the first split instruction to the server.

In some embodiments, when the terminal switches the companion object from the first state to the second state, the companion object is separated from the target part of the first virtual object. Since the companion object is attached to the target part in the first state, the switching process from the first state to the second state can be displayed by separating the companion object from the target part.

In some embodiments, the terminal reports the first split instruction to the server. Since in the second state, the companion object can perform an activity in the virtual scene as an independent individual, but the activity of the companion object is still limited in the second state. That is, the companion object in the second state can still be controlled by the user, and in a case that the user does not control the activity of the companion object, the companion object is to perform an activity under the control of behavior logic, for example, perform an activity under the control of the preset rule or the AI behavior model. Therefore, the terminal needs to report the first split instruction to the server, so as to instruct the server to configure the behavior logic of the companion object and take over part of the control permission of the companion object.

Step 1707: The server returns, in response to the first split instruction, an invisibility instruction to each terminal participating in the battle in a case that a state in which the companion object has been equipped with the target functional chip is queried.

The invisibility instruction is triggered in a case that the companion object has the invisibility function attribute and receives the first split instruction. In this embodiment of this disclosure, the companion object being equipped with the target functional chip to obtain the invisibility function attribute is used as an example for description. Therefore, in this case, the invisibility instruction may be triggered in a case that the companion object is equipped with the target functional chip and receives the first split instruction.

The foregoing step 1707 is a possible implementation in which the server returns the invisibility instruction to each terminal participating in the game in response to the first split instruction in a case that it is queried that the companion object has the invisibility function attribute. In this embodiment of this disclosure, the companion object being equipped with the target functional chip to obtain the invisibility function attribute is used as an example for description. Therefore, in this case, by querying whether the companion object is equipped with the target functional chip, the server can determine whether the companion object has the invisibility function attribute, and then returns the invisibility instruction to each terminal participating in the game in the case of detecting a state in which the companion object has been equipped with the target functional chip, which represents that the companion object has the invisibility function attribute.

In some embodiments, after the server on the terminal reports the first split instruction, the server queries about the assembly state parameter of the companion object for the target functional chip based on the subordinate object ID of the companion object carried in the first split instruction. When the assembly state parameter indicates an assembled state, it represents that the companion object has been equipped with the target functional chip, and therefore the companion object has the invisibility function attribute and needs to make the companion object invisible in the second state. In this case, the server transmits the invisibility instruction for the companion object to each terminal participating in the battle.

In some other embodiments, assuming that the companion object can obtain the invisibility function attribute in a plurality of ways, the companion object may still have the invisibility function attribute even if not equipped with the target functional chip, and the server side may maintain the invisibility attribute parameter of the companion object. The invisibility attribute parameter is used for indicating whether the companion object has the invisibility function attribute. After the terminal reports the first split instruction to the server, the server queries the invisibility attribute parameter of the companion object based on the subordinate object ID of the companion object carried in the first split instruction. When the invisibility attribute parameter indicates that the companion object has the invisibility function attribute, it represents that the companion object in the second state needs to be made invisible. In this case, the server transmits the invisibility instruction for the companion object to each terminal participating in the battle.

In some embodiments, the invisibility instruction transmitted by the server to the terminals participating in the battle (including the terminal corresponding to the first virtual object and other terminals) carries at least the subordinate object ID of the companion object, and any terminal participating in the battle makes the companion object invisible corresponding to the subordinate object ID after receiving the invisibility instruction.

In some embodiments, the server further records that the companion object is in the second state after receiving the first split instruction reported by the terminal. In the second state, since the companion object performs an activity as an independent individual in the virtual scene, the companion object no longer provides a debuff for the health point loss caused by the first virtual object, but only provides a debuff for the health point loss caused by the companion object, thereby providing a specific confrontation assistance function for the first virtual object to which the companion object belongs as an independent individual.

Exemplarily, in a case that the companion object is in the second state, a health point loss caused by the companion object to any other virtual object has a second target probability of carrying a debuff corresponding to the companion object. The other virtual objects include but are not limited to: non-friendly virtual objects such as a neutral virtual object, a second virtual object belonging to a different team from the first virtual object, and a companion object of the second virtual object. In other words, the companion object in the second state has a specific probability of adding a debuff to the damage caused by the companion object itself. The debuff corresponds to the companion object, and different types of companion objects may provide different debuffs. For the description of the debuff, reference is made to the foregoing step 1704, and the details are not described herein again.

In the foregoing cases, whenever the server receives confrontation operation information of the companion object reported by the terminal, it is determined based on the confrontation operation information whether a confrontation operation of the companion object hits any other virtual object. In a case that another virtual object is hit, the health point loss caused by the foregoing confrontation operation to the hit another virtual object has the second target probability of carrying the debuff corresponding to the companion object.

Exemplarily, in a case that the companion object is in the second state, the health point loss caused by the companion object to any other virtual object due to the shooting operation has the second target probability of carrying the debuff corresponding to the companion object. In other words, only the health point loss caused by a long-range shooting attack performed by the companion object has a specific probability of carrying the debuff.

In the foregoing cases, whenever the server receives shooting operation information of the companion object reported by the terminal, it is determined based on the shooting operation information whether a projectile fired by a shooting operation of the companion object hits any other virtual object. In a case that another virtual object is hit, the health point loss caused by the foregoing shooting operation to the hit another virtual object has the second target probability of carrying the debuff corresponding to the companion object.

Step 1708: The terminal makes the companion object invisible in the second state in response to the invisibility instruction.

The terminal receives the invisibility instruction transmitted by the server, and makes the companion object invisible in the second state in response to the invisibility instruction. The invisibility of the companion object does not mean that the companion object is removed from the virtual scene, but the companion object is still in the virtual scene and is invisible to each terminal participating in the battle, that is, the terminal does not display the companion object indicated in the invisibility instruction.

In an example, an object model of the companion object is invisible to all terminals. In this case, in order to facilitate viewing of a location of the companion object thereof by the terminal corresponding to the first virtual object, the object model of the companion object may not be displayed, but the location of the companion object may be identified in the virtual scene or a map control. However, for each terminal participating in the battle except the terminal corresponding to the first virtual object, neither the object model of the companion object nor the location of the companion object can be seen.

In an example, the object model of the companion object is only visible to the terminal corresponding to the first virtual object with the master-slave relationship, but not to the other terminals participating in the battle. In this case, in order to make the user know that the companion object is invisible, the object model of the companion object may be displayed differently. For example, a specific transparency or edge flicker special effects are set for the companion object to prompt that the companion object is only visible to itself (only visible to the owner).

In an example, the object model of the companion object is only visible to the first virtual object and the terminal belonging to the same team as the first virtual object, but not to the other terminals participating in the battle. The display mode of the object model is similar to that in the previous case, and details are not described herein again.

In some embodiments, when the object model of the companion object is not displayed, the transparency of the object model of the companion object may be set to fully transparent, or the visibility of the object model of the companion object may be set to invisible (only visible to the owner, only visible to friends, or the like). In an example, shadow mapping performed on the companion object is further stopped to prevent another player from perceiving the invisible companion object by observing a shadow projected by the companion object under the light. The invisibility manner is not specifically limited in this embodiment of this disclosure.

In the foregoing steps 1707-1708, in a case that the companion object is equipped with the target functional chip and thus has the invisibility function attribute, after the companion object is switched to the second state, the terminal makes the companion object invisible in the second state, which is equivalent to providing a new interactive mode of invisibility of the companion object by assembling the target functional chip to obtain the invisibility function attribute, so that the companion object can assist the first virtual object in participating in the confrontation gameplay of the battle more effectively.

Step 1709: The terminal displays the companion object in the second state in response to the companion object satisfying an invisibility removal condition.

In some embodiments, since the companion object cannot always be invisible unconditionally, the invisibility removal condition is set for the companion object. When the companion object satisfies the invisibility removal condition, the companion object in the second state is to be displayed in the virtual scene.

In some embodiments, when the companion object in the second state is displayed, the transparency of the object model of the companion object is set to opaque, or the visibility of the object model of the companion object is set to visible to all. In an example, the shadow mapping of the companion object is restored, so as to achieve a better rendering effect on the companion object.

In some embodiments, the invisibility removal condition includes at least one of the following: a virtual health point of the companion object decreases; or the companion object initiates interaction with the first virtual object, the companion object and the first virtual object belonging to different teams; or an invisibility duration of the companion object reaches an invisibility threshold.

In some embodiments, the invisibility removal condition includes that an invisibility duration reaches an invisibility threshold. Then when the invisibility duration of the companion object reaches the invisibility threshold, the companion object is to be displayed in the virtual scene. The invisibility threshold is any value greater than 0. For example, the invisibility threshold is 10 seconds, 30 seconds, 1 minute, and the like. The invisibility threshold is not specifically limited in this embodiment of this disclosure.

In some embodiments, the invisibility removal condition includes that a virtual health point of the companion object is reduced. Then when the virtual health point of the companion object is reduced due to an external attack, the companion object is to be displayed in the virtual scene. Since the companion object is revealed when being attacked by the external attack, a manner of actively checking the invisible companion object can be provided.

In some embodiments, the invisibility removal condition includes that the companion object initiates an interaction with the first virtual object. The companion object is invisible to the first virtual object when being invisible. In other words, the first virtual object is a virtual object that has no permission to see the companion object when the companion object is invisible. In an example, when the companion object is only visible to the owner, then the companion object is only visible to the first virtual object, and all virtual objects except the first virtual object have no permission to see the invisible companion object. Therefore, all virtual objects except the first virtual object belong to the first virtual object. When the companion object is only visible to friends, then the companion object is only visible to the first virtual object and a friendly virtual object belonging to the same team as the first virtual object (also including the companion object of the friendly virtual object), and all of the virtual objects belonging to different teams from the first virtual object (including the neutral virtual object, the second virtual object belonging to a different team from the first virtual object, and the companion object of the second virtual object) have no permission to see the invisible companion object. Therefore, all of the virtual objects belonging to different teams from the first virtual object belong to the first virtual object, and whether the first virtual object includes a friendly virtual object is not specifically limited in this embodiment of this disclosure. Under the constraint of the foregoing invisibility removal condition, when the companion object actively attacks the first virtual object in the virtual scene, the companion object is to be displayed in the virtual scene, so as to facilitate identification of the orientation of the initiator of the interaction by the first virtual object, that is, the companion object, in time after the interaction.

In an exemplary scene, it is assumed that the invisible companion object does not actively attack the companion object of the second virtual object and the neutral virtual object. In this case, the invisible companion object only actively attacks the second virtual object. In a case that the invisibility removal condition is that the virtual health point of the companion object is reduced or the companion object initiates interaction with the first virtual object, then when the companion object is attacked by the second virtual object, the companion object of the second virtual object, or the neutral virtual object, resulting in the decrease in the health point of the companion object, the companion object is to be revealed in the virtual scene. Alternatively, when the companion object actively attacks the second virtual object, the companion object is also revealed in the virtual scene, which is equivalent to that under this setting, although the companion object of the second virtual object and the neutral virtual object have no permission to see the companion object of the currently invisible first virtual object, since the invisible companion object is set not to actively attack the companion object of the second virtual object and the neutral virtual object, it represents that the companion object only actively attacks the second virtual object, and the first virtual object and the second virtual object are the same in this case.

Any combination of the foregoing technical solutions can be used to obtain additional embodiments of the present disclosure, and the details are not described herein again.

According to the method provided in this embodiment of this disclosure, an interactive mode that supports the invisibility of the companion object after switching to the second state is provided, so that the companion object remains invisible in a case that the invisibility removal condition is not satisfied. Only in a case that the invisibility removal condition is satisfied, the companion object is revealed, so that the companion object can assist the first virtual object in confrontation and ambush more effectively, thereby enriching the interactive modes among different virtual objects and improving the efficiency of human-computer interaction.

In the foregoing embodiment, how the user controls the companion object to be merged, how to control the companion object to be separated from the ground for splitting, and a process in which the server controls the companion object to be invisible when detecting that the companion object has the invisibility function attribute and receives the first split instruction are described in detail. In this embodiment of this disclosure, a marked prop provided to the companion object in a case that the companion object has the invisibility function attribute (for example, equipped with the target functional chip) is to be described in detail, which can identify the location of the hit second virtual object and is to be described below.

In this embodiment of this disclosure, the user can control the companion object to fire a marked prop to the second virtual object, and the marked prop can be used in a case that the companion object has the invisibility function attribute. In addition, since the marked prop may be fired by the first virtual object controlled by the user in the first state of the first virtual object and the companion object, or the marked prop may be fired by the companion object controlled by the user in the second state of the companion object, or may be fired by the companion object based on behavior logic thereof. The companion object firing the marked prop in the case of satisfying a firing condition is used as an example for description in this embodiment of this disclosure.

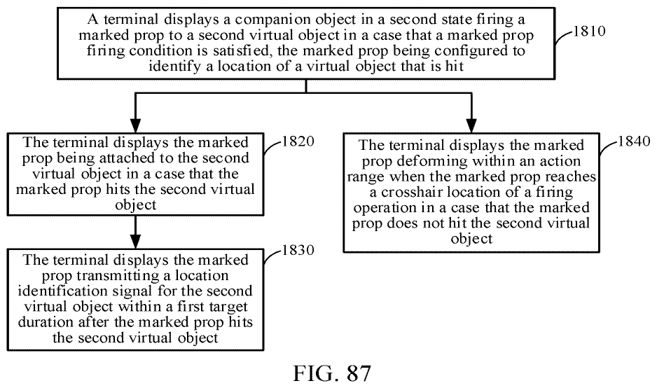

FIG. 87 is an interaction flowchart of a method for controlling a marked prop according to an embodiment of this disclosure. Referring to FIG. 87, the embodiment is performed through interaction between a terminal and a server. The terminal and the server are both examples of an electronic device. The embodiment includes the following steps.

Step 1810: A terminal displays a companion object in a second state firing a marked prop to a third virtual object in a case that a marked prop firing condition is satisfied, the marked prop being configured to identify a location of a virtual object that is hit.

The third virtual object belongs to different teams from the first virtual object. In other words, the third virtual object is a virtual object that belongs to different teams from the first virtual object and that is controlled by a player. A difference between the first virtual object involved in the invisibility removal condition described in the previous embodiment and the third virtual object to be attacked by the marked prop in this embodiment of this disclosure is that the first virtual object is a virtual object that has no permission to see the invisible companion object. Therefore, the first virtual object does not exclude the friendly virtual object, that is, it is possible that the friendly virtual object belongs to the first virtual object when the companion object is invisible to the friend. However, since the marked prop is a virtual prop with attack power, the third virtual object to be attacked by the marked prop is the virtual object controlled by the player that belongs to a different team from the first virtual object, that is, the third virtual object usually excludes the friendly virtual object.

In some embodiments, the firing condition is a condition that the companion object can fire the marked prop to any third virtual object. In an example, the firing condition includes at least one of the following: the third virtual object is located within an interaction range of the companion object; or an instruction to fire the marked prop transmitted by the first virtual object to the companion object is received; or the third virtual object performs an interactive behavior that causes the virtual health point of the companion object to decrease.

Exemplarily, in a case that the firing condition includes that the third virtual object is within the interaction range of the companion object, the companion object in the second state automatically triggers the firing of the marked prop to the third virtual object when detecting that the third virtual object has entered the interaction range of the companion object. The interaction range is an attack range of the companion object, for example, the attack range is a firing range of the marked prop. If the third virtual object is outside the interaction range, it indicates that the third virtual object is beyond the range of the marked prop, and interaction with the third virtual object cannot be performed through the marked prop.

In an example, when the behavior logic of the companion object is deployed on the server side, and the server detects that the third virtual object enters the interaction range of the companion object, the companion object is controlled to fire the marked prop to the third virtual object, and the marked prop is synchronized to each terminal participating in the battle. Alternatively, when the behavior logic of the companion object is deployed on the client, that is, a terminal side, the terminal controls the companion object to fire the marked prop to the third virtual object when detecting that the third virtual object enters the interaction range of the companion object, and reports the marked prop to the server, and the server synchronizes the marked prop to another terminal participating in the battle, which is not specifically limited in this embodiment of this disclosure.

Exemplarily, the user can control the companion object in the second state to fire the marked prop to the third virtual object in a case that the firing condition includes receiving the firing instruction of the marked prop transmitted by the first virtual object to the companion object. Since a quantity of marked props is usually limited, for example, only one marked prop is provided in a battle, the manner of manually controlling and firing marked prop can be convenient for the user to decide a firing time and a firing trajectory of the marked prop, and can increase the hit rate of marked prop and improve the operability of the user in the confrontation process.

In an example, the user controls the companion object to fire the third virtual object by triggering the firing instruction of the marked prop, and the trigger mode of the firing instruction includes: the user performs a triggering operation on a shooting control of the marked prop; or the user performs a target triggering operation on the companion object; or the user inputs a voice instruction or a gesture instruction to fire the marked prop; or the user performs a preset triggering operation on the third virtual object, and the trigger mode of the firing instruction is not specifically limited in this embodiment of this disclosure.

For example, the trigger mode is that the user performs a triggering operation on the shooting control of the marked prop. In this case, the shooting control of the marked prop is provided in the virtual scene, and the shooting control is displayed in the virtual scene only in a case that the companion object has the invisibility function attribute. When the firing instruction is triggered based on the firing control, a mode of shooting using a sight and a mode of shooting without using a sight are provided. The mode of shooting using a sight is a shooting mode for accurate aiming by using a sight, and the mode of shooting without using a sight is a mode of shooting of direct aiming in the virtual scene. The mode of shooting without using a sight is also referred to as a hip-fire mode.

Exemplarily, in the mode of shooting using a sight, the user clicks/taps the shooting control to enter the state of lifting the scope, can control to adjust the crosshair for the current firing through a joystick control, and then clicks/taps the shooting control again after adjusting the crosshair, so as to generate the firing instruction to fire the marked prop to the location indicated by the crosshair.

Exemplarily, in the mode of shooting without using a sight, the user holds down the shooting control to enter the aiming state, can control to adjust the crosshair for the current firing through a joystick control, and then releases the shooting control after adjusting the crosshair, so as to generate the firing instruction to fire the marked prop to the location indicated by the crosshair.

The foregoing shooting control may always be displayed in the virtual scene when the companion object has the invisibility function attribute and the quantity of marked props is greater than 0, or the foregoing shooting control can only be summoned after the user clicks/taps the marked props in a virtual prop bar, which is not specifically limited in this embodiment of this disclosure.

For example, the trigger mode is that the user performs the target triggering operation on the companion object, and in this case, the user can generate the firing instruction for the marked prop by performing the target triggering operation on the companion object displayed in the virtual scene. Exemplarily, the target triggering operation includes that the user presses and then releases the companion object. In this case, when a pressing duration for which the user presses the companion object exceeds a pressing threshold, the user enters the aiming state, and the user can adjust the crosshair for the current firing by using the companion object as the center of the joystick, and release the companion object after adjusting the crosshair, so as to generate the firing instruction to fire the marked prop to the location indicated by the crosshair. Exemplarily, the target triggering operation includes that the user holds down the companion object and slides to a target region, and enters the aiming state after sliding to the target region. The user can hold down the joystick control to adjust the crosshair for the current firing, and then release the joystick control after adjusting the crosshair, so as to generate the firing instruction to fire the marked prop to the location indicated by the crosshair.

For example, the trigger mode is that the user inputs a voice instruction to fire the marked prop. For example, the user inputs a voice instruction of “firing a marked prop” to enter the aiming state, and the user can click/tap any location in the virtual scene as the crosshair for the current firing, and trigger the firing instruction to fire the marked prop to the location indicated by the crosshair after releasing.

For example, the trigger mode is that the user inputs a gesture instruction to fire the marked prop. For example, the user holds down the companion object and the third virtual object with two fingers, and performs a sliding operation that the two fingers gradually approach. When the two fingers are close together, it represents that the gesture instruction is detected, and the user enters the aiming state. The user can click/tap any location in the virtual scene as the crosshair for the current firing, and trigger the firing instruction to fire the marked prop to the location indicated by the crosshair after releasing.

For example, the trigger mode is that the user performs a preset triggering operation on the third virtual object. For example, the user finds the marked prop from the virtual prop bar, and holds down the marked prop to perform a sliding operation of sliding toward the third virtual object, and when sliding to the third virtual object, automatically triggers the firing instruction to fire the marked prop to the location indicated by the crosshair by using the current model center of the third virtual object as the crosshair.

In some embodiments, after the firing instruction of the marked prop is triggered, the terminal locally controls the companion object in the second state to fire the marked prop to the third virtual object in response to the firing instruction. For example, a firing trajectory from the companion object to the location indicated by the crosshair is generated, then the marked prop moving along the firing trajectory is displayed in the virtual scene, then the terminal reports the firing instruction and the firing trajectory to the server, and the server synchronizes the firing trajectory of the marked prop to another terminal participating in the battle.

In some embodiments, after the firing instruction of the marked prop is triggered, the terminal reports the firing instruction to the server in response to the firing instruction. The firing instruction carries the location indicated by the crosshair and a location of the companion object. The server generates the firing trajectory and synchronizes the firing trajectory to each terminal participating in the battle. The terminal displays the marked prop moving along the firing trajectory in the virtual scene based on the firing trajectory returned by the server.

Since the third virtual object is in motion, and the crosshair aimed by the user may deviate from the third virtual object, the fired marked prop may not be able to hit the third virtual object. In a case that the marked prop hits the third virtual object, the following steps 1820 and 1830 are performed, and in a case that the marked prop does not hit the third virtual object, the following step 1840 is performed.

Step 1820: The terminal displays the marked prop being attached to the third virtual object in a case that the marked prop hits the third virtual object.

In some embodiments, if the marked prop hits the third virtual object, for example, only the marked prop hitting an object model of the third virtual object is deemed to hit the third virtual object, or the marked prop hitting a collision detection range of the third virtual object is deemed to hit the third virtual object, the server side may flexibly configure different hit detection logics, which is not specifically limited in this embodiment of this disclosure. Since the marked prop can identify the location of the third virtual object, which is convenient for the user to control the first virtual object to perform subsequent confrontation with the third virtual object, the marked prop may be attached to the third virtual object. For example, when hitting the object model is regarded as a hit, the marked prop is attached to a contact point with the third virtual object when the third virtual object is hit. For another example, when hitting the hit collision detection range is regarded as a hit, the marked props are uniformly attached to a specified part of the third virtual object, for example, uniformly attached to a shoulder, a leg, or an abdomen. The specified part is not specifically limited in this embodiment of this disclosure.

In some embodiments, before the marked prop being attached to the third virtual object is displayed, an attachment animation of the marked prop may further be played. The attachment animation may be preloaded locally by the terminal or immediately pulled from the server by the terminal in response to the firing instruction. The loading time of the attachment animation is not specifically limited in this embodiment of this disclosure.

Step 1830: The terminal displays the marked prop transmitting a location identification signal for the third virtual object within a first target duration after the marked prop hits the third virtual object.

The first target duration is any value greater than 0, for example, the first target duration is 10 seconds, 15 seconds, 20 seconds, and the like, which is not specifically limited in this embodiment of this disclosure.

In some embodiments, after the marked prop is attached to the third virtual object, the terminal may control the marked prop to continuously transmit the location identification signal within the first target duration after the marked prop hits the third virtual object. Since the marked prop moves based on the third virtual object, the location identification signal shown by the marked prop can remind the user of the current location of the third virtual object. In this way, even if the third virtual object walks into a bunker, the first virtual object can find the third virtual object in time through the location identification signal.

In some embodiments, the location identification signal has different representation forms. For example, the location identification signal is a light signal of a color that continuously flashes (such as red light, blue light, and green light that continuously flashes). For another example, the location identification signal is a marker pattern prominently displayed in a minimap control. In an example, the current location of the third virtual object is indicated by a red dot that continuously flashes in the minimap control. For another example, the location identification signal is a guide line (also referred to as a navigation line) that is triggered from the first virtual object to be directed at the third virtual object, so as to guide the first virtual object to pursue the third virtual object. The representation form of the location identification signal is not specifically limited in this embodiment of this disclosure.

In some embodiments, the marked prop not only can continuously transmit the location identification signal within the first target duration, but also can continuously make a noise within the first target duration. In this way, the action interference to the third virtual object can be increased, and the noise can further cover up some action sound effects made by the first virtual object during the pursuit, thereby providing better assistance for the first virtual object to participate in the confrontation.

Step 1840: The terminal displays the marked prop deforming within an action range when the marked prop reaches a crosshair location of a firing operation in a case that the marked prop does not hit the third virtual object.

In some embodiments, if the marked prop does not hit the third virtual object, the marked prop is triggered to deform within the action range of the marked prop when reaching the crosshair location of the firing operation (that is, an end point of the firing trajectory), and the action range herein is a range that can be affected by the deformation of the marked prop. The foregoing deformation operation may be that the terminal controls the marked prop to deform, and then displays a deformation animation of the marked prop, or may be that the server controls the marked prop to deform, and then synchronously displays the deformation animation of the marked prop to each terminal participating in the battle for display, which is not specifically limited in this embodiment of this disclosure. For example, the deformation animation represents the deformation process of the marked prop from an overall form to a fragment form after the marked prop moves to the crosshair location.

In some embodiments, the marked prop can cause a specific amount of health point loss to virtual objects within the action range after deforming at the crosshair location. For example, the foregoing health point loss is a constant value, and in this case, virtual health points of different virtual objects within the action range may be reduced by the constant value. For another example, the foregoing health point loss is negatively correlated with a distance between the virtual object and the crosshair location. That is to say, a smaller distance between the virtual object within the action range and the crosshair location leads to a higher health point loss, and a larger distance between the virtual object within the action range and the crosshair location leads to a lower health point loss. Whether the health point loss is a constant value is not specifically limited in this embodiment of this disclosure.

In some embodiments, in order to provide a richer interaction manner for the third virtual object, the marked prop can be destroyed. In this case, a prop damage degree of the marked props will gradually increase when they are injured. Therefore, the third virtual object may attack the marked prop, or control the companion object thereof to attack the marked prop, or summon a teammate thereof to control the corresponding virtual object to attack the marked prop, so as to increase the prop damage degree of the marked prop. When the prop damage degree is greater than a damage threshold, the marked prop may no longer identify the location of the hit virtual object. In other words, when the prop damage degree is greater than the damage threshold, the marked prop may no longer transmit the location identification signal. The damage threshold is any value greater than 0, for example, the loss threshold is 70%, 80%, or 100%, and the loss threshold is not specifically limited in this embodiment of this disclosure. That is, the marked prop being destroyed is displayed in response to the attack on the marked prop satisfying a condition.

In some embodiments, since the marked prop continuously transmits the location identification signal within the first target duration, the marked prop does not completely lose the ability to transmit the location identification signal in a case that the prop damage degree is less than or equal to the damage threshold, but the period of transmitting the location identification signal by the marked prop may be gradually extended with the increase of the prop damage degree (but not greater than the damage threshold). For example, when the prop damage degree is 0%, the marked prop transmits the location identification signal in real time every frame, when the prop damage degree is 20%, the marked prop transmits the location identification signal every 5 frames, and when the prop damage degree is 50%, the marked prop transmits the location identification signal every 10 frames, thereby reflecting the gradual damage process of the marked prop.

In some embodiments, the foregoing damage threshold is a threshold at which the marked prop loses the ability to identify the location. Therefore, when the prop damage degree is greater than the damage threshold, the marked prop no longer transmits the location identification signal, but in this case, the marked prop can still continue to make noise to interfere with actions and operations of the third virtual object, until the prop damage degree reaches 100%, all functions of the marked prop are completely ineffective, and in this case, the marked prop stops making noise.

Any combination of the foregoing technical solutions can be used to obtain additional embodiments of the present disclosure, and the details are not described herein again.

According to the method provided in this embodiment of this disclosure, the action of the third virtual object can be strongly interfered with by providing an interactive mode that supports the companion object to identify the location of the third virtual object by using the marked prop, which facilitates locating of the location of the third virtual object in time by the first virtual object, and a decision is made on the subsequent confrontation strategy for the third virtual object, so that the companion object can better assist the first virtual object in confrontation, which enriches the interactive modes among different virtual objects, and improves the efficiency of human-computer interaction.

In the foregoing embodiment, a marked prop provided to the companion object is described in detail. The marked prop can identify the location of the hit third virtual object. The firing of the marked prop is more concealed and strategic in a case that the companion object has the invisibility function attribute, so as to achieve an unexpected confrontation effect. In this embodiment of this disclosure, a detailed description is to be given to actions to be performed by the companion object through a first split instruction in the case of having no invisibility function attribute.

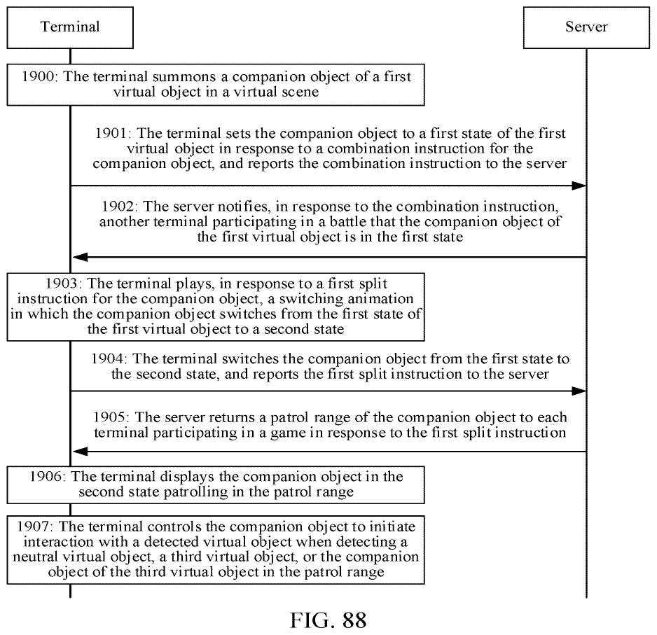

FIG. 88 is an interaction flowchart of a method for displaying a virtual object according to an embodiment of this disclosure. Referring to FIG. 88, the embodiment is performed through interaction between a terminal and a server. The terminal and the server are both examples of an electronic device. The embodiment includes the following steps.

Step 1900: A terminal summons a companion object of a first virtual object in a virtual scene.

The foregoing step 1900 is similar to the foregoing step 1700, and details are not described herein again.

Step 1901: The terminal sets the companion object to a first state of the first virtual object in response to a combination instruction for the companion object, and reports the combination instruction to the server.

The foregoing step 1901 is similar to the foregoing step 1703, and details are not described herein again.

Step 1902: The server notifies, in response to the combination instruction, another terminal participating in a battle that the companion object of the first virtual object is in the first state.

The foregoing step 1902 is similar to the foregoing step 1704, and details are not described herein again.

Step 1903: The terminal plays, in response to a first split instruction for the companion object, a switching animation in which the companion object switches from the first state of the first virtual object to a second state.

The foregoing step 1903 is similar to the foregoing step 1705, and details are not described herein again.

Step 1904: The terminal switches the companion object from the first state to the second state, and reports the first split instruction to the server.

The foregoing step 1904 is similar to the foregoing step 1706, and details are not described herein again.

Step 1905: The server returns a patrol range of the companion object to each terminal participating in a game in response to the first split instruction.

In some embodiments, after the terminal reports the first split instruction to the server, the server queries the invisibility attribute parameter of the companion object based on the subordinate object ID of the companion object carried in the first split instruction. When the invisibility attribute parameter indicates that the companion object does not have the invisibility function attribute, it is not necessary to make the companion object invisible in the second state. In this case, the companion object is to be set to patrol within a patrol range. Exemplarily, when the companion object obtains the invisibility function attribute by assembling a target functional chip, the foregoing invisibility attribute parameter may be provided as an assembly state parameter of the companion object for the target functional chip, and then the server may query the assembly state parameter in response to the first split instruction. When the assembly state parameter indicates that the companion object is in an unassembled state, it represents that the companion object does not have the invisibility function attribute, and it is not necessary to make the companion object invisible in the second state. In this case, the companion object is to be set to patrol within a patrol range.

In some embodiments, in a case that it is determined that the companion object does not have the invisibility function attribute, the server may determine the patrol range of the companion object and return the determined patrol range to each terminal participating in the battle.

In an example, the server determines a patrol range by using a landing point of the companion object on the ground as the center, for example, a circular patrol range with a radius of R (R>0) by using the landing point as the center, or a square patrol range with a side length of A (A>0) by using the landing point as the center, or a rectangular patrol range, and an irregular patrol range, and the shape of the patrol range is not specifically limited in this embodiment of this disclosure.

In an example, the server determines a patrol range by using the first virtual object as the center, for example, a circular patrol range with a radius of R (R>0) by using the first virtual object as the center, or a square patrol range with a side length of A (A>0) by using the first virtual object as the center, or a rectangular patrol range, and an irregular patrol range, and the shape of the patrol range is not specifically limited in this embodiment of this disclosure.

Step 1906: The terminal displays the companion object in the second state patrolling in the patrol range.

In some embodiments, after receiving the patrol range returned by the server in a case that the companion object does not have the invisibility function attribute, the terminal displays the companion object in the second state patrolling in the patrol range, and the patrolling means that the companion object walks randomly in the patrol range and attacks any other virtual object that enters the patrol range or the perception range of the companion object. In an example, other virtual objects include non-friendly virtual objects such as a neutral virtual object, a third virtual object belonging to a different team from the first virtual object, and a companion object of the third virtual object.

In some embodiments, for the terminal that controls the first virtual object, the terminal further displays the patrol range of the companion object while displaying the companion object in the virtual scene, so that the first virtual object can check the patrol range at any time to decide a confrontation strategy therefor.

In some embodiments, for another terminal that controls another virtual object, the another terminal displays only the companion object in the virtual scene. If the another virtual object controlled by the another terminal is equipped with some functional props for viewing of the patrol range, the patrol range of the companion object may be displayed through the functional prop, so that the another virtual object can plan an action route thereof.

Step 1907: The terminal controls the companion object to initiate interaction with a detected virtual object when detecting a neutral virtual object, a third virtual object, or the companion object of the third virtual object in the patrol range.

In some embodiments, when any non-friendly virtual object such as the neutral virtual object, the third virtual object belonging to a different team from the first virtual object, or the companion object of the third virtual object steps into the patrol range, the terminal controls the companion object to attack the detected virtual object, for example, controlling the companion object to fire some projectiles of shooting props to the detected virtual object, or controlling the companion object to perform a normal attack, a melee attack, and the like on the detected virtual object, which is not specifically limited in this embodiment of this disclosure.

In some other embodiments, assuming that the companion object is an intelligent AI object controlled by an AI behavior model, the AI behavior model is to configure a perception range for the companion object. The perception range represents a range of non-friendly virtual objects that the companion object can perceive. For example, the perception range is a fan-shaped region associated with an orientation of the companion object, or the perception range is a circular region centered on the companion object. The shape of the perception range is not specifically limited in this embodiment of this disclosure. Next, when any non-friendly virtual object such as the neutral virtual object, the third virtual object belonging to a different team from the first virtual object, or the companion object of the third virtual object is located in the perception range, the terminal controls the companion object to attack the detected virtual object, for example, controlling the companion object to fire some projectiles of shooting props to the detected virtual object, or controlling the companion object to perform a normal attack, a melee attack, and the like on the detected virtual object, which is not specifically limited in this embodiment of this disclosure.

The terminal controls the attack initiated by the companion object, and if the attacked virtual object is hit, the health point loss caused to the hit virtual object still has a second target probability of carrying a debuff corresponding to the companion object. For the description of the debuff, reference is made to the previous embodiment, and details are not described herein again.

Any combination of the foregoing technical solutions can be used to obtain additional embodiments of the present disclosure, and the details are not described herein again.

According to the method provided in this embodiment of this disclosure, by providing an interactive mode in which the companion object patrols in the patrol range and attacks the non-friendly virtual object that enters the patrol range, the companion object can better assist the first virtual object in confrontation with the non-friendly virtual object, which enriches the interactive modes among different virtual objects, and improves the efficiency of human-computer interaction.

In the foregoing embodiment, a detailed description is to be given to actions to be performed by the companion object through a first split instruction in the case of having no invisibility function attribute. In this embodiment of this disclosure, a detailed description is to be given to actions to be performed by the companion object through a second split instruction. A difference between the first split instruction and the second split instruction is that the first split instruction does not specify the third virtual object to be followed, and therefore the companion object is to be fired from a target part of the attached first virtual object to the ground. However, the second split instruction specifies the third virtual object to be followed, and therefore the companion object is fired toward the third virtual object and always follows the third virtual object until a second target duration is reached. A detailed description is to be given below.

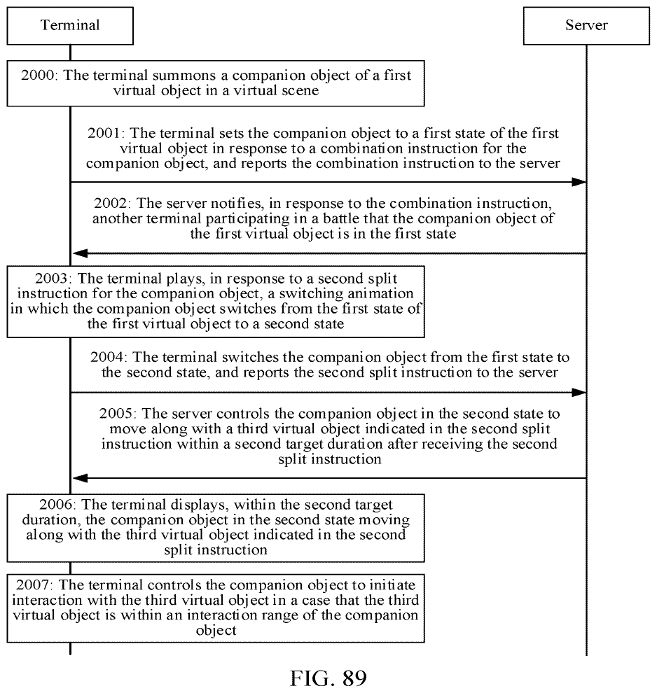

FIG. 89 is an interaction flowchart of a method for displaying a virtual object according to an embodiment of this disclosure. Referring to FIG. 89, the embodiment is performed through interaction between a terminal and a server. The terminal and the server are both examples of an electronic device. The embodiment includes the following steps.

Step 2000: A terminal summons a companion object of a first virtual object in a virtual scene.

The foregoing step 2000 is similar to the foregoing step 1700, and details are not described herein again.

Step 2001: The terminal sets the companion object to a first state of the first virtual object in response to a combination instruction for the companion object, and reports the combination instruction to a server.

The foregoing step 2001 is similar to the foregoing step 1703, and details are not described herein again.

Step 2002: The server notifies, in response to the combination instruction, another terminal participating in a battle that the companion object of the first virtual object is in the first state.

The foregoing step 2002 is similar to the foregoing step 1704, and details are not described herein again.

Step 2003: The terminal plays, in response to a second split instruction for the companion object, a switching animation in which the companion object switches from the first state of the first virtual object to a second state.

The foregoing step 2003 is similar to the foregoing step 1705, and details are not described herein again.

The first split instruction and the second split instruction may correspond to the same or different switching animations. For the representation form and the loading time of the switching animation, reference is made to the description of the previous embodiment, and the details are not described herein again.

Step 2004: The terminal switches the companion object from the first state to the second state, and reports the second split instruction to the server.

In some embodiments, when the terminal switches the companion object from the first state to the second state, the companion object is separated from the target part of the first virtual object. Since the companion object is attached to the target part in the first state, the switching process from the first state to the second state can be displayed by separating the companion object from the target part.

In some embodiments, the companion object is fired to the ground after being separated from the target part through the first split instruction. Therefore, the first split instruction is also referred to as a “ground instruction”. A third virtual object with no clear directivity performs patrolling in a specified patrol range and attacks the non-friendly virtual object that enters the perception range when having no invisibility function attribute, and is to be invisible in case of having the invisibility function attribute. In this case, it may be set that the neutral virtual object and other companion objects are not actively attacked during the invisibility, but only the third virtual object belonging to a different team from the first virtual object is actively attacked, and when an invisibility removal condition is satisfied, the third virtual object is removed from invisibility and revealed in the virtual scene.

In some embodiments, different from the first split instruction, the second split instruction has a third virtual object with clear directivity. That is, it is specified that the companion object is to move with the third virtual object after switching to the second state. Therefore, the second split instruction is also referred to as an “enemy instruction”. In this case, the companion object is to be fired toward the third virtual object after being separated from the target part. Since the third virtual object may be displaced or evaded, the companion object may fall on the ground near the third virtual object, follow the third virtual object, and continue to launch an attack.

After the state switching from the first state to the second state is realized in response to the second split instruction, the terminal reports the second split instruction to the server. In an example, the second split instruction carries at least a subordinate object ID of the companion object and an object ID of the third virtual object.

Step 2005: The server controls the companion object in the second state to move along with a third virtual object indicated in the second split instruction within a second target duration after receiving the second split instruction.

In some embodiments, an AI behavior model of the companion object is deployed on a server side. In this case, within the second target duration since receiving the second split instruction, the server determines a location of the companion object at the frame based on a location of the third virtual object at each frame within the second target duration, and ensures that the location of the third virtual object does not exceed the interaction range of the companion object. Then, the location of the companion object determined by the server frame by frame is returned to each terminal participating in the battle, which is equivalent to ensuring that the companion object can infinitely perceive and attack the third virtual object within the second target duration. The second target duration is any value greater than 0, for example, the second target duration is 5 seconds, 10 seconds, 15 seconds, and the like.

In some embodiments, in addition to returning the location of the companion object determined frame by frame, the server may further return the posture of the companion object determined frame by frame to each terminal participating in the battle because the AI behavior model is deployed on the server side. In this way, the terminal can be prevented from participating in the posture calculation process, so as to save the processing resources of the terminal and avoid freezing of the terminal as a result of insufficient processing resources.

In some other embodiments, the server prunes and compresses the trained AI behavior model and transmits the pruned and compressed AI behavior model to each terminal participating in the battle. Then the server only needs to synchronize the location of each frame when the companion object moves with the third virtual object, and the terminal locally calculates and generates the posture of the companion object at each frame, thereby saving the communication overhead between the server and the terminal.

Step 2006: The terminal displays, within the second target duration, the companion object in the second state moving along with the third virtual object indicated in the second split instruction.

In some embodiments, the terminal renders the companion object in the virtual scene based on the location and posture of the companion object within the second target duration, and renders the third virtual object in the virtual scene based on the location and posture of the third virtual object within the second target duration. Since the server side determines the location of the companion object frame by frame based on the location of the third virtual object, the distance between the companion object and the third virtual object is close. For example, no matter how the third virtual object moves within the second target duration, the third virtual object is always within the perception range of the companion object. For another example, no matter how the third virtual object moves within the second target duration, the third virtual object always keeps the same distance from the companion object. How to ensure the manner of the companion object moving along with the third virtual object is not specifically limited in this embodiment of this disclosure.

In some embodiments, the terminal renders the object model of the companion object in the virtual scene based on the location of the companion object returned by the server and the posture of the companion object predicted by the locally stored AI behavior model, thereby displaying the companion object in the virtual scene.

In some embodiments, the terminal renders the object model of the companion object in the virtual scene based on the location and the posture of the companion object returned by the server, thereby displaying the companion object in the virtual scene.

In some embodiments, the terminal controlling the third virtual object synchronizes control operation information of the third virtual object to the server, and the server determines the location and the posture of the third virtual object in each frame based on the control operation information, and synchronizes the location and the posture of the third virtual object in each frame to each terminal participating in the battle. The terminal renders the object model of the third virtual object in the virtual scene based on the location and the posture of the third virtual object synchronized by the server in each frame, thereby displaying the third virtual object in the virtual scene.

Step 2007: The terminal controls the companion object to initiate interaction with the third virtual object in a case that the third virtual object is within an interaction range of the companion object.

The interaction range involved in step 2007 has different meanings from the perception range involved in the previous step 2006. The perception range means that the companion object can perceive the third virtual object and can launch an attack on the third virtual object, and the interaction range means that the third virtual object falls into the attack range of the companion object. If the third virtual object is located within the perception range of the companion object and outside the attack range, the companion object can only perceive the third virtual object in this case, but cannot launch an attack on the third virtual object, and may move to be closer so that the companion object can launch an attack on the third virtual object when the third virtual object enters the attack range of the companion object. Therefore, the perception range is equivalent to a range in which the companion object can perceive the third virtual object, and the interaction range is equivalent to an attack range such as an effective range of a normal attack of the companion object, a range of long-range shooting, and a range of a throwing prop.

In some embodiments, the foregoing interaction range includes but is not limited to: a circular range, a rectangular range, a square range, an irregular range, and the like, and the interaction range may have different maximum interaction heights based on different interaction types, which is not specifically limited in this embodiment of this disclosure.

In some embodiments, when the third virtual object is within the interaction range of the companion object, the companion object is controlled by the AI behavior model or a preset rule, and automatically launches an attack on the third virtual object. The foregoing AI behavior model and the preset rule may be deployed on the server side or the terminal side. If the AI behavior model and the preset rule are deployed on the server side, the server controls the companion object to launch an attack and synchronize the attack to each terminal participating in the battle. If the AI behavior model and the preset rule are deployed on the terminal side, the terminal controls the companion object to launch an attack and synchronize the attack to the server, and then the server synchronizes the attack to another terminal participating in the game.

In some embodiments, when initiating interaction with the third virtual object, the companion object may fire some projectiles of shooting props to the third virtual object, or perform a normal attack, a melee attack, and the like on the third virtual object, which is not specifically limited in this embodiment of this disclosure.

If the attack initiated by the companion object hits the attacked third virtual object or hits another virtual object instead, the health point loss caused to the hit virtual object still has a second target probability of carrying a debuff corresponding to the companion object. For the description of the debuff, reference is made to the previous embodiment, and details are not described herein again.

In some embodiments, after the second target duration, the companion object no longer perceives the third virtual object unconditionally and infinitely. In this case, the companion object will return to its original behavior logic, and it is decided whether the third virtual object can be perceived by the companion object at this time through the behavior logic. For example, when the third virtual object is within the perception range of the companion object, the third virtual object can still be searched and perceived by the normal behavior logic, and then the third virtual object continues to follow the third virtual object and launch an attack. When the third virtual object moves out of the perception range of the companion object, the companion object no longer perceives the third virtual object, that is, losing the following target. In this case, the companion object may wander randomly and move freely where the following target is lost.

Any combination of the foregoing technical solutions can be used to obtain additional embodiments of the present disclosure, and the details are not described herein again.

According to the method provided in this embodiment of this disclosure, an interactive mode that the companion object moves along with the specified third virtual object and automatically launches an attack on the third virtual object is provided, so as to better assist the first virtual object in solving the attack pressure brought by the third virtual object and facilitate making of a better interactive strategy by the first virtual object, so that the companion object can better assist the first virtual object in confrontation with the non-friendly virtual object, which enriches the interactive modes among different virtual objects, and improves the efficiency of human-computer interaction.

In the foregoing embodiments, a detailed description is given to that the user uses different instructions to activate the companion object to perform different behaviors, which is equivalent to providing a plurality of alternative behavior modes for the companion object, and different behavior modes can bring different confrontation assistance to the first virtual object, help the user decide an action and a strategy of the first virtual object, and bring a huge confrontation advantage in the battle.

In this embodiment of this disclosure, the detailed human-computer interaction process is described by using a TPS game scene as an example. Exemplarily, the companion object is referred to as a summoned creature in the TPS game, and the debuff corresponding to the companion object is set to be a DOT damage having an electric shock effect, which is to be described below.

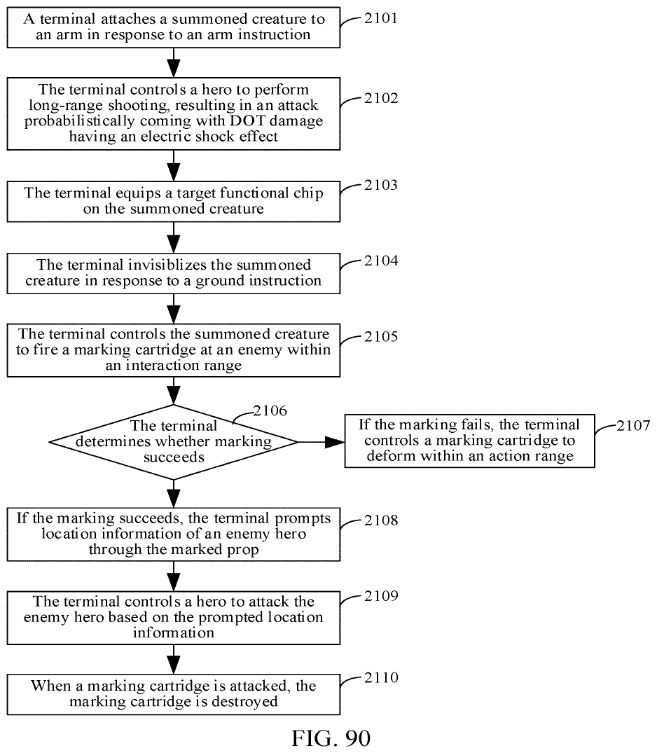

FIG. 90 is an interactive flowchart of a method for displaying a virtual object according to an embodiment of this disclosure. As shown in FIG. 90, the embodiment is performed by an electronic device. The electronic device is a terminal by way of example for description. The embodiment includes the following steps.

Step 2101: A terminal attaches a summoned creature to an arm in response to an arm instruction.

The arm instruction is an exemplary description of a combination instruction, the summoned creature is an exemplary description of the companion object, and the arm is an exemplary description of the companion object attached to a target part of a first virtual object. Therefore, the foregoing step 2101 is equivalent to the terminal attaching the companion object to the target part of the first virtual object in response to the combination instruction.

In some embodiments, a user triggers a summoning instruction for the summoned creature on the terminal, and one or more currently summonable summoned creatures are provided in a virtual scene. Then, the terminal performs a selection operation on any summonable summoned creature, thereby summoning the currently selected summoned creature into the virtual scene. Then, the user triggers the arm instruction for summoning, thereby switching the summoned creature to a first state of a hero, that is, attaching the summoned creature to an arm of the hero. In an example, a combination animation of the summoned creature attached to the arm of the hero after being turned into fragments is further played. Then, the terminal reports the arm instruction to the server. After receiving the arm instruction, the server adjusts an attack parameter of the hero controlled by the user, so that the long-range shooting damage caused by the hero controlled by the user has a specific probability of DOT damage having an electric shock effect. The adjusted attack parameter may be kept only on the server side, or may be transmitted to the terminal for updating.

Step 2102: The terminal controls a hero to perform long-range shooting to form an attack that causes DOT damage probably having an electric shock effect.

The hero controlled by the terminal is an exemplary description of the first virtual object, and the DOT damage having the electric shock effect is an exemplary description of a debuff corresponding to the companion object. Therefore, the foregoing step 2102 is equivalent to that in the first state, the user controls the first virtual object to perform long-range shooting through the terminal, and the health point loss caused by the long-range shooting of the first virtual object has a first target probability of coming with the debuff corresponding to the companion object.

In some embodiments, in the first state, the user can control the first virtual object to perform long-range shooting through the terminal. After obtaining the shooting instruction of the user to the first virtual object, the terminal reports the shooting instruction to the server, and the server calculates long-range shooting damage caused by the current shooting to an enemy hero based on the adjusted attack parameter, so that the long-range shooting damage has a specific probability of the DOT damage having the electric shock effect.

Step 2103: The terminal equips a target functional chip on the summoned creature.

In other words, the user triggers an assembly instruction for the target functional chip through the terminal, thereby controlling the companion object to assemble the target functional chip.

Step 2104: The terminal makes the summoned creature invisible in response to a ground instruction.

The ground instruction is an exemplary explanation of the first split instruction. Therefore, the foregoing step 2104 is equivalent to that the user triggers the first split instruction after assembling the target functional chip, and the companion object is fired from the target part to the ground and invisible after landing.

In this embodiment of this disclosure, the summoned creature (that is, the companion object) being equipped with the target functional chip to obtain the invisibility function attribute is still used as an example for description. In some other embodiments, the companion object can further obtain the invisibility function attribute by assembling invisible equipment, or obtain the invisibility function attribute under a specific condition (such as improving the character level) based on inherent talent, or the companion object can have the invisibility function attribute during releasing or lasting of a target virtual skill by releasing the first virtual object (such as the invisibility skill). The foregoing cases are only exemplary descriptions of the manner of obtaining the invisibility function attribute, but do not constitute a limitation on the manner of obtaining the invisibility function attribute.

In some embodiments, after the user triggers the ground instruction, the terminal displays a switching animation of the summoned creature switching from an arm form (that is, the first state) to a summoned creature form (that is, the second state), and reports the ground instruction to the server. After receiving the ground instruction, the server readjusts an attack parameter of the hero controlled by the user, so that the long-range shooting damage caused by the hero controlled by the user no longer has the possibility of DOT damage having an electric shock effect. The adjusted attack parameter may be kept only on the server side, or may be transmitted to the terminal for updating.

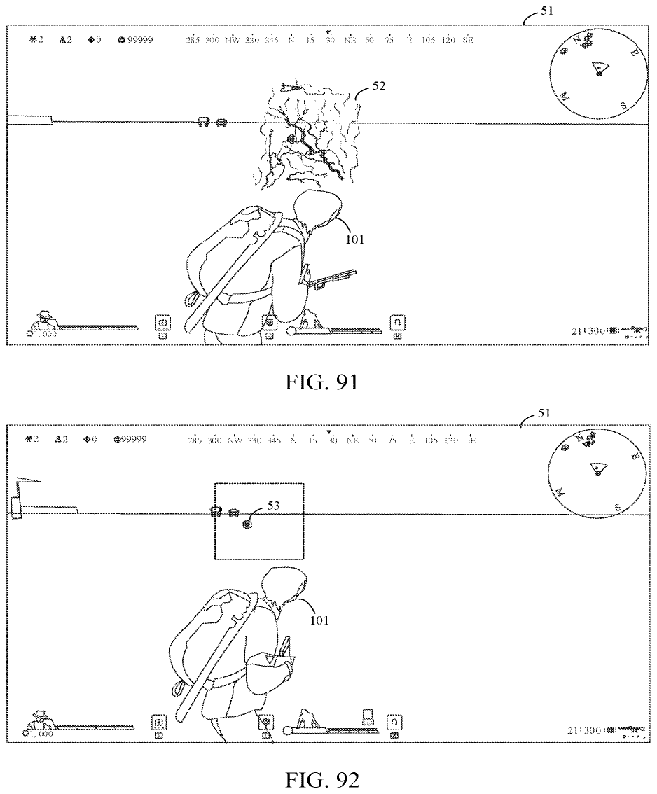

FIG. 91 is a schematic diagram of an interface of a switching animation according to an embodiment of this disclosure. As shown in FIG. 91, in a virtual scene 51, a hero 101 (that is, a first virtual object) controlled by a user is displayed. After the user controls the hero 101 summons a summoned creature (that is, the companion object of the first virtual object) to the virtual scene 51, the ground instruction is triggered. In this case, a switching animation 52 of switching the summoned creature from the first state to the second state is to be played to prompt the user to choose the summoned creature no longer attached to an arm of the hero, but fired to the ground through the ground instruction.

Further, since the target functional chip is assembled to obtain an invisibility function attribute, the summoned creature is invisible immediately upon landing after switching to a summoned creature form, and the summoned creature no longer actively attacks a neutral virtual object (that is, a wild monster) and the companion object of a non-friendly virtual object (that is, a summoned creature of an enemy hero) during the invisibility, but the summoned creature still actively attacks the non-friendly virtual object, that is, the enemy hero.

FIG. 92 is a schematic diagram of an interface of invisibility of a summoned creature according to an embodiment of this disclosure. As shown in FIG. 92, in a virtual scene 51, a hero 101 (that is, a first virtual object) controlled by a user is displayed. In a case that a target functional chip is assembled to obtain an invisibility function attribute, the summoned creature is invisible when a ground instruction is detected. It may be seen that an object model of the summoned creature is no longer displayed in the virtual scene from the perspective of an owner of the summoned creature. In FIG. 92, a space occupied by the invisible summoned creature is represented by a dashed box, and the object model of the summoned creature is invisible at this point. In addition, FIG. 92 further shows a location mark 53 of the summoned creature. The location mark 53 may be only visible to the owner (that is, the first virtual object), or the location mark 53 may only be visible to a friendly side (that is, the first virtual object and the friendly virtual object belonging to the same team as the first virtual object), so that the owner or the friendly side can learn the current location of the summoned creature to lay out the subsequent confrontation strategy.

In some embodiments, although in the second state, the long-range shooting attack of the hero no longer does not have the DOT damage having the electric shock effect, the summoned creature in the second state can still be controlled by the user to launch an attack, and the long-range shooting attack launched by the summoned creature in the second state still has a specific probability of the DOT damage having the electric shock effect.

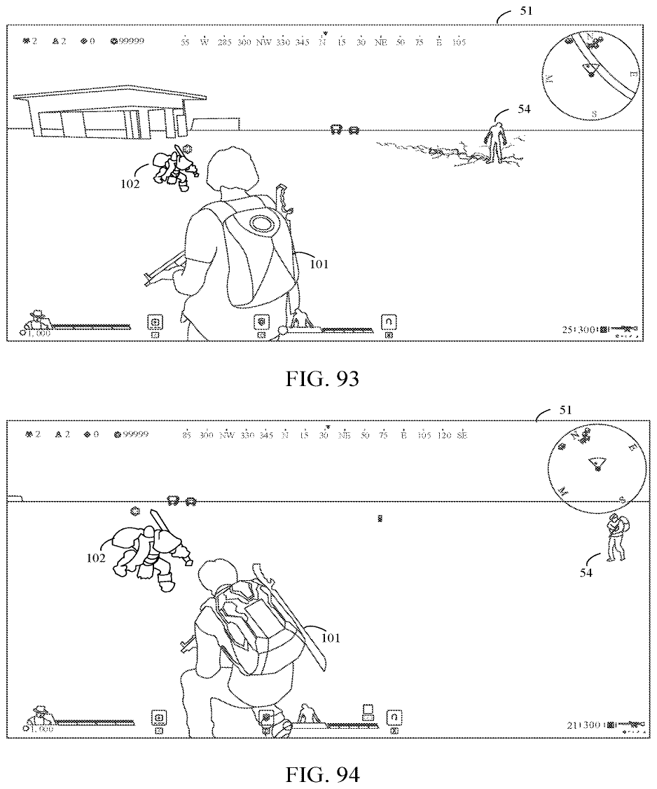

FIG. 93 is a schematic diagram of an effect of DOT damage having an electric shock effect according to an embodiment of this disclosure. As shown in FIG. 93, in a virtual scene 51, a hero 101 (that is, a first virtual object) controlled by a user, a summoned creature 102 of the hero (that is, a companion object of the first virtual object), and an enemy hero 54 (that is, a second virtual object belonging to a different team from the first virtual object) are displayed. It may be seen that in this case, the summoned creature 102 is in the second state of being separated from the hero 101, and the enemy hero 54 enters a perception range and an interaction range of the summoned creature 102, and triggers the summoned creature 102 to actively launch a long-range shooting attack on the enemy hero 54. In the case of DOT damage having the electric shock effect in the current long-range shooting, a current light effect that appears with an action trajectory of the enemy hero 54 is to be displayed in the virtual scene 51. The current light effect represents that the enemy hero 54 is currently being dealt DOT damage having the electric shock effect.

Step 2105: A terminal controls a summoned creature to fire a marking cartridge at an enemy within an interaction range.

The marking cartridge is an exemplary description of a marked prop. Therefore, the foregoing step 2105 is equivalent to that after a user is equipped with a target functional chip to obtain an invisibility function attribute, a firing instruction of the marked prop is triggered, so as to control the companion object to fire the marked prop to the enemy (such as a second virtual object) within the interaction range of the companion object.

FIG. 94 is a schematic diagram of an interface for controlling firing of a marking cartridge according to an embodiment of this disclosure. As shown in FIG. 94, in a virtual scene 51, a hero 101 (that is, a first virtual object) controlled by a user, a summoned creature 102 of the hero (that is, a companion object of the first virtual object), and an enemy hero 54 (that is, a second virtual object belonging to a different team from the first virtual object) are displayed. It may be seen that in this case, the summoned creature 102 is in a second state of being separated from the hero 101, and the enemy hero 54 enters a field of view of a third-person perspective of the user and is within an interaction range of the summoned creature 102 at this point, so that the user can control the summoned creature 102 to fire a marking cartridge at the enemy hero 54.

Step 2106: A terminal determines whether marking succeeds, if the marking fails, step 2107 is performed, and if the marking succeeds, step 2108 is performed.

In other words, the terminal determines whether a marked prop hits any virtual object. If any virtual object is not hit, it represents that the marking fails, and step 2107 is performed. If any virtual object is hit, it represents that the marking succeeds, and step 2108 is performed.

Step 2107: If the marking fails, the terminal controls a marking cartridge to deform within an action range.

In other words, in the case of marking failure, the terminal controls the marked prop to deform at an end point of a firing trajectory, that is, a crosshair location of a firing operation, and the deformation may lead to a decrease in virtual health points of all virtual objects within the action range, which is equivalent to realizing self-destruction logic of the marked prop.

Step 2108: If the marking succeeds, the terminal prompts location information of an enemy hero through the marked prop.

In other words, in a case that the marking succeeds, the terminal controls the marked prop to be attached to the enemy hero (that is, the hit virtual object) and continuously transmits a location identification signal, for example, continuously making noise with red light flashing.

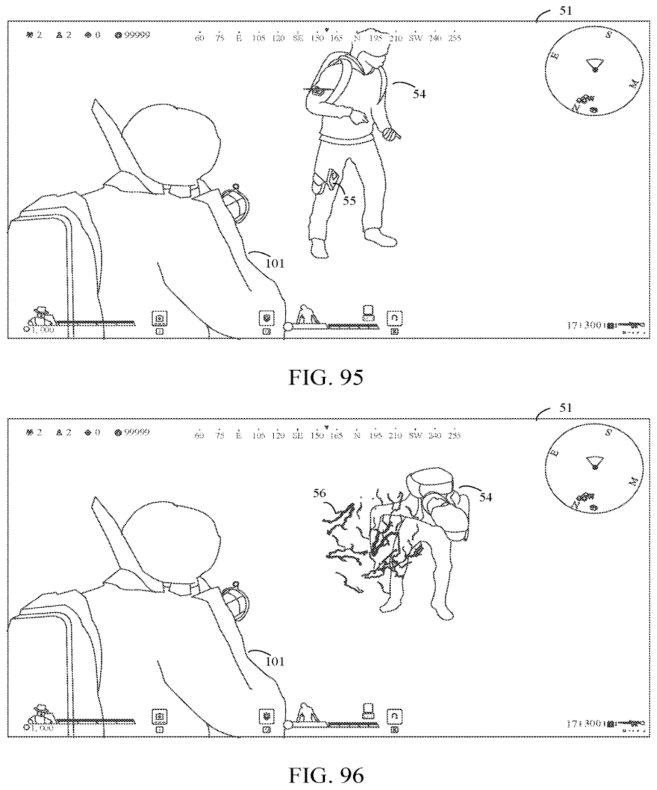

FIG. 95 is a schematic diagram of an interface of successful marking of a marking cartridge according to an embodiment of this disclosure. As shown in FIG. 95, in a virtual scene 51, a hero 101 (that is, a first virtual object) and an enemy hero 54 (that is, a second virtual object belonging to a different team from the first virtual object) controlled by a user are displayed. At this point, a summoned creature of the hero 101 is currently outside a field of view due to a zoom-in viewing angle, and therefore is not displayed in the virtual scene 51. After the user controls the summoned creature of the hero 101 to fire the marking cartridge 55 to the enemy hero 54, the marking cartridge 55 hits a leg of the enemy hero 54, and therefore the marking cartridge 55 is displayed on the leg of the enemy hero 54. The marking cartridge 55 is to continuously transmit a location identification signal of the enemy hero 55 within a first target duration after hitting the enemy hero 54.

Step 2109: The terminal controls a hero to attack the enemy hero based on the prompted location information.

In other words, since the location identification signal transmitted by the marked prop can feed back the location of the enemy hero, the user can control the user-controlled first virtual object through the terminal to launch an attack on the enemy hero.

Step 2110: When a marking cartridge is attacked, the marking cartridge is destroyed.

In other words, no matter whether an enemy hero or a hero has a specific probability of causing damage to the marked prop during the confrontation attack, when damage is caused to the marked prop, causing a prop damage degree of the marked prop to be greater than a loss threshold, the marked prop may lose the ability to report a location, that is, the marked prop is destroyed.

FIG. 96 is a schematic diagram of an interface of a marking cartridge according to an embodiment of this disclosure that is destroyed. As shown in FIG. 96, in a virtual scene 51, a hero 101 (that is, a first virtual object) and an enemy hero 54 (that is, a second virtual object belonging to a different team from the first virtual object) controlled by a user are displayed. At this point, a summoned creature of the hero 101 is currently outside a field of view due to a zoom-in viewing angle, and therefore is not displayed in the virtual scene 51. After the user controls a summoned creature of the hero 101 to fire a marking cartridge at the enemy hero 54, the marking cartridge hits the enemy hero 54. However, during the confrontation between the hero 101 and the enemy hero 54, the marking cartridge is attacked, causing the marking cartridges to be completely destroyed (that is, the prop damage degree reaches 100%). In this case, a destruction animation 56 of the marking cartridge is played in the virtual scene 51 to remind the opposing parties that the marking cartridge has become ineffective.

Any combination of the foregoing technical solutions can be used to obtain additional embodiments of the present disclosure, and the details are not described herein again.

In this embodiment of this disclosure, an interactive mode of a plurality of behavior modes based on a summoned creature is provided, so that the user has a more abundant interactive mode when confronting the enemy and has a more abundant decision-making time and decision-making mode in the battle. In addition, the user can further attack or avoid the enemy attack based on the prompt information of the marking cartridge, and when the user attacks the enemy, the marking cartridge may be affected and destroyed. Therefore, operational precision requirements of the user during confrontation are improved, and the user needs to decide the attack time in real time based on the battle situation, which improves the efficiency of human-computer interaction and optimizes game experience of the user.

### Stage IV: Control a Companion Object to Perform Another Task.

A player may further control the companion object in a second state to perform another task. The another task may be releasing a skill, releasing a prop, carrying materials, and the like. Stage IV is described below by using an example in which the companion object is controlled to carry sticky landmines and attack another second virtual object or third virtual object.

FIG. 97 is a schematic flowchart of a method for processing a special effects prop according to an exemplary embodiment of this disclosure. Steps are to be described below with reference to FIG. 97.

Step 2201: Display a virtual scene during a battle.

Before the battle starts, a terminal may determine a prop to be used by a player in the current battle through a prop selection operation triggered by the player. In response to an operation of starting the battle, the current battle is started.

After the battle is started, the displayed virtual scene may be a virtual scene displayed from a first-person perspective, or may be a virtual scene displayed from a third-person perspective, and may further be a virtual scene displayed from a bird's-eye view. The foregoing perspectives may be switched randomly.

The virtual scene includes a first virtual object, a companion object, and a third virtual object, and a subordinate relationship exists between the first virtual object and the companion object. The first virtual object belongs to a first game camp, and the third virtual object belongs to a second game camp. The first game camp and the second game camp are different game camps that confront each other in the battle.

The companion object may be a core-controlled virtual object. That is, the user may convert a machine-controlled second virtual object into a user-controlled virtual object through a skill chip (or referred to as a core chip). For example, a machine-controlled wild monster may be converted into a user-controlled nano companion through the skill chip.

The virtual scene displayed from the first-person perspective is used as an example. The displaying of the virtual scene may include: determining a field of view region of the virtual object based on a viewing location and a field of view of the virtual object in a complete virtual scene, and presenting a part of the virtual scene in the field of view region in the complete virtual scene, that is, the displayed virtual scene may be a part of the virtual scene relative to a panoramic virtual scene. Since the first-person perspective is a viewing perspective that can give the user the maximum impact, immersive perception of the user during operation can be realized.

The companion object is a subordinate virtual object of the first virtual object, and the first virtual object is a virtual object that throws a special effects prop. The companion object can be controlled by a terminal user corresponding to the first virtual object, and the companion object may be obtained by a player controlling the machine-controlled second virtual object in a game through the skill chip. If the first virtual object defeats the machine-controlled second virtual object during the battle, the control right of the second virtual object may be obtained through the skill chip, and companion objects having different functions may be obtained through different skill chips.

Step 2202: Control a first virtual object to throw a special effects prop to adsorb the special effects prop onto a companion object.

In some embodiments, prompt information is displayed on the companion object in response to a first operation of preparing to throw the special effects prop. The prompt information need not be provided in other examples.

The first operation of preparing to throw the special effects prop may be an operation of clicking/tapping a release control of the special effects prop. After the first operation is received, the special effects prop enters a throwing preparation stage. In response to the first operation, a picture of the first virtual object holding the special effects prop may be presented in the virtual scene, the companion object belonging to the first virtual object is determined, and prompt information is displayed on the companion object. The prompt information is used for indicating information about a location where the special effects prop is thrown.

In response to a second operation of throwing the special effects prop, the first virtual object is controlled to throw the special effects prop to adsorb the special effects prop onto the companion object.

In this embodiment of this disclosure, when it is detected that the operation of clicking/tapping the release control of the special effects prop disappears, it is determined that the second operation of throwing the special effects prop is received. At this point, in response to the second operation, the first virtual object may be controlled to throw the special effects prop and throw the special effects prop to a location of the companion object, so that the special effects prop is adsorbed on the companion object.

In some embodiments, after the special effects prop is adsorbed on the companion object, the special effects prop adsorbed on the companion object may be displayed in a preset first prominent display manner, and the companion object is displayed in a preset second prominent display manner. During implementation, the first prominent display manner may be displaying the special effects prop adsorbed on the companion object in a color that is in sharp contrast with the companion object. For example, when a main color of the companion object is red, the special effects prop may be displayed in green or yellow, and when the main color of the companion object is gray, the special effects prop may be displayed in red, green, yellow, or the like. The second prominent display manner may be displaying a part of the companion object in a color that is in sharp contrast with the companion object, for example, displaying a belt of the companion object in an eye-catching color.

Step 2203: Control the special effects prop to release special effects to cause damage to a third virtual object.

In some embodiments, in response to a first switching operation being received, the special effects prop is controlled to release the special effects to cause damage to the third virtual object, the first switching operation being used for switching the companion object from a second state to a first state.

In some embodiments, the special effects prop is controlled to release the special effects after a first preset duration to cause damage to the third virtual object in response to the third virtual object existing within a preset range of the companion object or the special effects prop.

In some embodiments, the third virtual object being in a deceleration effect is displayed in response to the third virtual object existing within a special effects range of the special effects prop.

As an example, after the special effects prop is adsorbed on the companion object, the companion object may be controlled to move by transmitting a movement instruction to the companion object. The movement instruction may be a patrol instruction, an enemy patrol instruction, or the like. When it is determined that a third virtual object displayed in the virtual scene or a third virtual object in an invisible state exists within a preset range of a location of the companion object or the special effects prop, the special effects prop is controlled to be released after the first preset duration.

The first preset duration may be 0 or a real number greater than 0. When the first preset duration is 0, it indicates that the special effects are to be released immediately when it is determined that the third virtual object belonging to a hostile camp exists within the preset range of the companion object or the special effects prop. When the preset duration is a real number greater than 0, it indicates that the special effects are to be released after waiting for a specific duration.

By using the method for processing the special effects prop provided in this embodiment of this disclosure, when the special effects prop needs to be thrown during the battle, prompt information is displayed on the companion object in response to the first operation of preparing to throw the special effects prop, and the prompt information is used for indicating the information about the location where the special effects prop is thrown. The companion object is a subordinate virtual object of the first virtual object, and the first virtual object is a virtual object that throws a special effects prop. When the second operation of throwing the special effects prop is received, in response to the second operation, the first virtual object is controlled to throw the special effects prop to adsorb the special effects prop onto the companion object. During patrolling of the enemy, the companion object releases special effects when sensing the third virtual object existing within the preset range, thereby causing ranged damage to the third virtual object. The third virtual object and the first virtual object belong to different game camps. In this way, in this embodiment of this disclosure, the special effects prop is adsorbed on the allied companion object. Therefore, after the special effects prop is thrown, the companion object may be used to control the release time of the special effects prop, thereby improving the controllability of the special effects prop and richness of gameplay.

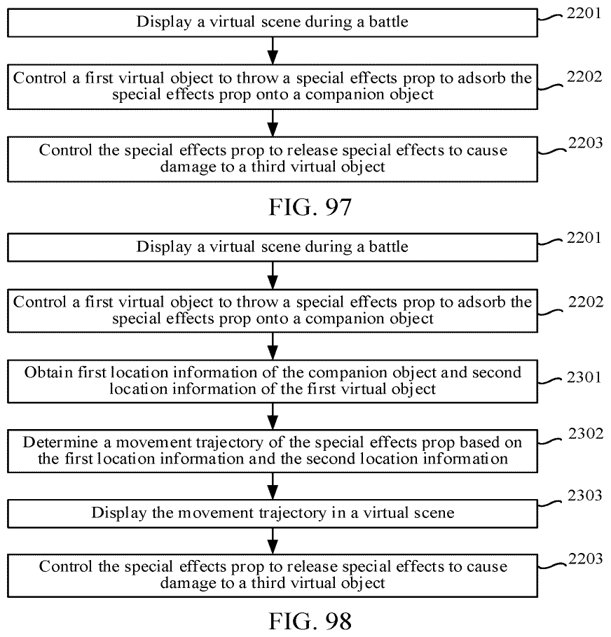

In some embodiments, a movement trajectory of the special effects prop may further be displayed through step 2301 to step 2303 shown in FIG. 98, and the steps are to be described below with reference to FIG. 98.

Step 2301: Obtain first location information of the companion object and second location information of the first virtual object.

The first location information of the companion object may be coordinate information of the companion object in the virtual scene, and similarly, the second location information of the first virtual object is coordinate information of the first virtual object in the virtual scene.

Step 2302: Determine a movement trajectory of the special effects prop based on the first location information and the second location information.

A preset initial speed of throwing the special effects prop and a preset weight of the special effects prop are obtained. The movement trajectory of the special effects prop is determined based on the first location information, the second location information, the initial speed, and the preset weight.

Step 2303: Display the movement trajectory in a virtual scene.

The movement trajectory is displayed by using a preset third prominent display style. For example, the movement trajectory may be displayed by using a red arc of a preset width, or the movement trajectory may be displayed by using a yellow dashed line of a preset width.

Through the foregoing step 2301 to step 2303, the movement trajectory of the special effects prop is determined based on the location (a starting point) of the first virtual object and the location (an end point) of the companion object, and the movement trajectory of the special effects prop is displayed in the virtual scene, so that the movement trajectory of the special effects prop can be determined and displayed before the special effects prop is thrown, the throwing preparation of the special effects prop can be realized, and the special effects prop can be prevented from being thrown to another location.

In some embodiments, when a companion object is displayed in the virtual scene displayed in a human-computer interaction interface, a status display region is presented in the human-computer interaction interface, and type information and health point information of the companion object are presented in the status display region. The type of the companion object may be a shield type, a patrol type, an attack type, and the like.

After the special effects prop is adsorbed onto the companion object, an identifier of the special effects prop may further be presented in the status display region, to prompt that the special effects prop is adsorbed on the companion object. Prop release countdown information is displayed in the status display region within a second preset duration before a release moment of the special effects prop is reached.

In some embodiments, a type of the prop release countdown information includes at least one of the following: a countdown progress bar; and a countdown value text. When the type of the prop release countdown information is the countdown progress bar, a length of the countdown progress bar gradually shortens with passage of time. When the type of the prop release countdown information is the countdown value text, with the passage of time, the countdown value text may be represented as a gradual decrease in the displayed number. In this way, the user can be intuitively and clearly reminded of the time when the special effects prop releases the special effects, so as to prompt the user to recall the companion object in time during releasing of the special effects, so that the companion object can be protected from damage.

In some embodiments, in order to enable the user to intuitively understand the power range generated during releasing of the special effects, a plurality of affected regions arranged radially may be displayed around the location of the companion object after the special effects prop is adsorbed on the companion object.

Different affected regions represent different degrees of influence of special effects. For example, when the virtual object is in an affected region A, after the special effects are released by the special effects prop, the state of the virtual object (such as a health point or a visual range) can be affected to some extent. The degree of influence caused corresponds to the affected region A. The plurality of affected regions may be geometric shapes having the same center or center of gravity, such as circles, sectors, rings, or squares. The affected regions may also be in irregular shapes.

The plurality of affected regions displayed in this embodiment of this disclosure may intuitively display the accurate location and an influence range of the special effects prop, and can keep away from the special effects prop with high-efficiency human-computer interaction operations, so that excessive operations are not needed, thereby concentrating on perceiving the virtual scene, and implementing desirable immersive perception of the virtual scene. Moreover, due to the reduction of human-computer interaction, the workload of graphic calculation for updating the virtual scene is reduced, and the consumption of related computing resources for human-computer interaction by graphic processing hardware is saved.

In some embodiments, before the special effects are released by the special effects prop, the location of the companion object is used as a radiation center, and the plurality of affected regions arranged radially are displayed between the radiation center and a radiation boundary corresponding to a radiation radius of the special effects prop.

When a distance between the fourth virtual object and the special effects prop is less than a safety distance threshold, and the special effects prop does not release the special effects, from the perspective of a fourth virtual object, the special effects prop adsorbed on the companion object is displayed in a preset first prominent display manner, the companion object is displayed in a preset second prominent display manner, and the plurality of affected regions arranged radially are displayed around the location of the companion object. The fourth virtual object belongs to a first game camp. That is, the fourth virtual object is a teammate of the first virtual object in the same camp.

In this embodiment of this disclosure, when the fourth virtual object is in the special effects influence range of the special effect prop thrown by the first virtual object, the fourth virtual object is prompted in real time. From the perspective of the fourth virtual object, the special effects prop adsorbed on the companion object is displayed in a preset first prominent display manner, the companion object is displayed in a preset second prominent display manner, and the plurality of affected regions arranged radially are displayed around the location of the companion object, so that the fourth virtual object can learn the location of the special effects prop in time to keep away from the special effects prop, thereby avoiding the influence brought by the special effects prop thrown by the companion and improving the efficiency of human-computer interaction.

As an example, from the perspective of the fourth virtual object, after the plurality of affected regions arranged radially are displayed around a target location, the displaying manner may further include: when at least one of the following conditions is satisfied, from the perspective of the fourth virtual object, stopping the display of the affected regions: the distance between the fourth virtual object and the special effects prop is not less than the safety distance threshold; and it is determined based on a movement trend of the fourth virtual object (such as a movement direction and speed) that the state of the fourth virtual object is not affected when the special effects are released by the special effects prop. According to this embodiment of this disclosure, the display of the affected regions can be stopped when the fourth virtual object does not understand the requirements of the special effects prop, and unnecessary calculation by the graphics processing hardware related to the display of the affected regions can be avoided, thereby saving resources.

In some embodiments, when the special effects prop is in the visual range of the fourth virtual object and the special effects prop has not released the special effects, from the perspective of the fourth virtual object, the special effects prop adsorbed on the companion object is displayed in a preset first prominent display manner, the companion object is displayed in a preset second prominent display manner, and the plurality of affected regions arranged radially are displayed around the location of the companion object. In this way, when the special effects props thrown by the first virtual object in the same group are in the visual range of the fourth virtual object, the fourth virtual object is prompted in real time, so that the fourth virtual object can learn the location of the special effects prop in time to keep away from the special effects prop, thereby avoiding the influence brought by the special effects prop thrown by the teammate and improving the efficiency of human-computer interaction.

In some embodiments, after the special effects prop is adsorbed on the companion object, during the movement of the companion object, if an attack operation of the third virtual object for the companion object is received and the attack operation acts on the special effects prop, the special effects prop is controlled to be disabled. The attack operation may be a long-range shooting operation, may further be a close-range killing operation, or may be an attack operation triggered by the third virtual object throwing other props on the companion object. As an example, when an attack operation acts on the special effects prop, the special effects prop is disabled immediately, or the power of the special effects prop is reduced to an extent every time an attack operation is received, and the special effects prop is disabled after a plurality of attack operations are received, so that the third virtual object can destroy the special effects prop.

In some embodiments, when a companion object on which the special effects prop is adsorbed is attacked and killed by another virtual object (such as a wild monster) rather than the third virtual object in the virtual scene, the special effects prop may be controlled to release special effects to cause damage to the wild monster, so as to protect the first virtual object. In addition, before the special effects prop is thrown, if a large quantity of wild monsters exist in a range close to the companion object, in order to prevent the special effects prop from being destroyed by the wild monster without sensing the third virtual object after adsorption, in this case, when the second operation of throwing the special effects prop is received, prompt information may be presented. The prompt information is used for prompting that the current scene is not suitable for throwing of the special effects prop, thereby improving the strategy and intelligence of the game.

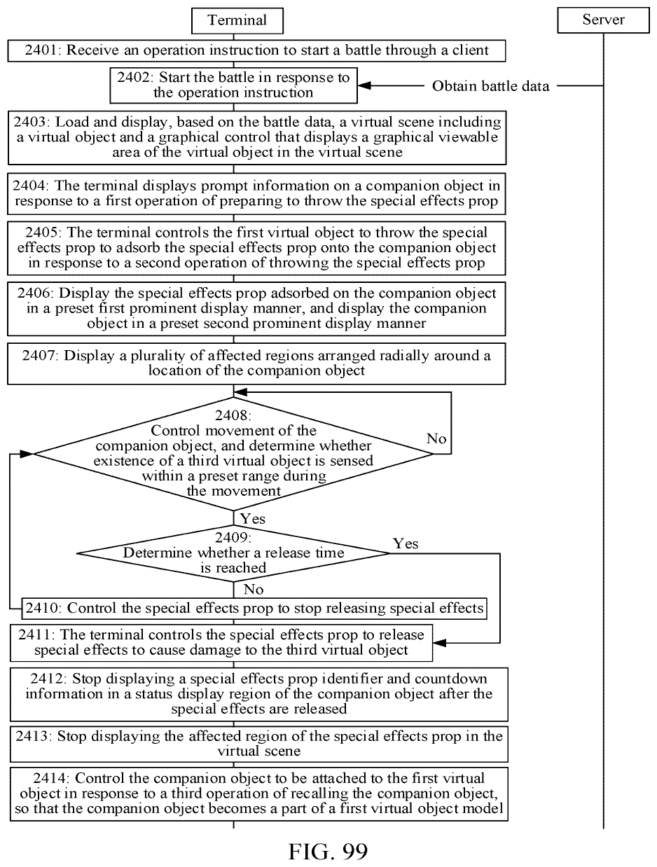

Based on the foregoing embodiments, this embodiment of this disclosure further provides a method for processing a special effects prop. FIG. 99 is a schematic flowchart of another implementation of a method for processing a special effects prop according to an embodiment of this disclosure. Steps are described below with reference to FIG. 99.

Step 2401: A terminal receives an operation instruction to start a battle through a client.

In this embodiment of this disclosure, the client may be a game application client, and the operation instruction to open the client may be an instruction generated based on a user clicking/tapping or touching a game application icon in a display screen of the terminal. The server may be a server corresponding to the application client.

In some embodiments, the client may further be a browser client, that is, the user may enter the game through a web page.

Step 2402: The terminal starts the battle and obtains battle data from the server in response to the operation instruction.

Step 2403: The terminal loads and displays, based on the battle data, a virtual scene including a virtual object and a graphical control that displays a graphical viewable area of the virtual object in the virtual scene.

The virtual scene herein may be an image frame including a game scene, and the virtual object may include a user-controlled object or a machine-controlled object.

For example, a quantity of virtual objects participating in interaction in the virtual scene may be preset, or may be dynamically determined based on the quantity of clients participating in the interaction.

A shooting game is used as an example. The user may control the virtual object to fall freely, glide, or fall after a parachute is opened in the sky in the virtual scene, or to run, jump, creep, or bend forward on land, or may control the virtual object to swim, float, or dive in the ocean. The user may also control the virtual object to ride in a virtual vehicle to move in the virtual scene. For example, the virtual vehicle may be a virtual automobile, a virtual aircraft, and a virtual yacht. Only the foregoing scene is used as an example for description herein, which is not limited in this embodiment of this disclosure. The user may also control the virtual object to interact with another virtual object in a confrontational manner through the special effects prop. For example, the special effects prop may be a projective special effects prop such as adsorption landmines and grenades.

Step 2404: The terminal displays prompt information on a companion object in response to a first operation of preparing to throw the special effects prop.

The prompt information is used for indicating information about a location where the special effects prop is thrown.

Step 2405: The terminal controls the first virtual object to throw the special effects prop to adsorb the special effects prop onto the companion object in response to a second operation of throwing the special effects prop.

The implementation processes of the foregoing step 2404 and step 2405 are similar to those of step 2202 and step 2203, and reference may be made to the implementation processes of step 2202 and step 2203.

In some embodiments, after the special effects prop is adsorbed on the companion object, a status display region of the first virtual object may be presented in a human-computer interaction interface, and type information, a health point, a special effects prop identifier, and prop release countdown information of the companion object are displayed in the status display region.

Step 2406: The terminal displays the special effects prop adsorbed on the companion object in a preset first prominent display manner, and displays the companion object in a preset second prominent display manner.

Step 2407: The terminal displays a plurality of affected regions arranged radially around a location of the companion object.

Step 2408: The terminal controls movement of the companion object and determines whether existence of a third virtual object is sensed within a preset range during the movement.

During the movement of the companion object, it may be determined whether another virtual object exists within the preset range by sensing pressure through a mechanical sensor, sensing sound through an ultrasonic sensor, or sensing heat through an infrared sensor. When it is determined that the another virtual object exists within the preset range, it is further determined based on an identifier of the another virtual object whether the another virtual object is the third virtual object or a friendly virtual object. When it is determined that the existence of the third virtual object is sensed within the preset range, step 2409 is performed, and when the existence of the third virtual object is not sensed during the movement, step 2408 continues to be performed.

Step 2409: The terminal determines whether a release time is reached.

In some embodiments, the step has at least the following two implementations.

The first implementation includes: determining a release moment of the special effects prop based on a current moment and a preset duration; further determining whether the release moment is reached, determining that the release time is reached when it is determined that the release moment of the special effects prop is reached, and then performing step 2411; and determining that the release time is not reached when the release moment of the special effects prop is not reached, and then performing step 2410.

The current moment is a moment when the terminal senses that the third virtual object exits within the preset range, rather than a moment when the special effects prop is thrown.

The second implementation includes: obtaining a quantity of fourth virtual objects currently in an affected region when the release moment of the special effects prop is reached; determining whether the quantity of objects is less than a preset quantity threshold, determining that the release time is reached when it is determined that the quantity of objects is less than the quantity threshold, and then performing step 2411; and determining that the release time is not reached when the quantity of objects is greater than or equal to the quantity threshold, and then performing step 2410.

In the first implementation, when the release moment is reached, that is, the release time is determined, the special effects prop can be released in time at this point to cause ranged damage to the third virtual object. In the second implementation, when the release moment is reached, it is further necessary to further determine a quantity of friendly virtual objects in the affected region of the special effects prop. When the quantity of friendly virtual objects is less than a specific quantity threshold, it is determined that the release time is reached, so as to avoid causing damage to a large quantity of friendly virtual objects during release of special effects.

In some embodiments, in response to a first switching operation being received, the special effects prop is controlled to release the special effects to cause damage to the third virtual object, the first switching operation being used for switching the companion object from a second state to a first state. Alternatively, the special effects prop is controlled to release the special effects after a first preset duration to cause damage to another virtual object in response to another virtual object existing within a preset range of the companion object or the special effects prop. The another virtual object includes at least one of the third virtual object and the fourth virtual object.

Step 2410: The terminal controls the special effects prop to stop releasing special effects.

After step 2410, step 2408 may be performed again to determine whether the third virtual object is sensed again and the release time is reached.

Step 2411: The terminal controls the special effects prop to release special effects to cause damage to the third virtual object.

The special effects prop releasing special effects may be special effects prop exploding, causing ranged damage to the third virtual object.

Step 2412: After the special effects are released, the terminal stops displaying a special effects prop identifier and countdown information in a status display region of the companion object.

That is to say, after the explosion of the special effects prop, the special effects prop identifier and the countdown information are no longer displayed in the status display region, and only the type and a health point of the companion object are displayed in the status display region of the companion object at this point.

Step 2413: The terminal stops displaying the affected region of the special effects prop in the virtual scene.

Step 2414: The terminal controls the companion object to be attached to the first virtual object in response to a third operation of recalling the companion object, so that the companion object becomes a part of a first virtual object model.

In this embodiment of this disclosure, the terminal may control the companion object to execute a ground movement instruction, so as to control the companion object to move in the virtual scene, thereby finding the third virtual object. In addition to this, in order to avoid the influence of the ranged damage caused by the companion object when the special effect prop releases the special effects, the terminal may trigger the third operation of recalling the companion object when the special effect prop releases the special effect, thereby sending a deformation instruction to the companion object, so as to control the companion object to deform and obtain the deformed companion object. Exemplarily, when the companion object is a shield monster, the deformed companion object may be transformed into a shield. When the companion object is a patrol monster, the deformed companion object may be transformed into goggles or glasses, that is, the deformed companion object corresponds to the type of the companion object.

The companion object in the first state may become a part of the first virtual object, and the companion object in the second state may return to the first virtual object in a flight form, so as to quickly evacuate from the affected region where the special effects are released, so as to use the flight form to immunize the damage caused during the release of the special effects prop.

In the method for processing a special effects prop provided in this embodiment of this disclosure, after the terminal starts a battle in response to an operation instruction to start the battle being received through the client, when the special effects prop needs to be thrown, the terminal determines the companion object in response to the first operation of preparing to project the special effects prop, and summons the companion object, that is, displays the companion object in the virtual scene. The companion object is a subordinate virtual object of the first virtual object, and the first virtual object is a virtual object that throws a special effects prop. When the second operation of throwing the special effects prop is received, the special effects prop is adsorbed onto the companion object in response to the second operation. Then, the movement of the companion object is controlled to patrol the enemy. When the existence of the third virtual object within the preset range is sensed during the movement of the companion object and the release time is reached, the special effects are released, thereby causing ranged damage to the third virtual object. In addition, while the special effects are being released, the terminal may control the companion object to deform and control the deformed companion object to return to the first virtual object, and the deformed companion object can be immune to the damage caused by the release of the special effects during the return. In this way, the release time of the special effects prop may be controlled through the companion object after the special effects prop is thrown, so as to ensure that the third virtual object can be confronted accurately. The companion object may further be deformed after the release of special effects, so as to ensure that the companion object is protected from the damage caused by the release of special effects, and effectively saves its own health point, thereby improving the combat effectiveness of the virtual object.

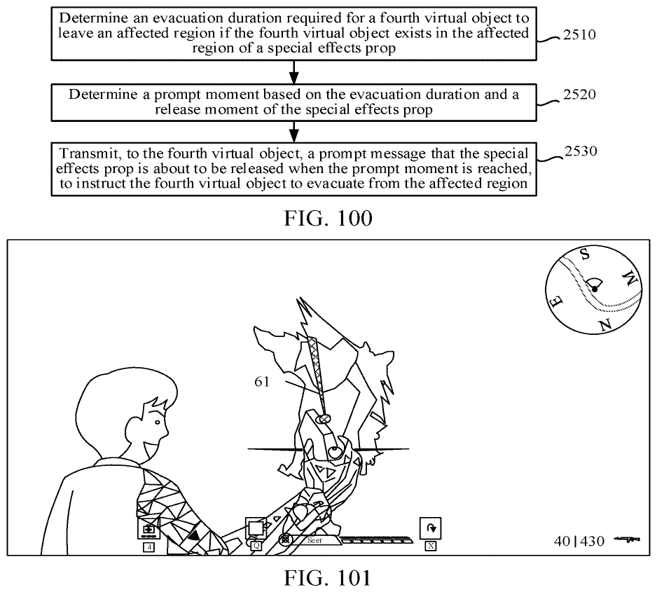

In some embodiments, as shown in FIG. 100, after the terminal determines that the existence of the third virtual object is sensed within the preset range from the companion object or the special effects prop, and determines the release moment based on the current moment and the preset duration, the following steps may further be performed.

Step 2510: Determine an evacuation duration required for a fourth virtual object to leave an affected region if the fourth virtual object exists in the affected region of the special effects prop.

During implementation of the step, a shortest distance between the fourth virtual object and an edge of the affected region may be determined based on third location information of the fourth virtual object, and then the evacuation duration required for the fourth virtual object to leave the affected region is determined based on the shortest distance and a movement speed of the fourth virtual object.

Step 2520: Determine a prompt moment based on the evacuation duration and the release moment of the special effects prop.

During implementation, a moment corresponding to the evacuation duration before the release moment is the prompt moment. For example, if the release moment is 15:11:10 and the evacuation duration is 2 seconds, the prompt moment is 15:11:08.

Step 2530: Transmit, to the fourth virtual object, a message that the special effects is about to be released when the prompt moment is reached, to instruct the fourth virtual object to evacuate from the affected region.

During implementation, in order to ensure that the fourth virtual object can be evacuated in time, a direction for fastest evacuation of the fourth virtual object may be presented simultaneously when the prompt message is presented.

Through the foregoing step 2510 to step 2530, before the special effects are released, a friendly virtual object in the affected region of the special effects prop can be prompted to evacuate in time, thereby avoiding causing damage to the virtual object in its own camp caused by releasing the special effects. In some embodiments, in order to further reduce the possibility of damaging the virtual object in its own camp, when it is determined that the friendly virtual object exists within an influence range of the special effects prop, prompt information is immediately transmitted to the friendly virtual object to instruct the fourth virtual object to evacuate from the affected region, so as to avoid damage.

An exemplary application of this embodiment of this disclosure in an application scene is to be described below.

This embodiment of this disclosure provides a method for processing a special effects prop. In this embodiment of this disclosure, the special effects prop being an adsorption landmine and the companion object being a nano companion are used as an example for description. The method for processing a special effects prop provided in this embodiment of this disclosure may be applied to a game product having a core-controlled nano companion, and a player may convert a wild monster to different nano companions through different core chips to assist the player in the combat, for example, may convert the wild monster to a patrol monster, a shield monster, and the like. The patrol monster may help the friendly virtual object obtain a view, and the shield monster may generate a shield. By using the method for processing a special effects prop provided in this embodiment of this disclosure, the player uses the adsorption landmine to aim at the nano companion, and adsorbs the landmine onto the nano companion, and an indication line 61 shown in FIG. 101 is used for indicating a location for releasing during the release.

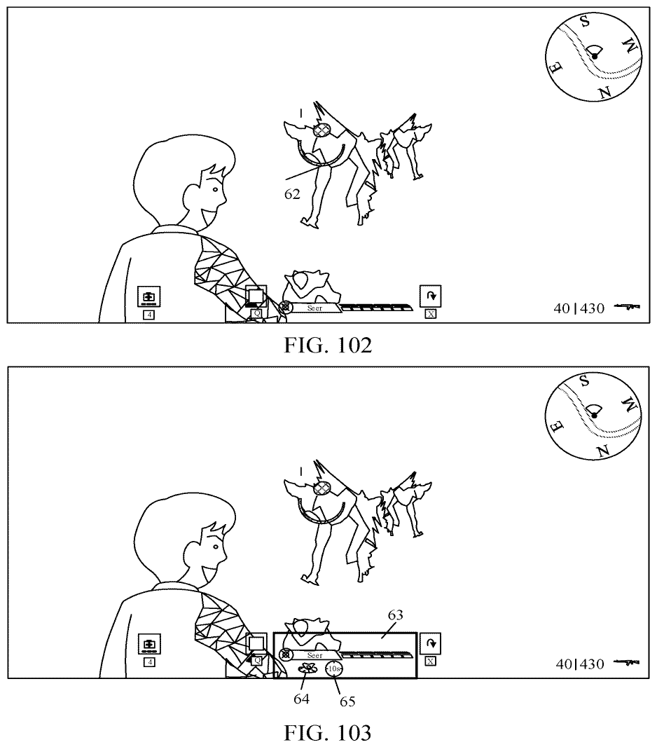

As shown in FIG. 102, after the landmine is adsorbed on the nano companion, a prompt line 62 may be maintained on the nano companion, so that the player can determine the nano companion with the landmine adsorbed, thereby controlling the nano companion with the landmine adsorbed to execute some instructions, for example, executing an automatic enemy search instruction. In the process of the nano companion automatically searching for an enemy, the adsorbed landmine may explode after sensing that an enemy exists within the preset range, causing multi-range damage. In this embodiment of this disclosure, the landmine may also sense an invisible enemy player.

The landmine may also cause damage to the nano companion when exploding. Since the nano companion can execute a plurality of instructions, including at least an arm instruction and a ground instruction, at the moment when the landmine explodes, the arm instruction may be used to recall the arm of the nano companion, so that the nano companion is immune to part of the damage.

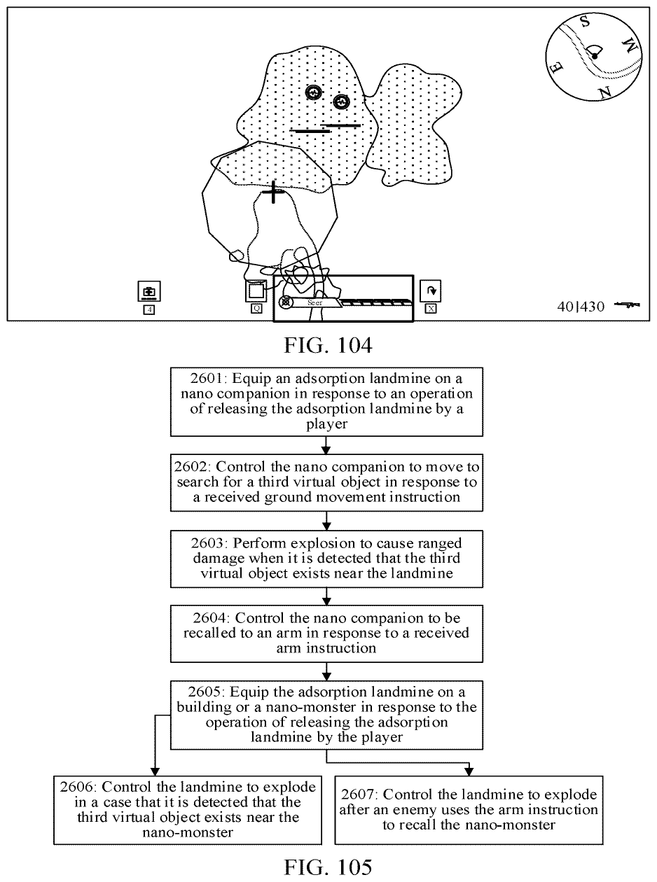

In the actual application process, a prompt region 63 shown in FIG. 103 is further presented in a lower part of a game interface. A type of a nano companion in normal use and status information of the nano companion may be presented in the prompt region. In this embodiment of this disclosure, when a landmine is adsorbed on the nano companion, a landmine identifier 64 and countdown information 65 are further presented in the prompt region, which prompts that the landmine is adsorbed on the nano companion. After the landmine explodes, as shown in FIG. 104, the landmine identifier and the countdown information disappear, and in this case, the player may be prompted to recall the nano companion and avoid damage. The explosion of the landmine may cause ranged damage, and may affect the player and the nano companion, and the nano companion may also be killed by the landmine.

The adsorption landmine may be adsorbed on the nano companion, and may further be adsorbed at another location, for example, on a building or a nano-monster. The landmine may not explode immediately if adsorbed on the nano-monster, but explodes after sensing the enemy hero, or explodes automatically after the nano companion dies, or may explode immediately after the enemy recalls the nano-monster to the arm.

The technical implementation process of the method for processing a special effects prop provided in this embodiment of this disclosure is described below, and the special effects prop being the adsorption landmine is used as an example for description. FIG. 105 is a schematic flowchart of another implementation of a method for processing a special effects prop according to an embodiment of this disclosure. As shown in FIG. 105, the flow includes the following steps.

Step 2601: Equip an adsorption landmine on a nano companion in response to an operation of releasing the adsorption landmine by a player.

Before a battle is played, the player needs to equip an equipment interface with an adsorption landmine prop, and then starts the battle. During the battle, the player may use the adsorption landmine and hold down the release button to enter a preparation stage, and after receiving the release preparation instruction of the user, the client displays prompt information, and displays a release trajectory of the adsorption landmine. When the player triggers the operation of releasing the adsorption landmine, the client obtains a release instruction of the user, equips the adsorption landmine on the nano companion based on the trajectory, and displays prompt information on the nano companion.

In addition, a game picture further includes a status information prompt region of the nano companion, and the client may further display landmine prompt information in the status information prompt region after obtaining an instruction for successful landmine equipping.

Step 2602: Control the nano companion to move to search for a third virtual object in response to a received ground movement instruction.

Step 2603: Perform explosion to cause ranged damage when it is detected that the third virtual object exists near the landmine.

When the client detects that the third virtual object exists within a preset range of the adsorption landmine, the landmine explodes, causing ranged damage, and the landmine prompt information disappears after the explosion.

Step 2604: Control the nano companion to be recalled to an arm in response to a received arm instruction.

After the landmine explodes, the player may use the arm instruction. After the client obtains the arm instruction of the player, in response to the arm instruction to control the nano companion to turn into fragments and fly back to the arm of the player to become a part of a virtual object of the player, the nano companion may be immune to damage during flying back after being turned into fragments.

Step 2605: Equip the adsorption landmine on a building or a nano-monster in response to the operation of releasing the adsorption landmine by the player.

Step 2606: Control the landmine to explode in a case that it is detected that the third virtual object exists near the nano-monster.

Step 2607: Control the landmine to explode after an enemy uses the arm instruction to recall the nano-monster.

When it is determined that the third virtual object uses the arm instruction, the nano companion is recalled to the arm, and when it is determined that the recalling succeeds, the landmine is controlled to generate explosion damage.

In the method for processing a special effects prop provided in this embodiment of this disclosure, through nano companion-guided gameplay, a nano companion may be summoned first, and then the adsorption landmine is adsorbed on the nano companion, so that the player can control the nano companion to move, and when it is detected that a third virtual object exists near the nano companion, explosion may be sensed (which can also be sensed even if the third virtual object is invisible). In this way, after the adsorption landmine is released, the time of landmine explosion may further be controlled by moving the nano companion, and the gameplay is more abundant.

FIG. 3 is a block diagram of an apparatus for controlling a companion object according to an exemplary embodiment of this disclosure. The apparatus includes a display module 20 and a control module 40. The display module 20 is configured to display a virtual scene, the virtual scene including a first virtual object and a companion object, the companion object being a subordinate object of the first virtual object. The control module 40 is configured to control the companion object to switch between a first state and a second state. The first state is a state in which the companion object is attached to the first virtual object in a first form to become a part of the first virtual object, and the second state being a state in which the companion object acts in a second form independently of the first virtual object.

In some embodiments, the display module 20 is configured to display a second virtual object, and the control module 40 is configured to control the first virtual object to convert the second virtual object to the companion object.

In some embodiments, the control module 40 is configured to control the first virtual object to interact with the second virtual object in a weak state in the virtual scene in a case that an attribute value of the first virtual object is greater than an attribute threshold, and to perform, in response to a set interaction result being achieved, one of the following processes:
switch the second virtual object from a third form to a fourth form by using a virtual prop, play a special effects animation in which the second virtual object in the fourth form moves to a location of the first virtual object, and convert the second virtual object in the fourth form to the companion object in the first state; and
convert the second virtual object to the companion object in the second state by using the virtual prop.

In some embodiments, the control module 40 is configured to: control the first virtual object to move to a location of a supply box; and control the first virtual object to perform a picking operation to obtain the virtual prop.

In some embodiments, at least two types of virtual props correspond to different companion objects.

In some embodiments, at least two types of companion objects are to be attached to different parts of the first virtual object.

In some embodiments, at least two types of companion objects provide different attribute promotion and/or skill assistance for the first virtual object.

In some embodiments, the first form is a form in which the companion object is attached to a body part of the first virtual object, and at least two types of companion objects correspond to different first forms.

In some embodiments, a type of the companion object includes: at least one of a shield object, a scouting object, and an attack object,
in a case that the companion object is the shield object, the shield object being configured to resist an attack performed by another virtual object in the virtual scene on the first virtual object;
in a case that the companion object is the scouting object, the scouting object being configured to release a scouting signal in a second region to sense a virtual object existing in the second region; and
in a case that the companion object is the attack object, the attack object being configured to assist the first virtual object in attacking a virtual object in a hostile camp.

In some embodiments, the control module 40 is configured to: control the companion object to switch from the first state to the second state in response to a first switching operation on the companion object; and control the companion object to switch from the second state to the first state in response to a second switching operation on the companion object.

In some embodiments, the control module 40 is configured to: determine a distance between a locked location and a location of the first virtual object in response to a first locking operation on the locked location; control the companion object to move to the locked location and switch the companion object from the first form to the second form at the locked location in a case that the distance is less than or equal to a first distance threshold; and control the companion object to move to a first location, switch the companion object from the first form to the second form at the first location, and control the companion object to move from the first location to the locked location in a case that the distance is greater than the first distance threshold,
a distance between the first location and the location of the first virtual object on a first connecting line being the first distance threshold, the first connecting line being used for connecting the locked location to the location of the first virtual object.

In some embodiments, the control module 40 is configured to: control the companion object to move to a second location and switch the companion object from the first form to the second form at the second location in a case that the locked location is a location unreachable by the companion object in the virtual scene,
the second location being a location on the first connecting line reachable by the companion object and closest to the locked location.

In some embodiments, the control module 40 is configured to: determine a ground projection location corresponding to the locked location in the virtual scene in a case that the locked location is in the air of the virtual scene; and control the at least one companion object in the second form to move from the locked location to the ground projection location through a virtual gravity, and attenuate a state parameter of a virtual object existing in a first region centered on the ground projection location.

In some embodiments, the control module 40 is configured to: in response to a second locking operation on a third virtual object, control the companion object to move to a third location, switch the companion object from the first form to the second form at the third location, and control the companion object to move from the third location to the location of the third virtual object, a distance between the third location and the location of the third virtual object on a second connecting line being a second distance threshold, the second connecting line being used for connecting the location of the first virtual object to the location of the third virtual object.

In some embodiments, the control module 40 is configured to: control the companion object to switch from the first state to the second state in a case that the first virtual object and/or the companion object satisfies a first switching condition; and control the companion object to switch from the second state to the first state in a case that the first virtual object and/or the companion object satisfies a second switching condition.

In some embodiments, the first switching condition includes at least one of the following:
a quantity of second virtual objects within an attack range of the first virtual object is less than or equal to a first quantity threshold;
the first virtual object or another object in a first camp to which the first virtual object belongs needs assistance; and
a time to attack a second camp arrives, the second camp being a hostile camp of the first camp to which the first virtual object belongs;
a duration for which the companion object is in the first form reaches a first duration threshold; and
the first virtual object enters an aiming state.

In some embodiments, the second switching condition includes at least one of the following:
the quantity of second virtual objects within the attack range of the first virtual object is greater than or equal to a second quantity threshold;
a distance between the first virtual object and the companion object is greater than or equal to a third distance threshold;
a duration for which the companion object is in the second form reaches a second duration threshold;
the companion object completes a task and does not receive a new task triggering operation within a waiting time after completing the task;
the first virtual object exits the aiming state;
an attribute value of the companion object is less than a preset threshold; and
the companion object receives an attack from a third virtual object.

In some embodiments, the control module 40 is configured to: control the companion object to move to a fourth location in a first manner, control the companion object to move from the fourth location to a location of the first virtual object in the first manner, and switch the companion object from the second form to the first form in a case that the first virtual object and/or the companion object satisfies the second switching condition, a distance between the fourth location and the location of the first virtual object on a third connecting line being the third distance threshold, the third connecting line being used for connecting the location of the first virtual object to the location of the companion object.

In some embodiments, the control module 40 is configured to: control the companion object to move to the location of the first virtual object in a second manner and switch the companion object from the second form to the first form in a case that the first virtual object and/or the companion object satisfies the second switching condition,
the first manner being a manner in which the at least one companion object moves by instantaneously changing a location, and the second manner being a manner in which the at least one companion object moves by gradually changing the location.

In some embodiments, the apparatus further includes:
an obtaining module 60, configured to obtain a state of the companion object in the second form; and
a display module 20, configured to display prompt information when the at least one companion object is in an unresponsive state, the prompt information being used for prompting that the companion object is currently not switchable from the second state to the first state.

In some embodiments, the control module 40 is configured to control the companion object to be immune to damage during switching between the first state and the second state.

In some embodiments, the control module 40 is configured to control the companion object in the first state to enhance the first virtual object, the enhancement including at least one of the following:
enhancing a scouting capability of the first virtual object;
enhancing a defense capability of the first virtual object;
increasing a weapon attack speed of the first virtual object;
enhancing a weapon attack buff of the first virtual object; and
increasing an energy storage capacity of the first virtual object.

In some embodiments, the control module 40 is configured to control the companion object in the second state to assist the first virtual object, the assistance including at least one of the following:
assisting the first virtual object in scouting;
assisting the first virtual object in a defense;
assisting the first virtual object in a patrol;
assisting the first virtual object in an attack; and
assisting the first virtual object in a taunt.

In some embodiments, the control module 40 is configured to: display first location information of a third virtual object in a map display control in response to the first virtual object not entering an aiming state and the third virtual object being discovered through scouting of a first region centered on the first virtual object; scout a first fan-shaped region centered at the first virtual object in response to the first virtual object entering the aiming state; and display second location information of the third virtual object in the map display control in a case that the third virtual object is discovered through scouting of the first fan-shaped region,
an accuracy of the second location information being greater than an accuracy of the first location information.

In some embodiments, the companion object corresponds to an energy value progress bar. The control module 40 is configured to scout a second fan-shaped region within a first duration in response to the first virtual object entering the aiming state and an energy value indicated in the energy value progress bar satisfying an enhancement condition,
the energy value progress bar being configured to indicate the first duration, and a size of the second fan-shaped region being greater than a size of the first fan-shaped region.

In some embodiments, the control module 40 is configured to store energy corresponding to the energy value progress bar in response to the first virtual object not entering the aiming state.

In some embodiments, the display module 20 is configured to display second location information of the third virtual object in the map display control and set the third virtual object to a marked state in a case that the third virtual object is discovered through scouting within the first duration,
the second location information of the third virtual object in the marked state being to be continuously displayed in the map display control, and the marked state having a duration.

In some embodiments, the control module 40 is configured to control the companion object to perform scouting at a specified location or in a specified region in the virtual scene; and the display module 20 is configured to display location information of a third virtual object in a map display control in response to the companion object discovering the third virtual object through scouting of the virtual scene.

In some embodiments, the control module 40 is configured to control the companion object to mimic an image of the third virtual object.

In some embodiments, the display module 20 is configured to display an image selection interface and display selectable images corresponding to at least two third virtual objects on the image selection interface in a case that the at least two third virtual objects exist; and
the control module 40 is configured to determine the selected image of the third virtual object in response to a selection operation on the images.

In some embodiments, the control module 40 is configured to: control the companion object to exit mimicry and return to the second form in response to the companion object after mimicry being attacked by the third virtual object; and control the companion object in the second form to scout the virtual scene for objects.

In some embodiments, the control module 40 is configured to: control the companion object to release a marking wave around and display a second region affected by the marking wave; and prominently display the third virtual object and display third location information of the third virtual object in the map display control for viewing by a friendly virtual object in a first camp to which the first virtual object belongs in response to the companion object discovering the third virtual object through scouting of the second region.

In some embodiments, the control module 40 is configured to: control the companion object to lock the third virtual object in response to the companion object discovering the third virtual object through scouting of the second region; and display the third virtual object at a target location in a see-through view in a case that the third virtual object moves in the virtual scene and moves to the target location blocked by an obstacle.

In some embodiments, the control module 40 is configured to control the companion object to track the third virtual object and update and display the location information of the third virtual object in the map display control in response to a tracking instruction for the third virtual object.

In some embodiments, the control module 40 is configured to control the companion object in the first form to increase a shield energy storage capacity for the first virtual object not in an aiming state.

In some embodiments, the control module 40 is configured to control the companion object in the second state to release a first virtual shield in an aiming direction where the first virtual object is used as a reference location in response to the first virtual object being in an aiming state.

In some embodiments, the display module 20 is configured to display the first virtual shield being changed from a first shield form to a second shield form in response to the first virtual object performing a virtual attack activity,
a protecting effect of the first shield form being better than that of the second shield form, and the first virtual object and a third virtual object belonging to different virtual camps.

In some embodiments, the display module 20 is configured to: display reduced shield energy of the first virtual shield based on shield energy consumed by the virtual attack activity in response to the first virtual object performing the virtual attack activity; and display the first virtual shield being changed from the first shield form to the second shield form, the second shield form being determined based on the reduced shield energy.

In some embodiments, the control module 40 is configured to control the companion object in the second state to release the first virtual shield in a changed aiming direction in response to the aiming direction of the first virtual object being changed.

In some embodiments, the control module 40 is configured to control the companion object in the first form to enhance the first virtual object, including at least one of following steps:
controlling the companion object in the first form to increase the weapon attack speed of the first virtual object; and
controlling the companion object in the first form to add the weapon attack buff of the first virtual object.

In some embodiments, the control module 40 is configured to control the first virtual object to launch virtual ammunition with an explosion effect in response to no other shooting operation being received within a target duration before a current shooting operation is received.

In some embodiments, the control module 40 is configured to control the first virtual object to store explosion energy of the virtual ammunition in response to the companion object being loaded with the long-range enhancement prop and a current shooting operation being not received.

In some embodiments, the control module 40 is configured to store the explosion energy of the virtual ammunition again in response to another shooting operation being received before a storage time of the explosion energy of the virtual ammunition reaches the target duration.

In some embodiments, the control module 40 is configured to determine whether a weapon equipped on the first virtual object satisfies a weapon enhancement condition of a companion object.

In some embodiments, the control module 40 is configured to control the companion object in the second state to assist the first virtual object, the assistance including at least one of the following:
controlling the companion object in the second state to perform a patrol behavior in the virtual scene;
controlling the companion object in the second state to taunt a third virtual object in the virtual scene;
controlling the companion object in the second state to perform a melee attack on the third virtual object in the virtual scene;
controlling the companion object in the second state to track the third virtual object in the virtual scene; and
controlling the companion object in the second state to perform a long-range attack on the third virtual object in the virtual scene.

In some embodiments, a melee buff and/or a long-range buff is probabilistic.

In some embodiments, the melee buff and/or the long-range buff includes at least one of the following effects:
damage over time (DOT); paralysis; reducing an armor recovery rate; and reducing a defensive power.

In some embodiments, the display module 20 is configured to: display the companion object in the second state being in a detonated state in response to an attribute value of the companion object being less than a preset threshold; and display, in response to a detonation instruction being received, prompt information indicating that the companion object in the second state detonates.

In some embodiments, the display module 20 is configured to add an invisibility effect to the companion object in the second state, the companion object being invisible to a third virtual object in the virtual scene when being made invisible.

In some embodiments, the control module 40 is configured to control the fourth companion object in the second state to remove the invisibility effect in response to the companion object satisfying an invisibility removal condition.

In some embodiments, the invisibility removal condition includes at least one of the following:
a virtual health point of the companion object decreases; or
the companion object initiates interaction with the third virtual object in the virtual scene.

In some embodiments, the display module 20 is configured to display the companion object firing a marked prop to a third virtual object in a case that a marked prop firing condition is satisfied, the marked prop being configured to identify a location of a virtual object that is hit.

In some embodiments, the display module 20 is configured to: display the marked prop being attached to the third virtual object in a case that the marked prop hits the third virtual object; and display the marked prop transmitting a location identification signal for the third virtual object within a first target duration after the marked prop hits the third virtual object.

In some embodiments, the firing condition includes at least one of the following: the third virtual object is located within an interaction range of the companion object;
an instruction to fire the marked prop transmitted by the first virtual object to the companion object is received; and
the third virtual object performs an interactive behavior that causes the virtual health point of the companion object to decrease.

In some embodiments, the display module 20 is configured to display the marked prop being destroyed in response to the attack on the marked prop satisfying a condition.

In some embodiments, the control module 40 is configured to: control the companion object in the first state to perform a first enhancement on the first virtual object in a case that the companion object is not equipped with an enhancement prop; and control the companion object in the first state to perform a second enhancement on the first virtual object in a case that the companion object is equipped with the enhancement prop,
an enhancement effect of the second enhancement being better than that of the first enhancement.

In some embodiments, the control module 40 is configured to: control the companion object in the first state to perform a first assistance on the first virtual object in a case that the companion object is not equipped with an enhancement prop; and control the companion object in the first state to perform a second assistance on the first virtual object in a case that the companion object is equipped with the enhancement prop,
an assistance effect of the second assistance being better than that of the first assistance.

In some embodiments, the control module 40 is configured to: control a first virtual object to throw a special effects prop to adsorb the special effects prop onto a companion object; and control the special effects prop to release special effects to cause damage to a third virtual object.

In some embodiments, the control module 40 is configured to: control the special effects prop to release the special effects to cause damage to the third virtual object in response to a first switching operation being received, the first switching operation being used for switching the companion object from a second state to a first state; or control the special effects prop to release the special effects after a first preset duration to cause damage to another virtual object in response to another virtual object existing within a preset range of the companion object or the special effects prop.

In some embodiments, the display module 20 is configured to: present a status display region, and present type information and health point information of the companion object in the status display region; present an identifier of the special effects prop in the status display region to prompt that the special effects prop is adsorbed on the companion object after the special effects prop is adsorbed onto the companion object; and display prop release countdown information in the status display region within a second preset duration before a release moment of the special effects prop is reached.

In some embodiments, the another virtual object includes the third virtual object belonging to a different camp from the first virtual object.

In some embodiments, the control module 40 is configured to: determine a release moment of the special effects prop based on a current moment and the first preset duration in response to the third virtual object existing within the preset range of the companion object or the special effects prop; and control the special effects prop to release the special effects in a case that the release moment of the special effects prop is reached.

In some embodiments, the control module 40 is configured to: obtain a quantity of third virtual objects currently in an affected region when the release moment of the special effects prop is reached; and control the special effects prop to suspend the release of the special effects in a case that the quantity of objects is greater than or equal to a quantity threshold.

In some embodiments, the display module 20 is configured to display the third virtual object being in a deceleration effect in response to the third virtual object existing within a special effects range of the special effects prop.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

An exemplary embodiment of this disclosure further provides a computer-readable storage medium, such as a non-transitory computer-readable storage medium. The computer-readable storage medium stores at least one program, the at least one program being loaded and executed by a processor to implement the method for controlling a companion object according to the foregoing method embodiments.

An exemplary embodiment of this disclosure further provides a computer program product, the computer program product including at least one program, the at least one program being stored in a computer-readable storage medium. A processor of a computer device reads signaling from the computer-readable storage medium, and the processor executes the signaling, so that the computer device performs the method for controlling a companion object according to the foregoing method embodiments.

An exemplary embodiment of this disclosure further provides a computer program, the computer program including at least one program, the at least one program being stored in a computer-readable storage medium. A processor of a computer device reads signaling from the computer-readable storage medium, and the processor executes the signaling, so that the computer device performs the method for controlling a companion object according to the foregoing method embodiments.

What is claimed is:

1. A method for controlling an associated virtual object, the method comprising:
outputting, for display, a virtual scene of a virtual environment, the virtual environment including a first virtual object;
controlling the first virtual object to move in the virtual environment;
controlling a state of the associated virtual object of the first virtual object to switch between a first state and a second state based on a first user input; and
outputting, for display, the associated virtual object based on the state of the associated virtual object, wherein
in the first state, the associated virtual object is carried by the first virtual object and configured perform a first function; and
in the second state, the associated virtual object is configured to move separately from the first virtual object and perform a second function that is different from the first function.

2. The method according to claim 1, wherein:
the first function is to enhance the first virtual object, and
the second function is to assist the first virtual object to perform a task.

3. The method according to claim 1, wherein
when the associated virtual object is in the first state, the associated virtual object is in a first form that is attached to the first virtual object, and
when the associated virtual object is in the second state, the associated virtual object is in a second form that is configured to move separately from the first virtual object, the first form of the associated virtual object being different from the second form of the associated virtual object.

4. The method according to claim 1, wherein
the first function is to increase a first visible region of the virtual environment from a position of the first virtual object, and
the second function is to increase a second visible region of the virtual environment from a position of the associated virtual object.

5. The method according to claim 1, wherein
the second function is to perform scouting of a region of the virtual environment based on a second user input; and
the method further includes outputting, for display, location information of a third virtual object when the third virtual object is in the scouted region of the virtual environment.

6. The method according to claim 1, wherein
the first function is to increase a shield attribute of the first virtual object, and
the second function is to generate a virtual shield in the virtual environment.

7. The method according to claim 6, wherein a position of the virtual shield is based on an aiming direction of the first virtual object.

8. The method according to claim 1, wherein
the first function is to perform a first enhancement on the first virtual object based on the associated virtual object not being equipped with an enhancement prop;
the first function is to perform a second enhancement on the first virtual object based on the associated virtual object being equipped with the enhancement prop; and
an enhancement effect of the second enhancement is greater than an enhancement effect of the first enhancement.

9. The method according to claim 1, wherein
the second function is to perform a first assistance of the first virtual object based on the associated virtual object not being equipped with an enhancement prop;
the second function is to perform a second assistance of the first virtual object based on the associated virtual object being equipped with the enhancement prop; and
an assistance effect of the second assistance is greater than an assistance effect of the first assistance.

10. A non-transitory computer-readable storage medium storing instruction which, when executed by a processor, cause the processor to perform:
outputting, for display, a virtual scene of a virtual environment, the virtual environment including a first virtual object;
controlling the first virtual object to move in the virtual environment;
controlling a state of an associated virtual object of the first virtual object to switch between a first state and a second state based on a first user input; and
outputting, for display, the associated virtual object based on the state of the associated virtual object, wherein
in the first state, the associated virtual object is carried by the first virtual object and configured perform a first function; and
in the second state, the associated virtual object is configured to move separately from the first virtual object and perform a second function that is different from the first function.

11. The non-transitory computer-readable storage medium according to claim 10, wherein:
the first function is to enhance the first virtual object, and
the second function is to assist the first virtual object to perform a task.

12. The non-transitory computer-readable storage medium according to claim 10, wherein:
when the associated virtual object is in the first state, the associated virtual object is in a first form that is attached to the first virtual object, and
when the associated virtual object is in the second state, the associated virtual object is in a second form that is configured to move separately from the first virtual object, the first form of the associated virtual object being different from the second form of the associated virtual object.

13. The non-transitory computer-readable storage medium according to claim 10, wherein:
the first function is to increase a first visible region of the virtual environment from a position of the first virtual object, and
the second function is to increase a second visible region of the virtual environment from a position of the associated virtual object.

14. The non-transitory computer-readable storage medium according to claim 10, wherein:
the second function is to perform scouting of a region of the virtual environment based on a second user input; and
the instructions, when executed by the processor, further cause the processor to perform outputting, for display, location information of a third virtual object when the third virtual object is in the scouted region of the virtual environment.

15. The non-transitory computer-readable storage medium according to claim 10, wherein:
the first function is to increase a shield attribute of the first virtual object, and
the second function is to generate a virtual shield in the virtual environment.

16. The non-transitory computer-readable storage medium according to claim 15, wherein a position of the virtual shield is based on an aiming direction of the first virtual object.

17. The non-transitory computer-readable storage medium according to claim 10, wherein
the first function is to perform a first enhancement on the first virtual object based on the associated virtual object not being equipped with an enhancement prop;
the first function is to perform a second enhancement on the first virtual object based on the associated virtual object being equipped with the enhancement prop; and
an enhancement effect of the second enhancement is greater than an enhancement effect of the first enhancement.

18. The non-transitory computer-readable storage medium according to claim 10, wherein
the second function is to perform a first assistance of the first virtual object based on the associated virtual object not being equipped with an enhancement prop;
the second function is to perform a second assistance of the first virtual object based on the associated virtual object being equipped with the enhancement prop; and
an assistance effect of the second assistance is greater than an assistance effect of the first assistance.

19. An information processing apparatus, comprising:
processing circuitry configured to:
output, for display, a virtual scene of a virtual environment, the virtual environment including a first virtual object;
control the first virtual object to move in the virtual environment;
control a state of an associated virtual object of the first virtual object to switch between a first state and a second state based on a first user input; and
output, for display, the associated virtual object based on the state of the associated virtual object, wherein
in the first state, the associated virtual object is carried by the first virtual object and configured perform a first function; and
in the second state, the associated virtual object is configured to move separately from the first virtual object and perform a second function that is different from the first function.

20. The information processing apparatus according to claim 19, wherein:
the first function is to enhance the first virtual object, and
the second function is to assist the first virtual object to perform a task.
